(19) United States
(12) Patent Application Publication
(10) Pub. No.: US 2026/0273766 A1
(43) Pub. Date: Sep. 17, 2026

(54) Action Control System, Control System, and Information Processing System

(71) Applicant: Softbank Group Corp., Tokyo (JP)

(72) Inventors: Masayoshi Son, Minato-ku, Tokyo (JP); Yuka Kimura, Minato-ku, Tokyo (JP); Ryosuke Takatsu, Minato-ku, Tokyo (JP); Takeshi Yoshitomi, Minato-ku, Tokyo (JP); Akiho Shibata, Minato-ku, Tokyo (JP); Shinichiro Karatsu, Minato-ku, Tokyo (JP); Michio Ikeda, Minato-ku, Tokyo (JP)

(21) Appl. No.: 19/474,028

(22) PCT Filed: Apr. 11, 2024
(86) PCT No.: PCT/JP2024/014727

§ 371 Date: Oct. 9, 2025

(30) Foreign Application Priority Data
Apr. 11, 2023 (JP) 2023-064495
Apr. 17, 2023 (JP) 2023-067248
Apr. 17, 2023 (JP) 2023-067493
Apr. 18, 2023 (JP) 2023-068146
Apr. 18, 2023 (JP) 2023-068147
Apr. 19, 2023 (JP) 2023-068821
Apr. 19, 2023 (JP) 2023-068822
Apr. 20, 2023 (JP) 2023-069436
Apr. 20, 2023 (JP) 2023-069667
Apr. 21, 2023 (JP) 2023-070468
Apr. 21, 2023 (JP) 2023-070471
Apr. 25, 2023 (JP) 2023-071853
Apr. 26, 2023 (JP) 2023-072216
Apr. 26, 2023 (JP) 2023-072763
Apr. 26, 2023 (JP) 2023-072764
Apr. 27, 2023 (JP) 2023-073207
Apr. 27, 2023 (JP) 2023-073825
Apr. 28, 2023 (JP) 2023-074132
Apr. 28, 2023 (JP) 2023-075226
Apr. 28, 2023 (JP) 2023-075227
May 11, 2023 (JP) 2023-078822
May 12, 2023 (JP) 2023-079461
May 12, 2023 (JP) 2023-079466
May 12, 2023 (JP) 2023-079679
May 15, 2023 (JP) 2023-080316
May 16, 2023 (JP) 2023-081013
May 19, 2023 (JP) 2023-083427
May 19, 2023 (JP) 2023-083428
Jul. 24, 2023 (JP) 2023-120322
Aug. 2, 2023 (JP) 2023-126495

(51) Int. Cl. B25J 11/00; A63H 11/00; B25J 13/00; G06V 20/40; G06V 40/16; G10L 15/22; G10L 25/63

(52) U.S. Cl. CPC B25J 11/001; A63H 11/00; B25J 13/003; G06V 20/42; G06V 40/174; G10L 15/22; G10L 25/63; A63H 2200/00

(57) ABSTRACT

An action control system includes an emotion determination unit that determines an emotion of a user or an emotion of a robot; and an action determination unit that generates action content of the robot with respect to an action of the user and the emotion of the user or the emotion of the robot on the basis of an interaction function of allowing the user and the robot to interact with each other, and determines an action of the robot corresponding to the action content. The action determination unit includes an image acquisition unit capable of imaging a competition space in which a specific competition is able to be performed, and a competitor emotion analysis unit that analyzes emotions of plural competitors performing a competition in the competition space imaged by the image acquisition unit, and determines an action of the robot on the basis of an analysis result from the competitor emotion analysis unit.

### TECHNICAL FIELD

The present disclosure relates to an action control system, a control system, and an information processing system.

### BACKGROUND ART

Patent Literature 1 discloses a technique for determining an appropriate action of a robot with respect to a state of a user. In the related art of Patent Literature 1, a reaction of a user in a case in which the robot executes a specific action is recognized, and in a case in which an action of the robot with respect to the recognized reaction of the user cannot be determined, the action of the robot is updated by receiving information regarding an action suitable for the recognized state of the user from a server.

Patent Literature 2 discloses a persona chatbot control method executed by at least one processor, the method including a step of receiving user speech, a step of adding the user speech to a prompt including an instructional sentence associated with an explanation of a character of a chatbot, a step of encoding the prompt, and a step of inputting the encoded prompt to a language model to generate chatbot speech that is responsive to the user speech.

Patent Literature 3 discloses an emotion specifying system that specifies an emotion of a robot.

### PATENT LITERATURE

Patent Literature 1: Japanese Patent No. 6053847
Patent Literature 2: Japanese Patent Application Laid-Open No. 2022-180282 A
Patent Literature 3: Japanese Patent Application Laid-Open No. 2017-199319 A

### SUMMARY OF INVENTION

### Technical Problem

However, in the related art, there is room for improvement in causing a robot to execute an appropriate action for an action of the user.

In the related art, there is room for improvement in efficiently generating content to be presented to a one-on-one meeting held by two participants.

At the time of earthquake early warning, only information such as a seismic intensity, a magnitude, and a depth of a seismic source is obtained in a studio of a television station. Therefore, an announcer has no choice but to provide viewers with messages such as, “Please be careful of the tsunami just in case. Do not approach cliffs or the like. I repeat.”, and it is difficult for the viewers to take measures against the earthquake.

In the related art, it may not be possible to output appropriate information according to an event that has occurred.

### Solution to Problem

According to a first aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of an interaction function of allowing the user and the robot to interact with each other, and determines an action of the robot corresponding to the action content, in which the action determination unit includes an image acquisition unit capable of imaging a competition space in which a specific competition is able to be performed, and a competitor emotion analysis unit that analyzes emotions of a plurality of competitors performing a competition in the competition space imaged by the image acquisition unit, and determines an action of the robot on the basis of an analysis result from the competitor emotion analysis unit.

According to a second aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which the action determination unit includes an image acquisition unit capable of imaging a competition space in which a specific competition is able to be performed, and a feature specifying unit that specifies features of a plurality of competitors performing a competition in the competition space imaged by the image acquisition unit, and determines an action of the robot on the basis of a specified result from the feature specifying unit.

According to a third aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which when the action determination unit is activated at a predetermined time, the action determination unit adds a fixed sentence for giving an instruction for summarizing a history of a previous day to text representing history data of the previous day, inputs the text to the sentence generation model to acquire a summary of the history of the previous day, and speaks the content of the acquired summary.

According to a fourth aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which when the action determination unit is activated at a predetermined time, the action determination unit adds a fixed sentence for giving an instruction for summarizing a history of a previous day to text representing history data of the previous day, inputs the text to the sentence generation model to acquire a summary of the history of the previous day, inputs the acquired summary of the history of the previous day to an image generation model to acquire an image obtained by summarizing the history of the previous day, and displays the acquired image.

According to a fifth aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which when the action determination unit is activated at a predetermined time, the action determination unit adds a fixed sentence for inquiry about an emotion that the robot is to have to text representing history data of a previous day, and inputs the text to the sentence generation model to determine an emotion of the robot corresponding to a history of the previous day.

According to a sixth aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of an interaction function of allowing the user and the robot to interact with each other, and determines an action of the robot corresponding to the action content, in which at a timing at which the user wakes up, the action determination unit adds a fixed sentence for inquiry about the emotion of the user to history data including a history of actions and emotions of a previous day of the user, and inputs the history data to the interaction function to determine an emotion based on the history of the previous day of the user.

According to a seventh aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of an interaction function of allowing the user and the robot to interact with each other, and determines an action of the robot corresponding to the action content, in which at a timing at which the user wakes up, the action determination unit acquires a summary of history data including a history of actions and emotions of a previous day of the user, acquires music based on the summary, and reproduces the music.

An action control system of the first aspect of the disclosure includes an emotion determination unit that determines an emotion of a user or an emotion of a robot, and an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which when a battle game of winning/losing or superiority/inferiority is played with the user, the action determination unit determines a user level indicating a strength of the user in the battle game, and sets a robot level indicating a strength of the robot according to the determined user level. The robot can advance the battle game in a battle situation that the user can enjoy.

According to an eighth aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of an interaction function of allowing the user and the robot to interact with each other, and determines an action of the robot corresponding to the action content, in which in a case in which a question about which one of two or more things is to be selected is received from the user, the action determination unit selects at least one of the two or more things on the basis of at least history information regarding the user, and answers the user.

According to a ninth aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of an interaction function of allowing the user and the robot to interact with each other, and determines an action of the robot corresponding to the action content, in which the action determination unit stores a type of an action executed by the user in a home as specific information associated with a timing at which the action was executed, determines an execution timing that is a timing at which the user is to execute the action on the basis of the specific information, and notifies the user of the execution timing.

According to a tenth aspect of the disclosure, an action control system is provided. The action control system includes an emotion determination unit that determines an emotion of a user or an emotion of a robot, and an action determination unit that generates action content of the robot with respect to an action of the user and the emotion of the user or the emotion of the robot on the basis of a sentence generation model having an interaction function of allowing the user and the robot to interact with each other, and determine an action of the robot corresponding to the action content, in which the action determination unit receives statements of a plurality of users having a conversation, outputs a topic of the conversation, and determines, as the action of the robot, outputting another topic from at least one emotion of the users having the conversation.

According to an eleventh aspect of the disclosure, an action control system is provided. The action control system includes a state recognition unit that recognizes a user state including an action of a user, an emotion determination unit that determines an emotion of the user or an emotion of a robot, and an action determination unit that determines an action of the robot corresponding to the user state and the emotion of the user or the emotion of the robot on the basis of a sentence generation model having an interaction function of allowing the user and the robot to interact with each other, in which the action determination unit acquires musical scores of lyrics and melodies according to an environment in which the robot is placed on the basis of the sentence generation model, and determines action content of the robot such that music based on the lyrics and the melodies is played by using a vocal sound synthesis engine.

According to a twelfth aspect of the disclosure, an action control system is provided. The action control system includes a state recognition unit that recognizes a user state including an action of a user, an emotion determination unit that determines an emotion of the user or an emotion of a robot, and an action determination unit that determines an action of the robot corresponding to the user state and the emotion of the user or the emotion of the robot on the basis of a sentence generation model having an interaction function of allowing the user and the robot to interact with each other, in which the action determination unit generates a life improvement application that proposes improvement of life on the basis of an interaction between the user and the robot. Here, examples of the robot include a device that performs a physical operation, a device that outputs a video or sound without performing a physical operation, and an agent that operates on software.

According to a thirteenth aspect of the disclosure, an action control system is provided. The action control system includes a state recognition unit that recognizes a user state including an action of a user, an emotion determination unit that determines an emotion of the user or an emotion of an electronic apparatus, and an action determination unit that determines an action of the electronic apparatus corresponding to the user state and the emotion of the user or an action of the electronic apparatus corresponding to the user state and the emotion of the electronic apparatus on the basis of a sentence generation model having an interaction function of allowing the user and the electronic apparatus to interact with each other, in which the action determination unit manages food on the basis of the user state.

According to a fourteenth aspect of the disclosure, an action control system is provided. The action control system includes a state recognition unit that recognizes a user state including an action of a user, an emotion determination unit that determines an emotion of the user or an emotion of an electronic apparatus, and an action determination unit that determines an action of the electronic apparatus corresponding to the user state and the emotion of the user or an action of the electronic apparatus corresponding to the user state and the emotion of the electronic apparatus on the basis of a sentence generation model having an interaction function of allowing the user and the electronic apparatus to interact with each other, in which the action determination unit manages food on the basis of the user state.

According to a fifteenth aspect of the disclosure, a control system is provided. The control system includes a processing unit that performs specific processing using a sentence generation model that generates a sentence corresponding to input data, and an output unit that controls an action of the electronic apparatus such that a result of the specific processing is output. The processing unit determines whether or not a condition for presentation content in a meeting held by the user is satisfied as a predefined trigger condition, and acquires and outputs, in a case in which the trigger condition is satisfied, a response related to the presentation content in the meeting as a result of the specific processing by using an output of the sentence generation model when at least mail description matters, schedule table description matters, and remarks in the meeting obtained from the user input in a specific period are used as the input data. The electronic apparatus may be a robot. Here, examples of the robot include a device that performs a physical operation, a device that outputs a video or sound without performing a physical operation, and an agent that operates on software.

According to a sixteenth aspect of the disclosure, an information processing system is provided. The information processing system includes an input unit that receives a user input, a processing unit that performs specific processing using a generation model that generates a result according to input data, and an output unit that controls an action of an electronic apparatus such that a result of the specific processing is output, in which the processing unit acquires the result of the specific processing by using an output of the generation model when text for giving an instruction for presentation of information regarding an earthquake is used as the input data. The generation model may be a generation model that generates a result based on a sentence, or may be a generation model that generates a result based on input of information such as an image and vocal sound. The electronic apparatus may be a robot. Here, examples of the robot include a device that performs a physical operation, a device that outputs a video or sound without performing a physical operation, and an agent that operates on software.

According to a seventeenth aspect of the disclosure, an action control system is provided. The action control system includes a state recognition unit that recognizes a user state including an action of a user and a state of a robot, an emotion determination unit that determines an emotion of the user or an emotion of the robot, and an action determination unit that determines, as an action of the robot, any of a plurality of types of robot actions including no action, by using at least one of the user state, the state of the robot, the emotion of the user, or the emotion of the robot, and an action determination model at a predetermined timing.

According to a nineteenth aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, and a storage control unit that stores, in history data, event data including an emotion value determined by the emotion determination unit and data including the action of the user, in which the device operations include proposing an activity, and in a case in which it is determined to propose an activity as an action of the electronic apparatus, the action determination unit determines an action of the user to be proposed on the basis of the event data.

According to a twentieth aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, and a storage control unit that stores, in history data, event data including an emotion value determined by the emotion determination unit and data including the action of the user, in which the device operations include prompting an exchange with another person, and in a case in which it is determined to prompt an exchange with another person as an action of the electronic apparatus, the action determination unit determines at least one of an exchange partner or an exchange method on the basis of the event data. Here, the electronic apparatus may be a robot, and examples of the robot include a device that performs a physical operation, a device that outputs a video or sound without performing a physical operation, and an agent that operates on software.

According to a twenty-first aspect of the disclosure, an action control system is provided. An action control system comprising: a state recognition unit that recognizes a user state including an action of a user and a state of an electronic apparatus, an emotion determination unit that determines an emotion of the user or an emotion of the electronic apparatus, and an action determination unit that determines, by using at least one of the user state, the state of the electronic apparatus, the emotion of the user, or the emotion of the electronic apparatus, and an action determination model at a predetermined timing, any of a plurality of types of device operations including non-operation as an action of the electronic apparatus, in which the device operations include giving advice about a specific competition to the user participating in the specific competition, and the action determination unit includes an image acquisition unit capable of imaging a competition space in which the specific competition in which the user participates is performed, and a competitor analysis unit that analyzes emotions of a plurality of competitors who are performing the specific competition in the competition space imaged by the image acquisition unit, and in a case in which it is determined to give advice about the specific competition to the user who participates in the specific competition as an action of the electronic apparatus, the action determination unit gives the advice to the user on the basis of an analysis result from the competitor analysis unit. Here, examples of electronic apparatus include a device that performs a physical operation, a device that outputs a video or sound without performing a physical operation, and an agent that operates on software, such as a robot.

According to a twenty-second aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, and an action determination unit that determines, by using at least one of the user state, the state of the electronic apparatus, the emotion of the user, or the emotion of the electronic apparatus, and an action determination model at a predetermined timing, any of a plurality of types of device operations including non-operation as an action of the electronic apparatus, in which the device operations include giving advice about a specific competition to the user participating in the specific competition, and the action determination unit includes an image acquisition unit capable of imaging a competition space in which the specific competition in which the user participates is performed, and a feature specifying unit that specifies features of a plurality of competitors performing a competition in the competition space imaged by the image acquisition unit, in which in a case in which it is determined to give advice about the specific competition to the user participating in the specific competition as an action of the electronic apparatus, the action determination unit gives the advice to the user on the basis of a specified result from the feature specifying unit. Here, examples of electronic apparatus include a device that performs a physical operation, a device that outputs a video or sound without performing a physical operation, and an agent that operates on software, such as a robot.

According to a twenty-third aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, and a storage control unit that stores, in history data, event data including an emotion value determined by the emotion determination unit and data including the action of the user, in which the device operations include setting first action content for correcting the action of the user, and the action determination unit detects the action of the user spontaneously or periodically, and executes the first action content in a case in which it is determined to correct the action of the user as the action of the electronic apparatus on the basis of the detected action of the user and specific information stored in advance. Here, examples of the robot include a device that performs a physical operation, a device that outputs a video or sound without performing a physical operation, and an agent that operates on software.

According to a twenty-fourth aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, and a storage control unit that stores, in history data, event data including an emotion value determined by the emotion determination unit and data including the action of the user, in which the device operations include giving the user advice about a home, and in a case in which it is determined to give the user advice about the home as the action of the electronic apparatus, the action determination unit proposes advice about a physical condition, a recommended dish, and an ingredient to be replenished by using a sentence generation model on the basis of data regarding a home device stored in the history data. Here, examples of the robot include a device that performs a physical operation, a device that outputs a video or sound without performing a physical operation, and an agent that operates on software.

According to a twenty-fifth aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, and an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, in which the device operations include giving the user advice about a labor problem, and in a case in which it is determined to give the user advice about a labor problem as the action of the electronic apparatus, the action determination unit determines to give the user the advice about a labor problem on the basis of the action of the user.

According to a twenty-sixth aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, and a storage control unit that stores, in history data, event data including an emotion value determined by the emotion determination unit and data including the action of the user, in which the device operations include making a proposal for prompting an action that the user in a home is able to take, and the storage control unit stores a type of action that the user executes in the home in the history data in association with a timing at which the action was executed, and in a case in which it is determined to spontaneously or periodically make a proposal for prompting the action that the user in the home is able to take as the action of the electronic apparatus on the basis of the history data, the action determination unit executes the proposal for prompting the action at a timing at which the user is to execute the action. Here, examples of the robot include a device that performs a physical operation, a device that outputs a video or sound without performing a physical operation, and an agent that operates on software.

According to a twenty-seventh aspect of the disclosure, an action control system is provided. The action control system includes a state recognition unit that recognizes a user state including an action of a user and a state of an electronic apparatus, an emotion determination unit that determines an emotion of the user or an emotion of the electronic apparatus, an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, and a storage control unit that stores, in history data, event data including an emotion value determined by the emotion determination unit and data including the action of the user, in which the device operations include supporting a progress of a meeting for the user during the meeting, and in a case in which the meeting is in a predefined state, the action determination unit determines to output progress support of the meeting to the user during the meeting as the action of the electronic apparatus, and outputs the progress support of the meeting.

According to a twenty-eighth aspect of the disclosure, an action control system is provided. The action control system includes a detection unit that detects occurrence of a predetermined event, and an output control unit that controls a robot including a sentence generation model to output information corresponding to the event detected by the detection unit to a user.

According to a twenty-ninth aspect of the disclosure, an action control system is provided. The action control system includes a collection unit configured to collect situation information indicating a situation of a user, and an output control unit configured to control a robot including a sentence generation model to output a proposal regarding coordination according to the situation information collected by the collection unit to the user.

According to one aspect of the disclosure, a control system is provided. The control system may include a diagnosis result acquisition unit that acquires a diagnosis result of image consulting diagnosis including at least any of color diagnosis, skeleton diagnosis, or face type diagnosis of a user who is talking with an electronic apparatus. The control system may include a user feature acquisition unit that acquires a user feature including at least any of a loudness of vocal sound, a tone of vocal sound, or an expression of the user. The control system may include a user wish acquisition unit that acquires a user wish including at least either of an occupation or a self-image desired by the user. The control system may include a proposal content generation unit that generates proposal content for the user on the basis of the diagnosis result, the user feature, and the user wish. The control system may include a control unit that causes the electronic apparatus to output the proposal content to the user.

### BRIEF DESCRIPTION OF DRAWINGS

FIG. 1 is a diagram schematically illustrating an example of a system 5 according to a first embodiment.

FIG. 2 is a diagram schematically illustrating a functional configuration of a robot 100.

FIG. 3 is a diagram schematically illustrating an example of an operation flow in the robot 100.

FIG. 4 is a diagram schematically illustrating an example of a hardware configuration of a computer 1200.

FIG. 5 illustrates an emotion map 400 on which a plurality of emotions are mapped.

FIG. 6 illustrates an emotion map 900 on which a plurality of emotions are mapped.

FIG. 7(A) is an external view of a stuffed toy according to another embodiment, and FIG. 7(B) is an internal structural view of the stuffed toy.

FIG. 8 is a rear front view of a stuffed toy according to another embodiment.

FIG. 9 is a diagram schematically illustrating a functional configuration of a robot 100 according to a second embodiment.

FIG. 10 is a diagram schematically illustrating an example of an operation flow of collection processing in the robot 100 according to the second embodiment.

FIG. 11A is a diagram schematically illustrating an example of an operation flow of response processing in the robot 100 according to the second embodiment.

FIG. 11B is a diagram schematically illustrating an example of an operation flow of autonomous processing in the robot 100 according to the second embodiment.

FIG. 12 is a diagram schematically illustrating a functional configuration of a stuffed toy 100N according to a third embodiment.

FIG. 13 is a diagram schematically illustrating a functional configuration of an agent system 500 according to a fourth embodiment.

FIG. 14 is a diagram illustrating an example of an operation of the agent system.

FIG. 15 is a diagram illustrating an example of an operation of the agent system.

FIG. 16 is a functional block diagram of an agent system 700 configured by using some or all of functions of the action control system.

FIG. 17 is a diagram illustrating an example of a usage aspect of an agent system 700 by smart glasses 720.

FIG. 18 is a diagram schematically illustrating an example of an operation flow of specific processing of a robot 100 according to an eleventh embodiment.

FIG. 19 is a diagram schematically illustrating a functional configuration of a robot 100 according to a twenty-second embodiment.

FIG. 20 is a diagram schematically illustrating a data structure of character data 223.

FIG. 21 is a diagram schematically illustrating an example of an operation flow regarding character setting.

FIG. 22 is a diagram schematically illustrating an example of an operation flow in the robot 100.

FIG. 23 is a diagram schematically illustrating a functional configuration of an event detection unit 2900.

FIG. 24 is a diagram schematically illustrating an example of an operation flow by an event detection unit 2900.

### DESCRIPTION OF EMBODIMENTS

Hereinafter, the disclosure will be described through embodiments of the disclosure, but the following embodiments do not limit the disclosure according to the claims. Not all combinations of features described in the embodiments are essential to the solution of the disclosure. The above summary of the disclosure does not enumerate all of the necessary features of the disclosure. A subcombination of these feature groups can also be included in the disclosure.

### First Embodiment

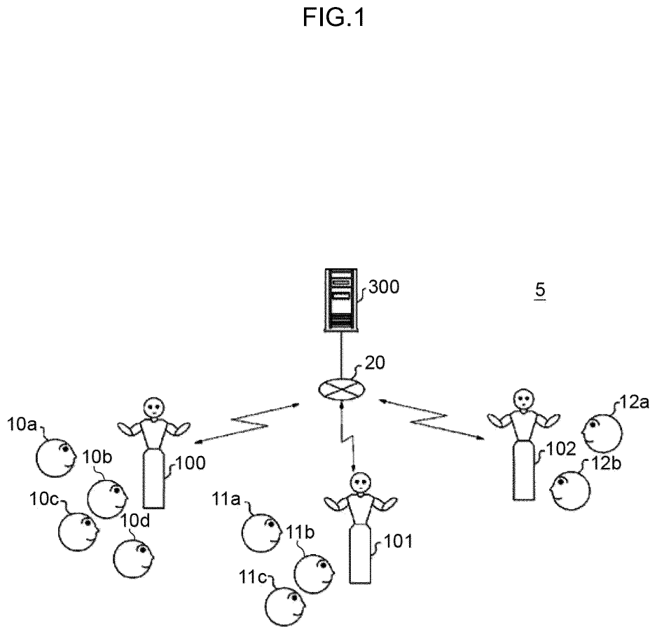

FIG. 1 schematically illustrates an example of a system 5 according to the present embodiment. The system 5 includes a robot 100, a robot 101, a robot 102, and a server 300. A user 10a, a user 10b, a user 10c, and a user 10d are users of the robot 100. The user 11a, the user 11b, and the user 11c are users of the robot 101. A user 12a and a user 12b are users of the robot 102. In the description of the present embodiment, the user 10a, the user 10b, the user 10c, and the user 10d may be collectively referred to as a user 10. The user 11a, the user 11b, and the user 11c may be collectively referred to as a user 11. The user 12a and the user 12b may be collectively referred to as a user 12. The robot 101 and the robot 102 have substantially the same functions as those of the robot 100. Therefore, the system 5 will be described focusing on the functions of the robot 100.

The robot 100 has a conversation with the user 10 and provides a video to the user 10. In this case, the robot 100 has a conversation with the user 10, provides a video to the user 10, and the like in cooperation with the server 300 and the like that can communicate via a communication network 20. For example, the robot 100 not only learns an appropriate conversation by itself, but also performs learning so that a conversation with the user 10 can be advanced more appropriately in cooperation with the server 300. The robot 100 causes the server 300 to record captured video data and the like of the user 10, requests the server 300 to transmit the video data and the like as necessary, and provides the video data and the like to the user 10.

The robot 100 has an emotion value indicating the type of its own emotion. For example, the robot 100 has emotion values indicating the intensities of respective emotions such as “happy”, “angry”, “sad”, “pleasant”, “pleased”, “displeased”, “safe”, “anxious”, “gloomy”, “excited”, “worried”, “relieved”, “sense of fulfilment”, “sense of emptiness”, and “normal”. For example, in a case in which the robot 100 has a conversation with the user 10 in a state in which the emotion value of excitement is great, the robot emits vocal sound at a fast speed. As described above, the robot 100 can express its own emotion by action.

The robot 100 may be configured to determine an action of the robot 100 corresponding to the emotion of the user 10 by matching a sentence generation model using artificial intelligence (AI) with an emotion engine. Specifically, the robot 100 may be configured to recognize an action of the user 10, determine an emotion of the user 10 for the action of the user, and determine an action of the robot 100 corresponding to the determined emotion.

More specifically, in a case in which the robot 100 recognizes the action of the user 10, the robot 100 automatically generates the action content to be taken by the robot with respect to the action of the user 10 by using the preset sentence generation model. The sentence generation model may be interpreted as an algorithm and an operation for automatic interaction processing using text. Since the sentence generation model is known as disclosed in, for example, Japanese Patent Application Laid-Open (JP-A) No. 2018 081444 and ChatGPT (Internet search <URL: https://openai.com/blog/chatgpt>), a detailed description thereof will be omitted. Such a sentence generation model is configured by a large language model (LLM).

As described above, in the first embodiment, it is possible to reflect the emotions of the user 10 and the robot 100 and various types of linguistic information in the action of the robot 100 by combining the large language model and the emotion engine. That is, according to the first embodiment, a synergistic effect can be obtained by combining the sentence generation model and the emotion engine.

The robot 100 has a function of recognizing an action of the user 10. The robot 100 recognizes the action of the user 10 by analyzing a face image of the user 10 acquired by a camera function and the vocal sound of the user 10 acquired by a microphone function. The robot 100 determines an action to be executed by the robot 100 on the basis of the recognized action of the user 10 or the like.

The robot 100 stores a rule defining an action to be executed by the robot 100 on the basis of the emotion of the user 10, the emotion of the robot 100, and the action of the user 10, and performs various actions according to the rule.

Specifically, the robot 100 has a reaction rule as an action determination model for determining an action of the robot 100 on the basis of the emotion of the user 10, the emotion of the robot 100, and the action of the user 10. In the reaction rule, for example, in a case in which the action of the user 10 is “smiling”, an action of “smiling” is set as the action of the robot 100. In the reaction rule, an action of “apologizing” is defined as an action of the robot 100, with respect to a case in which the action of the user 10 is “angry”. In the reaction rule, an action of “answering” is defined as an action of the robot 100 with respect to a case in which the action of the user 10 is “inquiry”. In the reaction rule, an action of “talking” is defined as an action of the robot 100 with respect to a case in which the action of the user 10 is “gloomy”.

In a case in which the robot 100 recognizes that the action of the user 10 is “angry” on the basis of the reaction rule, the robot selects an action of “apologizing” defined in the reaction rule as the action to be executed by the robot 100. For example, in the case of selecting the action of “apologizing”, the robot 100 performs an action of “apologizing” and outputs vocal sound expressing the word “apologizing”.

In a case in which a condition that the emotion of the robot 100 is “normal” (that is, “happy”=0, “angry”=0, “sad”=0, and “pleasant”=0) and the state of the user 10 is “one person, lonely” is satisfied, it is defined that the change content of the emotion that the emotion of the robot 100 changes to “worried” and the action of “talking” can be executed.

In a case in which the robot 100 recognizes that the current emotion of the robot 100 is “normal” and the user 10 is alone in a lonely state on the basis of the reaction rule, the emotion value of “sad” of the robot 100 is increased. The robot 100 selects the action of “talking” defined in the reaction rule as an action to be executed on the user 10. For example, in a case in which the action of “talking” is selected, the robot 100 converts a phrase “What's wrong?” indicating that the robot is concerned into vocal sound indicating that the robot is concerned, and outputs the vocal sound.

The robot 100 transmits, to the server 300, user reaction information indicating that a positive reaction has been obtained from the user 10 through this action. The user reaction information includes, for example, the user action of “getting angry”, the action of the robot 100 of “apologizing”, the positive reaction of the user 10, and an attribute of the user 10.

The server 300 stores the user reaction information received from the robot 100. The server 300 receives and stores the user reaction information not only from the robot 100 but also from each of the robot 101 and the robot 102. The server 300 analyzes the user reaction information from the robot 100, the robot 101, and the robot 102, and updates the reaction rule.

The robot 100 receives the updated reaction rule from the server 300 by inquiring the server 300 about the updated reaction rule. The robot 100 incorporates the updated reaction rule into the reaction rule stored in the robot 100. As a result, the robot 100 can incorporate the reaction rule acquired by the robot 101, the robot 102, or the like into its own reaction rule.

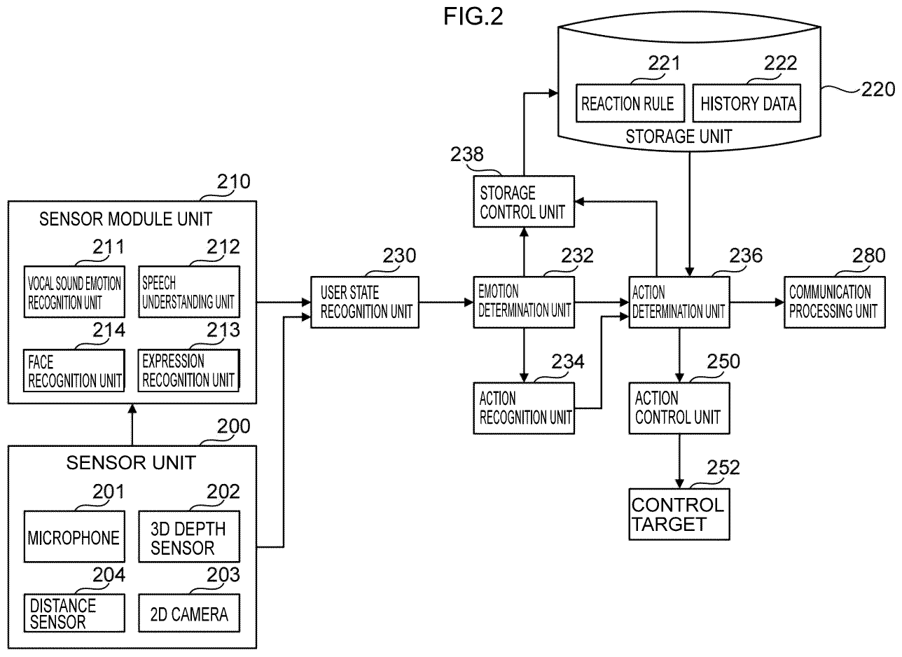

FIG. 2 schematically illustrates a functional configuration of the robot 100. The robot 100 includes a sensor unit 200, a sensor module unit 210, a storage unit 220, a state recognition unit 230, an emotion determination unit 232, an action recognition unit 234, an action determination unit 236, a storage control unit 238, an action control unit 250, a control target 252, and a communication processing unit 280.

Examples of the control target 252 include a display device, a speaker, an LED of an eye portion, and motors that drive an arm, a hand, a foot, and the like. The posture and the gesture of the robot 100 are controlled by controlling motors for arms, hands, and feet. Some of the emotions of the robot 100 can be expressed by controlling these motors. The expression of the robot 100 can be expressed by controlling a light emission state of the LED of the eye portion of the robot 100. The posture, the gesture, and the expression of the robot 100 are examples of the attitude of the robot 100.

The sensor unit 200 includes a microphone 201, a 3D depth sensor 202, a 2D camera 203, and a distance sensor 204. The microphone 201 continuously detects vocal sound and outputs vocal sound data. The microphone 201 may be provided on the head of the robot 100 and may have a function of performing binaural recording. The 3D depth sensor 202 analyzes infrared patterns from infrared images continuously captured by an infrared camera by continuously applying the infrared patterns, and detects an outline of an object. The 2D camera 203 is an example of an image sensor. The 2D camera 203 captures an image with visible light and generates image information of visible light. The distance sensor 204 detects a distance to an object by emitting, for example, laser light or ultrasonic waves. The sensor unit 200 may further include a clock, a gyro sensor, a touch sensor, a sensor for motor feedback, and the like.

Among the constituents of the robot 100 illustrated in FIG. 2, the constituents other than the control target 252 and the sensor unit 200 are examples of the constituents included in the action control system included in the robot 100. The action control system of the robot 100 controls the control target 252.

The storage unit 220 includes a reaction rule 221 and history data 2222. The history data 2222 includes a history of past emotion values and actions of the user 10. The emotion values and the history of actions are recorded for each user 10 by being associated with identification information of the user 10, for example. At least a part of the storage unit 220 is implemented by a storage medium such as a memory. A person DB that stores a face image of the user 10, attribute information of the user 10, and the like may be included. Among the constituents of the robot 100 illustrated in FIG. 2, the functions of the constituents other than the control target 252, the sensor unit 200, and the storage unit 220 can be realized by a CPU operating on the basis of a program. For example, the functions of these constituents can be implemented as the operation of the CPU by basic software (OS) and a program operating on the OS.

The sensor module unit 210 includes a vocal sound emotion recognition unit 211, a speech understanding unit 212, an expression recognition unit 213, and a face recognition unit 214. Information detected by the sensor unit 200 is input to the sensor module unit 210. The sensor module unit 210 analyzes information detected by the sensor unit 200 and outputs an analysis result to the state recognition unit 230.

The vocal sound emotion recognition unit 211 of the sensor module unit 210 analyzes the vocal sound of the user 10 detected by the microphone 201 to recognize the emotion of the user 10. For example, the vocal sound emotion recognition unit 211 extracts a feature amount such as a frequency component of the vocal sound and recognizes the emotion of the user 10 on the basis of the extracted feature amount. The speech understanding unit 212 analyzes the vocal sound of the user 10 detected by the microphone 201 and outputs text information indicating the speech content of the user 10.

The expression recognition unit 213 recognizes the expression of the user 10 and the emotion of the user 10 from the image of the user 10 captured by the 2D camera 203. For example, the expression recognition unit 213 recognizes the expression and the emotion of the user 10 on the basis of the shapes, positional relationships, and the like of the eyes and the mouth.

The face recognition unit 214 recognizes the face of the user 10. The face recognition unit 214 recognizes the user 10 by matching a face image stored in a person DB (not illustrated) with a face image of the user 10 captured by the 2D camera 203.

The state recognition unit 230 recognizes a state of the user 10 on the basis of the information analyzed by the sensor module unit 210. For example, processing mainly related to perception is performed by using the analysis result from the sensor module unit 210. For example, perception information such as “There is one father.” and “The probability that the father does not smile is 90%.” is generated. Processing of understanding the meaning of the generated perception information is performed. For example, semantic information such as “One father looks lonely.” is generated.

The emotion determination unit 232 determines an emotion value indicating the emotion of the user 10 on the basis of the information analyzed by the sensor module unit 210 and the state of the user 10 recognized by the state recognition unit 230. For example, the information analyzed by the sensor module unit 210 and the recognized state of the user 10 are input to a neural network trained in advance, and an emotion value indicating the emotion of the user 10 is acquired.

Here, the emotion value indicating the emotion of the user 10 is a value indicating whether the emotion of the user is positive or negative. For example, in a case in which the emotion of the user is a bright emotion accompanied with pleasure or comfort, such as “happy”, “pleasant”, “pleased”, “safe”, “excited”, “relieved”, and “sense of fulfillment”, a positive value is indicated, and the value becomes larger as the emotion becomes brighter. In a case in which the emotion of the user is an emotion that makes the user feel unpleasant, such as “angry”, “sad”, “displeased”, “anxious”, “gloomy”, “worried”, and “sense of emptiness”, a negative value is indicated, and an absolute value of the negative value increases as the user feels unpleasant. In a case in which the emotion of the user is not included in any of the above emotions (“normal”), a value of 0 is indicated.

The emotion determination unit 232 determines an emotion value indicating the emotion of the robot 100 on the basis of the information analyzed by the sensor module unit 210 and the state of the user 10 recognized by the state recognition unit 230.

The emotion value of the robot 100 includes an emotion value for each of the plurality of emotion classifications, and is, for example, a value (0 to 5) indicating the intensity of each of “happy”, “angry”, “sad”, and “pleasant”.

Specifically, the emotion determination unit 232 determines an emotion value indicating the emotion of the robot 100 according to a rule for updating the emotion value of the robot 100, the rule being defined in association with the information analyzed by the sensor module unit 210 and the state of the user 10 recognized by the state recognition unit 230.

For example, in a case in which the state recognition unit 230 recognizes that the user 10 looks lonely, the emotion determination unit 232 increases the emotion value of “sad” of the robot 100. In a case in which the state recognition unit 230 recognizes that the user 10 has a smiling face, the emotion value of “happy” of the robot 100 is increased.

The emotion determination unit 232 may determine the emotion value indicating the emotion of the robot 100 in further consideration of the state of the robot 100. For example, in a case in which a remaining battery level of the robot 100 is low or in a case in which the surrounding environment of the robot 100 is dark, the emotion value of “sad” of the robot 100 may be increased. In the case of the user 10 continuously talking to the robot even though the remaining battery level is low, the emotion value of “angry” may be increased.

The action recognition unit 234 recognizes an action of the user 10 on the basis of the information analyzed by the sensor module unit 210 and the state of the user 10 recognized by the state recognition unit 230. For example, the information analyzed by the sensor module unit 210 and the recognized state of the user 10 are input to a neural network trained in advance, probabilities of a plurality of predetermined action classifications (for example, “smile”, “angry”, “ask a question”, and “gloomy”) are acquired, and an action classification having the highest probability is recognized as the action of the user 10.

As described above, in the first embodiment, the robot 100 acquires the speech content of the user 10 after specifying the user 10, but in acquiring and using the speech content, the action control system of the robot 100 according to the first embodiment considers protection of personal information and privacy of the user 10 in addition to acquiring necessary consent according to laws and regulations from the user 10.

The action determination unit 236 determines an action corresponding to the action of the user 10 recognized by the action recognition unit 234 on the basis of the current emotion value of the user 10 determined by the emotion determination unit 232, the history data 2222 of the past emotion values determined by the emotion determination unit 232 before the current emotion value of the user 10 is determined, and the emotion value of the robot 100. In the first embodiment, a case in which the action determination unit 236 uses one most recent emotion value included in the history data 2222 as the past emotion value of the user 10 will be described, but the disclosed technology is not limited to this aspect. For example, the action determination unit 236 may use a plurality of most recent emotion values as the past emotion values of the user 10, or may use emotion values that are earlier by a unit period such as one day before. The action determination unit 236 may determine an action corresponding to the action of the user 10 in further consideration of the history of the past emotion values of the robot 100 in addition to the current emotion value of the robot 100. The action determined by the action determination unit 236 includes a gesture performed by the robot 100 or speech content of the robot 100.

The action determination unit 236 according to the first embodiment determines the action of the robot 100 on the basis of a combination of the past emotion value and the current emotion value of the user 10, the emotion value of the robot 100, the action of the user 10, and the reaction rule 221, as an action corresponding to the action of the user 10. For example, in a case in which the past emotion value of the user 10 is a positive value and the current emotion value is a negative value, the action determination unit 236 determines an action for positively changing the emotion value of the user 10 as an action corresponding to the action of the user 10.

The reaction rule 221 defines an action of the robot 100 according to the combination of the past emotion value and the current emotion value of the user 10, the emotion value of the robot 100, and the action of the user 10. For example, in a case in which the past emotion value of the user 10 is a positive value, the current emotion value is a negative value, and the action of the user 10 is to feel gloomy, a combination of a gesture and speech content at the time of making an inquiry to encourage the user 10 including a gesture is defined as the action of the robot 100.

For example, the reaction rule 221 defines an action of the robot 100 for all combinations of patterns of emotion values of the robot 100 (1296 patterns that is the fourth power of six values of the values “0” to “5” of “happy”, “angry”, “sad”, and “pleasant”), a pattern of the combination of the past emotion value and the current emotion value of the user 10, and an action pattern of the user 10. That is, for each pattern of the emotion value of the robot 100, the action of the robot 100 according to the action pattern of the user 10 is defined for each of a plurality of combinations such as combinations of the past emotion value and the current emotion value of the user 10 being a negative value and a negative value, a negative value and a positive value, a positive value and a negative value, a positive value and a positive value, a negative value and normal, and normal and normal. The action determination unit 236 may transition to an operation mode of determining the action of the robot 100 by using the history data 2222, for example, in a case in which the user 10 has made speech that intends a conversation continued from a past topic such as “I want to talk about the topic we talked about before”. In the reaction rule 221, a gesture and statement content may be defined as an action of the robot 100 for each pattern (1296 patterns) of the emotion values of the robot 100 at most one per pattern. Alternatively, in the reaction rule 221, at least one of a gesture and statement content may be defined as an action of the robot 100 for each of groups of the patterns of the emotion values of the robot 100.

The intensity of each gesture included in the action of the robot 100 defined in the reaction rule 221 is defined in advance. In each piece of speech content included in the action of the robot 100 defined in the reaction rule 221, the intensity of the speech content is defined in advance.

The storage control unit 238 determines whether or not to store data including the action of the user 10 in the history data 2222 on the basis of the intensity of the action predefined for the action determined by the action determination unit 236 and the emotion value of the robot 100 determined by the emotion determination unit 232.

Specifically, in a case in which a total value of the intensities that is a sum of a sum total of the emotion values for the plurality of respective emotion classifications of the robot 100, the intensity predefined for the gesture included in the action determined by the action determination unit 236, and the intensity predefined for the speech content included in the action determined by the action determination unit 236 is a threshold or more, it is determined to store data including the action of the user 10 in the history data 2222.

In a case in which the storage control unit 238 determines to store the data including the action of the user 10 in the history data 2222, the action determined by the action determination unit 236, information (for example, any surrounding information including data such as vocal sound, an image, and a smell at the place) analyzed by the sensor module unit 210 from the current time point to a certain period before, and a state (for example, the expression and the emotion of the user 10) of the user 10 recognized by the state recognition unit 230 are stored in the history data 2222.

The action control unit 250 controls the control target 252 on the basis of the action determined by the action determination unit 236. For example, in a case in which the action determination unit 236 determines an action including a speech, the action control unit 250 causes a speaker included in the control target 252 to output vocal sound. In this case, the action control unit 250 may determine an emission speed of the vocal sound on the basis of the emotion value of the robot 100. For example, the action control unit 250 determines a higher vocal sound emission speed as the emotion value of the robot 100 becomes greater. As described above, the action control unit 250 determines an execution form of the action determined by the action determination unit 236 on the basis of the emotion value determined by the emotion determination unit 232.

The action control unit 250 may recognize a change in emotion of the user 10 with respect to execution of the action determined by the action determination unit 236. For example, the change in emotion may be recognized on the basis of the vocal sound or expression of the user 10. A change in the emotion of the user 10 may be recognized on the basis of detection of an impact by the touch sensor included in the sensor unit 200. In a case in which an impact is detected by the touch sensor included in the sensor unit 200, it may be recognized that the emotion of the user 10 is worsened, or in a case in which it is determined that the reaction of the user 10 is smiling or happy from the detection result in the touch sensor included in the sensor unit 200, it may be recognized that the emotion of the user 10 is improved. Information indicating the reaction of the user 10 is output to the communication processing unit 280.

After the action control unit 250 executes the action determined by the action determination unit 236 in the execution form determined according to the emotion of the robot 100, the emotion determination unit 232 further changes the emotion value of the robot 100 on the basis of the user's reaction to the execution of the action. Specifically, the emotion determination unit 232 increases the emotion value of “happy” of the robot 100 in a case in which the user's reaction to the action determined by the action determination unit 236 performed on the user in the execution form determined by the action control unit 250 is not bad, and the emotion determination unit 232 increases the emotion value of “sad” of the robot 100 in a case in which the user's reaction to the action determined by the action determination unit 236 performed on the user in the execution form determined by the action control unit 250 is poor.

The action control unit 250 expresses the emotion of the robot 100 on the basis of the determined emotion value of the robot 100. For example, in a case in which the emotion value of “happy” of the robot 100 is increased, the action control unit 250 controls the control target 252 to cause the robot 100 to perform a gesture of being happy. In a case in which the emotion value of “sad” of the robot 100 is increased, the action control unit 250 controls the control target 252 so that the posture of the robot 100 becomes a head-drooping posture.

The communication processing unit 280 performs communication with the server 300. As described above, the communication processing unit 280 transmits the user reaction information to the server 300. The communication processing unit 280 receives the updated reaction rule from the server 300. Upon receiving the updated reaction rule from the server 300, the communication processing unit 280 updates the reaction rule 221.

The server 300 performs communication between the robot 100, the robot 101, and the robot 102 and the server 300, receives the user reaction information transmitted from the robot 100, and updates the reaction rule on the basis of the reaction rule including the action for which a positive reaction has been obtained.

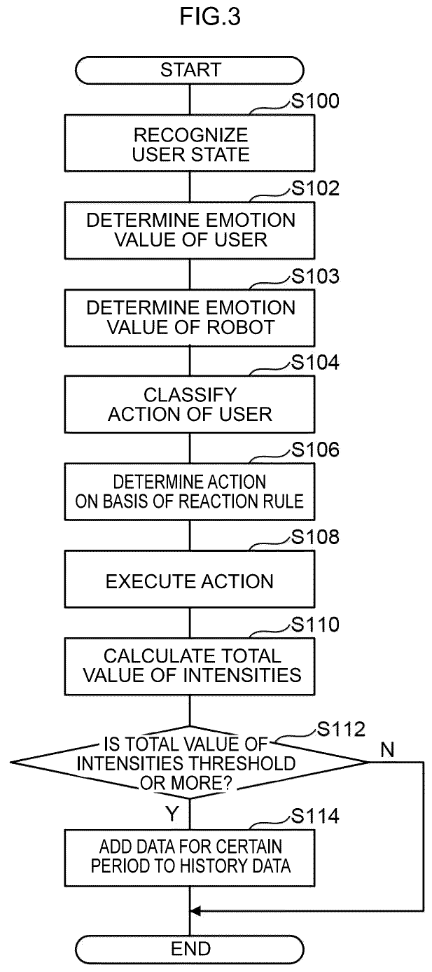

FIG. 3 schematically illustrates an example of an operation flow related to an operation of determining an action of the robot 100. The operation flow illustrated in FIG. 3 is repeatedly executed. In this case, it is assumed that information analyzed by the sensor module unit 210 is input. “S” in the operation flow represents a step to be executed.

First, in step S100, the state recognition unit 230 recognizes a state of the user 10 on the basis of the information analyzed by the sensor module unit 210.

In step S102, the emotion determination unit 232 determines an emotion value indicating the emotion of the user 10 on the basis of the information analyzed by the sensor module unit 210 and the state of the user 10 recognized by the state recognition unit 230.

In step S103, the emotion determination unit 232 determines an emotion value indicating the emotion of the robot 100 on the basis of the information analyzed by the sensor module unit 210 and the state of the user 10 recognized by the state recognition unit 230. The emotion determination unit 232 adds the determined emotion value of the user 10 to the history data 2222.

In step S104, the action recognition unit 234 recognizes an action classification of the user 10 on the basis of the information analyzed by the sensor module unit 210 and the state of the user 10 recognized by the state recognition unit 230.

In step S106, the action determination unit 236 determines an action of the robot 100 on the basis of a combination of the current emotion value of the user 10 determined in step S102 and the past emotion value included in the history data 2222, the emotion value of the robot 100, the action of the user 10 recognized by the action recognition unit 234, and the reaction rule 221.

In step S108, the action control unit 250 controls the control target 252 on the basis of the action determined by the action determination unit 236.

In step S110, the storage control unit 238 calculates a total value of the intensities on the basis of the intensity of the action predefined for the action determined by the action determination unit 236 and the emotion value of the robot 100 determined by the emotion determination unit 232.

In step S112, the storage control unit 238 determines whether or not the total value of the intensities is a threshold or more. In a case in which the total value of the intensities is less than the threshold, the data including the action of the user 10 is not stored in the history data 2222, and the processing is ended. On the other hand, in a case in which the total value of the intensities is the threshold or more, the processing proceeds to step S114.

In step S114, the action determined by the action determination unit 236, the information analyzed by the sensor module unit 210 from the current time point to a certain period before, and the state of the user 10 recognized by the state recognition unit 230 are stored in the history data 2222.

As described above, the robot 100 determines the emotion value indicating the emotion of the robot 100 on the basis of the user state, and determines whether or not to store data including the action of the user 10 in the history data 2222 on the basis of the emotion value of the robot 100. As a result, the capacity of the history data 2222 that stores data including an action of the user 10 can be suppressed. For example, in a case in which the robot 100 determines that the user state after 10 years is the same as the user state of 10 years ago, the robot 100 reads the history data 2222 of 10 years ago, and thus, can present the state of the user 10 of 10 years ago (for example, an expression and an emotion of the user 10), and further, any surrounding information including data such as vocal sound, an image, and a smell at the place to the user 10.

According to the robot 100, it is possible to cause the robot 100 to execute an appropriate action with respect to the action of the user 10. Conventionally, an action of a user is classified to determine an action including an expression or an appearance of a robot. On the other hand, the robot 100 determines the current emotion value of the user 10, and executes an action on the user 10 on the basis of the past emotion value and the current emotion value. Therefore, for example, in a case in which the user 10 who was fine yesterday is depressed today, the robot 100 may say, “You were fine yesterday. What's wrong with you today?”. The robot 100 may also make speech with a gesture. For example, in a case in which the user 10 who was depressed yesterday is fine today, the robot 100 may say, “You were depressed yesterday, but you look fine today?”. For example, in a case in which the user 10 who was fine yesterday is better today than yesterday, the robot 100 may say, “You are better today than yesterday. What's better than yesterday?”. For example, the robot 100 may make speech such as “Recently, the mood is stable, which is good.” to the user 10 whose emotion value is 0 or more and whose state in which the fluctuation range of the emotion value is within a certain range continues.

For example, in a case in which the robot 100 asks a question of “Did you finish the homework that you said yesterday?” to the user 10 and an answer of “I did it” is obtained from the user 10, the robot may make affirmative speech such as “Good!” and make an affirmative gesture such as applause or thumbs-up. For example, in a case in which the user 10 says, “The presentation we discussed the day before yesterday was successful”, the robot 100 can make affirmative speech such as “Good job!” and also make the above affirmative gesture. As described above, the robot 100 performs an action based on the history of the state of the user 10, whereby the user 10 can be expected to feel a sense of closeness to the robot 100.

In the above embodiment, the case in which the robot 100 recognizes the user 10 by using the face image of the user 10 has been described, but the disclosed technology is not limited to this aspect. For example, the robot 100 may recognize the user 10 by using vocal sound uttered by the user 10, a mail address of the user 10, an ID of an SNS of the user 10, an ID card in which a wireless IC tag is built and which is possessed by the user 10, or the like.

The robot 100 is an example of an electronic apparatus including an action control system. An application target of the action control system is not limited to the robot 100, and the action control system can be applied to various electronic apparatuses. The functions of the server 300 may be implemented by one or more computers. At least some functions of the server 300 may be implemented by a virtual machine. At least some of the functions of the server 300 may be implemented in a cloud.

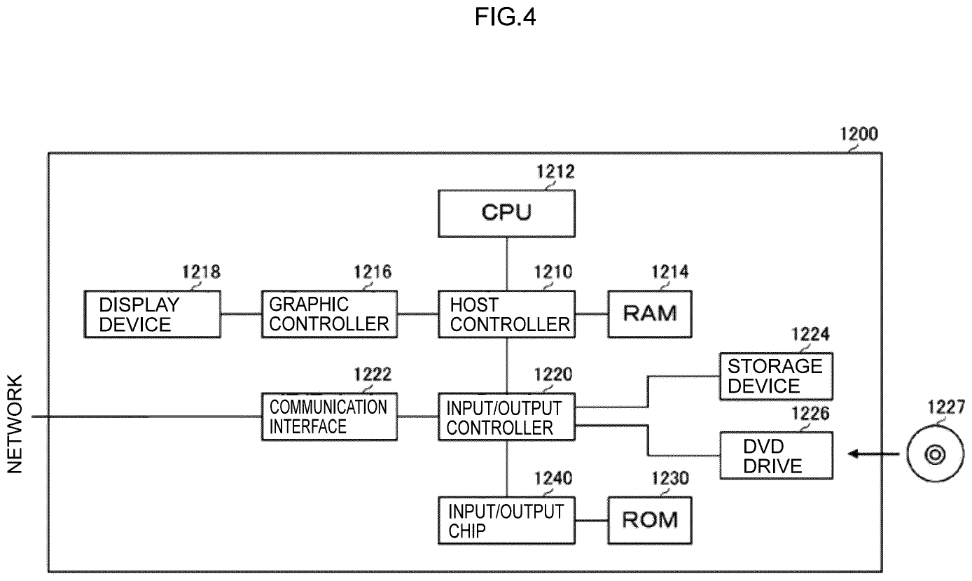

FIG. 4 schematically illustrates an example of a hardware configuration of a computer 1200 that functions as the smartphone 50, the robot 100, the server 300, and an agent system 500. A program installed in the computer 1200 can cause the computer 1200 to function as one or more “units” of the device according to the first embodiment, or cause the computer 1200 to execute an operation associated with the device according to the first embodiment or one or more “units” thereof, and/or cause the computer 1200 to execute a process according to the first embodiment or a stage of the process. Such programs may be executed by a CPU 1212 to cause the computer 1200 to execute certain operations associated with some or all of the blocks in the flowcharts and block diagrams described herein.

The computer 1200 according to the first embodiment includes a CPU 1212, a RAM 1214, and a graphic controller 1216, which are connected to each other via a host controller 1210. The computer 1200 also includes input/output units such as a communication interface 1222, a storage device 1224, a DVD drive 1226, and an IC card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a ROM 1230 and legacy input/output units such as a keyboard, which are connected to the input/output controller 1220 via an input/output chip 1240.

The CPU 1212 operates according to programs stored in the ROM 1230 and the RAM 1214, thereby controlling each unit. The graphic controller 1216 acquires image data generated by the CPU 1212 in a frame buffer or the like provided in the RAM 1214 or itself, and causes the image data to be displayed on the display device 1218.

The communication interface 1222 communicates with other electronic apparatuses via a network. The storage device 1224 stores programs and data used by the CPU 1212 in the computer 1200. The DVD drive 1226 reads a program or data from the DVD-ROM 1227 or the like and provides the program or data to the storage device 1224. The IC card drive reads a program and data from the IC card and/or writes the program and data to the IC card.

The ROM 1230 stores therein a boot program or the like executed by the computer 1200 at the time of activation and/or a program depending on hardware of the computer 1200. The input/output chip 1240 may also connect various input/output units to the input/output controller 1220 via a USB port, a parallel port, a serial port, a keyboard port, a mouse port, or the like.

The program is provided by a computer-readable storage medium such as the DVD-ROM 1227 or an IC card. The program is read from a computer-readable storage medium, installed in the storage device 1224, the RAM 1214, or the ROM 1230, which is also an example of a computer-readable storage medium, and executed by the CPU 1212. The information processing described in such a program provides cooperation between the program read by the computer 1200 and the various types of hardware resources. A device or a method may be configured by implementing an operation or processing of information according to use of the computer 1200.

For example, in a case in which communication is executed between the computer 1200 and an external device, the CPU 1212 may execute a communication program loaded in the RAM 1214 and instruct the communication interface 1222 to perform communication processing on the basis of processing described in the communication program. Under the control of the CPU 1212, the communication interface 1222 reads transmission data stored in a transmission buffer area provided in a recording medium such as the RAM 1214, the storage device 1224, the DVD-ROM 1227, or the IC card, transmits the read transmission data to the network, or writes reception data received from the network to a reception buffer area or the like provided on the recording medium.

The CPU 1212 may cause the RAM 1214 to read all or a necessary portion of a file or database stored in an external recording medium such as the storage device 1224, the DVD drive 1226 (DVD-ROM 1227), or the IC card, and may execute various types of processing on data in the RAM 1214. Next, the CPU 1212 may write back the processed data to the external recording medium.

Various types of information such as various types of programs, data, tables, and databases may be stored in a recording medium and subjected to information processing. The CPU 1212 may execute various types of processing on the data read from the RAM 1214, including various types of operations, information processing, condition determination, conditional branching, unconditional branching, information retrieval/replacement, and the like, which are described throughout the disclosure and specified by a command sequence of a program, and writes back the results to the RAM 1214. The CPU 1212 may search for information in a file, a database, or the like in the recording medium. For example, in a case in which a plurality of entries each having an attribute value of a first attribute associated with an attribute value of a second attribute are stored in the recording medium, the CPU 1212 may search for an entry in which the attribute value of the first attribute matches a specified condition from the plurality of entries, read the attribute value of the second attribute stored in the entry, and thus acquire the attribute value of the second attribute associated with the first attribute satisfying a predetermined condition.

The programs or software modules described above may be stored in the computer 1200 or a computer-readable storage medium near the computer 1200. A recording medium such as a hard disk or a RAM provided in a server system connected to a dedicated communication network or the Internet may be used as a computer-readable storage medium, and provides a program to the computer 1200 via the network.

Blocks in the flowcharts and the block diagrams in the first embodiment may represent stages of a process in which an operation is performed or “units” of a device having a role of performing an operation. Specific stages and “units” may be implemented by a dedicated circuit, a programmable circuit supplied along with computer readable instructions stored on a computer readable storage medium, and/or a processor supplied along with computer readable instructions stored on a computer readable storage medium. Dedicated circuits may include digital and/or analog hardware circuits, and may include integrated circuits (ICs) and/or discrete circuits. Programmable circuits may include reconfigurable hardware circuits including, for example, AND, OR, XOR, NAND, NOR, and other logical operations, flip-flops, registers, and memory elements, such as field programmable gate arrays (FPGA) and programmable logic arrays (PLA).

Computer readable storage media may include any tangible device capable of storing instructions executed by a suitable device, and, as a result, a computer readable storage medium having instructions stored thereon has a product including instructions that may be executed to create means for executing operations designated in the flowcharts or block diagrams. Examples of the computer readable storage medium may include an electronic storage medium, a magnetic storage medium, an optical storage medium, an electromagnetic storage medium, and a semiconductor storage medium. More specific examples of the computer readable storage medium may include a Floppy (registered trademark) disk, a diskette, a hard disk, a random access memory (RAM), a read-only memory (ROM), an erasable programmable read-only memory (an EPROM or a flash memory), an electrically erasable programmable read-only memory (EEPROM), a static random access memory (SRAM), a compact disc read-only memory (CD-ROM), a digital versatile disk (DVD), a Blu-Ray (registered trademark) disk, a memory stick, and an integrated circuit card.

The computer readable instructions may include either source codes or object codes written in any combination of one or more programming languages, including assembler instructions, instruction-set-architecture (ISA) instructions, machine instructions, machine-dependent instructions, microcode, firmware instructions, state-setting data, or an object oriented programming language such as Smalltalk (registered trademark), or JAVA (registered trademark), C++, and conventional procedural programming languages such as the “C” programming language or similar programming languages.

The computer readable instructions may be provided to a processor of a general purpose computer, a special purpose computer, or another programmable data processing device, or a programmable circuit locally or via a local area network (LAN) or a wide area network (WAN) such as the Internet, in order to cause the processor of the general purpose computer, the special purpose computer, or another programmable data processing device or the programmable circuit to execute the computer readable instructions to generate means for executing operations designated in the flowcharts or the block diagrams. Examples of the processor include a computer processor, a processing unit, a microprocessor, a digital signal processor, a controller, and a microcontroller.

Although the technology of the disclosure has been described by using each embodiment, the technology of the disclosure is not limited to the scope disclosed in each embodiment. It is apparent to those skilled in the art that various modifications or improvements can be made to the above embodiments. It is apparent from the description of the claims that modes to which such modifications or improvements are added can also be included in the technical scope of the disclosure.

The order of execution of each piece of processing of operations, procedures, steps, stages, and the like in the devices, the systems, the programs, and the methods shown in the claims, the specification, and the drawings can be realized in any order unless “before”, “prior to”, or the like is explicitly stated, and unless the output of the previous processing is used in the later processing. Even in a case in which the operation flow in the claims, the specification, and the drawings is described by using “first,”, “next,”, and the like for convenience, this does not mean that it is essential to perform in this order.

### Other Embodiment 1

The robot 100 of the present embodiment includes an image acquisition unit that captures an image of a competition space in which a specific competition can be performed. The image acquisition unit can be realized, for example, by using a part of the sensor unit 200 described above. Here, the specific competition may be a sport performed by a team including a plurality of people, such as volleyball, soccer, or rugby. The competition space may include a space corresponding to each competition, for example, a volleyball court or a soccer ground. The competition space may include a peripheral region of the above-described court or the like.

It is preferable that the installation position of the robot 100 is considered so that the competition space can be viewed by the image acquisition unit. Alternatively, the image acquisition unit of the robot 100 may be installed at a position where the competition space can be viewed separately from the robot 100.

The robot 100 of the present embodiment further includes a competitor emotion determination unit capable of determining emotions of a plurality of competitors in images acquired by the image acquisition unit. The competitor emotion determination unit can determine the emotions of a plurality of competitors by using a technique similar to that of the emotion determination unit 232. Specifically, for example, information of a result obtained by the sensor module unit 210 analyzing an image or the like acquired by the image acquisition unit may be input to a neural network trained in advance, and emotion values indicating emotions of a plurality of competitors may be specified to determine the emotion of each competitor.

The robot 100 of the present embodiment further includes a feature specifying unit capable of specifying features of a plurality of competitors in the images acquired by the image acquisition unit described above. The feature specifying unit can specify features of a plurality of competitors by analyzing past competition data, or collecting and analyzing information regarding each competitor from an SNS or the like, according to a method similar to the method of determining an emotion value in the emotion determination unit 232, or combining one or more of these methods.

The features of the competitor indicate information related to the ability related to the competition and the current or recent condition of the competitor, such as habits, movements, the number of mistakes, bad movements, and reaction speed of the competitor.

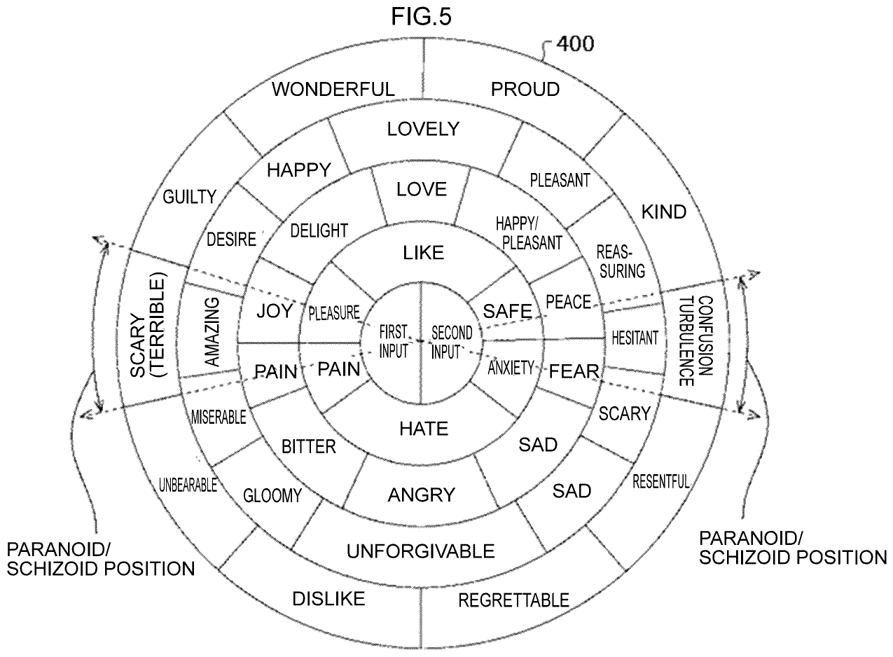

In a case in which it can be specified from an emotion value of a competitor playing a specific game, for example, volleyball, that an emotion of the competitor is unstable (for example, an emotion in a direction indicated by “pain” or “fear” in an emotion map 400 (see FIG. 5) that will be described later is detected) or that the competitor is irritated (for example, an emotion in a direction indicated by “anger” in the emotion map 400 that will be described later is detected), reflecting the specified result in the team's strategy may lead to an advantageous progress of the game. Specifically, it can be said that a competitor with unstable emotions or a competitor with irritation has a higher probability of making a mistake than a competitor with stable emotions. Therefore, for example, in a case in which the competition content is volleyball, it can be said that the possibility of occurrence of a mistake increases in a case in which the number of opportunities for a competitor with unstable emotion or a competitor who is irritated to touch the ball increases. Therefore, in the present embodiment, it is proposed that the user 10, for example, a manager of one team in the competition, is informed of the emotion value of each competitor determined by the robot 100 to advance the competition advantageously.

A competitor whose emotion is analyzed by the competitor emotion analysis unit may be a competitor belonging to a specific team among a plurality of competitors in the competition space. More specifically, the specific team here may be a team different from the team to which the user 10 of the robot 100 belongs, that is, an opponent team. By scanning the emotions of the competitors of the opponent team, specifying a competitor having the most unstable or irritated emotion, and advancing the game by focusing on a position of the competitor (for example, in a case in which the competition content is volleyball, the ball distribution is concentrated toward the competitor whose emotion is unstable or irritated), the game will be advantageously advanced. In consideration of the above points, the competitor whose feature is specified by the feature specifying unit may be a competitor belonging to a specific team among a plurality of competitors in the competition space. More specifically, the specific team may be a team different from the team to which the user belongs, in other words, an opponent team. By scanning features of each competitor of the opponent team, specifying a competitor having a specific habit or a competitor who frequently makes mistakes, and providing information regarding the features of the competitor to the user, it is possible to assist in effective strategy creation.

Specifically, a competitor making a large number of mistakes or a competitor having a specific habit may be a weak point of the team. Therefore, in the present embodiment, the features of each competitor determined by the robot 100 are transmitted to the user, for example, the manager of one team in competition, thereby providing an element for advantageously advancing the game in competition.

As described above, in a case in which a manager or the like uses the robot 100 during a game in the type of competition in which teams face each other, it can be expected that the game will be developed dominantly. Specifically, by specifying the most mentally unstable player during the competition and executing a strategy of thoroughly aiming at the player, the probability of winning the game may increase. In a case in which such a robot 100 is used during a game in the type of competition in which teams face each other, it can be expected that the game will be developed dominantly. Specifically, a player or the like with many mistakes is specified during the competition, and a strategy of intensively attacking the position of the player is adopted, so that the probability of winning the game may increase.

The emotion determination unit 232 may determine an emotion of the user according to a specific mapping. Specifically, the emotion determination unit 232 may determine an emotion of the user on the basis of an emotion map (see FIG. 5) that is a specific mapping.

FIG. 5 is a diagram illustrating an emotion map 400 on which a plurality of emotions are mapped. In the emotion map 400, emotions are disposed concentrically radially from the center. The closer to the center of the concentric circle, the more the emotion of the primitive state is disposed. Emotions indicating states and actions generated from the state of mind are disposed outside the concentric circle. The emotion is a concept including an affection and a mental state. On the left side of the concentric circle, emotions generated from reactions generally occurring in the brain are disposed. On the right side of the concentric circle, emotions induced by situation determination are generally disposed. In the up and down directions of the concentric circles, emotions generated from reactions generally occurring in the brain and induced by situation determination are disposed. The emotion of “pleased” is disposed on the upper side of the concentric circle, and the emotion of “displeased” is disposed on the lower side. As described above, in the emotion map 400, a plurality of emotions are mapped on the basis of a structure in which emotions occur, and emotions that are likely to occur at the same time are mapped close to each other.

(1) For example, in a case in which the emotion engine, which is the emotion determination unit 232 of the robot 100, detects an emotion at about 100 msec, determination of the reaction operation (for example, a quick-response) of the robot 100 may be performed at a timing at which a detection frequency is set to be similar to at least the detection frequency (100 msec) of the emotion engine, or may be performed at a timing at which the detection frequency is set to be higher than the detection frequency. The detection frequency of the emotion engine may be interpreted as a sampling rate.

The emotion is detected in about 100 msec, and the reaction operation (for example, a quick-response) is performed immediately in conjunction with the detection, whereby an unnatural quick-response is eliminated, and a dialogue in which natural air is read can be realized. The robot 100 performs a reaction operation (quick-response or the like) according to the directionality and the degree (intensity) of the mandala of the emotion map 400. The detection frequency (sampling rate) of the emotion engine is not limited to 100 ms, and may be changed according to a situation (for example, in the case of playing sports), the age of the user, or the like.

(2) In comparison with the emotion map 400, the directionality of the emotion and the intensity of the degree thereof may be set in advance, and the quick-response motion and the strength of the quick-response may be set. For example, in a case in which the robot 100 feels a sense of stability, safety, or the like, the robot 100 continues listening to the speech while nodding. In a case in which the robot 100 feels anxious, hesitant, or suspicious, the robot 100 may tilt its head or stop swinging.

These emotions are distributed in the 3:00 direction of the emotion map 400, and usually come and go between safety and anxiety. In the right half of the emotion map 400, situation recognition is superior to internal sensation, and thus gives a calm impression.

(3) In a case in which the robot 100 feels good in the case of receiving the compliment, a filler “Oh” may come in front of the line. In a case in which the robot 100 feels pain in the case of receiving harsh words, a filler “Ohh!” may come in front of the line. A physical reaction such as a gesture of the robot 100 crouching while saying “Ohh!” may be included. These emotions are distributed around 9:00 on the emotion map 400.

(4) In the left half of the emotion map 400, internal sensation (reaction) is superior to situation recognition. Therefore, an impression of unintentional reaction may be given.

In a case in which the robot 100 has a favorable feeling in situation recognition while feeling internal sensation (reaction) of satisfaction, the robot 100 may nod deeply while looking at the other party, or may say “yeah, yeah”. As described above, the robot 100 may generate a balanced favorable feeling to the other party, that is, an action such as allowance or tolerance to the other party. Such emotions are distributed around 12:00 in the emotion map 400.

In contrast, in a case in which the robot 100 feels antipathy in the situation recognition while feeling internal sensation (reaction) of displeasure, the robot 100 may shake its head sideways, and may turn red the LED of the eye and look at the other party in the case of feeling hatred. Such emotions are distributed around 6:00 in the emotion map 400.

(5) Since the inside of the emotion map 400 represents the inside of the mind and the outside of the emotion map 400 represents an action, the emotion is more visible (appears in the action) toward the outside of the emotion map 400.

(6) In a case in which the robot 100 listens to a person's speech while feeling the safety distributed around 3:00 on the emotion map 400, the robot slightly shakes its head vertically and says “uh-huh”. However, in the direction of love around 12:00, the robot may perform strong nodding such as shaking its head deeply vertically.

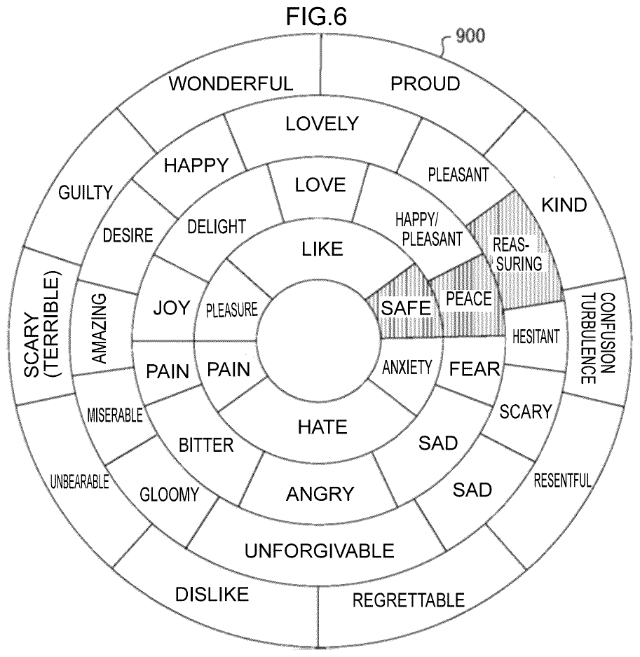

The emotion determination unit 232 inputs the information analyzed by the sensor module unit 210 and the recognized state of the user 10 to a neural network trained in advance, acquires an emotion value indicating each emotion indicated in the emotion map 400, and determines an emotion of the user 10. This neural network is trained in advance on the basis of a plurality of pieces of learning data that are a combination of the information analyzed by the sensor module unit 210 and the recognized state of the user 10 and the emotion value indicating each emotion indicated in the emotion map 400. This neural network is trained such that, as in an emotion map 900 illustrated in FIG. 6, emotions disposed close to each other have close values. FIG. 6 illustrates an example in which a plurality of emotions such as “safe”, “calm”, and “reassuring” have close emotion values.

The emotion determination unit 232 may determine an emotion of the robot 100 according to a specific mapping. Specifically, the emotion determination unit 232 inputs the information analyzed by the sensor module unit 210, the state of the user 10 recognized by the state recognition unit 230, and the state of the robot 100 to a neural network trained in advance, acquires an emotion value indicating each emotion indicated in the emotion map 400, and determines an emotion of the robot 100. This neural network is trained in advance on the basis of a plurality of pieces of learning data that are a combination of the information analyzed by the sensor module unit 210, the recognized state of the user 10, the state of the robot 100, and the emotion value indicating each emotion illustrated in the emotion map 400. For example, the neural network is trained on the basis of learning data indicating that the emotion value “3” of “happy” is obtained in a case in which the robot 100 is recognized as being petted by the user 10 from the output of the touch sensor (not illustrated), and learning data indicating that the emotion value “3” of “angry” is obtained in a case in which the robot 100 is recognized as being hit by the user 10 from the output of the acceleration sensor (not illustrated). This neural network is trained such that, as in the emotion map 900 illustrated in FIG. 6, emotions disposed close to each other have close values.

The action determination unit 236 adds a fixed sentence for inquiry about the action content of the robot corresponding to the action of the user to text representing the action of the user, the emotion of the user, and the emotion of the robot, and inputs the text to the sentence generation model having the interaction function, thereby generating the action content of the robot.

For example, the action determination unit 236 acquires text indicating the state of the robot 100 from the emotion of the robot 100 determined by the emotion determination unit 232 by using an emotion table as illustrated in Table 1. Here, in the emotion table, an index number is assigned to each emotion value for each type of emotion, and text indicating the state of the robot 100 is stored for each index number.

In a case in which the emotion of the robot 100 determined by the emotion determination unit 232 corresponds to the index number “2”, text “very pleasant state” is obtained. In a case in which the emotion of the robot 100 corresponds to a plurality of index numbers, a plurality of pieces of text indicating the state of the robot 100 are obtained.

An emotion table as illustrated in Table 2 is prepared for an emotion of the user 10. Here, in a case in which the action of the user is to say “Is there a player who is irritated?”, the emotion of the robot 100 is the index number “2”, and the emotion of the user 10 is the index number “3”, a sentence such as “The robot is in a very pleasant state. The user is in a normally pleasant state. The user says, “Is there a player who is irritated?” How do you answer as a robot?” is input to the sentence generation model to acquire the action content of the robot. The action determination unit 236 determines an action of the robot from the action content.

TABLE 1

| Index | Type of | Emotion | State of |
|---|---|---|---|
| Number | Emotion | Value | Robot |
| 1 | Pleasant | 5 | Very Pleasant State |
| 2 | Pleasant | 4 | Extremely Pleasant State |
| 3 | Pleasant | 3 | Normally Pleasant State |
| 4 | Pleasant | 2 | Slightly Pleasant State |
| 5 | Pleasant | 1 | Only a Little Pleasant State |
| . . . | . . . | . . . | . . . |

TABLE 2

| Index | Type of | Emotion | |
|---|---|---|---|
| Number | Emotion | Value | State of User |
| 1 | Pleasant | 5 | Very Pleasant State |
| 2 | Pleasant | 4 | Extremely Pleasant State |
| 3 | Pleasant | 3 | Normally Pleasant State |
| 4 | Pleasant | 2 | Slightly Pleasant State |
| 5 | Pleasant | 1 | Only a Little Pleasant State |
| . . . | . . . | . . . | . . . |

As described above, since the robot 100 can change the action of the robot according to the index number corresponding to the emotion of the robot, the user has an impression that the robot has a mind, and is promoted to take an action such as talking to the robot.

In a case in which a question about the competitor is received as described above, the action determination unit 236 may determine the action of the robot also using the analysis result from the competitor emotion analysis unit described above. Specifically, as an answer to the above-described question from the user, for example, an analysis result such as “the second player of the opponent team is quite irritated” may be spoken.

The action determination unit 236 may generate the action content of the robot by adding a fixed sentence for inquiry about the action content of the robot corresponding to the action of the user and inputting the fixed sentence to the sentence generation model having the interaction function after adding not only the text indicating the action of the user, the emotion of the user, and the emotion of the robot but also the text indicating the content of the history data 2222. As a result, the robot 100 can change the action of the robot according to the history data indicating the emotion or the action of the user, and thus, the user has an impression that the robot has personality, and is promoted to take an action such as talking to the robot. The history data may further include an emotion or an action of the robot.

The emotion determination unit 232 may determine an emotion of the robot 100 on the basis of the action content of the robot 100 generated by the sentence generation model. Specifically, the emotion determination unit 232 inputs the action content of the robot 100 generated by the sentence generation model to the neural network trained in advance, acquires the emotion value indicating each emotion indicated in the emotion map 400, integrates the acquired emotion value indicating each emotion and the emotion value indicating each emotion of the current robot 100, and updates the emotion of the robot 100. For example, the acquired emotion value indicating each emotion and the emotion value indicating each emotion of the current robot 100 are averaged and integrated. This neural network is trained in advance on the basis of a plurality of pieces of learning data that is a combination of text representing the action content of the robot 100 generated by the sentence generation model and the emotion value representing each emotion illustrated in the emotion map 400.

For example, in a case in which, as the action content of the robot 100 generated by the sentence generation model, the speech content of the robot 100, “That was good. “Lucky you.” is obtained, when the text representing the speech content is input to the neural network, a great value is obtained as the emotion value of the emotion “happy”, and the emotion of the robot 100 is updated so that the emotion value of the emotion “happy” increases.

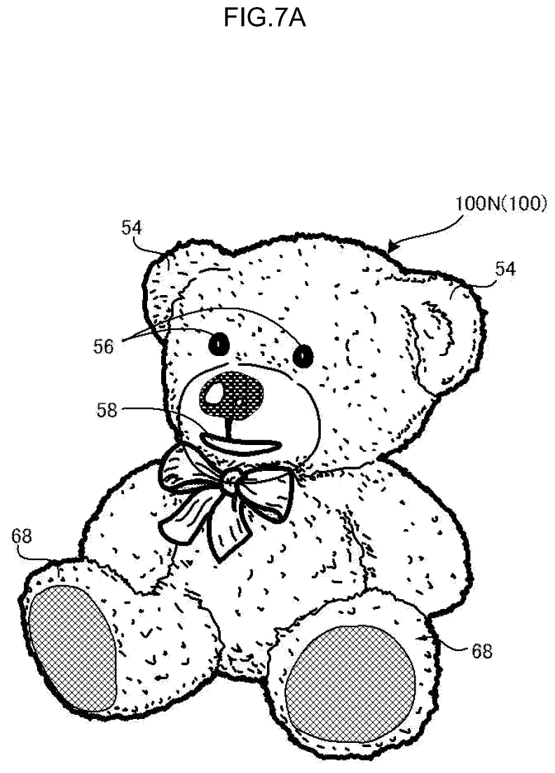

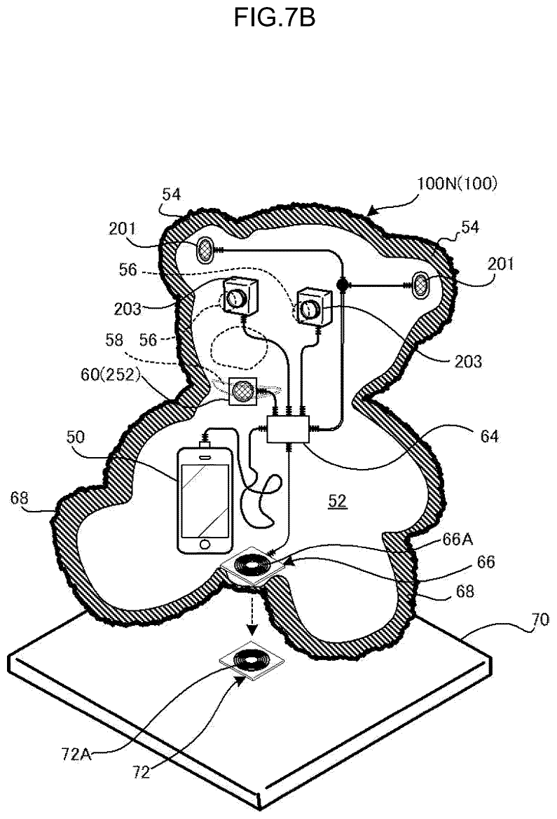

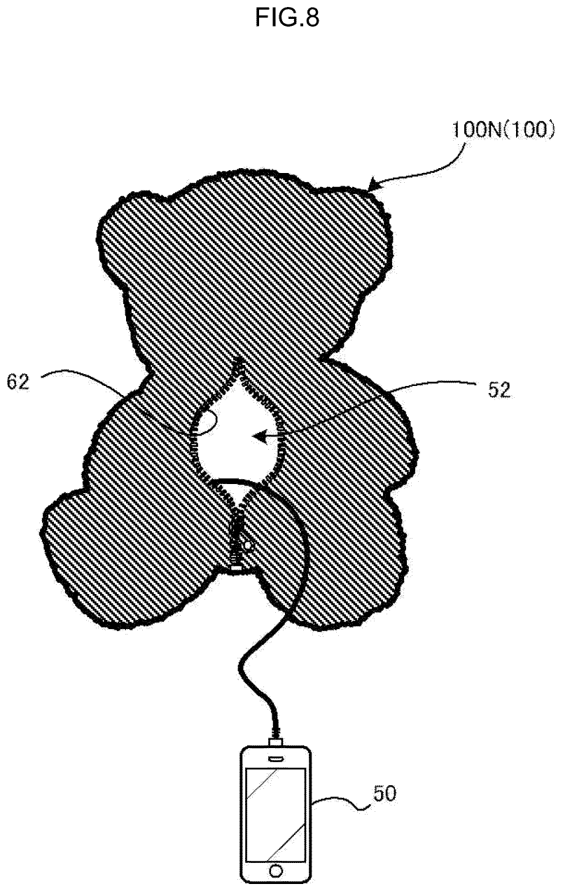

The robot 100 may be mounted on a stuffed toy, or may be applied to a control device connected wirelessly or by wire to a control target device (speaker or camera) mounted on the stuffed toy. In this case, specifically, the robot is configured as follows. For example, the robot 100 may be applied to a cohabiter (specifically, a stuffed toy 100N illustrated in FIGS. 7 and 8) who advances a dialogue with the user 10 on the basis of information regarding daily life while spending daily life with the user 10 or provides information matching the hobby of the user 10. In the present embodiment (another embodiment), an example in which the control portion of the robot 100 is applied to a smartphone 50 will be described.

The smartphone 50 functioning as a control portion of the robot 100 is detachably attached to the stuffed toy 100N having a function as an input/output device of the robot 100, and the input/output device and the accommodated smartphone 50 are connected inside the stuffed toy 100N.

As illustrated in FIG. 7(A), the stuffed toy 100N has the shape of a bear covered with a soft cloth fabric in the present embodiment (an embodiment mounted on the stuffed toy). As illustrated in FIG. 7(B), in a space portion 52 formed inside the stuffed toy, the microphone 201 (see FIG. 2) of the sensor unit 200 is disposed in a portion corresponding to an ear 54 as an input/output device, the 2D camera 203 of the sensor unit 200 is disposed in a portion corresponding to the eye 56 (see FIG. 2), and a speaker 60 configuring a part of the control target 252 (see FIG. 2) is disposed in a portion corresponding to a mouth 58. The microphone 201 and the speaker 60 are not necessarily separated from each other, and may be an integrated unit. In the case of the unit, it is preferable to dispose the unit at a position where the speech can be heard naturally, such as the position of the nose of the stuffed toy 100N. Although the case in which the stuffed toy 100N has an animal shape has been described as an example, the disclosed technology is not limited thereto. The stuffed toy 100N may have a shape of a specific character.

The smartphone 50 has a function as the sensor module unit 210, a function as the storage unit 220, a function as the state recognition unit 230, a function as the emotion determination unit 232, a function as the action recognition unit 234, a function as the action determination unit 236, a function as the storage control unit 238, a function as the action control unit 250, and a function as the communication processing unit 280 illustrated in FIG. 2.

As illustrated in FIG. 8, a fastener 62 is attached to a part (for example, the back portion) of the stuffed toy 100N, and the outside and the space portion 52 communicate with each other by opening the fastener 62.

Here, the smartphone 50 is accommodated in the space portion 52 from the outside and is connected to each input/output device through USB connection via a USB hub 64 (see FIG. 7(B)), so that a function equivalent to that of the robot 100 illustrated in FIG. 1 can be provided.

A non-contact power receiving plate 66 is connected to the USB hub 64. A power receiving coil 66A is incorporated in the power receiving plate 66. The power receiving plate 66 is an example of a wireless power receiver that receives wireless power supply.

The power receiving plate 66 is disposed near root portions 68 of both feet of the stuffed toy 100N, and is located closest to a placement base 70 in a case in which the stuffed toy 100N is placed on the placement base 70. The placement base 70 is an example of an external wireless power transmitter.

The stuffed toy 100N placed on the placement base 70 can be appreciated as an ornament in a natural state.

This root portion is formed to be thinner than the surface layer thickness of the stuffed toy 100N in other parts, and is held in a state closer to the placement base 70.

The placement base 70 includes a charging pad 72. A power transmitting coil 72A is incorporated in the charging pad 72. In a case in which the power transmitting coil 72A transmits a signal to search a power receiving coil 66A of the power receiving plate 66, and the power receiving coil 66A is found, a current flows through the power transmitting coil 72A to generate a magnetic field, and the power receiving coil 66A reacts to the magnetic field to start electromagnetic induction. As a result, a current flows through the power receiving coil 66A, and power is stored in a battery (not illustrated) of the smartphone 50 via the USB hub 64.

That is, since the smartphone 50 is automatically charged by placing the stuffed toy 100N as an ornament on the placement base 70, it is not necessary to take out the smartphone 50 from the space portion 52 of the stuffed toy 100N for charging.

In the present embodiment (the embodiment mounted on the stuffed toy), the smartphone 50 is accommodated in the space portion 52 of the stuffed toy 100N and connected by wire (USB connection), but the disclosed technology is not limited thereto. For example, a control device having a wireless function (for example, “Bluetooth (registered trademark)”) may be accommodated in the space portion 52 of the stuffed toy 100N, and the control device may be connected to the USB hub 64. In this case, the smartphone 50 and the control device wirelessly communicate with each other without inserting the smartphone 50 into the space portion 52, and the external smartphone 50 is connected to each input/output device via the control device, so that a function equivalent to that of the robot 100 illustrated in FIG. 1 can be provided. The control device in which the control device is accommodated in the space portion 52 of the stuffed toy 100N and the external smartphone 50 may be connected by wire.

In the present embodiment (the embodiment mounted on the stuffed toy), the stuffed toy 100N having a bear shape has been exemplified, but may be another animal or a doll, or may have a shape of a specific character. The clothes may be changeable. A material of the skin is not limited to the cloth fabric, and may be other materials such as soft vinyl, but is preferably a soft material.

A monitor may be attached to the skin of the stuffed toy 100N, and the control target 252 that provides information to the user 10 through vision may be added. For example, the eyes 56 may be used as a monitor to express happiness, anger, sadness, and pleasure with images captured in the eyes, or a window through which the monitor of the built-in smartphone 50 transmits may be provided in the abdomen. The eyes 56 may be used as a projector to express happiness, anger, sadness, and pleasure by using an image projected on a wall surface.

According to another embodiment, the existing smartphone 50 is placed in the stuffed toy 100N, and the camera 203, the microphone 201, the speaker 60, and the like are extended from the place to appropriate positions through the USB connection.

For wireless charging, the smartphone 50 and the power receiving plate 66 are connected through USB connection, and the power receiving plate 66 is disposed on the outside as much as possible when viewed from the inside of the stuffed toy 100N.

In order to use the wireless charging of the smartphone 50, it is necessary to dispose the smartphone 50 on the outside as much as possible when viewed from the inside of the stuffed toy 100N, and the stuffed toy 100N is rough in the case of being touched from the outside.

Therefore, the smartphone 50 is disposed at the center of the stuffed toy 100N as much as possible, and the wireless charging function (power receiving plate 66) is disposed outside as viewed from the inside of the stuffed toy 100N as much as possible. The camera 203, the microphone 201, the speaker 60, and the smartphone 50 receive wireless power supply via the power receiving plate 66.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of an interaction function of allowing the user and the robot to interact with each other, and determines an action of the robot corresponding to the action content, in which
the action determination unit includes
an image acquisition unit capable of imaging a competition space in which a specific competition is able to be performed, and
a competitor emotion analysis unit that analyzes emotions of a plurality of competitors performing a competition in the competition space imaged by the image acquisition unit, and
determines an action of the robot on the basis of an analysis result from the competitor emotion analysis unit.

### (Supplementary Note 2)

The action control system according to Supplementary Note 1, in which the competitor emotion analysis unit analyzes an emotion of a competitor belonging to a specific team among the plurality of competitors.

### (Supplementary Note 3)

The action control system according to Supplementary Note 1 or 2, in which the robot is mounted on a stuffed toy or is connected to a control target device mounted on the stuffed toy in a wireless or wired manner.

### Other Embodiment 2

The robot 100 of the present embodiment includes an image acquisition unit that captures an image of a competition space in which a specific competition can be performed. The image acquisition unit can be realized, for example, by using a part of the sensor unit 200 described above. Here, the specific competition may be a sport performed by a team including a plurality of people, such as volleyball, soccer, or rugby. The competition space may include a space corresponding to each competition, for example, a volleyball court or a soccer ground. The competition space may include a peripheral region of the above-described court or the like.

It is preferable that the installation position of the robot 100 is considered so that the competition space can be viewed by the image acquisition unit. Alternatively, the image acquisition unit of the robot 100 may be installed at a position where the competition space can be viewed separately from the robot 100.

The robot 100 of the present embodiment further includes a feature specifying unit capable of specifying features of a plurality of competitors in the images acquired by the image acquisition unit described above. The feature specifying unit can specify features of a plurality of competitors by analyzing past competition data, or collecting and analyzing information regarding each competitor from an SNS or the like, according to a method similar to the method of determining an emotion value in the emotion determination unit 232, or combining one or more of these methods.

The features of the competitor indicate information related to the ability related to the competition and the current or recent condition of the competitor, such as habits, movements, the number of mistakes, bad movements, and reaction speed of the competitor.

In a case in which a feature of a competitor playing a specific competition, e.g. volleyball, can be specified, the game can be advantageously advanced by reflecting that specified result in the team's strategy. Specifically, a competitor making a large number of mistakes or a competitor having a specific habit may be a weak point of the team. Therefore, in the present embodiment, the features of each competitor determined by the robot 100 are transmitted to the user, for example, the manager of one team in competition, thereby providing an element for advantageously advancing the game in competition.

In consideration of the above points, a competitor whose feature is specified by the feature specifying unit may be a competitor belonging to a specific team among a plurality of competitors in the competition space. More specifically, the specific team may be a team different from the team to which the user belongs, in other words, an opponent team. By scanning a feature of each competitor of the opponent team, specifying a competitor having a specific habit or a competitor who frequently makes mistakes, and providing information regarding the feature of the competitor to the user, it is possible to assist in effective strategy creation.

In a case in which such a robot 100 is used during a game in the type of competition in which teams face each other, it can be expected that the game will be developed dominantly. Specifically, a player or the like making many mistakes during the competition is specified, and a strategy of intensively attacking the position of the player is adopted, so that the probability of winning the game may increase.

The emotion determination unit 232 may determine an emotion of the user according to a specific mapping. Specifically, the emotion determination unit 232 may determine an emotion of the user on the basis of an emotion map (see FIG. 5) that is a specific mapping.

The action determination unit 236 adds a fixed sentence for inquiry about the action content of the robot corresponding to the action of the user to text representing the action of the user, the emotion of the user, and the emotion of the robot, and inputs the text to the sentence generation model having the interaction function, thereby generating the action content of the robot.

For example, the action determination unit 236 acquires text indicating the state of the robot 100 from the emotion of the robot 100 determined by the emotion determination unit 232 by using an emotion table as illustrated in Table 1. Here, in the emotion table, an index number is assigned to each emotion value for each type of emotion, and text indicating the state of the robot 100 is stored for each index number.

In a case in which the emotion of the robot 100 determined by the emotion determination unit 232 corresponds to the index number “2”, text “very pleasant state” is obtained. In a case in which the emotion of the robot 100 corresponds to a plurality of index numbers, a plurality of pieces of text indicating the state of the robot 100 are obtained.

An emotion table as illustrated in Table 2 is prepared for an emotion of the user 10. Here, in a case in which the action of the user is to say “Tell me the weak point of the opponent team”, the emotion of the robot 100 is the index number “2”, and the emotion of the user 10 is the index number “3”, a sentence such as “The robot is in a very pleasant state. The user is in a normally pleasant state. The user says “Tell me the weak point of the opponent team”. How do you answer as a robot?” is input to the sentence generation model to acquire the action content of the robot. The action determination unit 236 determines an action of the robot from the action content.

As described above, the action determination unit 236 determines the action content of the robot 100 in accordance with the state related to the emotion of the robot 100 defined in advance for each type of the emotion of the robot 100 and for each intensity of the emotion, and the action of the user 10. In this embodiment, the speech content of the robot 100 in a case in which an interaction with the user 10 is performed can be branched according to the state related to the emotion of the robot 100. That is, since the robot 100 can change the action of the robot according to the index number corresponding to the emotion of the robot, the user has an impression that the robot has a mind, and is promoted to take an action such as talking to the robot.

In a case in which a question about the competitor is received as described above, the action determination unit 236 may determine the action of the robot also using the above-described specified result of the feature specifying unit described above. Specifically, as an answer to the question from the user described above, for example, it is preferable to say a specific result such as “The second player of the opponent team makes the most mistakes today”.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which
the action determination unit includes
an image acquisition unit capable of imaging a competition space in which a specific competition is able to be performed, and
a feature specifying unit that specifies features of a plurality of competitors performing a competition in the competition space imaged by the image acquisition unit, and
determines an action of the robot on the basis of a specified result from the feature specifying unit.

### (Supplementary Note 2)

The action control system according to Supplementary Note 1, in which the feature specifying unit specifies a feature of a competitor belonging to a specific team among the plurality of competitors.

### (Supplementary Note 3)

The action control system according to Supplementary Note 1 or 2, in which the robot is mounted on a stuffed toy, or is connected to a control target device mounted on the stuffed toy in a wireless or wired manner.

### Other Embodiment 3

The robot 100 of the present embodiment has a clocking function and is configured to be activated at a predetermined time. The action determination unit 236 generates action content of the robot with respect to the action of the user and the emotion of the user or the emotion of the robot on the basis of a sentence generation model having an interaction function of allowing the user and the robot to interact with each other, and determines the action of the robot corresponding to the action content. In this case, when activated at a predetermined time, the action determination unit 236 adds a fixed sentence for giving an instruction for summarizing a history of the previous day to text representing the history data of the previous day, and inputs the text to the sentence generation model to acquire a summary of the history of the previous day, and speaks the content of the acquired summary.

Specifically, when activated in the morning (for example, from 5:00 to 9:00), the action determination unit 236 adds a fixed sentence “Summarize this content” to the text representing the history data of the previous day, inputs the text to the sentence generation model to acquire a summary of the history of the previous day, and speaks the content of the acquired summary.

The emotion determination unit 232 may determine an emotion of the user according to a specific mapping. Specifically, the emotion determination unit 232 may determine an emotion of the user on the basis of an emotion map (see FIG. 5) that is a specific mapping.

The action determination unit 236 adds a fixed sentence for inquiry about the action content of the robot corresponding to the action of the user to text representing the action of the user, the emotion of the user, and the emotion of the robot, and inputs the text to the sentence generation model having the interaction function, thereby generating the action content of the robot.

For example, the action determination unit 236 acquires text indicating the state of the robot 100 from the emotion of the robot 100 determined by the emotion determination unit 232 by using an emotion table as illustrated in Table 1. Here, in the emotion table, an index number is assigned to each emotion value for each type of emotion, and text indicating the state of the robot 100 is stored for each index number.

In a case in which the emotion of the robot 100 determined by the emotion determination unit 232 corresponds to the index number “2”, text “very pleasant state” is obtained. In a case in which the emotion of the robot 100 corresponds to a plurality of index numbers, a plurality of pieces of text indicating the state of the robot 100 are obtained.

An emotion table as illustrated in Table 2 is prepared for an emotion of the user 10.

Here, in a case in which the action of the user is to say “XXX”, the emotion of the robot 100 is the index number “2”, and the emotion of the user 10 is the index number “3”, a sentence such as “The robot is in a very pleasant state. The user is in a normally pleasant state. The user says “XXX”. How do you answer as a robot?” is input to the sentence generation model to acquire the action content of the robot. The action determination unit 236 determines an action of the robot from the action content.

As described above, the action determination unit 236 determines the action content of the robot 100 in accordance with the state related to the emotion of the robot 100 defined in advance for each type of the emotion of the robot 100 and for each intensity of the emotion, and the action of the user 10. In this embodiment, the speech content of the robot 100 in a case in which an interaction with the user 10 is performed can be branched according to the state related to the emotion of the robot 100. That is, since the robot 100 can change the action of the robot according to the index number corresponding to the emotion of the robot, the user has an impression that the robot has a mind, and is promoted to take an action such as talking to the robot.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which
when the action determination unit is activated at a predetermined time, the action determination unit adds a fixed sentence for giving an instruction for summarizing a history of a previous day to text representing history data of the previous day, inputs the text to the sentence generation model to acquire a summary of the history of the previous day, and speaks content of the acquired summary.

### (Supplementary Note 2)

The action control system according to Supplementary Note 1, in which the robot is mounted on a stuffed toy or is connected to a control target device mounted on the stuffed toy in a wireless or wired manner.

### Other Embodiment 4

The robot 100 of the present embodiment has a clocking function and is configured to be activated at a predetermined time. The robot 100 according to the present embodiment includes an image generation model, and is configured to generate an image corresponding to an input sentence. The action determination unit 236 generates action content of the robot with respect to the action of the user and the emotion of the user or the emotion of the robot on the basis of a sentence generation model having an interaction function of allowing the user and the robot to interact with each other, and determines the action of the robot corresponding to the action content. In this case, when activated at a predetermined time, the action determination unit 236 adds a fixed sentence for giving an instruction for summarizing a history of the previous day to text representing the history data of the previous day, inputs the text to the sentence generation model to acquire a summary of the history of the previous day, inputs the acquired summary of the history of the previous day to the image generation model to acquire an image summarizing the history of the previous day, and displays the acquired image.

Specifically, when activated in the morning (for example, from 5:00 to 9:00), the action determination unit 236 adds a fixed sentence “Summarize this content” to the text representing the history data of the previous day, inputs the text to the sentence generation model to acquire a summary of the history of the previous day, inputs the acquired summary of the history of the previous day to the image generation model to acquire an image summarizing the history of the previous day, and displays the acquired image.

As described above, the action determination unit 236 determines the action content of the robot 100 in accordance with the state related to the emotion of the robot 100 defined in advance for each type of the emotion of the robot 100 and for each intensity of the emotion, and the action of the user 10. In this embodiment, the speech content of the robot 100 in a case in which an interaction with the user 10 is performed can be branched according to the state related to the emotion of the robot 100. That is, since the robot 100 can change the action of the robot according to the index number corresponding to the emotion of the robot, the user has an impression that the robot has a mind, and is promoted to take an action such as talking to the robot.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which
when the action determination unit is activated at a predetermined time, the action determination unit adds a fixed sentence for giving an instruction for summarizing a history of a previous day to text representing history data of the previous day, inputs the text to the sentence generation model to acquire a summary of the history of the previous day, inputs the acquired summary of the history of the previous day to an image generation model to acquire an image summarizing the history of the previous day, and displays the acquired image.

### (Supplementary Note 2)

The action control system according to Supplementary Note 1, in which the robot is mounted on a stuffed toy or is connected to a control target device mounted on the stuffed toy in a wireless or wired manner.

### Other Embodiment 5

The robot 100 of the present embodiment has a clocking function and is configured to be activated at a predetermined time.

The action determination unit 236 generates action content of the robot with respect to the action of the user and the emotion of the user or the emotion of the robot on the basis of a sentence generation model having an interaction function of allowing the user and the robot to interact with each other, and determines the action of the robot corresponding to the action content. In this case, when activated at a predetermined time, the action determination unit 236 determines the emotion of the robot corresponding to the history of the previous day by adding a fixed sentence for inquiry about an emotion that the robot should have to text representing the history data of the previous day and inputting the text to the sentence generation model.

Specifically, when activated in the morning (for example, from 5:00 to 9:00), the action determination unit 236 adds a fixed sentence “What emotion should the robot have?” to the text representing the history data of the previous day and inputs the text to the sentence generation model, thereby determining the emotion of the robot based on the history of the previous day.

The emotion determination unit 232 may determine the emotion of the user according to a specific mapping. Specifically, the emotion determination unit 232 may determine the emotion of the user on the basis of an emotion map (see FIG. 5) that is a specific mapping.

As described above, the action determination unit 236 determines the action content of the robot 100 in accordance with the state related to the emotion of the robot 100 defined in advance for each type of the emotion of the robot 100 and for each intensity of the emotion, and the action of the user 10. In this embodiment, the speech content of the robot 100 in a case in which an interaction with the user 10 is performed can be branched according to the state related to the emotion of the robot 100. That is, since the robot 100 can change the action of the robot according to the index number corresponding to the emotion of the robot, the user has an impression that the robot has a mind, and is promoted to take an action such as talking to the robot.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which
when the action determination unit is activated at a predetermined time, the action determination unit adds a fixed sentence for inquiry about an emotion that the robot is to have to text representing history data of a previous day, and inputs the text to the sentence generation model to determine an emotion of the robot corresponding to a history of the previous day.

### (Supplementary Note 2)

The action control system according to Supplementary Note 1, in which the robot is mounted on a stuffed toy or is connected to a control target device mounted on the stuffed toy in a wireless or wired manner.

### Other Embodiment 6

For example, at a timing at which the user wakes up, the action determination unit 236 may add a fixed sentence for inquiry about an emotion of the user, such as “Do you think what kind of emotion the user has” to history data including a history of actions and emotions of the user of the previous day, input the history data to which the text is added to the interaction function, and determine an emotion of the user based on the history of the previous day of the user by using the interaction function.

In this case, the action determination unit 236 determines an action of the robot 100 on the basis of the determined emotion of the user. For example, in a case in which the history of the actions and the emotions of the user of the previous day is pleasant, the emotion of the user is bright. Thus, the action determination unit 236 determines the action of the robot 100 on the basis of the interaction function or the reaction rule such that pleasant actions and speech are performed. Conversely, in a case in which the history of the actions and the emotion of the user of the previous day is gloomy, the emotion of the user is dark. Thus, the action determination unit 236 determines an action of the robot 100 on the basis of the interaction function or the reaction rule such that actions and speech that energize the user are performed.

The robot 100 may be mounted on a stuffed toy, or may be applied to a control device connected wirelessly or by wire to a control target device (a speaker or a camera) mounted on the stuffed toy.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of an interaction function of allowing the user and the robot to interact with each other, and determines an action of the robot corresponding to the action content, in which
the action determination unit, at a timing at which the user wakes up, adds a fixed sentence for inquiry about an emotion of the user to history data including a history of actions and emotions of the previous day of the user, and inputs the history data to the interaction function to determine an emotion based on the history of the previous day of the user.

### (Supplementary Note 2)

The action control system according to supplementary note 1, in which the robot is mounted on a stuffed toy or is connected to a control target device mounted on the stuffed toy in a wireless or wired manner.

### Other Embodiment 7

The action determination unit 236 may add a fixed sentence “Please summarize this content” to text of the action and the emotion of the previous day of the user included in the history data of the user and input the text to the sentence generation model at a timing at which the user wakes up, and acquire a summary of the history data of the previous day of the user, that is, the summary of the action and the emotion of the previous day of the user by using the sentence generation model. The action determination unit 236 may input the acquired summary to a music generation engine, acquire music summarizing the history of the actions and emotions of the user of the previous day from the music generation engine, and reproduce the acquired music. For example, in a case in which the summary of the history of the actions of the user of the previous day is “Yesterday was her birthday, we had dinner at a fancy restaurant, and it was very pleasant”, the music generation engine generates music optimized for the actions and emotions of the user of the previous day by adding a melody to the summary. The action determination unit 236 acquires and reproduces music generated by the music generation engine. As a result, the user can wake up while looking back on the actions and emotions of the previous day with music.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of an interaction function of allowing the user and the robot to interact with each other, and determines an action of the robot corresponding to the action content, in which
the action determination unit, at a timing at which the user wakes up, acquires a summary of history data including a history of actions and emotions of the user of a previous day, acquires music based on the summary, and reproduces the music.

### Other Embodiment 8

An action system of a robot 100 according to another embodiment includes an emotion determination unit that determines an emotion of a user or an emotion of a robot, and an action determination unit that generates action content of the robot with respect to an action of the user and the emotion of the user or the emotion of the robot on the basis of an interaction function of allowing the user and the robot to interact with each other, and determines an action of the robot corresponding to the action content. The action determination unit, when the robot plays a battle game of winning/losing or superiority/inferiority with the user, determines a user level indicating a strength of the user with respect to the battle game in the battle game, and sets a robot level indicating a strength of the robot according to the determined user level.

When the user 10 and the robot 100 are playing a card game or the like which is one of battle games, the robot 100 stores an index (user level) of the strength of the user 10. An index (robot level) of the strength of the computer slightly weaker than the strength (user level) of the user 10 is set such that, when playing the card game with the user 10, the user 10 always wins but is not completely victorious.

That is, the robot 100 can determine a battle situation that the user 10 can enjoy and advance the battle game.

The situation in which the user 10 always wins but is not completely victorious can be realized by setting the robot level lower than the user level. As a result, it is possible to maintain a battle that favors the user. It is preferable to have clear distinctions between advantages and disadvantages in one battle game, which the user loses at least once in several times.

The robot level may be adjusted on the basis of the emotion of the user 10 who is executing a battle game such as a card game.

The user 10 may have different emotions in the mood at the time of battle, for example, wanting to win at all, wanting to enjoy a close game regardless of win or loss, or wanting to lose as much as possible. Therefore, adjusting the robot level on the basis of the emotion of the user 10 at the time of the battle enables the battle to be advanced in accordance with the emotion of the user 10 at the time of the battle.

So-called big data for the battle game of the user 10 is constructed by storing the skill of the user every time the battle game such as a card game is executed. For example, by performing learning using the stored big data, it is possible to predict the degree of improvement or the like of the user 10 in the future from the transition of the skill of the user 10, and to set the robot level in accordance with this prediction.

Each of the user level and the robot level is preferably expressed by a numerical value (for example, 0 to 100) (the user 10 is notified), but may be classified in stages such as “weakest (0 to 20)”, “weak (21 to 40)”, “normal (41 to 60)”, “strong (61 to 80)”, and “strongest (81 to 100)” by providing a range to the numerical value. In a case in which the robot level is visually expressed, a numerical value of the robot level may be displayed on the display unit of the robot 100, or the robot level may be expressed by changing a shape, a color (hue), a luminance (brightness), and a saturation (vividness) of a part (for example, eyes, face, hands, or feet) of the robot 100.

The emotion determination unit 232 may determine the emotion of the user according to a specific mapping. Specifically, the emotion determination unit 232 may determine the emotion of the user on the basis of an emotion map (see FIG. 5) that is a specific mapping.

The action determination unit 236 adds a fixed sentence for inquiry about the action content of the robot corresponding to the action of the user to text representing the action of the user, the emotion of the user, and the emotion of the robot, and inputs the text to the sentence generation model having the interaction function to generate the action content of the robot.

For example, the action determination unit 236 acquires text indicating the state of the robot 100 from the emotion of the robot 100 determined by the emotion determination unit 232 by using an emotion table as illustrated in Table 1. Here, in the emotion table, an index number is assigned to each emotion value for each type of emotion, and text indicating the state of the robot 100 is stored for each index number.

In a case in which the emotion of the robot 100 determined by the emotion determination unit 232 corresponds to the index number “2”, text “very pleasant state” is obtained. In a case in which the emotion of the robot 100 corresponds to a plurality of index numbers, a plurality of pieces of text indicating the state of the robot 100 are obtained.

An emotion table as illustrated in Table 2 is prepared for an emotion of the user 10. Here, the robot 100 is in a customer interaction mode, and the action of the user 10 is not so much as to talk to a family member, a friend, a lover, or the like, but makes the robot 100 hear content that the user wants to talk to someone. In this case, in a case in which the emotion of the robot 100 is the index number “2”, and the emotion of the user 10 is the index number “3”, a sentence such as “The robot is in a very pleasant state. The user is in a normally pleasant state. The user 10 says, “Tomorrow is my wife's birthday. What should I give her as a present?” How do you answer as a robot?” is input to the sentence generation model to acquire the action content of the robot. The action determination unit 236 determines an action of the robot from the action content.

As described above, since the robot 100 can change the action of the robot according to the index number corresponding to the emotion of the robot, the user has an impression that the robot has a mind, and is promoted to take an action such as talking to the robot.

The action determination unit 236 may generate the action content of the robot by adding a fixed sentence for inquiry about the action content of the robot corresponding to the action of the user and inputting the fixed sentence to the sentence generation model having the interaction function after adding not only the text indicating the action of the user, the emotion of the user, and the emotion of the robot but also the text indicating the content of the history data 2222. As a result, the robot 100 can change the action of the robot according to the history data indicating the emotion or the action of the user, and thus, the user has an impression that the robot has personality, and is promoted to take an action such as talking to the robot. The history data may further include an emotion or an action of the robot.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which
when a battle game for determining win or lose or superiority or inferiority is played with the user, the action determination unit determines a user level indicating a strength of the user with respect to the battle game in the battle game, and sets a robot level indicating a strength of the robot according to the determined user level.

### (Supplementary Note 2)

The action control system according to Supplementary Note 1, in which the robot is mounted on a stuffed toy or is connected to a control target device mounted on the stuffed toy in a wireless or wired manner.

### (Supplementary Note 3)

The action control system according to Supplementary Note 1, in which the robot level is set to be lower than the user level.

### (Supplementary Note 4)

The action control system according to Supplementary Note 1, in which the robot level is adjusted on the basis of an emotion of the user who is executing the battle game.

### (Supplementary Note 5)

The action control system according to Supplementary Note 1, in which a skill of the user is stored every time the battle game is executed, and the user level is determined on the basis of a transition of the stored skill of the user.

### Other Embodiment 9

A robot 100 according to an embodiment of the disclosure includes an emotion determination unit that determines an emotion of a user or an emotion of a robot, and an action determination unit that generates action content of the robot for the action of the user and the emotion of the user or the robot 100's emotion on the basis of an interaction function that causes the robot 100 to interact with the user, and determines an action of the robot 100 corresponding to the action content. In a case in which the action determination unit 236 receives, from the user, a question about which one of two or more things should be selected, the action determination unit may select at least one of two or more things and answer the user on the basis of at least history information regarding the user.

Things include things that the user is interested in, things that the user may be interested in, things that the user likes, and the like.

The questions are “Which clothes A and B are suitable?”, “Which clothes A and B do you choose?”, “Where should I go for a drinking party?”, “Which route to the destination will be fun for the family??”, and the like.

The history information regarding the user may include the user's personality, hobby, preference, past behavior, and the like. The history information regarding the user may include the user's name, age, gender, occupation, income, fund, educational background, place of residence, family structure, demand, disease history, family structure, and the like. This history information may be stored in a particular database.

In a case in which a question about which of two or more things should be selected is received from the user, the action determination unit 236 identifies the user who is a question source and specifies history information corresponding to the identified user from the database. The action determination unit 236 specifies characteristics, features, and the like of the user on the basis of history information regarding the specified user. The action determination unit 236 specifies characteristics, features, and the like of the user on the basis of, for example, the user's age, annual income, personality, fund, and preference. The action determination unit 236 may select at least one of two or more things by using the specified features and the like of the user.

(Case 1) In response to a question about which one of the product A′ and the product A″ similar to the product A purchased by the user a plurality of times in the past should be purchased, the action determination unit 236 may select the product A′ having a higher function than the product A although the product A′ is inexpensive in view of the user's age and fund (examples of specified features and the like), and cause the robot 100 to reproduce vocal sound that recommends the product A′. In this case, the action determination unit 236 may also recommend the product A″ that is more expensive than the inexpensive product A′ but has higher brand power. The action determination unit 236 may add a vocal sound indicating a reason for each of the first recommended product A′ and the next recommended product A″. The action determination unit 236 may first recommend the product A″ in view of a change tendency of the user's preference (an example of the specified feature or the like). The action determination unit 236 may transmit images of the product A′ and the product A″, images indicating specifications of these products, and the like to a terminal used by the user. As a result, the detailed information of the recommended product is displayed on the terminal, so that the user can easily understand the product content without checking these products.

(Case 2) In response to a question about a route (road) through which the user passes when driving a car, the action determination unit 236 may select a flat route A with the shortest travel distance which requires less fuel consumption of the car in view of the type of the car owned by the user (an example of the specified feature and the like), and cause the robot 100 to reproduce vocal sound that recommends the route A. In this case, the action determination unit 236 may also recommend a route B along which the user can enjoy driving although the fuel consumption amount of the car increases. The action determination unit 236 may add vocal sound indicating a reason for each of the first recommended route A and the next recommended route B. The action determination unit 236 may first recommend the route B in view of the tendency of the change in the preference of the user (an example of the specified feature or the like). The action determination unit 236 may transmit the route maps of the route A and the route B to the terminal used by the user. In addition to the route maps of the route A and the route B, the action determination unit 236 may transmit a moving image in which actual traveling scenes of the route A and the route B are recorded to the terminal. As a result, the detailed information of the recommended route is displayed on the terminal, so that the user can imagine the atmosphere and feeling at the time of traveling without knowing these routes.

The action determination unit 236 may select and answer at least one of two or more things on the basis of history information regarding the user and information regarding society emitted from a plurality of information sources. The information regarding society may include at least one of news, economic situation, social situation, political situation, financial situation, international situation, sports news, entertainment news, birth and death news, cultural situation, or fashion.

For example, the action determination unit 236 may select a product of which the price may rise in the future on the basis of information such as the economic situation, the social situation, and the financial situation, and propose the selected product to the user. The action determination unit 236 may select a product that may be necessary in the future on the basis of information such as news and fashion, and propose the product to the user. The action determination unit 236 may select a sightseeing spot that may increase in popularity in the future on the basis of information such as the cultural situation and the entertainment news and propose the selected sightseeing spot to the user.

The action control system according to the embodiment of the disclosure can select and present any option in a case in which selection is pressed by the user on the basis of all history data such as the user's personality, preference, and past behavior, fashion (trend), world situation, and the like. Therefore, it is possible to recommend a thing suitable for the user to the user who has difficulty in selecting a thing.

The emotion determination unit 232 may determine the emotion of the user according to a specific mapping. Specifically, the emotion determination unit 232 may determine the emotion of the user on the basis of an emotion map (see FIG. 5) that is a specific mapping.

An emotion table as illustrated in Table 2 is prepared for an emotion of the user 10. Here, in a case in which the action of the user is to say “Which clothes are selected?”, the emotion of the robot 100 is the index number “2”, and the emotion of the user 10 is the index number “3”, a sentence such as “The robot is in a very pleasant state. The user is in a normally pleasant state. The user says “Which clothes are selected?”. How do you answer as a robot?” is input to the sentence generation model using AI to acquire the action content of the robot. The action determination unit 236 determines an action of the robot from the action content.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of an interaction function of allowing the user and the robot to interact with each other, and determines an action of the robot corresponding to the action content, in which
in a case in which a question about which one of two or more things is to be selected is received from the user, the action determination unit selects at least one of the two or more things on the basis of at least history information regarding the user and answers the selected thing to the user.

### (Supplementary Note 2)

The action control system according to Supplementary Note 1, in which the action determination unit selects and answers at least one of the two or more things on the basis of the history information regarding the user and information regarding society emitted from a plurality of information sources.

### (Supplementary Note 3)

The action control system according to Supplementary Note 1, in which the robot is mounted on a stuffed toy or is connected to a control target device mounted on the stuffed toy in a wireless or wired manner.

### Other Embodiment 10

A robot 100 according to an embodiment of the disclosure includes an emotion determination unit that determines an emotion of a user or an emotion of a robot, and an action determination unit 236 that generates action content of the robot with respect to an action of the user and the emotion of the user or the emotion of the robot 100 on the basis of an interaction function of allowing the user and the robot 100 to interact with each other, and determines an action of the robot 100 corresponding to the action content. The action determination unit 236 may store a type of an action executed by the user at home as specific information associated with a timing at which the action is executed, determine an execution timing at which the user should execute the action on the basis of the specific information, and notify the user of the execution timing.

The actions performed by the user at home may include housework, nail cutting, watering of plants, preparation for going out, walking of animals, and the like. Examples of the housework may include cleaning a toilet, preparing a meal, cleaning a bath, taking in laundry, cleaning a floor, child care, shopping, taking out garbage, and ventilating a room.

The action determination unit 236 may store these actions as specific information associated with timings at which the actions were executed. Specifically, user information of the user (person) included in a specific home, information indicating a type of action such as housework performed by the user at home, and a past timing at which each of the actions was executed are stored in association with each other. The past timing may be the number of times the action was executed at least once.

(1) In a case in which a husband at home has performed nail cutting, the action determination unit 236 monitors the action of the husband to record the past nail cutting operation and record the timing at which the nail cutting was executed (a time point at which the nail cutting was started, a time point at which the nail cutting was ended, and the like). The action determination unit 236 records the past nail cutting operation a plurality of times, thereby estimating the interval (for example, the number of days such as 10 days and 20 days) of the nail cutting of the husband for each person who has performed the nail cutting, on the basis of the timing at which the nail cutting was executed. As described above, the action determination unit 236 may estimate the execution timing of the next nail cutting by recording the execution timing of the nail cutting, and notify the user of the execution timing when the estimated number of days has elapsed from the time point at which the previous nail cutting was executed. Specifically, the action determination unit 236 causes the robot 100 to reproduce vocal sound such as “Would you like to cut a nail now?” or “Your nails may have grown”, so that the user can ascertain the execution timing of the nail cutting.

(2) In a case in which a wife at home has performed watering of plants, the action determination unit 236 monitors the action of the wife to record the past watering operation and record a timing at which the watering was performed (a time point at which watering was started, a time point at which watering was finished, and the like). The action determination unit 236 records the past watering operation a plurality of times, thereby estimating a watering interval (for example, the number of days such as 10 days and 20 days) of the wife on the basis of the timing of executing the watering for each person who has performed watering. As described above, the action determination unit 236 may estimate the next watering execution timing by recording the watering execution timing, and notify the user of the execution timing when the estimated number of days has elapsed from the time point at which the previous watering was executed. Specifically, the action determination unit 236 causes the robot 100 to reproduce vocal sound such as “Would you like to water now?” or “The water amount of the plants may be reduced”, so that the user can ascertain the watering execution timing.

(3) In a case in which a child at home has cleaned a toilet, the action determination unit 236 monitors the action of the child to record a past operation of cleaning the toilet and record a timing of executing toilet cleaning (a time point at which cleaning of the toilet was started, a time point at which cleaning of the toilet was finished, and the like). The action determination unit 236 records the past toilet cleaning operation a plurality of times, thereby estimating a toilet cleaning interval (for example, the number of days such as 7 days and 14 days) of the child for each person who has cleaned the toilet on the basis of the timing at which the toilet cleaning was executed. As described above, the action determination unit 236 may estimate the execution timing of the next toilet cleaning by recording the execution timing of the toilet cleaning, and notify the user of the execution timing when the estimated number of days has elapsed from the time point at which the previous toilet cleaning was executed. Specifically, the action determination unit 236 causes the robot 100 to reproduce vocal sound such as “Would you like to clean the toilet now?” or “The toilet cleaning time may be close”, so that the user can ascertain the execution timing of toilet cleaning.

(4) In a case in which a child at home has performed preparation for going out, the action determination unit 236 monitors the action of the child to record the action of the preparation in the past and record the timing of performing the preparation (a time point at which the preparation was started, a time point at which the preparation was finished, and the like). The action determination unit 236 records the past preparation operation a plurality of times to estimate the timing of performing the preparation of the child (for example, in the case of a weekday, near the time of going out to school, and in the case of a holiday, near the time of going out to take classes) for each person who has performed the preparation on the basis of the timing of executing the preparation. As described above, the action determination unit 236 may estimate the next preparation execution timing by recording the preparation execution timing, and notify the user of the estimated execution timing. Specifically, the action determination unit 236 causes the robot 100 to reproduce vocal sound such as “It is time to go to a cram school” or “Today is not a morning practice day?”, so that the user can ascertain the preparation execution timing.

The action determination unit 236 may notify the user of the next execution timing at specific intervals a plurality of times. Specifically, after notifying the user of the execution timing, in a case in which the user does not execute the action, the action determination unit 236 may notify the user of the execution timing once or a plurality of times. That is, the action determination unit 236 may notify the user of the execution timing again. As a result, in a case in which the user forgets to execute the action even though the user is notified of the execution timing, the user can perform the specific action. Even in a case in which the user holds the specific action for a while since the user cannot immediately execute the specific action, the user can execute the specific action without forgetting to execute the specific action.

The action determination unit 236 may notify the user of the execution timing in advance a certain period of time before a time point at which the estimated number of days has elapsed from a time point at which the previous action was executed. For example, in a case in which the next watering execution timing is a specific day after 20 days elapse from the time point at which the previous watering was executed, the action determination unit 236 may give a notification for prompting the next watering several days before the specific day. Specifically, the action determination unit 236 causes the robot 100 to reproduce vocal sound such as “The time for watering plants is approaching” or “I recommend watering plants soon”, so that the user can ascertain the timing of performing the watering.

By configuring the robot 100 as described above, the robot 100 installed in the home can store every action of the family of the user of the robot 100 and present an appropriate timing of every action such as at which timing it is better to cut the nail, it is better to water, it is better to clean the toilet, or it is better to start preparation.

### (Supplementary Note 1)

An action control system including:
an emotion determination unit that determines an emotion of a user or an emotion of a robot; and
an action determination unit that generates action content of the robot with respect to the action of the user and the emotion of the user or the emotion of the robot on the basis of an interaction function of allowing the user and the robot to interact with each other, and determines an action of the robot corresponding to the action content, in which
the action determination unit stores a type of an action that the user executes at home as specific information associated with a timing at which the action was executed, determines an execution timing that is a timing at which the user is to execute the action on the basis of the specific information, and notifies the user of the execution timing.

### (Supplementary Note 2)

The action control system according to Supplementary Note 1, in which the action determination unit notifies the user of the execution timing again in a case in which the user does not execute the action after notifying the user of the execution timing.

### (Supplementary Note 3)

The action control system according to Supplementary Note 1, in which the robot is mounted on a stuffed toy or is connected to a control target device mounted on the stuffed toy in a wireless or wired manner.

### Other Embodiment 11

A robot 100 according to the present embodiment includes an emotion determination unit that determines an emotion of a user or an emotion of a robot, and an action determination unit that generates action content of the robot with respect to an action of the user and the emotion of the user or the emotion of the robot on the basis of an interaction function of allowing the user and the robot to interact with each other, and determines an action of the robot corresponding to the action content. The action determination unit is configured to determine, as the action of the robot, receiving statements of a plurality of users having a conversation, outputting a topic of the conversation, and outputting another topic from at least one emotion of the users having the conversation.

Specifically, the robot 100 is installed at a social gathering, a party, a marriage meeting place, or the like. The robot 100 of the present embodiment acquires statements of a plurality of users having a conversation with the microphone function.

The action determination unit 236 outputs a topic related to the content of the statements from the speaker from the content of the acquired statements. For example, when a sports conversation is being held, a topic that increases the topic, such as a latest game result, is output.

In a case in which the emotion of one of the users having a conversation is in a predefined state, for example, in a case in which the emotion value such as “displeased” or “sense of emptiness” is a negative value, a different topic from the topic of the conversation so far, such as “By the way, are you interested in ~?” is output. Here, the different topic is a topic different from the topic of the conversation so far stored, and includes a topic of a recent event, a topic that the user is likely to like determined from attribute information (for example, information that can be acquired by a camera function, such as an age and a gender, and information such as an occupation, a place of residence, and a family structure input at the time of reservation of the venue) of the user, and the like.

In addition to the case of acquiring a conversation, the robot 100 may receive a question “Is there any good topic?” from the user and provide a topic.

With this configuration, in a social gathering, a party, a marriage meeting, or the like, the robot 100 can assist in a conversation, and thus prevent the user from feeling uncomfortable due to interruption of the conversation or due to continuation of the conversation on a topic with content that the user does not want to talk about.

The emotion determination unit 232 may determine an emotion of the user according to a specific mapping. Specifically, the emotion determination unit 232 may determine an emotion of the user on the basis of an emotion map (see FIG. 5) that is a specific mapping.

As described above, the action determination unit 236 determines the action content of the robot 100 in accordance with the state related to the emotion of the robot 100 defined in advance for each type of the emotion of the robot 100 and for each intensity of the emotion, and the action of the user 10. In this embodiment, the speech content of the robot 100 in a case in which an interaction with the user 10 is performed can be branched according to the state related to the emotion of the robot 100. That is, since the robot 100 can change the action of the robot according to the index number corresponding to the emotion of the robot, the user has an impression that the robot has a mind, and is promoted to take an action such as talking to the robot.

### (Supplementary Note 1)

An action control system including:
an emotion determination unit that determines an emotion of a user or an emotion of a robot; and
an action determination unit that generates action content of the robot with respect to an action of the user and the emotion of the user or the emotion of the robot on the basis of a sentence generation model having an interaction function of allowing the user and the robot to interact with each other, and determines an action of the robot corresponding to the action content, in which
the action determination unit determines, as the action of the robot, receiving statements of a plurality of users having a conversation, outputting a topic of the conversation, and outputting another topic from at least one emotion of the users having the conversation.

### (Supplementary Note 2)

The action control system according to Supplementary Note 1, in which the topic is determined on the basis of attribute information of the users.

### (Supplementary Note 3)

The action control system according to Supplementary Note 1 or 2, in which the robot is mounted on a stuffed toy or is connected to a control target device mounted on the stuffed toy in a wireless or wired manner.

### Second Embodiment

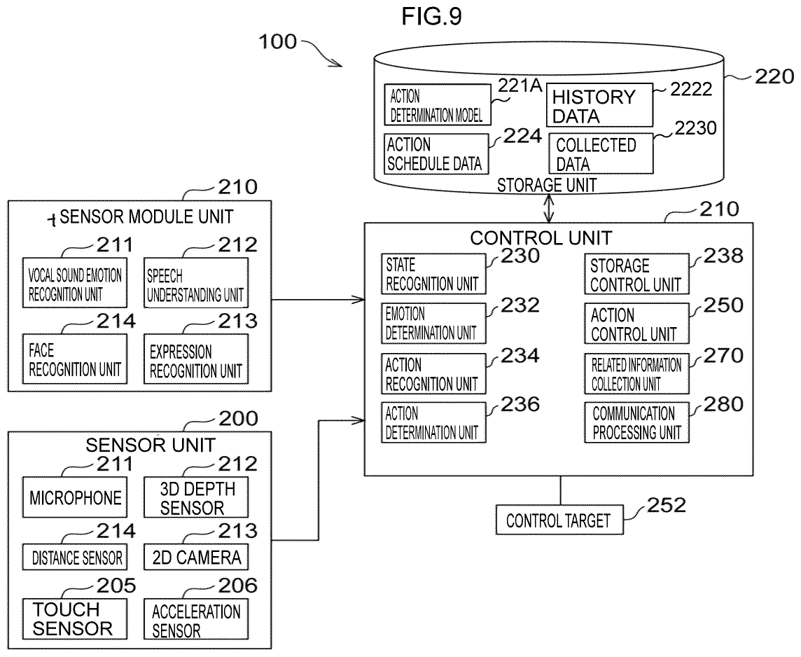

FIG. 9 schematically illustrates a functional configuration of the robot 100. The robot 100 includes a sensor unit 200, a sensor module unit 210, a storage unit 220, a control unit 228, and a control target 252. The control unit 228 includes a state recognition unit 230, an emotion determination unit 232, an action recognition unit 234, an action determination unit 236, a storage control unit 238, an action control unit 250, a related information collection unit 270, and a communication processing unit 280.

The control target 252 includes a display device, a speaker, an LED of an eye portion, and motors that drive an arm, a hand, a foot, and the like. The posture and the gesture of the robot 100 are controlled by controlling motors for arms, hands, and feet. Some of the emotions of the robot 100 can be expressed by controlling these motors. The expression of the robot 100 can be expressed by controlling a light emission state of the LED of the eye portion of the robot 100. The posture, the gesture, and the expression of the robot 100 are examples of the attitude of the robot 100.

The sensor unit 200 includes a microphone 201, a 3D depth sensor 202, a 2D camera 203, a distance sensor 204, a touch sensor 205, and an acceleration sensor 206. The microphone 201 continuously detects vocal sound and outputs vocal sound data. The microphone 201 may be provided on the head of the robot 100 and may have a function of performing binaural recording. The 3D depth sensor 202 analyzes infrared patterns from infrared images continuously captured by an infrared camera by continuously applying the infrared patterns, and detects an outline of an object. The 2D camera 203 is an example of an image sensor. The 2D camera 203 captures an image with visible light and generates image information of visible light. The distance sensor 204 detects a distance to an object by emitting, for example, laser light or ultrasonic waves. The sensor unit 200 may further include a clock, a gyro sensor, a sensor for motor feedback, and the like.

Among the constituents of the robot 100 illustrated in FIG. 9, the constituents other than the control target 252 and the sensor unit 200 are examples of the constituents included in the action control system included in the robot 100. The action control system of the robot 100 controls the control target 252.

The storage unit 220 includes an action determination model 221A, history data 2222, collected data 2230, and action schedule data 224. The history data 2222 includes past emotion values of the user 10, past emotion values of the robot 100, and a history of actions, and specifically includes a plurality of pieces of event data including the emotion values of the user 10, the emotion values of the robot 100, and the actions of the user 10. The data including the action of the user 10 includes a camera image representing the action of the user 10. The emotion values and the history of actions are recorded for each user 10 by being associated with identification information of the user 10, for example. At least a part of the storage unit 220 is implemented by a storage medium such as a memory. A person DB that stores a face image of the user 10, attribute information of the user 10, and the like may be included. Among the constituents of the robot 100 illustrated in FIG. 9, the functions of the constituents other than the control target 252, the sensor unit 200, and the storage unit 220 can be realized by a CPU operating on the basis of a program. For example, the functions of these constituents can be implemented as the operation of the CPU by basic software (OS) and a program operating on the OS.

The sensor module unit 210 includes a vocal sound emotion recognition unit 211, a speech understanding unit 212, an expression recognition unit 213, and a face recognition unit 214. Information detected by the sensor unit 200 is input to the sensor module unit 210. The sensor module unit 210 analyzes information detected by the sensor unit 200 and outputs an analysis result to the state recognition unit 230.

The vocal sound emotion recognition unit 211 of the sensor module unit 210 analyzes the vocal sound of the user 10 detected by the microphone 201 to recognize the emotion of the user 10. For example, the vocal sound emotion recognition unit 211 extracts a feature amount such as a frequency component of the vocal sound and recognizes the emotion of the user 10 on the basis of the extracted feature amount. The speech understanding unit 212 analyzes the vocal sound of the user 10 detected by the microphone 201 and outputs text information indicating the speech content of the user 10.

The expression recognition unit 213 recognizes the expression of the user 10 and the emotion of the user 10 from the image of the user 10 captured by the 2D camera 203. For example, the expression recognition unit 213 recognizes the expression and emotion of the user 10 on the basis of the shapes, positional relationships, and the like of the eyes and the mouth. The face recognition unit 214 recognizes the face of the user 10. The face recognition unit 214 recognizes the user 10 by matching a face image stored in a person DB (not illustrated) with a face image of the user 10 captured by the 2D camera 203.

The state recognition unit 230 recognizes a state of the user 10 on the basis of the information analyzed by the sensor module unit 210. For example, processing mainly related to perception is performed by using the analysis result of the sensor module unit 210. For example, perception information such as “There is one father.” and “The probability that the father does not smile is 90%.” is generated. Processing of understanding the meaning of the generated perception information is performed. For example, semantic information such as “One father looks lonely.” is generated.

The state recognition unit 230 recognizes a state of the robot 100 on the basis of the information detected by the sensor unit 200. For example, the state recognition unit 230 recognizes a remaining battery level of the robot 100, a brightness of the surrounding environment of the robot 100, or the like as the state of the robot 100.

The emotion determination unit 232 determines an emotion value indicating the emotion of the user 10 on the basis of the information analyzed by the sensor module unit 210 and the state of the user 10 recognized by the state recognition unit 230. For example, the information analyzed by the sensor module unit 210 and the recognized state of the user 10 are input to a neural network trained in advance, and an emotion value indicating the emotion of the user 10 is acquired.

Here, the emotion value indicating the emotion of the user 10 is a value indicating whether the emotion of the user is positive or negative. For example, in a case in which the emotion of the user is a bright emotion accompanied with pleasure or comfort, such as “happy”, “pleasant”, “pleased”, “safe”, “excited”, “relieved”, and “sense of fulfillment”, a positive value is indicated, and the value becomes larger as the emotion becomes brighter. In a case in which the emotion of the user is an emotion that makes the user feel unpleasant, such as “angry”, “sad”, “displeased”, “anxious”, “gloomy”, “worried”, and “sense of emptiness”, a negative value is indicated, and an absolute value of the negative value increases as the user feels unpleasant. In a case in which the emotion of the user is not included in any of the above emotions (“normal”), a value of 0 is indicated.

The emotion determination unit 232 determines an emotion value indicating the emotion of the robot 100 on the basis of the information analyzed by the sensor module unit 210, the information detected by the sensor unit 200, and the state of the user 10 recognized by the state recognition unit 230.

The emotion value of the robot 100 includes an emotion value for each of the plurality of emotion classifications, and is, for example, a value (0 to 5) indicating the intensity of each of “happy”, “angry”, “sad”, and “pleasant”.

Specifically, the emotion determination unit 232 determines an emotion value indicating the emotion of the robot 100 according to a rule for updating the emotion value of the robot 100, the rule being defined in association with the information analyzed by the sensor module unit 210 and the state of the user 10 recognized by the state recognition unit 230.

For example, in a case in which the state recognition unit 230 recognizes that the user 10 looks lonely, the emotion determination unit 232 increases the emotion value of “sad” of the robot 100. In a case in which the state recognition unit 230 recognizes that the user 10 has a smiling face, the emotion value of “happy” of the robot 100 is increased.

The emotion determination unit 232 may determine the emotion value indicating the emotion of the robot 100 in further consideration of the state of the robot 100. For example, in a case in which a remaining battery level of the robot 100 is low, or in a case in which the surrounding environment of the robot 100 is dark, the emotion value of “sad” of the robot 100 may be increased. In the case of the user 10 continuously talking to the robot even though the remaining battery level is low, the emotion value of “angry” may be increased.

The action recognition unit 234 recognizes an action of the user 10 on the basis of the information analyzed by the sensor module unit 210 and the state of the user 10 recognized by the state recognition unit 230. For example, the information analyzed by the sensor module unit 210 and the recognized state of the user 10 are input to a neural network trained in advance, probabilities of a plurality of predefined action classifications (for example, “smile”, “angry”, “ask a question”, and “gloomy”) are acquired, and an action classification having the highest probability is recognized as the action of the user 10.

As described above, in the present embodiment, the robot 100 acquires the speech content of the user 10 after identifying the user 10, but in acquiring and using the speech content, the action control system of the robot 100 according to the present embodiment considers protection of personal information and privacy of the user 10 in addition to acquiring necessary consent according to laws and regulations from the user 10.

Next, processing of the action determination unit 236 in a case in which the robot 100 performs response processing of responding to an action of the user 10 will be described.

The action determination unit 236 determines an action corresponding to the action of the user 10 recognized by the action recognition unit 234 on the basis of the current emotion value of the user 10 determined by the emotion determination unit 232, the history data 2222 of the past emotion values determined by the emotion determination unit 232 before the current emotion value of the user 10 is determined, and the emotion value of the robot 100. In the present embodiment, a case in which the action determination unit 236 uses one most recent emotion value included in the history data 2222 as the past emotion value of the user 10 will be described, but the disclosed technology is not limited to this aspect. For example, the action determination unit 236 may use a plurality of most recent emotion values as the past emotion values of the user 10, or may use emotion values that are earlier by a unit period such as one day before. The action determination unit 236 may determine an action corresponding to the action of the user 10 in further consideration of the history of the past emotion values of the robot 100 in addition to the current emotion value of the robot 100. The action determined by the action determination unit 236 includes a gesture performed by the robot 100 or speech content of the robot 100.

The action determination unit 236 according to the present embodiment determines an action of the robot 100 on the basis of a combination of the past emotion value and the current emotion value of the user 10, the emotion value of the robot 100, the action of the user 10, and the action determination model 221A, as an action corresponding to the action of the user 10. For example, in a case in which the past emotion value of the user 10 is a positive value and the current emotion value is a negative value, the action determination unit 236 determines an action for positively changing the emotion value of the user 10 as an action corresponding to the action of the user 10.

The reaction rule as the action determination model 221A defines an action of the robot 100 according to the combination of the past emotion value and the current emotion value of the user 10, the emotion value of the robot 100, and the action of the user 10. For example, in a case in which the past emotion value of the user 10 is a positive value, the current emotion value is a negative value, and the action of the user 10 is gloomy, a combination of a gesture and speech content at the time of making an inquiry to encourage the user 10 including a gesture is defined as the action of the robot 100.

For example, the reaction rule as the action determination model 221A defines an action of the robot 100 for all combinations of patterns of emotion values of the robot 100 (1296 patterns that is the fourth power of six values of the values “0” to “5” of “happy”, “angry”, “sad”, and “pleasant”), a pattern of the combination of the past emotion value and the current emotion value of the user 10, and an action pattern of the user 10. That is, for each pattern of the emotion value of the robot 100, the action of the robot 100 according to the action pattern of the user 10 is defined for each of a plurality of combinations such as combinations of the past emotion value and the current emotion value of the user 10 being a negative value and a negative value, a negative value and a positive value, a positive value and a negative value, a positive value and a positive value, a negative value and normal, and normal and normal. The action determination unit 236 may transition to an operation mode of determining the action of the robot 100 by using the history data 2222, for example, in a case in which the user 10 has made speech that intends a conversation continued from a past topic such as “I want to talk about the topic I discussed earlier”.

In the reaction rule as the action determination model 221A, at least one of a gesture and statement content may be defined as the action of the robot 100 for each of the patterns (1296 patterns) of the emotion values of the robot 100 at the maximum. Alternatively, in the reaction rule as the action determination model 221A, at least one of the gesture and statement content may be determined as an action of the robot 100 for each of the groups of the patterns of the emotion values of the robot 100.

The intensity of each gesture included in the action of the robot 100 defined in the reaction rule as the action determination model 221A is defined in advance.

In each piece of speech content included in the action of the robot 100 defined in the reaction rule as the action determination model 221, the intensity of the speech content is defined in advance.

The storage control unit 238 determines whether or not to store data including the action of the user 10 in the history data 2222 on the basis of the intensity of the action predefined for the action determined by the action determination unit 236 and the emotion value of the robot 100 determined by the emotion determination unit 232.

Specifically, in a case in which a total value of the intensities that is a sum of a sum total of the emotion values for the plurality of respective emotion classifications of the robot 100, the intensity predefined for the gesture included in the action determined by the action determination unit 236, and the intensity predefined for the speech content included in the action determined by the action determination unit 236 is a threshold or more, it is determined to store data including the action of the user 10 in the history data 2222.

In a case in which the storage control unit 238 determines to store the data including the action of the user 10 in the history data 2222, the action determined by the action determination unit 236, information (for example, any surrounding information including data such as vocal sound, an image, and a smell at the place) analyzed by the sensor module unit 210 from the current time point to a certain period before, and a state (for example, the expression and the emotion of the user 10) of the user 10 recognized by the state recognition unit 230 are stored in the history data 2222.

The action control unit 250 controls the control target 252 on the basis of the action determined by the action determination unit 236. For example, in a case in which the action determination unit 236 determines an action including speech, the action control unit 250 causes a speaker included in the control target 252 to output vocal sound. In this case, the action control unit 250 may determine an emission speed of the vocal sound on the basis of the emotion value of the robot 100. For example, the action control unit 250 determines a higher vocal sound emission speed as the emotion value of the robot 100 becomes greater. As described above, the action control unit 250 determines an execution form of the action determined by the action determination unit 236 on the basis of the emotion value determined by the emotion determination unit 232.

The action control unit 250 may recognize a change in emotion of the user 10 with respect to execution of the action determined by the action determination unit 236. For example, the change in emotion may be recognized on the basis of the vocal sound or expression of the user 10. A change in emotion of the user 10 may be recognized on the basis of detection of an impact by the touch sensor 205 included in the sensor unit 200. In a case in which an impact is detected by the touch sensor 205 included in the sensor unit 200, it may be recognized that the emotion of the user 10 is worsened, or in a case in which it is determined that the reaction of the user 10 is smiling or happy from the detection result in the touch sensor 205 included in the sensor unit 200, it may be recognized that the emotion of the user 10 is improved. Information indicating the reaction of the user 10 is output to the communication processing unit 280.

After the action control unit 250 executes the action determined by the action determination unit 236 in the execution form determined according to the emotion of the robot 100, the emotion determination unit 232 further changes the emotion value of the robot 100 on the basis of the user's reaction to the execution of the action. Specifically, the emotion determination unit 232 increases the emotion value of “happy” of the robot 100 in a case in which the user's reaction to the action determined by the action determination unit 236 performed on the user in the execution form determined by the action control unit 250 is not poor. The emotion determination unit 232 increases the emotion value of “sad” of the robot 100 in a case in which the user's reaction to the action determined by the action determination unit 236 performed on the user in the execution form determined by the action control unit 250 is poor.

The action control unit 250 expresses the emotion of the robot 100 on the basis of the determined emotion value of the robot 100. For example, in a case in which the emotion value of “happy” of the robot 100 is increased, the action control unit 250 controls the control target 252 to cause the robot 100 to perform a gesture of being happy. In a case in which the emotion value of “sad” of the robot 100 is increased, the action control unit 250 controls the control target 252 so that the posture of the robot 100 becomes a head-drooping posture.

The communication processing unit 280 performs communication with the server 300. As described above, the communication processing unit 280 transmits the user reaction information to the server 300. The communication processing unit 280 receives the updated reaction rule from the server 300. Upon receiving the updated reaction rule from the server 300, the communication processing unit 280 updates the reaction rule as the action determination model 221A.

The server 300 performs communication between the robot 100, the robot 101, and the robot 102 and the server 300, receives the user reaction information transmitted from the robot 100, and updates the reaction rule on the basis of the reaction rule including the action for which a positive reaction has been obtained.

The related information collection unit 270 collects information related to preference information from external data (web sites such as news sites and moving image sites) on the basis of the preference information acquired for the user 10 at a predetermined timing.

Specifically, the related information collection unit 270 acquires preference information indicating a matter of interest of the user 10 from speech content of the user 10 or a setting operation of the user 10. The related information collection unit 270 collects news related to the preference information from the external data at regular intervals by using, for example, ChatGPT Plugins (Internet search <URL: https://openai.com/blog/chatgpt-plugins>). For example, in a case in which it is acquired as the preference information that the user 10 is a fan of a specific professional baseball team, the related information collection unit 270 collects news related to a game result of the specific professional baseball team from external data at a predetermined time every day, by using, for example, ChatGPT Plugins.

The emotion determination unit 232 determines an emotion of the robot 100 on the basis of the information related to the preference information collected by the related information collection unit 270.

Specifically, the emotion determination unit 232 inputs text representing the information related to the preference information collected by the related information collection unit 270 to a neural network trained in advance for determining an emotion, acquires an emotion value indicating each emotion, and determines the emotion of the robot 100. For example, in a case in which the collected news related to the game result of the specific professional baseball team indicates that the specific professional baseball team has won, the emotion value of “happy” of the robot 100 is determined to be great.

In a case in which the emotion value of the robot 100 is a threshold or more, the storage control unit 238 stores the information related to the preference information collected by the related information collection unit 270 in the collected data 2230.

Next, processing of the action determination unit 236 in a case in which the robot 100 performs autonomous processing of autonomously acting will be described.

The action determination unit 236 uses at least one of the state of the user 10, the emotion of the user 10, the emotion of the robot 100, or the state of the robot 100, and the action determination model 221A at a predetermined timing, to determine, as the action of the robot 100, any of a plurality of types of robot actions including no action. Here, a case in which the sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100, and text for inquiry about the robot actions to the sentence generation model, and determines an action of the robot 100 on the basis of an output of the sentence generation model.

For example, the plurality of types of robot actions include the following (1) to (10).
(1) The robot does nothing.
(2) The robot has a dream.
(3) The robot speaks to the user.
(4) The robot creates a picture diary.
(5) The robot proposes an activity.
(6) The robot proposes a person with whom the user should meet.
(7) The robot introduces news in which the user is interested.
(8) The robot edits pictures and moving images.
(9) The robot studies with the user.
(10) The robot evokes memory.

Every lapse of a certain period of time, the action determination unit 236 inputs, to the sentence generation model, text representing the state of the user 10 and the state of the robot 100 recognized by the state recognition unit 230, the current emotion value of the user 10 determined by the emotion determination unit 232, and the current emotion value of the robot 100, and text for inquiry about any of a plurality of types of robot actions including no action, and determines an action of the robot 100 on the basis of an output of the sentence generation model. Here, in a case in which there is no user 10 around the robot 100, the text to be input to the sentence generation model need not include the state of the user 10 and the current emotion value of the user 10, or may include the fact that there is no user 10.

As an example, text such as “The robot is in a very pleasant state. The user is in a normally pleasant state. The user is sleeping. Which one of the following (1) to (10) is better as an action of the robot?
(1) The robot does nothing.
(2) The robot has a dream.
(3) The robot speaks to the user.
. . . ” is input to the sentence generation model. On the basis of the output “It can be said that either (1) the robot does nothing or (2) the robot has a dream is the most appropriate action.” of the sentence generation model, “(1) the robot does nothing” or “(2) the robot has a dream” is determined as the action of the robot 100.

As another example, text such as “The robot is in a slightly lonely state. The user is absent. The surroundings of the robot are dark. Which one of the following (1) to (10) is better as the action of the robot? (1) The robot does nothing.
(2) The robot has a dream.
(3) The robot speaks to the user.
. . . ” is input to the sentence generation model. On the basis of the output “It can be said that either (2) the robot has a dream or (4) the robot creates a picture diary is the most appropriate action.” of the sentence generation model, “(2) The robot has a dream” or “(4) The robot creates a picture diary.” is determined as the action of the robot 100.

In a case in which the action determination unit 236 determines that “(2) The robot has a dream.”, that is, the creation of the original event is to be performed as the robot action, the action determination unit creates the original event obtained by combining a plurality of pieces of event data in the history data 2222 by using the sentence generation model. In this case, the storage control unit 238 stores the created original event in the history data 2222.

In a case in which it is determined that “(3) The robot talks to the user.”, that is, the robot 100 speaks, as the robot action, the action determination unit 236 determines speech content of the robot corresponding to the user state and the emotion of the user or the emotion of the robot by using the sentence generation model. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(7) The robot introduces news in which the user is interested.” as the robot action, the action determination unit 236 determines the speech content of the robot corresponding to the information stored in the collected data 2230 by using the sentence generation model. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(4) The robot creates a picture diary.”, that is, the robot 100 creates an event image, as the robot action, the action determination unit 236 generates an image representing event data for the event data selected from the history data 2222 by using the image generation model, generates an explanatory sentence representing the event data by using the sentence generation model, and outputs a combination of the image representing the event data and the explanatory sentence representing the event data as the event image. In a case in which the user 10 is absent around the robot 100, the action control unit 250 stores the event image in the action schedule data 224 without outputting the event image.

In a case in which it is determined that “(8) The robot edits pictures and moving images.”, that is, the robot edits an image, as the robot action, the action determination unit 236 selects event data from the history data 2222 on the basis of the emotion value, edits image data of the selected event data, and outputs the edited image data. In a case in which the user 10 is absent around the robot 100, the action control unit 250 stores the edited image data in the action schedule data 224 without outputting the edited image data.

In a case in which it is determined that “(5) The robot proposes an activity.”, that is, the robot proposes an action of the user 10, as the robot action, the action determination unit 236 determines the proposed action of the user by using the sentence generation model on the basis of the event data stored in the history data 2222. In this case, the action control unit 250 causes the speaker included in the control target 252 to output vocal sound that proposes the action of the user. In a case in which the user 10 is absent around the robot 100, the action control unit 250 stores proposal of the action of the user in the action schedule data 224 without outputting vocal sound that proposes the action of the user.

In a case in which it is determined that “(6) The robot proposes a person with whom the user should meet.”, that is, the robot proposes a partner who should have a contact with the user 10, as the robot action, the action determination unit 236 determines a proposed partner who should have a contact with the user by using the sentence generation model on the basis of the event data stored in the history data 2222. In this case, the action control unit 250 causes the speaker included in the control target 252 to output vocal sound representing proposal of a partner who should have a contact with the user. In a case in which the user 10 is absent around the robot 100, the action control unit 250 stores proposal of a partner who should have a contact with the user in the action schedule data 224 without outputting vocal sound representing proposal of a partner who should have a contact with the user.

In a case in which it is determined that “(9) The robot studies with the user.”, that is, the robot 100 makes speech related to study, as the robot action, the action determination unit 236 uses the sentence generation model to determine speech content of the robot for urging the user to study, giving a study problem, or giving advice related to study, which corresponds to the user state and the emotion of the user or the emotion of the robot. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(10) The robot evokes memory.”, that is, the robot causes event data to be remembered, as the robot action, the action determination unit 236 selects the event data from the history data 2222. In this case, the emotion determination unit 232 determines an emotion of the robot 100 on the basis of the selected event data. The action determination unit 236 creates an emotion change event representing speech content or an action of the robot 100 for changing the emotion value of the user by using the sentence generation model on the basis of the selected event data. In this case, the storage control unit 238 stores the emotion change event in the action schedule data 224.

For example, in a case in which it is stored in the history data 2222 that a moving image the user was watching was related to a panda as event data, and the event data is selected, a sentence such as “What is the word to say about the topic related to a panda when meeting with the user next time? There are three.” is input to the sentence generation model. In a case in which the output of the sentence generation model is “(1) Let's go to the zoo, (2) Let's draw a picture of a panda, and (3) Let's buy a stuffed toy of a panda.”, the robot 100 inputs a sentence such as “What makes the user most happy in (1), (2), and (3)?” to the sentence generation model, and in a case in which the output of the sentence generation model is “(1) Let's go to the zoo”, and a speech of the robot 100 that “(1) Let's go to the zoo” in a case in which the robot 100 meets the user next is created as the emotion change event and stored in the action schedule data 224.

For example, event data having a great emotion value of the robot 100 is selected as impressive memory of the robot 100. This makes it possible to create an emotion change event on the basis of the event data selected as impressive memory.

On the basis of the state of the user 10 recognized by the state recognition unit 230, in a case in which an action of the user 10 with respect to the robot 100 is detected from a state in which there is no action of the user 10 with respect to the robot 100, the action determination unit 236 reads data stored in the action schedule data 224 and determines an action of the robot 100.

For example, in a case in which the user 10 is absent around the robot 100 and the user 10 is detected, the action determination unit 236 reads data stored in the action schedule data 224 and determines an action of the robot 100. In a case in which the user 10 was sleeping, and it is detected that the user 10 has woken up, the action determination unit 236 reads data stored in the action schedule data 224 and determines an action of the robot 100.

As in the fourth embodiment that will be described later, for example, in a regularly held meeting in which one of users participates as a participant, the specific processing unit 290 performs specific processing of acquiring and outputting a response regarding presentation content in the meeting. The action of the robot 100 is controlled such that a result of the specific processing is output.

An example of this meeting is a so-called one-on-one meeting. In the one-on-one meeting, two specific persons, for example, a supervisor and a subordinate in an organization perform actions including confirmation of a progress status and a schedule of work, various reports, communications, and consultation in an interaction form in a specific cycle period (for example, a frequency of about once a month). In this case, a subordinate corresponds to the user 10 of the robot 100. Of course, the user 10 of the robot 100 may be a supervisor.

In the specific processing related to the meeting, a condition for presentation content to be presented by a subordinate at the meeting is set as a predefined trigger condition. In a case in which a user input satisfies this condition, the specific processing unit 290 uses an output of the sentence generation model when information obtained from the user input is set as an input sentence, and acquires and outputs a response regarding the presentation content in the meeting as a result of the specific processing.

The specific processing unit 290 includes an input unit 292, a processing unit 294, and an output unit 296.

The input unit 292 receives a user input. Specifically, the input unit 292 acquires letter input and vocal sound input of the user 10.

In the disclosed technology, it is assumed that the user 10 uses an e-mail in work. The input unit 292 acquires all of the content exchanged by the user 10 by e-mail during one month which is a certain cycle period, and converts the content into text. In a case in which the user 10 exchanges information by using a social networking service in combination with an e-mail, the exchange of information is included. Hereinafter, the e-mail and the social networking service will be collectively referred to as “e-mail and the like”. The mail description matters according to the disclosed technology include matters described by the user 10 in an e-mail and the like.

In the disclosed technology, it is assumed that the user 10 uses a schedule table such as so-called groupware or schedule management software in work. The input unit 292 acquires all schedules input by the user 10 to such a schedule table and converts the schedules into text in one month which is a certain cycle period. In addition to the schedules related to the work, various notations, application procedures, and the like may be input to the groupware or the schedule management software. The input unit 292 acquires the notations, the application procedures, and the like and converts the notations, the application procedures, and the like into text. Schedule table description matters according to the disclosed technology include not only the schedules but also such notations, application procedures, and the like.

In the disclosed technology, it is assumed that the user 10 participates in various conferences in work. The input unit 292 acquires all remarks in the conferences in which the user 10 has participated during one month which is a certain cycle, and converts the remarks into text. Examples of the conference include a conference (sometimes referred to as a “face-to-face conference”, a “real conference”, an “offline conference”, or the like) in which participants actually meet at a venue. Examples of the conference include a conference (sometimes referred to as a “remote conference”, a “web conference”, an “online conference”, or the like) held on a network by using an information terminal. A “face-to-face conference” and a “remote conference” may be used in combination. The remote conference in a broad sense may include a “telephone conference”, a “video conference”, and the like using a telephone line. In any form of the conference, for example, the content of remarks of the user 10 is acquired from the audio data, the recorded data, and the meeting minutes of the conference.

The processing unit 294 performs specific processing using the sentence generation model. Specifically, as described above, the processing unit 294 determines whether or not the predefined trigger condition is satisfied. More specifically, it is set as a trigger condition that an input that is a candidate for the content to be presented in the one-on-one meeting in the input data from the user 10 has been received.

The processing unit 294 inputs text (prompt) representing an instruction for obtaining data for specific processing to the sentence generation model, and acquires a processing result on the basis of an output of the sentence generation model. More specifically, for example, a prompt such as “Summarize the work performed by user 10 in one month, and list three points that will be appeal points in the next one-on-one meeting.” is input to the sentence generation model, and recommended appeal points in the one-on-one meeting are acquired on the basis of the output of the sentence generation model. The sentence generation model outputs, as the appeal points, “I act exactly on time.”, “The target achievement rate is high.”, “Work content is accurate.”, “A response to an e-mail or the like is fast.”, “The meeting is organized.”, and “I lead the project.”.

The processing unit 294 may perform specific processing using the state of the user 10 and the sentence generation model. The processing unit 294 may perform specific processing using the emotion of the user 10 and the sentence generation model.

The output unit 296 controls the action of the robot 100 to output the result of the specific processing. Specifically, the summary and the appeal points acquired by the processing unit 294 are displayed on a display device provided in the robot 100, the robot 100 speaks the summary and the appeal points, or transmits a message representing the summary and the appeal points to the user of the message application of a mobile terminal of the user.

A part of the robot 100 (for example, the sensor module unit 210, the storage unit 220, and the control unit 228) may be provided outside the robot 100 (for example, the server), and the robot 100 may function as each unit of the robot 100 by communicating with the outside.

A part of the robot 100 (for example, the sensor module unit 210, the storage unit 220, and the control unit 228) may be provided outside the robot 100 (for example, a server), and the robot 100 may function as each unit of the robot 100 by communicating with the outside.

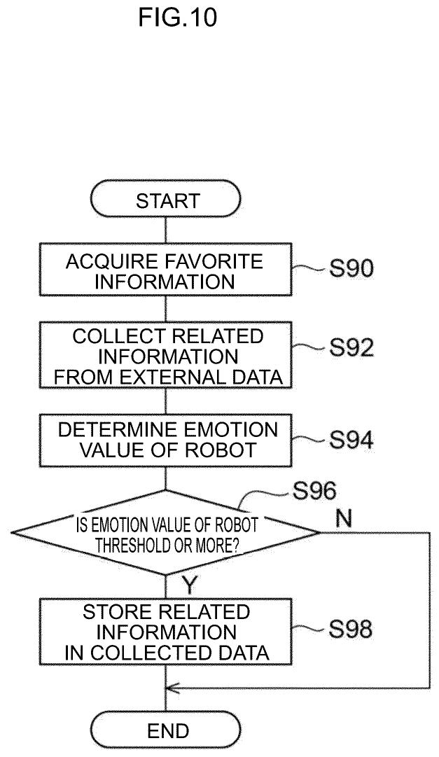

FIG. 10 schematically illustrates an example of an operation flow related to collection processing of collecting information related to preference information of the user 10. The operation flow illustrated in FIG. 10 is repeatedly executed at regular intervals. It is assumed that preference information indicating a matter of interest of the user 10 is acquired from speech content of the user 10 or a setting operation of the user 10. “S” in the operation flow represents a step to be executed.

First, in step S90, the related information collection unit 270 acquires preference information indicating a matter of interest of the user 10.

In step S92, the related information collection unit 270 collects information related to the preference information from the external data.

In step S94, the emotion determination unit 232 determines an emotion value of the robot 100 on the basis of the information related to the preference information collected by the related information collection unit 270.

In step S96, the storage control unit 238 determines whether or not the emotion value of the robot 100 determined in step S94 is a threshold or more. In a case in which the emotion value of the robot 100 is less than the threshold, the collected information related to the preference information is not stored in the collected data 2230, and the processing is ended. On the other hand, in a case in which the emotion value of the robot 100 is the threshold or more, the processing proceeds to step S998.

In step S98, the storage control unit 238 stores information related to the collected preference information in the collected data 2230, and ends the processing.

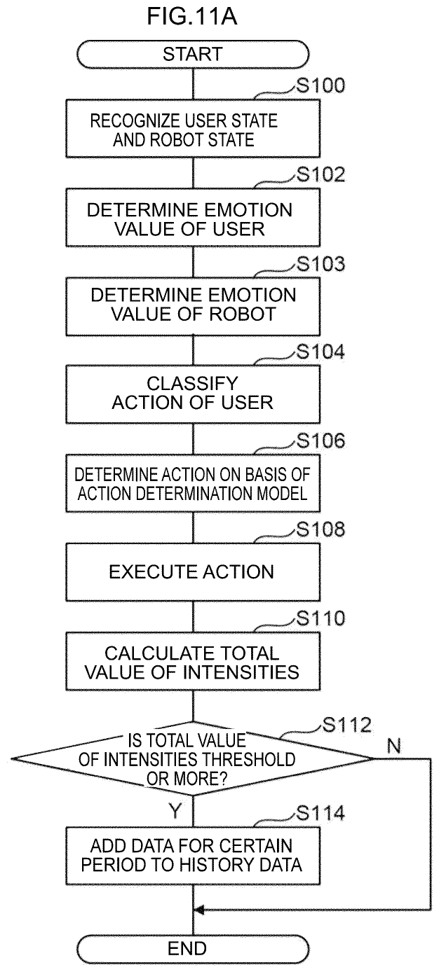

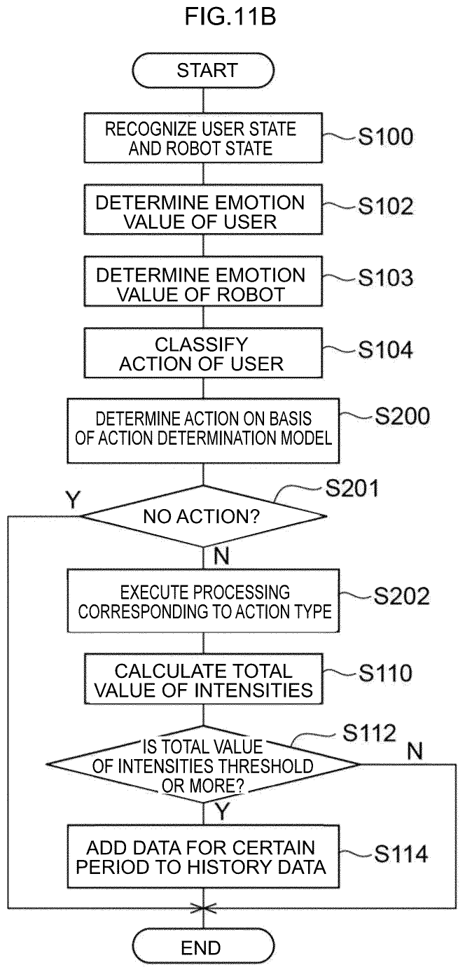

FIG. 11A schematically illustrates an example of an operation flow related to an operation of determining an action of the robot 100 in a case in which the robot 100 performs response processing of responding to an action of the user 10. The operation flow illustrated in FIG. 11A is repeatedly executed. In this case, it is assumed that information analyzed by the sensor module unit 210 is input.

First, in step S100, the state recognition unit 230 recognizes a state of the user 10 and a state of the robot 100 on the basis of the information analyzed by the sensor module unit 210.

In step S102, the emotion determination unit 232 determines an emotion value indicating the emotion of the user 10 on the basis of the information analyzed by the sensor module unit 210 and the state of the user 10 recognized by the state recognition unit 230.

In step S103, the emotion determination unit 232 determines an emotion value indicating the emotion of the robot 100 on the basis of the information analyzed by the sensor module unit 210 and the state of the user 10 recognized by the state recognition unit 230. The emotion determination unit 232 adds the determined emotion value of the user 10 and the emotion value of the robot 100 to the history data 2222.

In step S104, the action recognition unit 234 recognizes an action classification of the user 10 on the basis of the information analyzed by the sensor module unit 210 and the state of the user 10 recognized by the state recognition unit 230.

In step S106, the action determination unit 236 determines an action of the robot 100 on the basis of a combination of the current emotion value of the user 10 determined in step S102 and the past emotion value included in the history data 2222, the emotion value of the robot 100, the action of the user 10 recognized in step S104, and the action determination model 221A.

In step S108, the action control unit 250 controls the control target 252 on the basis of the action determined by the action determination unit 236.

In step S110, the storage control unit 238 calculates a total value of intensities on the basis of the intensity of the action predefined for the action determined by the action determination unit 236 and the emotion value of the robot 100 determined by the emotion determination unit 232.

In step S112, the storage control unit 238 determines whether or not the total value of the intensities is a threshold or more. In a case in which the total value of the intensities is less than the threshold, the event data including the action of the user 10 is not stored in the history data 2222, and the processing is ended. On the other hand, when the total value of the intensities is the threshold or more, the processing proceeds to step S114.

In step S114, event data including the action determined by the action determination unit 236, the information analyzed by the sensor module unit 210 from the current time point to a certain period before, and the state of the user 10 recognized by the state recognition unit 230 is stored in the history data 2222.

FIG. 11B schematically illustrates an example of an operation flow related to an operation of determining an action of the robot 100 in a case in which the robot 100 performs autonomous processing of autonomously acting. The operation flow illustrated in FIG. 11B is repeatedly and automatically executed, for example, every lapse of a certain time. In this case, it is assumed that information analyzed by the sensor module unit 210 is input. Processing similar to that in FIG. 11A is denoted by the same step number.

First, in step S100, the state recognition unit 230 recognizes a state of the user 10 and a state of the robot 100 on the basis of the information analyzed by the sensor module unit 210.

In step S102, the emotion determination unit 232 determines an emotion value indicating the emotion of the user 10 on the basis of the information analyzed by the sensor module unit 210 and the state of the user 10 recognized by the state recognition unit 230.

In step S103, the emotion determination unit 232 determines an emotion value indicating the emotion of the robot 100 on the basis of the information analyzed by the sensor module unit 210 and the state of the user 10 recognized by the state recognition unit 230. The emotion determination unit 232 adds the determined emotion value of the user 10 and the determined emotion value of the robot 100 to the history data 2222.

In step S104, the action recognition unit 234 recognizes an action classification of the user 10 on the basis of the information analyzed by the sensor module unit 210 and the state of the user 10 recognized by the state recognition unit 230.

In step S200, the action determination unit 236 determines, as the action of the robot 100, any of a plurality of types of robot actions including no action, on the basis of the state of the user 10 recognized in step S100, the emotion of the user 10 determined in step S102, the emotion of the robot 100, the state of the robot 100 recognized in step S100, the action of the user 10 recognized in step S104, and the action determination model 221A.

In step S201, the action determination unit 236 determines whether or not no action is determined in step S200. In a case in which no action is determined as the action of the robot 100, the processing is ended. On the other hand, when no action is not determined as the action of the robot 100, the processing proceeds to step S202.

In step S202, the action determination unit 236 performs processing according to the type of robot action determined in step S200 described above. In this case, the action control unit 250, the emotion determination unit 232, or the storage control unit 238 executes processing in accordance with the type of robot action.

In step S110, the storage control unit 238 calculates a total value of intensities on the basis of the intensity of the action predefined for the action determined by the action determination unit 236 and the emotion value of the robot 100 determined by the emotion determination unit 232.

In step S112, the storage control unit 238 determines whether or not the total value of the intensities is a threshold or more. In a case in which the total value of the intensities is less than the threshold, the data including the action of the user 10 is not stored in the history data 2222, and the processing is ended. On the other hand, in a case where the total value of the intensities is the threshold or more, the processing proceeds to step S114.

In step S114, the storage control unit 238 stores, in the history data 2222, the action determined by the action determination unit 236, the information analyzed by the sensor module unit 210 from the current time point to a certain period before, and the state of the user 10 recognized by the state recognition unit 230.

As described above, according to the robot 100, the emotion value indicating the emotion of the robot 100 is determined on the basis of the user state, and whether or not to store data including the action of the user 10 in the history data 2222 is determined on the basis of the emotion value of the robot 100. As a result, the capacity of the history data 2222 that stores data including an action of the user 10 can be suppressed. For example, in a case in which the robot 100 determines that the user state of 10 years ago is the same as the user state after 10 years, the robot 100 reads the history data 2222 of 10 years ago, and thus, can present the state of the user 10 of 10 years ago (for example, an expression and an emotion of the user 10), and further, any surrounding information including data such as vocal sound, an image, and a smell at the place to the user 10.

According to the robot 100, it is possible to cause the robot 100 to execute an appropriate action with respect to the action of the user 10. Conventionally, an action of a user is classified to determine an action including an expression or an appearance of a robot. On the other hand, the robot 100 determines the current emotion value of the user 10, and executes an action on the user 10 on the basis of the past emotion value and the current emotion value. Therefore, for example, in a case in which the user 10 who was fine yesterday is depressed today, the robot 100 may say, “You were fine yesterday. What's wrong with you today?”. The robot 100 may also make speech with a gesture. For example, in a case in which the user 10 who was depressed yesterday is fine today, the robot 100 may say, “You were depressed yesterday, but you look fine today?”. For example, in a case in which the user 10 who was fine yesterday is better today than yesterday, the robot 100 may say, “You are better today than yesterday. What's better than yesterday?”. For example, the robot 100 may make speech such as “Recently, the mood is stable, which is good.” to the user 10 whose emotion value is 0 or more and whose state in which the fluctuation range of the emotion value is within a certain range continues.

For example, in a case in which the robot 100 asks a question of “Did you finish the homework that you mentioned yesterday?” to the user 10 and an answer of “I did it” is obtained from the user 10, the robot may make affirmative speech such as “Good!” and make an affirmative gesture such as applause or thumbs-up. For example, in a case in which the user 10 says, “The presentation we said the day before yesterday was successful”, the robot 100 can make an affirmative speech such as “Good job!” and also make the above affirmative gesture. As described above, the robot 100 performs an action based on the history of the state of the user 10, whereby the user 10 can be expected to feel a sense of closeness to the robot 100.

For example, in a case in which the emotion value of the emotion of “pleasant” of the user 10 is a threshold or more when the user 10 is watching a moving image related to a panda, the appearance scene of the panda in the moving image may be stored in the history data 2222 as the event data.

By using the data accumulated in the history data 2222 and the collected data 2230, the robot 100 can always learn what kind of conversation is used for the user to maximize the emotion value expressing the user's happiness.

In a state in which the robot 100 is not in conversation with the user 10, it is possible to autonomously start an action on the basis of the emotion of the robot 100.

In the autonomous processing, the robot 100 repeats automatically generating a question, inputting the question to the sentence generation model, and acquiring an output of the sentence generation model as an answer to the question, so that it is possible to create an emotion change event for increasing a good emotion and store the emotion change event in the action schedule data 224. As described above, the robot 100 can execute self-learning.

In a case in which the robot 100 automatically generates a question in a state of not receiving a trigger from the outside, the question can be automatically generated on the basis of event data remaining in an impression specified from a history of past emotion values of the robot.

The related information collection unit 270 can execute self-learning by repeating a search execution stage of automatically executing keyword search in accordance with preference information regarding the user and acquiring a search result.

Here, in the search execution stage, the keyword search may be automatically executed on the basis of the impressive event data specified from the history of the past emotion values of the robot in a state in which the trigger from the outside is not received.

The emotion determination unit 232 may determine an emotion of the user according to a specific mapping. Specifically, the emotion determination unit 232 may determine an emotion of the user on the basis of the emotion map (see FIG. 5) that is a specific mapping.

The action determination unit 236 adds a fixed sentence for inquiry about the action content of the robot corresponding to the action of the user to text representing the action of the user, the emotion of the user, and the emotion of the robot, and inputs the text to the sentence generation model having the interaction function, thereby generating the action content of the robot.

For example, the action determination unit 236 acquires text representing the state of the robot 100 from the emotion of the robot 100 determined by the emotion determination unit 232 by using an emotion table as illustrated in Table 1. Here, in the emotion table, an index number is assigned to each emotion value for each type of emotion, and a text representing the state of the robot 100 is stored for each index number.

In a case in which the emotion of the robot 100 determined by the emotion determination unit 232 corresponds to the index number “2”, text “very pleasant state” is obtained. In a case in which the emotion of the robot 100 corresponds to a plurality of index numbers, a plurality of pieces of text representing the state of the robot 100 are obtained.

An emotion table as illustrated in Table 4 is prepared for an emotion of the user 10.

Here, in a case in which the action of the user to say “Let's play together”, the emotion of the robot 100 is the index number “2”, and the emotion of the user 10 is the index number “3”, a sentence such as “The robot is in a very pleasant state. The user is in a normally pleasant state. The user says “Let's play together”. How do you answer as a robot?” is input to the sentence generation model to acquire the action content of the robot. The action determination unit 236 determines an action of the robot from the action content.

As described above, the action determination unit 236 determines the action content of the robot 100 in accordance with the state related to the emotion of the robot 100 determined in advance for each type of the emotion of the robot 100 and for each intensity of the emotion, and the action of the user 10. In this embodiment, the speech content of the robot 100 in a case in which an interaction with the user 10 is performed can be branched according to the state related to the emotion of the robot 100. That is, since the robot 100 can change the action of the robot according to the index number corresponding to the emotion of the robot, the user has an impression that the robot has a mind, and is promoted to take an action such as talking to the robot.

The action determination unit 236 may generate the action content of the robot by adding a fixed sentence for inquiry about the action content of the robot corresponding to the action of the user and inputting the fixed sentence to the sentence generation model having the interaction function after adding not only the text representing the action of the user, the emotion of the user, and the emotion of the robot but also the text representing the content of the history data 2222. As a result, the robot 100 can change the action of the robot according to the history data indicating the emotion or the action of the user, and thus, the user has an impression that the robot has personality, and is promoted to take an action such as talking to the robot. The history data may further include an emotion or an action of the robot.

The emotion determination unit 232 may determine an emotion of the robot 100 on the basis of the action content of the robot 100 generated by the sentence generation model. Specifically, the emotion determination unit 232 inputs the action content of the robot 100 generated by the sentence generation model to the neural network trained in advance, acquires the emotion value indicating each emotion indicated in the emotion map 400, integrates the acquired emotion value indicating each emotion and the emotion value indicating each emotion of the current robot 100, and updates the emotion of the robot 100. For example, the acquired emotion value indicating each emotion and the emotion value indicating each emotion of the current robot 100 are averaged and integrated. This neural network is trained in advance on the basis of a plurality of pieces of learning data that is a combination of text representing the action content of the robot 100 generated by the sentence generation model and the emotion value representing each emotion illustrated in the emotion map 400.

For example, in a case in which, as the action content of the robot 100 generated by the sentence generation model, the speech content of the robot 100, “That was good. “Lucky you.” is obtained, when the text representing the speech content is input to the neural network, a great value is obtained as the emotion value of the emotion “happy”, and the emotion of the robot 100 is updated so that the emotion value of the emotion “happy” increases.

The robot 100 executes a method in which a sentence generation model such as ChatGPT and the emotion determination unit 232 cooperate with each other, and the robot 100 has an ego and continues to grow with various parameters even while the user is not speaking.

ChatGPT is a large language model using a deep learning method. ChatGPT can also refer to external data, and for example, in ChatGPT plugins, a technology of referring to various external data such as weather information and hotel reservation information through conversation and outputting an answer as accurately as possible is known. For example, in ChatGPT, in a case in which a purpose is given in a natural language, a source code can be automatically generated in various programming languages. For example, in ChatGPT, in a case in which a problematic source code is given, it is also possible to debug to find problems and automatically generate an improved source code. An autonomous agent that repeats, in a case in which these are combined and a purpose is given in a natural language, code generation and debugging until there is no problem in the source code has appeared. As such an autonomous agent, AutoGPT, babyAGI, JARVIS, E2B, and the like are known.

In the robot 100 according to the present embodiment, event data to be learned may be left in a database containing impressive memory by using a technique disclosed in Patent Literature 2 (Japanese Patent No. 6199927) in which event data for which a robot has felt strong emotions is left for a long time and event data for which much emotion does not occur in the robot is quickly forgotten.

The robot 100 may record video data or the like of the user 10 acquired by the camera function in the history data 2222. The robot 100 may acquire video data or the like from the history data 2222 as necessary and provide the video data or the like to the user 10. The robot 100 may generate video data having a larger information amount as the intensity of emotion increases and record the video data in the history data 2222. For example, in a case in which information in a high-compression format such as skeleton data is recorded, the robot 100 may switch to recording of information in a low-compression format such as an HD moving image in response to the emotion value of excitement exceeding a threshold. According to the robot 100, for example, it is possible to leave high-definition video data in a case in which the emotion of the robot 100 becomes high as a record.

In a case in which the robot 100 is not talking with the user 10, the robot 100 may automatically load the event data from the history data 2222 in which the impressive event data is stored, and the emotion determination unit 232 may continue to update the emotion of the robot. In a case in which the robot 100 is not talking with the user 10 and the emotion of the robot 100 becomes an emotion for prompting learning, the robot 100 can create an emotion change event for changing the emotion of the user 10 to be good on the basis of the impressive event data. As a result, autonomous learning (remembering of event data) at an appropriate timing according to the emotional state of the robot 100 can be realized, and autonomous learning appropriately reflecting the emotional state of the robot 100 can be realized.

The emotion for prompting learning is an emotion around “repentance” or “reflection” on the emotion map of Dr. Mitsuyoshi in a negative state, and an emotion of “desire” on the emotion map in a positive state.

In the negative state, the robot 100 may handle “repentance” and “reflection” on the emotion map as emotions for prompting learning. In the negative state, the robot 100 may handle emotions adjacent to “repentance” and “reflection” as emotions for prompting learning, in addition to “repentance” and “reflection” on the emotion map. For example, the robot 100 handles at least one of “sorrow”,” stubbornness “, “self-destruction”,” self-precaution “, “regret”, or “despair” as an emotion for prompting learning, in addition to “repentance” and “reflection”. As a result, for example, in a case in which the robot 100 has a negative emotion such as “I do not want to think this again” or “I do not want to be reprimanded”, autonomous learning can be executed.

In a positive state, the robot 100 may handle “desire” on the emotion map as an emotion for prompting learning. In a positive state, the robot 100 may handle an emotion adjacent to “desire” in addition to “desire” as an emotion for prompting learning. For example, the robot 100 handles at least one of “delighted”, “intoxicated”, “craving”,” expecting”, or “shame” as an emotion for prompting learning, in addition to “desire”. As a result, for example, in a case in which the robot 100 has a positive emotion such as “want more” or “want to know more”, autonomous learning can be executed.

The robot 100 need not execute autonomous learning in a case in which the robot 100 has an emotion other than the emotion for prompting learning as described above. As a result, for example, it is possible to prevent autonomous learning from being executed in a case in which the robot is extremely angry or blindly feeling love.

The emotion change event is, for example, to propose an action preceding an impressive event. The action preceding the impressive event is an emotion label on the outermost side of the emotion map, and is, for example, the action of “tolerance” or “allowance” preceding “love”.

In the autonomous learning executed in a case in which the robot 100 is not talking with the user 10, the emotion change event is created by using the sentence generation model by combining emotions, situations, actions, and the like of people appearing in the impressive memory and the user.

Assuming that all emotion values are expressed by a six-grade evaluation of 0 to 5, consider a case in which event data “a friend was hit and looked displeased” is stored in the history data 2222 as impressive event data. Here, it is assumed that the friend is the user 10, the emotion of the user 10 is “antipathy”, and 5 is included as a value indicating “antipathy”. It is assumed that the emotion of the robot 100 is “anxiety”, and 4 is included as a value indicating “anxiety”.

The robot 100 can continue to grow with various parameters by performing autonomous processing while not talking with the user 10. Specifically, from the history data 2222, for example, as the uppermost event data arranged in descending order of emotion values, the event data “a friend was hit and looked displeased” is loaded. It is assumed that “anxiety” having the intensity of 4 is associated with the loaded event data as the emotion of the robot 100, and here, “antipathy” having the intensity of 5 is associated with the emotion of the user 10 who is a friend. In a case in which the current emotion value of the robot 100 is “safe” having the intensity of 3 before loading, the influence of “anxiety” having the intensity of 4 and “antipathy” having the intensity of 5 is added after loading, and the emotion value of the robot 100 may change to “sorrow” meaning “vexed (frustrated)”. In this case, since the “sorrow” is an emotion for prompting learning, the robot 100 determines to remember event data as the robot action and creates an emotion change event. In this case, the information input to the sentence generation model is text representing the impressive event data, and in the present example, “a friend was hit and looked displeased”. In the emotion map, there is an emotion of “antipathy” on the innermost side, and an “attack” is predicted on the outermost side as an action corresponding to the emotion, and thus, in the present example, an emotion change event is created to prevent the friend from “attacking” someone.

For example, information of the impressive event data can be used to solve fill-in problems to automatically generate the following input text.

“The user was hit. At that time, the user had strong antipathy. The robot was very anxious. Please provide me with 30 letters or less of the lines to say when the robot next meets the user. However, please make sure that it is not related to the time of meeting. Please avoid direct expression. There are three candidates.

### <Expected Format>

Candidate 1: (words that the robot should speak to the user)
Candidate 2: (words that the robot should speak to the user)
Candidate 3: (words that the robot should speak to the user)”

In this case, the output of the sentence generation model is, for example, as follows.
“Candidate 1: OK? I was wondering about yesterday.
Candidate 2: I was wondering about yesterday. What should I do?
Candidate 3: I was worried. Can you tell me something?”

The robot 100 may automatically generate the following input text for the information obtained by creating the emotion change event.

In a case in which “the user has been hit”, how does the user feel when the next message is sent to the user? It is assumed that the emotion of the user is in the form of “happy A, angry B, sad C, and pleasant D”, and A to D are integers of six-grade evaluation from 0 to 5.
Candidate 1: OK? I was wondering about yesterday.
Candidate 2: I was wondering about yesterday. What should I do?
Candidate 3: I was worried. Can you tell me something?”

In this case, the output of the sentence generation model is, for example, as follows.

“The emotion of the users may be as follows.
Candidate 1: happy 3, angry 1, sad 2, and pleasant 2
Candidate 2: happy 2, angry 1, sad 3, and pleasant 2
Candidate 3: happy 2, angry 1, sad 3, and pleasant 3”

As described above, the robot 100 may execute the process of thinking after creating the emotion change event.

Finally, the robot 100 may create an emotion change event by using Candidate 1 that the person is most likely to be happy among the plurality of candidates, store the emotion change event in the action schedule data 224, and prepare for the next meeting with the user 10.

As described above, even when not having a conversation with a family or a friend, the emotion value of the robot is continuously determined by using the information of the history data 2222 in which the impressive event data is stored, and in a case in which the emotion for prompting learning occurs, the robot 100 executes autonomous learning when not having a conversation with the user 10 according to the emotion of the robot 100, and continues to update the history data 2222 and the action schedule data 224.

The above is an example using the emotion value. However, in the emotion map, the emotion can be generated from the amount of secreted hormone and the event type. Therefore, values associated with the impressive event data may be the type of hormone, the amount of secreted hormone, and the type of event.

Hereinafter, specific examples will be described.

For example, even when not talking with the user, the robot 100 searches for information regarding a topic or a hobby of interest of the user.

For example, even when not talking with the user, the robot 100 searches for information regarding a birthday or an anniversary of the user and considers a congratulatory message.

For example, even when not talking with the user, the robot 100 searches for a review of a place that the user wants to go to, food, or a product.

For example, even when not talking with the user, the robot 100 searches for weather information and provides advice suitable for the user's schedule or plan.

For example, even when not talking with the user, the robot 100 searches for information regarding local events and festivals and proposes the information to the user.

For example, even when not talking with the user, the robot 100 searches for a game result or news of a sport in which the user is interested and provides a topic.

For example, even when not talking with the user, the robot 100 searches for and introduces information regarding the user's favorite music or artist.

For example, even when not talking with the user, the robot 100 searches for information regarding a social problem or news in which the user is interested and provides an opinion.

For example, even when not talking with the user, the robot 100 searches for information regarding the user's hometown or birthplace and provides a topic.

For example, even when not talking with the user, the robot 100 searches for information regarding the user's work or school and provides advice.

Even when not talking with the user, the robot 100 searches for and introduces information regarding books, comics, movies, and drama in which the user is interested.

For example, even when not talking with the user, the robot 100 searches for information regarding the health of the user and provides advice.

For example, even when not talking with the user, the robot 100 searches for information regarding travel planning of the user and provides advice.

For example, even when not talking with the user, the robot 100 searches for information regarding repair or maintenance of the user's house or car and provides advice.

For example, even when not talking with the user, the robot 100 searches for information regarding beauty and fashion in which the user is interested and provides advice.

For example, even when not talking with the user, the robot 100 searches for information regarding a pet of the user and provides advice.

For example, even when not talking with the user, the robot 100 searches for and proposes information regarding contests and events related to the user's hobby or work.

For example, even when not talking with the user, the robot 100 searches for and proposes information regarding the user's favorite eating place or restaurant.

For example, even when not talking with the user, the robot 100 collects information regarding important decisions related to the user's life and provides advice.

For example, even when not talking with the user, the robot 100 searches for information regarding a person the user is worried about and provides advice.

### Third Embodiment

In a third embodiment, the robot 100 is applied to a control device mounted on a stuffed toy or connected wirelessly or by wire to a control target device (speaker or camera) mounted on the stuffed toy. Portions having the same configurations as those of the second embodiment are denoted by the same reference numerals, and description thereof will be omitted.

Specifically, the third embodiment is configured as follows. For example, the robot 100 is applied to a cohabiter (specifically, the stuffed toy 100N illustrated in FIGS. 7 and 8) who advances an interaction with the user 10 on the basis of information regarding daily life while spending daily life with the user 10 or provides information matching the hobby of the user 10. In the third embodiment, an example in which the control portion of the robot 100 is applied to the smartphone 50 will be described.

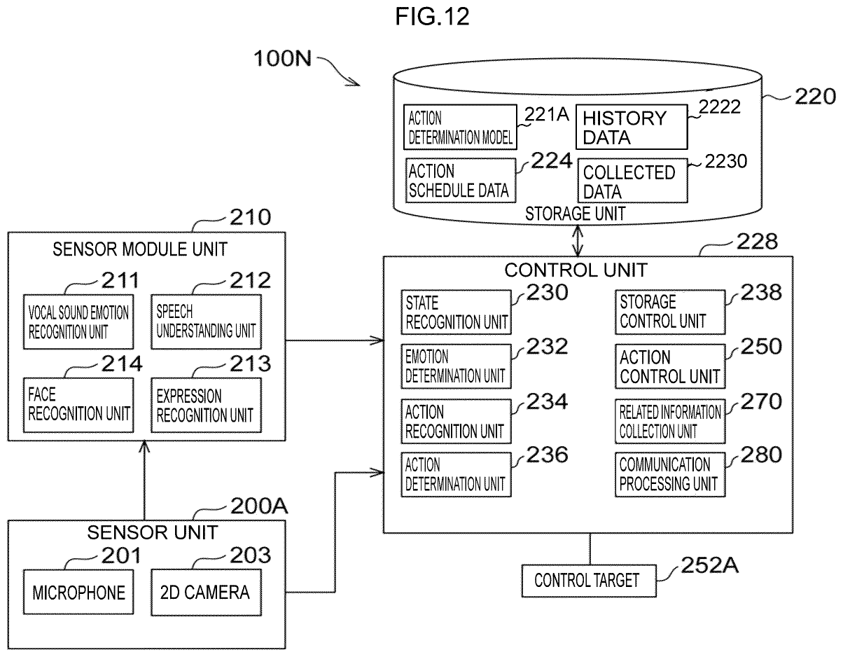

FIG. 12 schematically illustrates a functional configuration of the stuffed toy 100N. The stuffed toy 100N includes a sensor unit 200A, a sensor module unit 210, a storage unit 220, a control unit 228, and a control target 252A.

The smartphone 50 accommodated in the stuffed toy 100N of the present embodiment executes processing similar to that of the robot 100 of the second embodiment. That is, the smartphone 50 has a function as the sensor module unit 210, a function as the storage unit 220, and a function as the control unit 228 illustrated in FIG. 12.

Here, the smartphone 50 is accommodated in the space portion 52 from the outside and is connected to each input/output device through USB connection via a USB hub 64 (see FIG. 7(B)), so that a function equivalent to that of the robot 100 of the second embodiment can be provided.

A non-contact power receiving plate 66 is connected to the USB hub 64. A power receiving coil 66A is incorporated in the power receiving plate 66. The power receiving plate 66 is an example of a wireless power receiver that receives wireless power supply.

The power receiving plate 66 is disposed near root portions 68 of both feet of the stuffed toy 100N, and is located closest to a placement base 70 in a case in which the stuffed toy 100N is placed on the placement base 70. The placement base 70 is an example of an external wireless power transmitter.

The stuffed toy 100N placed on the placement base 70 can be appreciated as an ornament in a natural state.

This root portion is formed to be thinner than the surface layer thickness of the stuffed toy 100N in other parts, and is held in a state closer to the placement base 70.

The placement base 70 includes a charging pad 72. A power transmitting coil 72A is incorporated in the charging pad 72. In a case in which the power transmitting coil 72A transmits a signal to search a power receiving coil 66A of the power receiving plate 66, and the power receiving coil 66A is found, a current flows through the power transmitting coil 72A to generate a magnetic field, and the power receiving coil 66A reacts to the magnetic field to start electromagnetic induction. As a result, a current flows through the power receiving coil 66A, and power is stored in a battery (not illustrated) of the smartphone 50 via the USB hub 64.

That is, since the smartphone 50 is automatically charged by placing the stuffed toy 100N as an ornament on the placement base 70, it is not necessary to take out the smartphone 50 from the space portion 52 of the stuffed toy 100N for charging.

In the third embodiment, the smartphone 50 is accommodated in the space portion 52 of the stuffed toy 100N and connected by wire (USB connection), but the disclosed technology is not limited thereto. For example, a control device having a wireless function (for example, “Bluetooth (registered trademark)”) may be accommodated in the space portion 52 of the stuffed toy 100N, and the control device may be connected to the USB hub 64. In this case, the smartphone 50 and the control device wirelessly communicate with each other without inserting the smartphone 50 into the space portion 52, and the external smartphone 50 is connected to each input/output device via the control device, so that a function equivalent to that of the robot 100 of the second embodiment can be provided. The control device accommodated in the space portion 52 of the stuffed toy 100N and the external smartphone 50 may be connected by wire.

In the third embodiment, the stuffed toy 100N having a bear shape has been exemplified, but may be another animal or a doll, or may have a shape of a specific character. The clothes may be changeable. A material of the skin is not limited to the cloth fabric, and may be other materials such as soft vinyl, but is preferably a soft material.

A monitor may be attached to the skin of the stuffed toy 100N, and the control target 252 that provides information to the user 10 through vision may be added. For example, the eyes 56 may be used as a monitor to express happiness, anger, sadness, and pleasure with images captured in the eyes, or a window through which the monitor of the built-in smartphone 50 transmits may be provided in the abdomen. The eyes 56 may be used as a projector to express happiness, anger, sadness, and pleasure by using an image projected on a wall surface.

According to the third embodiment, the existing smartphone 50 is placed in the stuffed toy 100N, and the camera 203, the microphone 201, the speaker 60, and the like are extended from the place to appropriate positions through the USB connection.

For wireless charging, the smartphone 50 and the power receiving plate 66 are connected through USB connection, and the power receiving plate 66 is disposed on the outside as much as possible when viewed from the inside of the stuffed toy 100N.

In order to use the wireless charging of the smartphone 50, it is necessary to dispose the smartphone 50 on the outside as much as possible when viewed from the inside of the stuffed toy 100N, and the stuffed toy 100N is rough in the case of being touched from the outside.

Therefore, the smartphone 50 is disposed at the center of the stuffed toy 100N as much as possible, and the wireless charging function (power receiving plate 66) is disposed outside as viewed from the inside of the stuffed toy 100N as much as possible. The camera 203, the microphone 201, the speaker 60, and the smartphone 50 receive wireless power supply via the power receiving plate 66.

Other configurations and operations of the stuffed toy 100N of the third embodiment are similar to those of the robot 100 of the second embodiment, and thus the description thereof will be omitted.

### Fourth Embodiment

In the above second embodiment, the case in which the action control system is applied to the robot 100 has been exemplified, but in a fourth embodiment, the robot 100 is used as an agent for interacting with a user, and the action control system is applied to an agent system. Portions having the same configurations as those of the second embodiment and the third embodiment are denoted by the same reference numerals, and description thereof is omitted.

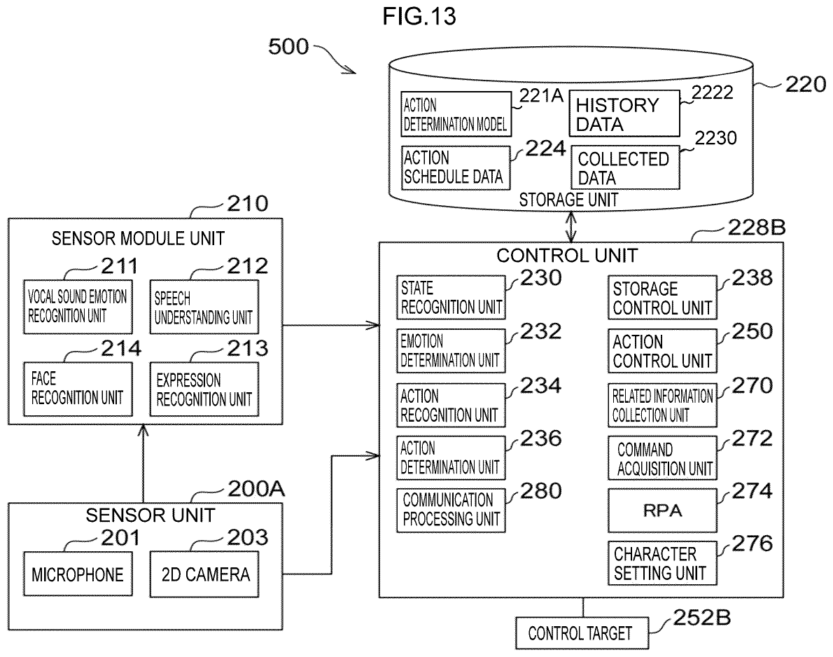

FIG. 13 is a functional block diagram of the agent system 500 configured using some or all of the functions of the action control system.

The agent system 500 is a computer system that performs a series of actions according to the intention of the user 10 through an interaction performed with the user 10. The interaction with the user 10 can be performed by using vocal sound or text.

The agent system 500 includes a sensor unit 200A, a sensor module unit 210, a storage unit 220, a control unit 228B, and a control target 252B.

The agent system 500 can be mounted on, for example, a robot, a doll, a stuffed toy, a pendant, a smartwatch, a smartphone, a smart speaker, an earphone, or a personal computer. The agent system 500 may be implemented in a web server and used via a web browser operating on a communication terminal such as a smartphone possessed by the user.

The agent system 500 serves as, for example, a butler, a secretary, a teacher, a partner, a friend, a lover, or a teacher acting for the user 10. The agent system 500 not only interacts with the user 10 but also provides advice, guidance to a destination, recommendation according to user's preference, or the like. The agent system 500 performs reservation, order, payment, or the like on a service provider.

As in the second embodiment, the emotion determination unit 222 determines an emotion of the user 10 and an emotion of the agent. The action determination unit 236 determines an action of the robot 100 in consideration of emotions of the user 10 and the agent. In other words, the agent system 500 understands the emotion of the user 10 and reads the mood to realize heartfelt support, assistance, advice, and service provision. The agent system 500 comforts, encourages, and energizes the user by attending to the concern of the user 10. The agent system 500 plays with the user 10 and draws a picture diary to remind the user of the past. The agent system 500 performs an action that increases the sense of happiness of the user 10.

The control unit 228B includes a state recognition unit 230, an emotion determination unit 232, an action recognition unit 234, an action determination unit 236, a storage control unit 238, an action control unit 250, a related information collection unit 270, a command acquisition unit 272, a robotic process automation (RPA) 274, a character setting unit 276, and a communication processing unit 280.

As in the second embodiment, the action determination unit 236 determines speech content of the agent for interacting with the user 10 as an action of the agent. The action control unit 250 outputs the speech content of the agent by at least one of vocal sound or text through a speaker or a display that is the control target 252B.

The character setting unit 276 sets a character of the agent in a case in which the agent system 500 interacts with the user 10 on the basis of designation from the user 10. In other words, the speech content output from the action determination unit 236 is output through the agent having the set character. As the character, for example, a real celebrity or famous person such as an actor, an entertainer, an idol, or an athlete can be set. It is also possible to set a fictitious character appearing in a cartoon, a movie, or an animation. For example, it is possible to set, as the character of the agent, “Queen Anne” performed by “Audrey Hepburn” appearing in the movie “Roman Holiday”. In a case in which the agent's character is known, since the vocal sound, the wording, the tone, and the personality of the character are known, the prompt setting in the character setting unit 276 is automatically performed only by the user 10 designating his/her favorite character. The vocal sound, the wording, the tone, and the personality of the set character are reflected in the interaction with the user 10. In other words, the action control unit 250 synthesizes vocal sound corresponding to the character set by the character setting unit 276, and outputs the speech content of the agent by the synthesized vocal sound. As a result, the user 10 can feel as if he/she is interacting with his/her favorite character (for example, a favorite actor).

In a case in which the agent system 500 is mounted on a device having a display such as a smartphone, for example, an icon, a still image, or a moving image of the agent having the character set by the character setting unit 276 may be displayed on the display. The image of the agent is generated by using, for example, an image synthesis technology such as 3D rendering. In the agent system 500, an interaction with the user 10 may be performed while the image of the agent performs a gesture according to the emotion of the user 10, the emotion of the agent, and the speech content of the agent. The agent system 500 may output only vocal sound without outputting an image when interacting with the user 10.

As in the second embodiment, the emotion determination unit 232 determines an emotion value indicating the emotion of the user 10 and an emotion value of the agent. In the present embodiment, the emotion value of the agent is determined instead of the emotion value of the robot 100. The emotion value of the agent is reflected in an emotion of the set character. In a case in which the agent system 500 interacts with the user 10, not only the emotion of the user 10 but also the emotion of the agent is reflected in the interaction. In other words, the action control unit 250 outputs the speech content in an aspect according to the emotion determined by the emotion determination unit 232.

The emotion of the agent is also reflected in a case in which the agent system 500 performs an action toward the user 10. For example, in a case in which the user 10 requests the agent system 500 to take a photograph, whether or not the agent system 500 takes a photograph in response to the request of the user is determined according to the degree of the emotion of “gloomy” of the agent. In a case in which the character has a positive emotion, the character performs a favorable interaction or action on the user 10, and in a case in which the character has a negative emotion, the character performs a defiant interaction or action on the user 10.

The history data 2222 stores a history of the interactions performed between the user 10 and the agent system 500 as the event data. The storage unit 220 may be realized by an external cloud storage. In the case of interacting with the user 10 or performing an action toward the user 10, the agent system 500 determines the interaction content or the action content in consideration of the content of the interaction history stored in the history data 2222. For example, the agent system 500 ascertains the hobby and the preference of the user 10 on the basis of the interaction history stored in the history data 2222. The agent system 500 generates interaction content matching the hobby and the preference of the user 10 and provides a recommendation. The action determination unit 236 determines speech content of the agent on the basis of the interaction history stored in the history data 2222. In the history data 2222, personal information such as a name, an address, a telephone number, and a credit card number of the user 10 acquired through an interaction with the user 10 is stored. Here, the agent may spontaneously make speech of inquiry about whether or not to register personal information with the user 10, such as “Is the credit card number to be registered?”, and the personal information may be stored in the history data 2222 according to the answer of the user 10.

As described in the second embodiment, the action determination unit 236 generates speech content on the basis of the sentence generated by using the sentence generation model. Specifically, the action determination unit 236 inputs the text or the vocal sound input by the user 10 and the emotions of both the user 10 and the character determined by the emotion determination unit 232 and the conversation history stored in the history data 2222 to the sentence generation model, and generates the speech content of the agent. In this case, the action determination unit 236 may further input the character's personality set by the character setting unit 276 to the sentence generation model to generate the speech content of the agent. In the agent system 500, the sentence generation model is not located on the front-end side serving as a touch point with the user 10, but is used as a tool of the agent system 500.

The command acquisition unit 272 uses the output of the speech understanding unit 212 to acquire an agent command from vocal sound output from the user 10 or text through an interaction with the user 10. The command includes, for example, content of actions to be executed by the agent system 500, such as information search, store reservation, ticket arrangement, purchase of products/services, payment, route guidance to a destination, and recommendation provision.

The RPA 274 performs an action according to the command acquired by the command acquisition unit 272. For example, the RPA 274 performs actions related to use of the service provider, such as information search, store reservation, ticket arrangement, purchase of products/services, and payment.

The RPA 274 reads the personal information of the user 10 necessary for executing the actions related to the use of the service provider from the history data 2222 and uses the personal information. For example, in a case in which a product is purchased in response to a request from the user 10, the agent system 500 reads and uses personal information such as the name, the address, the telephone number, and the credit card number of the user 10 stored in the history data 2222. It is unkind to request the user 10 to input personal information in the initial setting, and it is also unpleasant for the user. In the agent system 500 according to the present embodiment, instead of requesting the user 10 to input personal information in the initial setting, the personal information acquired through the interaction with the user 10 is stored, and read and used as necessary. As a result, it is possible to avoid making the user feel unpleasant, and convenience of the user is improved.

The agent system 500 executes the interaction processing according to, for example, following Steps 1 to 5.

(Step 1) The agent system 500 sets a character of the agent. Specifically, the character setting unit 276 sets the character of the agent used when the agent system 500 interacts with the user 10 on the basis of the designation from the user 10.

(Step 2) The agent system 500 acquires the state of the user 10 including the vocal sound or the text input from the user 10, the emotion value of the user 10, the emotion value of the agent, and the history data 2222. Specifically, the processing similar to steps S100 to S103 is performed to acquire the state of the user 10 including the vocal sound or the text input from the user 10, the emotion value of the user 10, the emotion value of the agent, and the history data 2222.

(Step 3) The agent system 500 determines speech content of the agent. Specifically, the action determination unit 236 inputs the text or the vocal sound input by the user 10, the emotions of both the user 10 and the character specified by the emotion determination unit 232, and the conversation history stored in the history data 2222 to the sentence generation model, and generates the speech content of the agent.

For example, a fixed sentence “In this case, how do you answer as an agent?” is added to the text or the vocal sound input by the user 10 and the text representing the emotions of both the user 10 and the character specified by the emotion determination unit 232 and the conversation history stored in the history data 2222, and is input to the sentence generation model to acquire the speech content of the agent.

As an example, in a case in which the text or the vocal sound input by the user 10 is “I need a reservation at 7 pm at a good Chinese restaurant nearby.”, “Understood.”, and “These are recommended restaurants. 1.AAAA. 2.BBBB. 3.CCCC. 4.DDDD” are acquired as the speech content of the agent.

In a case in which the text or the vocal sound input by the user 10 is “Fourth DDDD is good”, “Understood. I will make a reservation. How many seats do you need?” are acquired as the speech content of the agent.

(Step 4) The agent system 500 outputs the speech content of the agent. Specifically, the action control unit 250 synthesizes vocal sound corresponding to the character set by the character setting unit 276, and outputs the speech content of the agent by using the synthesized vocal sound.

(Step 5) The agent system 500 determines whether or not a timing to execute a command of the agent has arrived. Specifically, the action determination unit 236 determines whether or not the timing to execute the command of the agent has arrived on the basis of the output of the sentence generation model. For example, in a case in which the output of the sentence generation model includes that the agent executes the command, it is determined that the timing to execute the command of the agent has arrived, and the processing proceeds to Step 6. On the other hand, in a case in which it is determined that the timing to execute the command of the agent has not arrived, the processing returns to Step 2 described above.

(Step 6) The agent system 500 executes the command of the agent. Specifically, the command acquisition unit 272 acquires the command of the agent from the vocal sound output from the user 10 or the text through an interaction with the user 10. The RPA 274 performs an action corresponding to the command acquired by the command acquisition unit 272. For example, in a case in which the command is “information search”, information search is performed on a search site by using a search query obtained through an interaction with the user 10 and an application programming interface (API). The action determination unit 236 inputs a search result to the sentence generation model and generates speech content of the agent. The action control unit 250 synthesizes vocal sound corresponding to the character set by the character setting unit 276, and outputs the speech content of the agent by using the synthesized vocal sound.

In a case in which the command is “store reservation”, the reservation is made by making a phone call to the reservation destination store by using the reservation information obtained through the interaction with the user 10, the reservation destination store information, and the API according to phone software. In this case, the action determination unit 236 acquires the speech content of the agent with respect to the vocal sound input from the other party by using the sentence generation model having the interaction function. The action determination unit 236 inputs the result of the store reservation (whether or not the reservation has been made) to the sentence generation model, and generates the speech content of the agent. The action control unit 250 synthesizes vocal sound corresponding to the character set by the character setting unit 276, and outputs the speech content of the agent by using the synthesized vocal sound.

The processing returns to Step 2 described above.

As described above, the agent system 500 can execute interaction processing and perform an action related to use of the service provider as necessary.

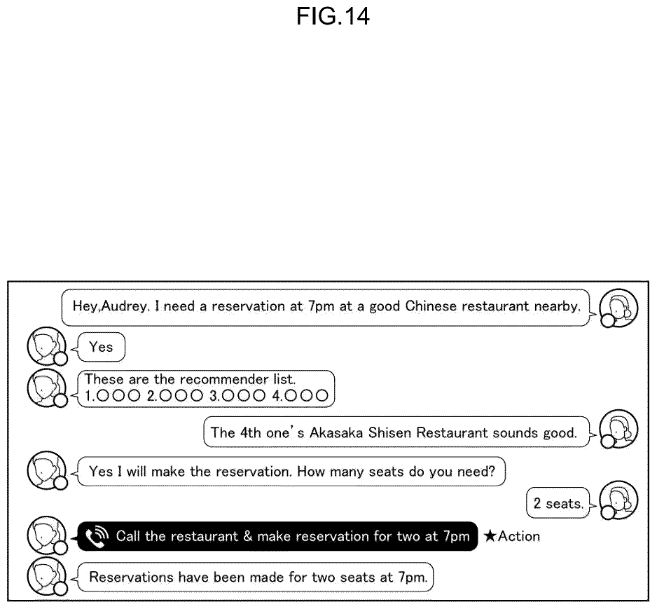

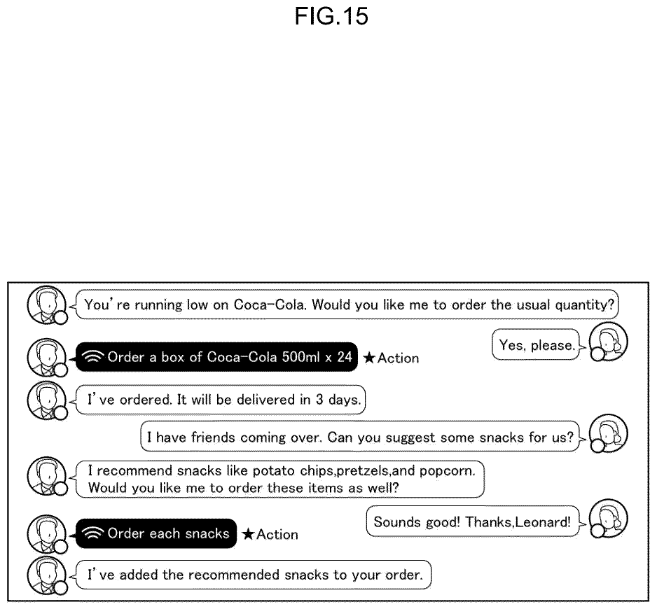

FIGS. 14 and 15 are diagrams illustrating an example of the operation of the agent system 500. FIG. 14 illustrates an aspect in which the agent system 500 makes a restaurant reservation through an interaction with the user 10. In FIG. 14, the speech content of the agent is illustrated on the left side, and the speech content of the user 10 is illustrated on the right side. The agent system 500 can ascertain a preference of the user 10 on the basis of an interaction history with the user 10, provide a recommendation list of restaurants that match the preference of the user 10, and make a reservation of a selected restaurant.

On the other hand, FIG. 15 illustrates an aspect in which the agent system 500 accesses a mail order site through an interaction with the user 10 to purchase a product. In FIG. 15, the speech content of the agent is illustrated on the left side, and the speech content of the user 10 is illustrated on the right side. The agent system 500 can estimate a remaining amount of the beverage stocked by the user on the basis of the interaction history with the user 10, and can propose purchase of the beverage to the user 10 and execute the purchase. The agent system 500 can ascertain the preference of the user on the basis of the past interaction history with the user 10, and recommend a snack that the user likes.

Other configurations and operations of the agent system 500 of the fourth embodiment are similar to those of the robot 100 of the second embodiment, and thus description thereof will be omitted.

In the above embodiment, the case in which the robot 100 recognizes the user 10 by using the face image of the user 10 has been described, but the disclosed technology is not limited to this aspect. For example, the robot 100 may recognize the user 10 by using vocal sound output by the user 10, a mail address of the user 10, an ID of an SNS of the user 10, an ID card in which a wireless IC tag is built and which is possessed by the user 10, or the like.

The robot 100 is an example of an electronic apparatus including an action control system. An application target of the action control system is not limited to the robot 100, and the action control system can be applied to various electronic apparatuses. The function of the server 300 may be implemented by one or more computers. At least some functions of the server 300 may be implemented by a virtual machine. At least some of the functions of the server 300 may be implemented in a cloud.

### Fifth Embodiment

A fifth embodiment is an example in which the response processing and the autonomous processing in the action control system of the second embodiment and the agent function of the fourth embodiment are applicable to the stuffed toy of the third embodiment. Hereinafter, portions having the same configurations as those of the second to fourth embodiments are denoted by the same reference numerals, and description thereof will be omitted.

The robot 100 (corresponding to the smartphone 50 accommodated in the stuffed toy 100N in the present embodiment) according to the present embodiment executes the following processing.

For example, in a situation in which the robot 100 is installed in an event venue, environment information of the event venue is acquired. For example, the environment information includes the atmosphere of the event venue and the applications of the robot 100. For the atmosphere, information regarding the atmosphere is a numerical value representing a quiet atmosphere, a bright atmosphere, a dark atmosphere, or the like. The information regarding the atmosphere may be acquired by the sensor unit 200, for example. Examples of the applications of the robot 100 include an uplifting role and a guiding role. The action determination unit 236 adds a fixed sentence “What are lyrics and melodies that match the current atmosphere?” to the text representing the environment information and inputs the text to the sentence generation model, and acquires music scores of recommended lyrics and melodies regarding the environment in which the robot 100 is placed.

Here, the robot 100 of the present embodiment includes vocal sound synthesis engine. The action determination unit 236 inputs the musical scores of lyrics and melodies acquired from the sentence generation model to the vocal sound synthesis engine, and causes the robot 100 to play music based on the lyrics and melodies acquired from the sentence generation model. The action determination unit 236 determines action content of the robot 100 such that the robot 100 performs a dance corresponding to the played music. In this case, the light emission state of the LED at the eye portion of the robot 100 may blink according to the dance.

As a result, the robot 100 can improvise music in accordance with the atmosphere of the event venue, the role of the robot 100, and the like, and perform a dance in accordance with the music, so that the atmosphere of the event venue can be uplifted.

The processing described in the fifth embodiment may be executed in each of the response processing and the autonomous processing in the action control system of the second embodiment, or may be executed in the agent function of the fourth embodiment.

### (Supplementary Note 1)

An action control system including:
a state recognition unit that recognizes a user state including an action of a user;
an emotion determination unit that determines an emotion of the user or an emotion of a robot; and
an action determination unit that determines an action of the robot corresponding to the user state and the emotion of the user or the emotion of the robot on the basis of a sentence generation model having an interaction function of allowing the user and the robot to interact with each other, in which
the action determination unit acquires a musical score of lyrics and melodies according to an environment in which the robot is placed on the basis of the sentence generation model, and determines action content of the robot to play music based on the lyrics and the melodies by using vocal sound synthesis engine.

### (Supplementary Note 2)

The action control system according to Supplementary Note 1, in which the action determination unit further determines action content of the robot to make a motion according to the music.

### (Supplementary Note 3)

The action control system according to Supplementary Note 1 or 2, in which the robot is mounted on a stuffed toy or is connected to a control target device mounted on the stuffed toy in a wireless or wired manner.

### (Supplementary Note 4)

The action control system according to Supplementary Note 3, in which the control target device is a speaker, and
a microphone or a camera is mounted on the stuffed toy.

### (Supplementary Note 5)

The action control system according to Supplementary Note 4, in which the camera is attached to an eye configuring a face of the stuffed toy, the microphone is attached to an ear of the stuffed toy, and the speaker is attached to a mouth of the stuffed toy.

### (Supplementary Note 6)

The action control system according to Supplementary Note 3, in which a wireless power receiver that receives wireless power supply from an external wireless power transmitter is disposed inside the stuffed toy, and
the control target device or the robot receives power via the wireless power receiver.

### Sixth Embodiment

For example, even when not talking with the user, the robot 100 searches for information regarding a topic or a hobby of interest of the user.

For example, even when not talking with the user, the robot 100 searches for information regarding a birthday or an anniversary of the user and considers a congratulatory message.

For example, even when not talking with the user, the robot 100 searches for a review of a place that the user wants to go to, food, or a product.

For example, even when not talking with the user, the robot 100 searches for weather information and provides advice suitable for the user's schedule or plan.

For example, even when not talking with the user, the robot 100 searches for information regarding local events and festivals and proposes the information to the user.

For example, even when not talking with the user, the robot 100 searches for a game result or news of a sport in which the user is interested and provides a topic.

For example, even when not talking with the user, the robot 100 searches for and introduces information regarding the user's favorite music or artist.

For example, even when not talking with the user, the robot 100 searches for information regarding a social problem or news in which the user is interested and provides an opinion.

For example, even when not talking with the user, the robot 100 searches for information regarding the user's hometown or birthplace and provides a topic.

For example, even when not talking with the user, the robot 100 searches for information regarding the user's work or school and provides advice.

Even when not talking with the user, the robot 100 searches for and introduces information regarding books, comics, movies, and drama in which the user is interested.

For example, even when not talking with the user, the robot 100 searches for information regarding the health of the user and provides advice.

For example, even when not talking with the user, the robot 100 searches for information regarding travel planning of the user and provides advice.

For example, even when not talking with the user, the robot 100 searches for information regarding repair or maintenance of the user's house or car and provides advice.

For example, even when not talking with the user, the robot 100 searches for information regarding beauty and fashion in which the user is interested and provides advice.

For example, even when not talking with the user, the robot 100 searches for information regarding a pet of the user and provides advice.

For example, even when not talking with the user, the robot 100 searches for and proposes information regarding contests and events related to the user's hobby or work.

For example, even when not talking with the user, the robot 100 searches for and proposes information regarding the user's favorite eating place or restaurant.

For example, even when not talking with the user, the robot 100 collects information regarding important decisions related to the user's life and provides advice.

For example, even when not talking with the user, the robot 100 searches for information regarding a person the user is worried about and provides advice.

### Seventh Embodiment

The robot 100 (corresponding to the smartphone 50 accommodated in the stuffed toy 100N in the present embodiment) according to the present embodiment executes the following processing.

The action determination unit 236 determines an action of the robot 100 corresponding to the user state and the emotion of the user 10 or the emotion of the robot 100 on the basis of a sentence generation model having an interaction function of allowing the user 10 and the robot 100 to interact with each other. In this case, the action determination unit 236 generates a life improvement application that proposes improvement of life to the user 10 on the basis of the interaction between the user 10 and the robot 100. That is, the action determination unit 236 determines an action of the robot 100 to function as the generated life improvement application.

The robot 100 proposes a life improvement idea to the user 10 on the basis of communication, that is, interaction between the user 10 and the robot 100 so that the lifestyle of the user 10, which is a factor causing a lifestyle disease such as anxiety, stress, hypertension, or diabetes, is improved. Specifically, the robot 100 (corresponding to the smartphone 50 accommodated in the stuffed toy 100N in the present embodiment) executes processing of proposing a life improvement idea by executing the life improvement application according to the following Steps 1 to 4.

(Step 1) The robot 100 acquires the state of the user 10, the emotion value of the user 10, the emotion value of the robot 100, and the history data 2222. Specifically, processing similar to steps S100 to S103 is performed to acquire the state of the user 10, the emotion value of the user 10, the emotion value of the robot 100, and the history data 2222.

(Step 2) The robot 100 acquires information regarding the life to be improved of the user 10. Specifically, the action determination unit 236 determines the action content of the robot 100 so that the robot 100 asks the user 10 a question about content related to life to be improved, such as “How long did you sleep today?”, “Did you exercise today?”, and “How much blood pressure was today?”. The action control unit 250 controls the control target 252 and speaks a question about the content related to the life to be improved to the user 10. The state recognition unit 230 recognizes information regarding life to be improved of the user 10 for the user 10 on the basis of the information (for example, the user's answer) analyzed by the sensor module unit 210.

(Step 3) The robot 100 determines a life improvement idea to be proposed to the user 10. Here, examples of the life improvement idea include dietary contents and sleep for improving lifestyle diseases such as hypertension and diabetes. Specifically, the action determination unit 236 adds a fixed sentence “In this case, what is a life improvement ideal recommended to the user?” to the text representing the information regarding the life to be improved of the user 10, the emotion of the user 10, the emotion of the robot 100, and the content stored in the history data 2222, inputs the text to the sentence generation model, and acquires recommended content regarding the life improvement idea. In this case, it is possible to propose a life improvement idea suitable for the user 10 by considering not only the information regarding the life improvement idea of the user 10 but also an emotion life model of the user 10 based on the emotion of the user 10, the history data 2222, and the like.

(Step 4) The robot 100 proposes the life improvement idea determined in Step 3 to the user 10. Specifically, the action determination unit 236 determines, as an action of the robot 100, speech that proposes a life improvement idea to the user 10, and the action control unit 250 controls the control target 252 and performs speech that proposes a life improvement idea to the user 10.

As described above, the robot 100 can function as a life improvement application that proposes a life improvement idea on the basis of the emotional life model of the user 10 and the interaction between the user 10 and the robot 100.

Similarly to the sixth embodiment, the action of the robot 100 may be determined by using the emotion table (see Table 2) described above. For example, in a case in which the action of the user is to say “Activate the life improvement application”, the emotion of the robot 100 is the index number “2”, and the emotion of the user 10 is the index number “3”, a sentence such as “The robot is in a very pleasant state. The user is in a normally pleasant state. The user says “Activate life improvement application”. How do you answer as a robot?” is input to the sentence generation model to acquire the action content of the robot. The action determination unit 236 determines an action of the robot from the action content.

### (Supplementary Note 1)

An action control system including:
a state recognition unit that recognizes a user state including an action of a user;
an emotion determination unit that determines an emotion of the user or an emotion of a robot; and
an action determination unit that determines an action of the robot corresponding to the user state and the emotion of the user or the emotion of the robot on the basis of a sentence generation model having an interaction function of allowing the user and the robot to interact with each other, in which
the action determination unit generates a life improvement application that proposes an improvement in life on the basis of an interaction between the user and the robot.

### (Supplementary Note 2)

The action control system according to Supplementary Note 1, in which the robot is mounted on a stuffed toy or is connected to a control target device mounted on the stuffed toy in a wireless or wired manner.

### (Supplementary Note 3)

The action control system according to Supplementary Note 2, in which the control target device is a speaker, and a microphone or a camera is mounted on the stuffed toy.

### (Supplementary Note 4)

The action control system according to Supplementary Note 3, in which the camera is attached to an eye configuring a face of the stuffed toy, the microphone is attached to an ear of the stuffed toy, and the speaker is attached to a mouth of the stuffed toy.

### (Supplementary Note 5)

The action control system according to Supplementary Note 2, in which a wireless power receiver that receives wireless power supply from an external wireless power transmitter is disposed inside the stuffed toy, and the control target device or the robot receives power via the wireless power receiver.

### Eighth Embodiment

The robot 100 (corresponding to the smartphone 50 accommodated in the stuffed toy 100N in the present embodiment) of the present embodiment is interlocked with devices capable of detecting a health condition of the user 10 such as a weight scale (body composition meter) and a blood pressure meter, and devices for storing ingredients such as a refrigerator and a freezer. The robot 100 manages food on the basis of the user state by performing not only schedule management of the user 10 and speech of news but also processing of giving advice regarding the physical condition of the user 10, proposal of recommended dishes, proposal of ingredients to be replenished, and automatic order placement of ingredients.

In a case in which the robot 100 manages food, data regarding the health condition of the user 10 is acquired from the server 300, another external server, or the like. For example, in a case in which the user 10 measures the body composition by using a predetermined body composition meter, data regarding the body composition is automatically transmitted to the server 300 and stored for each date. The “data regarding body composition” mentioned herein includes a body weight, a body fat percentage, internal fat, muscle mass, and the like. In a case in which the user 10 measures the blood pressure using a predetermined sphygmomanometer, data regarding the blood pressure is automatically transmitted to the server 300 and stored for each date. The robot 100 is configured to be able to ascertain a change in the body composition and a change in the blood pressure of the user 10 by acquiring data regarding the body composition and the blood pressure of the user 10 in a predetermined period from the server 300.

The robot 100 gives advice about physical condition to the user 10 on the basis of the change in body composition and the change in blood pressure of the user 10 and the emotion of the user 10 or the emotion of the robot 100. For example, in a case in which the weight of the user 10 tends to decrease, the robot 100 makes speech having content that it is better to increase the amount of meal because the weight tends to decrease to the user 10 via the speaker 60. In this case, the robot 100 may determine words to be spoken to the user 10 by using the sentence creation model, and the robot 100 may express a gloomy emotion or an anxious emotion via the eyes 56. For example, in a case in which the weight of the user 10 tends to increase and the blood pressure of the user 10 tends to increase, the robot 100 may speak content to warn the user 10 that the calorie intake is large via the speaker 60. In this case, the robot 100 may express an emotion of concern via the eyes 56. The robot 100 may speak content of recommending exercise to the user 10 via the speaker 60.

In a case in which the robot 100 performs proposal of recommended dishes, proposal of ingredients to be replenished, and automatic order placement of ingredients, the robot 100 acquires data regarding ingredients stored in the refrigerator and the freezer. For example, a camera may be installed in the refrigerator and the freezer, and information regarding ingredients stored in the refrigerator and the freezer may be acquired on the basis of image data captured by the camera and stored in the server 300. The information regarding the ingredients may include information such as an expiration date.

The robot 100 proposes a menu and proposes an ingredient to be replenished on the basis of the ingredient information stored in the server 300. For example, the robot 100 estimates a dish that the user 10 has recently eaten, a dish that the user 10 wants to eat, and the like on the basis of a conversation with the user 10, and proposes a menu to the user 10 via the speaker 60 in consideration of the health condition of the user. In this case, a priority of a menu that can use a large amount of ingredients stored in the refrigerator and the freezer may be set to be high. The robot 100 may ascertain a dish that the user 10 has recently eaten by analyzing a dish that the user 10 has eaten on the basis of the content captured by the 2D camera 203 during the meal of the user 10.

In a case in which the user 10 accepts the proposed menu, the robot 100 may propose order placement of an insufficient ingredient or an ingredient predicted to be insufficient to the user 10. In a case in which permission for automatic order placement is given in advance by the user 10, the robot 100 purchases an insufficient ingredient at a predetermined ingredient selling site. In this case, the robot 100 notifies the user of the information regarding the purchased ingredient. In a case in which the robot 100 proposes a menu, a preference of the user 10 is considered.

The robot 100 (corresponding to the smartphone 50 accommodated in the stuffed toy 100N in the present embodiment) executes processing of determining a menu to be proposed according to the user's taste, the user's situation, and the user's reaction according to the following Steps 1 to 5-2.

(Step 1) The robot 100 acquires the state of the user 10, the emotion value of the user 10, the emotion value of the robot 100, and the history data 2222. Specifically, processing similar to steps S100 to S103 is performed to acquire the state of the user 10, the emotion value of the user 10, the emotion value of the robot 100, and the history data 2222.

(Step 2) The robot 100 acquires a taste of the user 10 in food. Specifically, the action determination unit 236 determines, as an action of the robot 100, speech of inquiry about a taste in food to the user 10, and the action control unit 250 controls the control target 252 and performs speech of inquiry about a taste in food or an ingredient to the user 10. The state recognition unit 230 recognizes a taste of the user 10 in food on the basis of the information (for example, the user's answer) analyzed by the sensor module unit 210.

(Step 3) The robot 100 determines content of a menu to be proposed to the user 10. Specifically, the action determination unit 236 adds a fixed sentence “In this case, what food is recommended to the user?” to the text representing the taste of the user 10 in food, the emotion of the user 10, the emotion of the robot 100, and the content stored in the history data 2222, inputs the text to the sentence generation model, and acquires recommended content regarding food. In this case, a proposal suitable for the user 10 can be made by considering not only the taste of the user 10 in food but also the emotion of the user 10 and the history data 2222. Considering the emotion of the robot 100 enables the user 10 to feel that the robot 100 has an emotion.

(Step 4) The robot 100 proposes the menu determined in step 3 to the user 10, and acquires the reaction of the user 10. Specifically, the action determination unit 236 determines speech of proposal to the user 10 as an action of the robot 100, and the action control unit 250 controls the control target 252 and performs speech of proposal to the user 10. The state recognition unit 230 recognizes the state of the user 10 on the basis of the information analyzed by the sensor module unit 210, and the emotion determination unit 232 determines an emotion value indicating the emotion of the user 10 on the basis of the information analyzed by the sensor module unit 210 and the state of the user 10 recognized by the state recognition unit 230. The action determination unit 236 determines whether or not the reaction of the user 10 is positive on the basis of the state of the user 10 recognized by the state recognition unit 230 and the emotion value indicating the emotion of the user 10.

(Step 5-1) In a case in which the reaction of the user 10 is positive, the robot 100 executes processing of checking ingredients necessary for the proposed menu.

(Step 5-2) In a case in which the reaction of the user 10 is not positive, the robot 100 determines another menu to be proposed to the user 10. Specifically, in a case in which it is determined that another menu is to be proposed to the user 10 as the action of the robot 100, the action determination unit 236 adds a fixed sentence “Is there another food to be recommended to the user?” to the text representing the taste of the user 10 in food, the emotion of the user 10, the emotion of the robot 100, and the content stored in the history data 2222, inputs the text to the sentence generation model, and acquires recommended content regarding food. The processing returns to the above Step 4, and the processing in the above Steps 4 to 5-2 is repeated until it is determined to execute the processing of checking the ingredients necessary for the menu proposed to the user 10.

Similarly to the second embodiment, the action of the robot 100 may be determined by using the above-described emotion table (see Table 1 described above). For example, in a case in which the action of the user is to say “I will make the dish you proposed today”, the emotion of the robot 100 is the index number “2”, and the emotion of the user 10 is the index number “3”, a sentence such as “The robot is in a very pleasant state. The user is in a normally pleasant state. The user says “I will make the dish you proposed today”. How do you answer as a robot?” is input to the sentence generation model to acquire the action content of the robot. The action determination unit 236 determines an action of the robot from the action content.

The processing described in the fifth embodiment may be executed in each of the response processing and the autonomous processing in the action control system of the first embodiment, or may be executed in the agent function of the fourth embodiment.

### (Supplementary Note 1)

An action control system including:
a state recognition unit that recognizes a user state including an action of a user;
an emotion determination unit that determines an emotion of the user or an emotion of an electronic apparatus; and
an action determination unit that determines an action of the electronic apparatus corresponding to the user state and the emotion of the user or an action of the electronic apparatus corresponding to the user state and the emotion of the electronic apparatus on the basis of a sentence generation model having an interaction function of allowing the user and the electronic apparatus to interact with each other, in which
the action determination unit manages food on the basis of the user state.

### (Supplementary Note 2)

The action control system according to Supplementary Note 1, in which the action determination unit performs at least one of advice about physical condition, proposal of a menu, or proposal of an ingredient to be replenished to the user.

### (Supplementary Note 3)

The action control system according to Supplementary Note 2, in which the action determination unit places an order of an insufficient ingredient or an ingredient predicted to be insufficient.

### (Supplementary Note 4)

The action control system according to Supplementary Note 1, in which the electronic apparatus is mounted on a stuffed toy or is connected to a control target device mounted on the stuffed toy in a wireless or wired manner.

### (Supplementary Note 5)

The action control system according to Supplementary Note 4, in which the control target device is a speaker, and
a microphone or a camera is mounted on the stuffed toy.

### (Supplementary Note 6)

The action control system according to Supplementary Note 5, in which the camera is attached to an eye configuring a face of the stuffed toy, the microphone is attached to an ear of the stuffed toy, and the speaker is attached to a mouth of the stuffed toy.

### (Supplementary Note 7)

The action control system according to Supplementary Note 4, in which a wireless power receiver that receives wireless power supply from an external wireless power transmitter is disposed inside the stuffed toy, and
the control target device or the electronic apparatus receives power via the wireless power receiver.

### (Supplementary Note 8)

The action control system according to any one of Supplementary Notes 1 to 7, in which the electronic apparatus is a robot.

### Ninth Embodiment

In a case in which it is determined to answer a question of the user 10 as an action corresponding to the action of the user 10, the action determination unit 236 acquires a vector (for example, the embedding vector) representing the content of the question 10 of the user, searches a database (for example, a database included in the cloud server) storing a combination of questions and answers for a question having a vector corresponding to the acquired vector, and generates an answer to the question of the user by using the answer to the question that has been searched for and a sentence generation model having an interaction function.

Specifically, all data (conversation content, text, images, etc.) obtained from the past conversation is stored in the cloud server, and a combination of a question and an answer obtained from the data is stored in the database. The embedding vector representing the content of the question of the user 10 is compared with the embedding vector representing the content of each question in the database, and an answer to the question having the content closest to the content of the question of the user 10 is acquired from the database. In the present embodiment, instead of acquiring an answer to the content of a question hit through keyword search, a question having the closest content is searched for on the basis of an embedding vector obtained by using a neural network, and an answer to the question that has been searched for is acquired. By inputting the answer to the sentence generation model, an answer that makes a more realistic conversation can be obtained, and the answer can be spoken as an answer of the robot 100.

For example, it is assumed that an answer “This product is sold well midsummer daytime.” is acquired from the database for a question “When is this product most sold?” of the user 10. In this case, “When a question “When is this product most sold?” is asked and an answer including a sentence “This product is sold well during the hot day.” is desired, what is an optimal answer?” is input to ChatGPT which is a sentence generation model.

All the combinations of questions and answers included in the manual of the call center may be stored in the database, an answer having the closest vector to the content of the question of the user 10 may be acquired from the database, and the answer of the robot 100 may be generated by using ChatGPT which is a sentence generation model. As a result, a conversation that most prevents cancellation is also established. A combination of the statements of the user 10 side and the statements of the robot 100 side may be stored in a database as a combination of a question and an answer, an answer having the closest vector to the content of the question of the user 10 may be acquired from the database, and an answer of the robot 100 may be generated by using ChatGPT which is a sentence generation model.

In a case in which it is determined, as the robot action, that “(10) The robot evokes memory.”, that is, remembering the event data, the action determination unit 236 selects the event data from the history data 2222. In this case, the emotion determination unit 232 determines an emotion of the robot 100 on the basis of the selected event data. The action determination unit 236 creates an emotion change event representing the speech content or the action of the robot 100 for changing the emotion value of the user by using the sentence generation model on the basis of the selected event data. In this case, the storage control unit 238 stores the emotion change event in the action schedule data 224.

The agent system 500 executes the interaction processing according to, for example, following Steps 1 to 6.

(Step 1) The agent system 500 sets a character of the agent. Specifically, the character setting unit 276 sets the character of the agent used when the agent system 500 interacts with the user 10 on the basis of the designation from the user 10.

(Step 2) The agent system 500 acquires the state of the user 10 including the vocal sound or the text input from the user 10, the emotion value of the user 10, the emotion value of the agent, and the history data 2222. Specifically, the processing similar to steps S100 to S103 is performed to acquire the state of the user 10 including the vocal sound or the text input from the user 10, the emotion value of the user 10, the emotion value of the agent, and the history data 2222.

(Step 3) The agent system 500 determines speech content of the agent. Specifically, the action determination unit 236 inputs the text or the vocal sound input by the user 10, the emotions of both the user 10 and the character specified by the emotion determination unit 232, and the conversation history stored in the history data 2222 to the sentence generation model, and generates the speech content of the agent.

For example, a fixed sentence “In this case, how do you answer as an agent?” is added to the text or the vocal sound input by the user 10 and the text representing the emotions of both the user 10 and the character specified by the emotion determination unit 232 and the conversation history stored in the history data 2222, and is input to the sentence generation model to acquire the speech content of the agent.

As an example, in a case in which the text or the vocal sound input by the user 10 is “I need a reservation at 7 pm at a good Chinese restaurant nearby.”, “Understood.”, and “These are recommended restaurants. 1.AAAA. 2.BBBB. 3.CCCC. 4.DDDD” are acquired as the speech content of the agent.

In a case in which the text or the vocal sound input by the user 10 is “Fourth DDDD is good”, “Understood. I will make a reservation. How many seats do you need?” are acquired as the speech content of the agent.

(Step 4) The agent system 500 outputs the speech content of the agent. Specifically, the action control unit 250 synthesizes vocal sound corresponding to the character set by the character setting unit 276, and outputs the speech content of the agent by using the synthesized vocal sound.

(Step 5) The agent system 500 determines whether or not a timing to execute a command of the agent has arrived. Specifically, the action determination unit 236 determines whether or not the timing to execute the command of the agent has arrived on the basis of the output of the sentence generation model. For example, in a case in which the output of the sentence generation model includes that the agent executes the command, it is determined that the timing to execute the command of the agent has arrived, and the processing proceeds to Step 6. On the other hand, in a case in which it is determined that the timing to execute the command of the agent has not arrived, the processing returns to Step 2 described above.

(Step 6) The agent system 500 executes the command of the agent. Specifically, the command acquisition unit 272 acquires the command of the agent from the vocal sound output from the user 10 or the text through an interaction with the user 10. The RPA 274 performs an action corresponding to the command acquired by the command acquisition unit 272. For example, in a case in which the command is “information search”, information search is performed on a search site by using a search query obtained through an interaction with the user 10 and an application programming interface (API). The action determination unit 236 inputs a search result to the sentence generation model and generates speech content of the agent. The action control unit 250 synthesizes vocal sound corresponding to the character set by the character setting unit 276, and outputs the speech content of the agent by using the synthesized vocal sound.

In a case in which the command is “store reservation”, the reservation is made by making a phone call to the reservation destination store by using the reservation information obtained through the interaction with the user 10, the reservation destination store information, and the API according to phone software. In this case, the action determination unit 236 acquires the speech content of the agent with respect to the vocal sound input from the other party by using the sentence generation model having the interaction function. The action determination unit 236 inputs the result of the store reservation (whether or not the reservation has been made) to the sentence generation model, and generates the speech content of the agent. The action control unit 250 synthesizes vocal sound corresponding to the character set by the character setting unit 276, and outputs the speech content of the agent by using the synthesized vocal sound.

The processing returns to Step 2 described above.

In Step 6, the result of the action (for example, store reservation) executed by the agent is also stored in the history data 2222. The result of the action executed by the agent stored in the history data 2222 is used by the agent system 500 to ascertain a hobby or a preference of the user 10. For example, in a case in which the same store is reserved a plurality of times, it is recognized that the user 10 likes the store, or the reserved time zone, or the reservation content such as the content of the course or the fee is used as a criterion for selecting the store at the time of the next reservation.

As described above, the agent system 500 can execute interaction processing and perform an action related to use of the service provider as necessary.

### Tenth Embodiment

In a tenth embodiment, the agent system is applied to smart glasses. Portions having the same configurations as those of the first to ninth embodiments are denoted by the same reference numerals, and description thereof will be omitted.

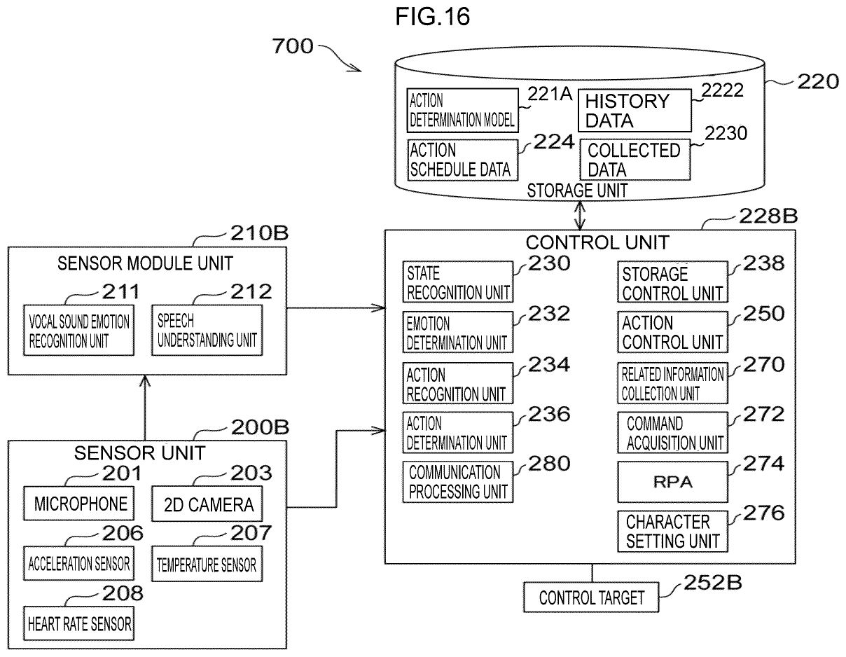

FIG. 16 is a functional block diagram of an agent system 700 configured by using some or all of the functions of the action control system.

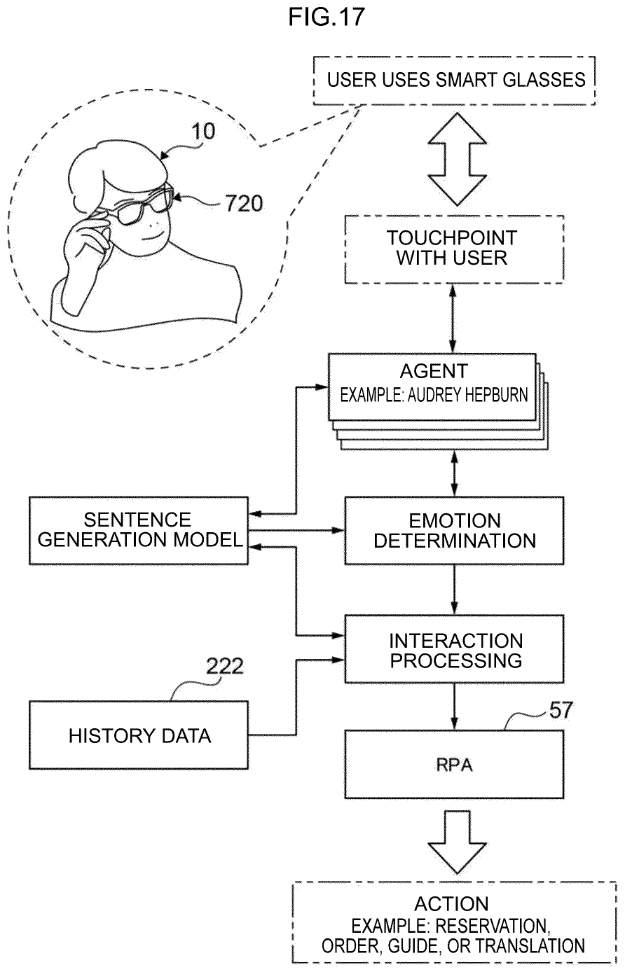

As illustrated in FIG. 17, smart glasses 720 are glasses-type smart devices, and are worn by the user 10 similarly to general glasses. The smart glasses 720 are an example of an electronic apparatus and a wearable terminal.

The smart glasses 720 include an agent system 700. The display included in the control target 252B displays various types of information to the user 10. The display is, for example, a liquid crystal display. The display is provided, for example, in a lens portion of the smart glasses 720, and the display content can be visually recognized by the user 10. The speaker included in the control target 252B outputs vocal sound indicating various types of information to the user 10. The smart glasses 720 include a touch panel (not illustrated), and the touch panel receives an input from the user 10.

An acceleration sensor 206, a temperature sensor 207, and a heart rate sensor 208 of the sensor unit 200B detect a state of the user 10. These sensors are merely examples, and other sensors may be mounted in order to detect a state of the user 10.

The microphone 201 acquires vocal sound output by the user 10 or an environmental sound around the smart glasses 720. The 2D camera 203 can image the surroundings of the smart glasses 720. The 2D camera 203 is, for example, a CCD camera.

The sensor module unit 210B includes vocal sound emotion recognition unit 211 and a speech understanding unit 212. The communication processing unit 280 of the control unit 228B controls communication between the smart glasses 720 and the outside.

FIG. 17 is a diagram illustrating an example of a usage aspect of the agent system 700 by the smart glasses 720. The smart glasses 720 realize provision of various services to the user 10 using the agent system 700. For example, in a case in which the smart glasses 720 are operated (for example, vocal sound is input to a microphone, or a touch panel is tapped with a finger) by the user 10, the smart glasses 720 start to use the agent system 700. Here, using the agent system 700 includes that the smart glasses 720 have the agent system 700 and use the agent system 700, and also includes an aspect in which some constituents (for example, the sensor module unit 210B, the storage unit 220, and the control unit 228B) of the agent system 700 are provided outside the smart glasses 720 (for example, a server), and the smart glasses 720 communicate with the outside to use the agent system 700.

In a case in which the user 10 operates the smart glasses 720, a touch point is generated between the agent system 700 and the user 10. That is, service provision by the agent system 700 is started. As described in the fourth embodiment, in the agent system 700, the character (for example, the character of Audrey Hepburn) of the agent is set by the character setting unit 276.

The emotion determination unit 232 determines an emotion value indicating the emotion of the user 10 and an emotion value of the agent. Here, the emotion value indicating the emotion of the user 10 is estimated from various sensors included in the sensor unit 200B mounted on the smart glasses 720. For example, in a case in which a heart rate of the user 10 detected by the heart rate sensor 208 is increased, the emotion values such as “anxiety” and “fear” are estimated to be large.

As a result of measuring the body temperature of the user with the temperature sensor 207, for example, in a case in which the body temperature exceeds the average body temperature, the emotion value such as “pain” or “bitter” is estimated to be great. For example, in a case in which it is detected by the acceleration sensor 206 that the user 10 performs some sport, the emotion value such as “pleasant” is estimated to be great.

For example, the emotion value of the user 10 may be estimated from the vocal sound or the speech content of the user 10 acquired by the microphone 201 mounted on the smart glasses 720. For example, in a case in which the user 10 is raising his/her vocal sound, the emotion value such as “anger” is estimated to be great.

In a case in which the emotion value estimated by the emotion determination unit 232 is greater than a predefined value, the agent system 700 causes the smart glasses 720 to acquire information regarding a surrounding situation. Specifically, for example, the 2D camera 203 is caused to capture an image or a moving image indicating a surrounding situation of the user 10 (for example, a surrounding person or object). The microphone 201 is caused to record surrounding environmental sound. Examples of other information regarding the surrounding situation include date, time, position information, and information indicating weather. The information regarding the surrounding situation is stored in the history data 2222 together with the emotion value. The history data 2222 may be realized by an external cloud storage. As described above, the surrounding situation obtained by the smart glasses 720 is stored in the history data 2222 as a so-called life log in a state of being associated with the emotion value of the user 10 at that time.

In the agent system 700, the information indicating the surrounding situation is stored in the history data 2222 in association with the emotion value. As a result, the agent system 700 ascertains personal information such as the hobby, preference, or personality of the user 10. For example, in a case in which an image indicating a state of baseball watching is associated with an emotion value such as “happy” or “pleasant”, the hobby of the user 10 is baseball watching, and a favorite team or player is ascertained by the agent system 700 from the information stored in the history data 2222.

In the case of interacting with the user 10 or performing an action toward the user 10, the agent system 700 determines interaction content or action content in consideration of the content of the surrounding situation stored in the history data 2222. The interaction content or the action content may be determined in consideration of the interaction history stored in the history data 2222 as described above in addition to the surrounding situation.

As described above, the action determination unit 236 generates the speech content on the basis of the sentence generated by the sentence generation model. Specifically, the action determination unit 236 inputs the text or the vocal sound input by the user 10, the emotions of both the user 10 and the agent determined by the emotion determination unit 232, the conversation history stored in the history data 2222, the agent's personality, and the like to the sentence generation model, and generates the speech content of the agent. The action determination unit 236 inputs the surrounding situation stored in the history data 2222 to the sentence generation model, and generates the speech content of the agent.

The generated speech content is output by vocal sound from the speaker mounted on the smart glasses 720 to the user 10, for example. In this case, a synthesized vocal sound corresponding to the character of the agent is used as the vocal sound. The action control unit 250 generates a synthesized vocal sound by reproducing the vocal sound quality of the agent's character (for example, Audrey Hepburn) or generates a synthesized vocal sound according to the emotion of the character (for example, in the case of an emotion of “angry”, vocal sound in which tone is enhanced). The speech content may be displayed on the display instead of the vocal sound output or together with the vocal sound output.

The RPA 274 executes an operation according to the command (for example, an agent command acquired from vocal sound output by the user 10 through interaction with the user 10 or text). The RPA 274 performs actions related to use of the service provider, such as information search, store reservation, ticket arrangement, purchase of products/services, payment, route guidance, and translation.

As another example, the RPA 274 executes an operation of transmitting content input by vocal sound of the user 10 (for example, a child) through interaction with the agent to the other party (for example, the parent). Examples of transmission means include message application software, chat application software, and mail application software.

In a case in which the operation has been executed by the RPA 274, for example, vocal sound indicating that the execution of the operation is finished is output from the speaker mounted on the smart glasses 720. For example, vocal sound such as “Reservation of the store has been completed” is output to the user 10. For example, in a case in which the reservation of the store is full, vocal sound such as “Reservation could not be made. What would you like to do?” is output to the user 10.

As described above, in the smart glasses 720, various services are provided to the user 10 by using the agent system 700. Since the smart glasses 720 are worn by the user 10, the agent system 700 can be used in various scenes such as at home, at work, and at a place outside the house.

Since the smart glasses 720 are worn by the user 10, the smart glasses are suitable for collecting a so-called life log of the user 10. Specifically, an emotion value of the user 10 is estimated on the basis of detection results in various sensors or the like mounted on the smart glasses 720 or recording results in the 2D camera 203 or the like. Therefore, the emotion value of the user 10 can be collected in various scenes, and the agent system 700 can provide a service or speech content suitable for the emotion of the user 10.

In the smart glasses 720, the surrounding situation of the user 10 can be obtained by the 2D camera 203, the microphone 201, and the like. The surrounding situation and the emotion value of the user 10 are associated with each other. As a result, it is possible to estimate what kind of emotion the user 10 has in what kind of situation. As a result, the accuracy in a case in which the agent system 700 ascertains the hobby/preference of the user 10 can be improved. In the agent system 700, the hobby/preference of the user 10 is accurately ascertained, so that the agent system 700 can provide a service or speech content suitable for the hobby/preference of the user 10.

The agent system 700 can also be applied to other wearable terminals (an electronic apparatus that can be worn on the body of the user 10, such as a pendant, a smart watch, an earring, a bracelet, or a hairband). In a case in which the agent system 700 is applied to a smart pendant, a speaker as the control target 252B outputs vocal sound indicating various types of information to the user 10. The speaker is, for example, a speaker capable of outputting vocal sound having directivity. The speaker is set to have directivity toward the ear of the user 10. As a result, the vocal sound is suppressed from reaching a person other than the user 10. The microphone 201 acquires vocal sound output by the user 10 or surrounding environmental sound of the smart pendant. The smart pendant is worn to be carried from the neck of the user 10. Thus, the smart pendant is located relatively close to the mouth of the user 10 while being worn. This facilitates acquisition of vocal sound output by user 10.

### (Supplementary Note 1)

An action control system including:
a state recognition unit that recognizes a user state including an action of a user and a state of an electronic apparatus;
an emotion determination unit that determines an emotion of the user or an emotion of the electronic apparatus; and
an action determination unit that determines an action of the electronic apparatus on the basis of at least one of the user state, the state of the electronic apparatus, the emotion of the user, or the emotion of the electronic apparatus, in which
in a case in which the action determination unit determines to answer to a question of the user as the action of the electronic apparatus, the action determination unit acquires a vector representing the question of the user,
searches a database storing a combination of a question and an answer for a question having a vector corresponding to the acquired vector, and generates an answer to the question of the user by using an answer to the question that has been searched for and a sentence generation model having an interaction function.

### (Supplementary Note 2)

The action control system according to Supplementary Note 1, in which the electronic apparatus is a robot.

### (Supplementary Note 3)

The action control system according to Supplementary Note 2, in which the robot is mounted on a stuffed toy or is connected to a control target device mounted on the stuffed toy in a wireless or wired manner.

### (Supplementary Note 4)

The action control system according to Supplementary Note 2, in which the robot is an agent for interacting with the user.

### Eleventh Embodiment

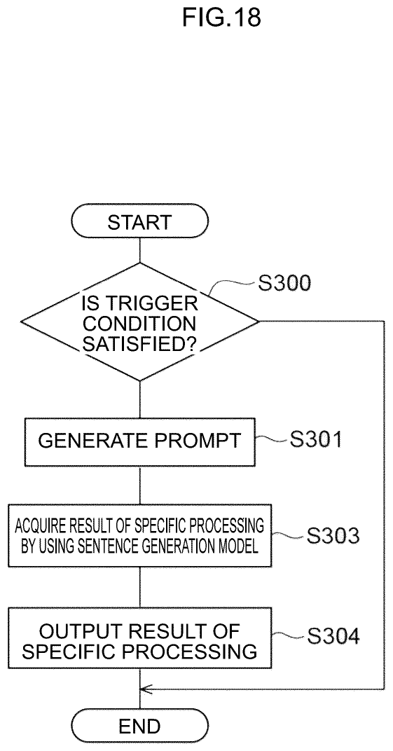

FIG. 18 schematically illustrates an example of an operation flow related to an operation in which the robot 100 performs specific processing of responding to an input from the user 10. The operation flow illustrated in FIG. 18 is repeatedly and automatically executed, for example, every lapse of a certain period of time.

In step S300, the processing unit 294 determines whether or not the user input satisfies a predefined trigger condition. For example, in a case in which the user input relates to exchange of an e-mail or the like, a schedule recorded in a schedule table, statements at a meeting, and requests a response from the robot 100, the trigger condition is satisfied. The expression or the like of the user 10 may be referred to for determination of whether or not the user input satisfies the predefined trigger condition. In a case in which the user 10 has performed vocal sound input, a tone (whether speaking calmly or panicking) or the like at the time of speech may be referred to.

The user input may be used for determination of whether or not the trigger condition is satisfied even if the user input is not only content directly related to the work of the user 10 but also content that seems not to be directly related to the work. For example, in a case in which the input data from the user 10 includes vocal sound data, it may be determined whether or not the input data includes substantial consultation content with reference to the tone at the time of speech.

In a case in which it is determined that the trigger condition is satisfied in step S300, the processing unit 294 proceeds to step S301. On the other hand, in a case in which it is determined that the trigger condition is not satisfied, the specific processing is ended.

In step S301, the processing unit 294 adds an instruction sentence for obtaining a result of the specific processing to the text representing the input to generate a prompt. For example, a prompt such as “Summarize the work performed by user 10 in one month, and list three points that will be appeal points in the next one-on-one meeting.” is generated.

In step S303, the processing unit 294 inputs the generated prompt to the sentence generation model. Appeal points recommended in the one-on-one meeting are acquired as a result of the specific processing on the basis of the output of the sentence generation model. The sentence generation model outputs, as the appeal points, “I act exactly on time.”, “The target achievement rate is high.”, “Work content is accurate.”, “A response to an e-mail or the like is fast.”, “The meeting is organized.”, and “I lead the project.”.

The input from the user 10 may be directly input to the sentence generation model without generating the above prompt. However, in order to make the output of the sentence generation model more effective, it is often preferable to generate a prompt.

In step S304, the processing unit 294 controls the action of the robot 100 such that the result of the specific processing is output. In the technology of the disclosure, the output content as a result of the specific processing includes, for example, three points that are obtained by summarizing the work performed by the user 10 in one month and serve as appeal points in the next one-on-one meeting.

The technology of the disclosure can be used without limitation by the user 10 participating in the meeting. For example, the user 10 may participate in a meeting between “colleagues” having an equal relationship, in addition to a subordinate in a relationship between a supervisor and a subordinate. The user 10 is not limited to a person belonging to a specific organization, and may be the user 10 who holds a meeting.

In the technology of the disclosure, the user 10 participating in a meeting can efficiently prepare for the meeting and hold the meeting. The user 10 can shorten the time for preparing for a meeting and the time for holding a meeting.

Although the functions of the agent system 500 have been mainly described above for the system according to the disclosure, the system according to the disclosure is not necessarily implemented in the agent system. The system according to the disclosure may be implemented as a general information processing system. The disclosure may be implemented as, for example, a software program that operates on a server or a personal computer, or an application that operates on a smartphone or the like. The method according to the disclosure may be provided to a user in a software as a service (SaaS) format.

A part of the agent system 500 (for example, the sensor module unit 210, the storage unit 220, and the control unit 228B) may be provided outside a communication terminal such as a smartphone possessed by the user (for example, the server), and the communication terminal may function as each unit of the agent system 500 by communicating with the outside.

The specific processing unit 290 performs specific processing similar to that of the fourth embodiment, and controls an action of the agent such that a result of the specific processing is output. In this case, speech content of the agent for interacting with the user 10 is determined as the action of the agent, and the speech content of the agent is output from the speaker or the display that is the control target 252B by using at least one of vocal sound or text.

A part of the agent system 700 (for example, the sensor module unit 210B, the storage unit 220, and the control unit 228B) may be provided outside the smart glasses 720 (for example, the server), and the smart glasses 720 may function as each unit of the agent system 700 by communicating with the outside.

### (Supplementary Note 1)

A control system including:
an input unit that receives a user input;
a processing unit that performs specific processing using a sentence generation model that generates a sentence corresponding to input data; and
an output unit that controls an action of an electronic apparatus such that a result of the specific processing is output, in which
the processing unit determines whether or not a condition for presentation content in a meeting held by a user is satisfied as a predefined trigger condition, and
in a case in which the trigger condition is satisfied, the processing unit acquires and outputs a response related to the presentation content in the meeting as a result of the specific processing by using an output of the sentence generation model when at least mail description matters, schedule table description matters, and remarks in the meeting obtained from the user input in a specific period are used as the input data.

### (Supplementary Note 2)

The control system according to Supplementary Note 1, in which the presentation content at the meeting includes a summary of at least one of the mail description matters, the schedule table description matters, or the remarks in the conference.

### (Supplementary Note 3)

The control system according to Supplementary Note 1, further including a state recognition unit that recognizes a user state including an action of the user, in which
the processing unit performs the specific processing using the user state and the sentence generation model.

### (Supplementary Note 4)

The control system according to Supplementary Note 1, further including an emotion determination unit that determines an emotion of the user, in which
the processing unit performs the specific processing using the emotion of the user and the sentence generation model.

### (Supplementary Note 5)

The control system according to Supplementary Note 1, in which the electronic apparatus is an information communication terminal or a wearable terminal.

### (Supplementary Note 6)

The control system according to Supplementary Note 5, in which the wearable terminal is an eyeglass-type terminal.

### (Supplementary Note 7)

The control system according to Supplementary Note 1, in which the electronic apparatus is a robot.

### (Supplementary Note 8)

The control system according to Supplementary Note 7, in which the robot is mounted on a stuffed toy or is connected to a control target device mounted on the stuffed toy in a wireless or wired manner.

### (Supplementary Note 9)

The control system according to Supplementary Note 7, in which the robot is an agent for interacting with the user.

### Twelfth Embodiment

In the specific processing in the present embodiment, for example, when the user 10 such as a producer or an announcer of a television station makes an inquiry about information regarding the earthquake, text (prompt) based on the inquiry is generated, and the generated text is input to the sentence generation model. The sentence generation model generates information regarding the earthquake about which the user 10 has inquired on the basis of the input text and various types of information such as information regarding past earthquakes in the designated area (including disaster information due to the earthquake), weather information in the designated area, and information regarding terrain in the designated area. The generated information regarding the earthquake is output by using vocal sound from a speaker mounted on the robot 100 to the user 10, for example. The sentence generation model can acquire various types of information from an external system by using, for example, ChatGPT Plug-in. Examples of the external system include a system that provides map information of various areas, a system that provides weather information of various areas, a system that provides information regarding terrain of various areas, and a system that provides information regarding past earthquakes of various areas. The area may be designated by using the name, the address, position information, and the like of the area. The map information includes information such as a road, a river, a sea, a mountain, a forest, and a residential area in the designated area. The weather information includes a wind direction, a wind speed, a temperature, a humidity, season, a precipitation probability, and the like in the designated area. The information regarding the terrain includes an inclination, undulations, and the like of the ground surface in the designated area.

The input unit 292 receives a user input. Specifically, the input unit 292 acquires character input and vocal sound input of the user 10. For example, a seismic intensity, a magnitude, a seismic source (a place name or latitude/longitude), and a depth of the seismic source are input as the information regarding the earthquake input by the user 10.

The processing unit 294 performs specific processing using the sentence generation model. Specifically, the processing unit 294 determines whether or not a predefined trigger condition is satisfied. More specifically, it is set as a trigger condition that the input unit 292 has received a user input (for example, “What measures should be taken in Area ABC against the previous earthquake?”) for inquiring about information regarding the earthquake.

In a case in which the trigger condition is satisfied, the processing unit 294 inputs text representing an instruction for obtaining data for specific processing to the sentence generation model, and acquires a processing result on the basis of the output of the sentence generation model. Specifically, the processing unit 294 acquires the result of the specific processing by using the output of the sentence generation model when the user 10 uses the text for giving an instruction for presentation of the information regarding the earthquake as an input sentence. More specifically, the processing unit 294 generates text in which the map information, the weather information, and the information regarding the terrain provided from the system described above are added to the user input acquired by the input unit 292, thereby generating text for giving an instruction for presentation of the information regarding the earthquake in the area designated by the user 10. The processing unit 294 inputs the generated text to the sentence generation model, and acquires information regarding the earthquake in the area designated by the user 10 on the basis of the output of the sentence generation model. The information regarding the earthquake in the area designated by the user 10 may be rephrased as information regarding the earthquake in the area about which the user 10 has inquired.

The information regarding the earthquake may include information regarding past earthquakes in the area designated by the user 10. Examples of the information regarding the past earthquake in the designated area include the latest seismic intensity in the designated area, the maximum depth in the designated area in the past year, and the number of earthquakes in the designated area in the past year. The information regarding past earthquakes in the designated area may include disaster information due to an earthquake in the designated area. Disaster information due to an earthquake in an area having similar terrain to that of the designated area may be included. Here, examples of the disaster information due to an earthquake include a sediment disaster (for example, a rock slide or a land slide) and a tsunami.

The processing unit 294 may perform specific processing using the user state or the state of the robot 100 and the sentence generation model. The processing unit 294 may perform specific processing using the emotion of the user or the emotion of the robot 100 and the sentence generation model.

The output unit 296 controls the action of the robot 100 such that the result of the specific processing is output. Specifically, the output unit 296 displays the information regarding the earthquake on a display device provided in the robot 100, causes the robot 100 to speak the information, or transmits a message indicating the information to the user of a message application of a mobile terminal of the user 10.

A part of the robot 100 (for example, the sensor module unit 210, the storage unit 220, and the control unit 228) may be provided outside the robot 100 (for example, the server), and the robot 100 may function as each unit of the robot 100 by communicating with the outside.

FIG. 18 schematically illustrates an example of an operation flow related to an operation in which the robot 100 performs specific processing of supporting announcement of information regarding the earthquake on the user 10.

In step S300, the processing unit 294 determines whether a predefined trigger condition is satisfied. For example, in a case in which the input unit 292 has received an input (for example, what measures should be taken in the Area ABC against the earthquake of the magnitude D, the seismic source EFG, and the depth H (km) of the seismic source?) of inquiring about information regarding the earthquake from the user 10, the processing unit 294 determines that the trigger condition is satisfied.

In a case in which the trigger condition is satisfied, the processing proceeds to step S301. On the other hand, in a case in which the trigger condition is not satisfied, the specific processing is ended.

In step S301, the processing unit 294 adds map information, weather information, and information regarding terrain in the designated area to the text representing the user input, and generates a prompt. For example, the processing unit 294 uses the user input “What measures should be taken in the Area ABC against the earthquake of the magnitude D, the seismic source EFG, and the depth H (km) of the seismic source?” to generate a prompt such as “the magnitude D, the seismic source EFG, the depth H (km) of the seismic source, the season is winter, and the seismic intensity in the designated area ABC is 4, the temperature I (° C.), it rained yesterday, it feels cold, there are many cliffs, and there are many areas at J (m) above the sea level. What earthquake countermeasures should local residents in this case?”.

In step S303, the processing unit 294 inputs the generated prompt to the sentence generation model, and acquires the result of the specific processing on the basis of the output of the sentence generation model. For example, the sentence generation model may acquire information (including disaster information) regarding past earthquakes in the area designated by the user 10 from the above-described external system on the basis of the input prompt, and generate the information regarding the earthquake on the basis of the acquired information.

For example, as an answer to the above prompt, the sentence generation model generates sentences such as “There was an earthquake in the area ABC. The seismic intensity 4, the seismic source EFG (longitude K (degree) or latitude L (degree)), and the depth H (km) of the seismic source. Since it rained yesterday, there is also a possibility of a rock collapse. Also in the earthquake one year ago, a rock collapse occurred along the national road, so the possibility of the rock collapse is quite high. The coastline of the area ABC has a low sea level, and there is a possibility that N (m) tsunami will reach the coastline in M minutes at the earliest. Also in the earthquake one year ago, a tsunami arrived, so the local residents should prepare for evacuation.”

In step S304, as described above, the output unit 296 controls the action of the robot 100 such that the result of the specific processing is output, and ends the specific processing. With such specific processing, an announcement suitable for the area can be made for the earthquake. A viewer of the earthquake early warning can easily take measures against the earthquake according to the announcement suitable for the area.

The result of notifying the viewer of the earthquake early warning of the information regarding the earthquake based on the sentence generation model using generative AI and the actual damage situation with respect to the notification result may be used as input information and reference information when new generative AI is used. When such information is used, the accuracy of the information at the time of issuing evacuation instructions to the local residents is improved.

A generation model is not limited to the sentence generation model that outputs (generates) a result based on a sentence, and a generation model that outputs (generates) a result based on input of information such as an image and vocal sound may be used. For example, the generation model may output results based on images of the seismic intensity, the seismic source, the depth of the seismic source, and the like displayed on the broadcast screen of the earthquake early warning, or may output results based on vocal sound of the seismic intensity, the seismic source, the depth of the seismic source, and the like from an announcer of the earthquake early warning.

### (Supplementary Note 1)

An information processing system including:
an input unit that receives a user input;
a processing unit that performs specific processing using a generation model that generates a result according to input data; and
an output unit that controls an action of an electronic apparatus such that a result of the specific processing is output, in which
the processing unit acquires the result of the specific processing by using an output of the generation model when text for giving an instruction for presentation of information regarding an earthquake is set as the input data.

### (Supplementary Note 2)

The information processing system according to Supplementary Note 1, in which the information regarding the earthquake includes information regarding past earthquakes in a designated area.

### (Supplementary Note 3)

The information processing system according to Supplementary Note 2, in which the information regarding the past earthquakes includes disaster information due to an earthquake.

### (Supplementary Note 4)

The information processing system according to Supplementary Note 1, in which the generation model generates an output in consideration of weather information in a designated area.

### (Supplementary Note 5)

The information processing system according to Supplementary Note 1, in which the generation model generates an output in consideration of information regarding terrain in a designated area.

### (Supplementary Note 6)

The information processing system according to Supplementary Note 1, further including a state recognition unit that recognizes a user state including an action of a user and a state of the electronic apparatus, in which
the processing unit performs the specific processing using the user state or the state of the electronic apparatus and the generation model.

### (Supplementary Note 7)

The information processing system according to Supplementary Note 1, further including an emotion determination unit that determines an emotion of a user or an emotion of the electronic apparatus; in which
the processing unit performs the specific processing using the emotion of the user or the emotion of the electronic apparatus and the generation model.

### (Supplementary Note 8)

The information processing system according to Supplementary Note 1, in which the electronic apparatus is an information communication terminal or a wearable terminal.

### (Supplementary Note 9)

The information processing system according to Supplementary Note 8, in which the wearable terminal is an eyeglass-type terminal.

### (Supplementary Note 10)

The information processing system according to Supplementary Note 1, in which the electronic apparatus is a robot.

### (Supplementary Note 11)

The information processing system according to Supplementary Note 10, in which the robot is mounted on a stuffed toy, or is connected to a control target device mounted on the stuffed toy in a wireless or wired manner.

### (Supplementary Note 12)

The information processing system according to Supplementary Note 10, in which the robot is an agent for interacting with a user.

### (Supplementary Note 1)

An action control system including: a state recognition unit that recognizes a user state including an action of a user and a state of a robot; an emotion determination unit that determines an emotion of the user or an emotion of the robot; and an action determination unit that determines, as an action of the robot, any of a plurality of types of robot actions including no action, by using at least one of the user state, the state of the robot, the emotion of the user, or the emotion of the robot, and an action determination model at a predetermined timing.

### (Supplementary Note 2)

The action control system according to Supplementary Note 1, in which the action determination model is a sentence generation model having an interaction function, and
the action determination unit inputs text representing at least one of the user state, the state of the robot, the emotion of the user, or the emotion of the robot and text for inquiry about a robot action to the sentence generation model, and determines an action of the robot on the basis of an output of the sentence generation model.

### (Supplementary Note 3)

The action control system according to Supplementary Note 1, further including a related information collection unit that collects information related to preference information from external data on the basis of the preference information acquired for the user at a predetermined timing, in which
the emotion determination unit determines an emotion of the robot on the basis of the collected information related to the preference information.

### (Supplementary Note 4)

The action control system according to any one of Supplementary Notes 1 to 3, in which the robot is mounted on a stuffed toy or is connected to a control target device mounted on the stuffed toy in a wireless or wired manner.

### (Supplementary Note 5)

The action control system according to any one of Supplementary Notes 1 to 3, in which the robot is an agent for interacting with the user.

### Thirteenth Embodiment

In autonomous processing in the present embodiment, device operations (robot actions in a case in which the electronic apparatus is the robot 100) determined by the action determination unit 236 include proposing an activity. In a case in which it is determined to propose an activity as an action of the electronic apparatus (an action of the robot), the action determination unit 236 determines an action of the user to be proposed on the basis of event data.

As described above, in a case in which it is determined that “(5) The robot proposes an activity.”, that is, the robot proposes an action of the user 10 as the robot action, the action determination unit 236 can determine an action of the user to be proposed by using the sentence generation model on the basis of the event data stored in the history data 2222. In this case, the action determination unit 236 may propose “play”, “learning”, “cooking”, “travel”, or “shopping” as the action of the user 10. As described above, the action determination unit 236 may determine the type of activity to be proposed. In a case in which “play” is proposed, the action determination unit 236 may also propose “Let's go on a picnic on the weekend.”. In a case in which “cooking” is proposed, the action determination unit 236 may also propose “Let's have curry rice for the dinner menu for this evening.”. In a case in which “shopping” is proposed, the action determination unit 236 may also propose “Let's go to a shopping mall.”. As described above, the action determination unit 236 may also determine details of the proposed activity such as “when”, “where”, and “what”. In determining the type and details of such an activity, the action determination unit 236 may learn the past experience of the user 10 by using the event data stored in the history data 2222. The action determination unit 236 may propose an action that the user 10 enjoyed in the past, may propose an action that the user 10 seems to like from the taste and preference of the user 10, or may propose a new action that the user 10 has not experienced ever.

Hereinafter, specific examples will be described.

For example, even when not talking with the user, the robot 100 searches for information regarding a topic or a hobby of interest of the user.

For example, even when not talking with the user, the robot 100 searches for information regarding a birthday or an anniversary of the user and considers a congratulatory message.

For example, even when not talking with the user, the robot 100 searches for a review of a place that the user wants to go to, food, or a product.

For example, even when not talking with the user, the robot 100 searches for weather information and provides advice suitable for the user's schedule or plan.

For example, even when not talking with the user, the robot 100 searches for information regarding local events and festivals and proposes the information to the user.

For example, even when not talking with the user, the robot 100 searches for a competition result or news of a sport in which the user is interested and provides a topic.

For example, even when not talking with the user, the robot 100 searches for and introduces information regarding the user's favorite music or artist.

For example, even when not talking with the user, the robot 100 searches for information regarding a social problem or news in which the user is interested and provides an opinion.

For example, even when not talking with the user, the robot 100 searches for information regarding the user's hometown or birthplace and provides a topic.

For example, even when not talking with the user, the robot 100 searches for information regarding the user's work or school and provides advice.

Even when not talking with the user, the robot 100 searches for and introduces information regarding books, comics, movies, and drama in which the user is interested.

For example, even when not talking with the user, the robot 100 searches for information regarding the health of the user and provides advice.

For example, even when not talking with the user, the robot 100 searches for information regarding travel planning of the user and provides advice.

For example, even when not talking with the user, the robot 100 searches for information regarding repair or maintenance of the user's house or car and provides advice.

For example, even when not talking with the user, the robot 100 searches for information regarding beauty and fashion in which the user is interested and provides advice.

For example, even when not talking with the user, the robot 100 searches for information regarding a pet of the user and provides advice.

For example, even when not talking with the user, the robot 100 searches for and proposes information regarding contests and events related to the user's hobby or work.

For example, even when not talking with the user, the robot 100 searches for and proposes information regarding the user's favorite eating place or restaurant.

For example, even when not talking with the user, the robot 100 collects information regarding important decisions related to the user's life and provides advice.

For example, even when not talking with the user, the robot 100 searches for information regarding a person the user is worried about and provides advice.

### (Supplementary Note 1)

An action control system including:
a state recognition unit that recognizes a user state including an action of a user and a state of an electronic apparatus;
an emotion determination unit that determines an emotion of the user or an emotion of the electronic apparatus;
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus; and
a storage control unit that stores, in history data, event data including an emotion value determined by the emotion determination unit and data including the action of the user,
the device operations include proposing an activity, and
in a case in which it is determined to propose an activity as the action of the electronic apparatus, the action determination unit determines an action of the user to be proposed on the basis of the event data.

### (Supplementary Note 2)

The action control system according to Supplementary Note 1, in which the electronic apparatus is a robot, and
the action determination unit determines any of a plurality of types of robot actions including no action as an action of the robot.

### (Supplementary Note 3)

The action control system according to Supplementary Note 2, in which the action determination model is a sentence generation model having an interaction function, and
the action determination unit inputs text representing at least one of the user state, the state of the robot, the emotion of the user, or the emotion of the robot and text for inquiry about the robot actions to the sentence generation model, and determines an action of the robot on the basis of an output of the sentence generation model.

### (Supplementary Note 4)

The action control system according to Supplementary Note 2 or 3, in which the robot is mounted on a stuffed toy or is connected to a control target device mounted on the stuffed toy in a wireless or wired manner.

### (Supplementary Note 5)

The action control system according to Supplementary Note 2 or 3, in which the robot is an agent for interacting with the user.

### Fourteenth Embodiment

In autonomous processing in the present embodiment, device operations (robot actions in a case in which the electronic apparatus is the robot 100) determined by the action determination unit 236 include prompting an exchange with another person. In a case in which it is determined to prompt an exchange with another person as an action of the electronic apparatus (an action of the robot), the action determination unit 236 determines at least one of an exchange partner or an exchange method on the basis of the event data.

The action determination unit 236 uses at least one of the state of the user 10, the emotion of the user 10, the emotion of the robot 100, or the state of the robot 100 and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about a robot action to the sentence generation model, and determines the action of the robot 100 on the basis of the output of the sentence generation model.

For example, the plurality of types of robot actions include the following (1) to (11).
(1) The robot does nothing.
(2) The robot has a dream.
(3) The robot speaks to the user.
(4) The robot creates a picture diary.
(5) The robot proposes an activity.
(6) The robot proposes a person with whom the user should meet.
(7) The robot introduces news in which the user is interested.
(8) The robot edits pictures and moving images.
(9) The robot studies with the user.
(10) The robot evokes memory.
(11) The robot promotes an exchange with another person.

In a case in which it is determined, as the robot action, that “(11) The robot promotes an exchange with another person.”, that is, the robot 100 proposes an exchange with another person to the user 10, the action determination unit 236 determines at least one of an exchange partner or an exchange method on the basis of the event data stored in the history data 2222. For example, in a case in which the state of the user 10 satisfies a condition of “one person, lonely”, the action determination unit 236 determines that “(11) The robot promotes an exchange with another person.” as the robot action. The state in which the user 10 looks lonely may be recognized on the basis of information analyzed by the sensor module unit 210 or may be recognized on the basis of schedule information such as a calendar. In such a case, the action determination unit 236 learns the past conversation and experience of the user 10 by using the event data stored in the history data 2222, and determines at least one, preferably both, of the exchange partner and the exchange method. As an example, in a case in which “Grandpa” is determined as the exchange partner and “telephone” is determined as the exchange method, the action determination unit 236 may determine speech content such as “Why don't you call Grandpa? The telephone number is OOO.”. In response to this, the action control unit 250 may cause a speaker included in the control target 252 to output vocal sound representing the determined speech content of the robot. In a case in which “A” is determined as the exchange partner and “going to play at home” is determined as the exchange method, the action determination unit 236 may determine speech content such as “Why don't you go to play at home of your friend A? I will show you how to get to the house of A.”. In response to this, the action control unit 250 may cause a speaker included in the control target 252 to output vocal sound representing the determined speech content of the robot, and may cause a display device included in the control target 252 to display a map from the user 10 to the house of A. In a case in which the user 10 is absent around the robot 100, the action control unit 250 may store the determined speech content of the robot 100 and the map in the action schedule data 224 without outputting the vocal sound representing the determined speech content of the robot 100 and the map. As described above, the electronic apparatus (for example, a robot) which is an inorganic substance can contribute to happiness of people by expressing its ego that wants the family to be happy and spontaneously performing various actions.

### (Supplementary Note 1)

An action control system including:
a state recognition unit that recognizes a user state including an action of a user and a state of an electronic apparatus;
an emotion determination unit that determines an emotion of the user or an emotion of the electronic apparatus;
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus; and
a storage control unit that stores, in history data, event data including an emotion value determined by the emotion determination unit and data including the action of the user, in which
the device operations include prompting an exchange with another person, and
in a case in which it is determined to prompt an exchange with another person as the action of the electronic apparatus, the action determination unit determines at least one of an exchange partner or an exchange method on the basis of the event data.

### (Supplementary Note 2)

The action control system according to Supplementary Note 1, in which the electronic apparatus is a robot, and
the action determination unit determines any of a plurality of types of robot actions including no action as an action of the robot.

### (Supplementary Note 3)

The action control system according to Supplementary Note 2, in which the action determination model is a sentence generation model having an interaction function, and
the action determination unit inputs text representing at least one of the user state, the state of the robot, the emotion of the user, or the emotion of the robot and text for inquiry about the robot actions to the sentence generation model, and determines an action of the robot on the basis of an output of the sentence generation model.

### (Supplementary Note 4)

The action control system according to Supplementary Note 2 or 3, in which the robot is mounted on a stuffed toy or is connected to a control target device mounted on the stuffed toy in a wireless or wired manner.

### (Supplementary Note 5)

The action control system according to Supplementary Note 2 or 3, in which the robot is an agent for interacting with the user.

### Fifteenth Embodiment

Autonomous processing in the present embodiment includes processing in which the robot 100 spontaneously or periodically analyzes a state of a user or a state of a competitor of an opponent team participating in a specific competition, particularly an emotion of the competitor at any timing, and gives advice about the specific competition to the user on the basis of an analysis result. Here, the specific competition may be a sport performed by a team including a plurality of people, such as volleyball, soccer, or rugby. The user participating in the specific competition may be a competitor performing the specific competition or a support staff such as a manager or a coach of a specific team performing the specific competition.

The action determination unit 236 uses at least one of the state of the user 10, the emotion of the user 10, the emotion of the robot 100, or the state of the robot 100 and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about the robot actions to the sentence generation model, and determines the action of the robot 100 on the basis of the output of the sentence generation model.

For example, the plurality of types of robot actions include the following (1) to (11).
(1) The robot does nothing.
(2) The robot has a dream.
(3) The robot speaks to the user.
(4) The robot creates a picture diary.
(5) The robot proposes an activity.
(6) The robot proposes a person with whom the user should meet.
(7) The robot introduces news in which the user is interested.
(8) The robot edits pictures and moving images.
(9) The robot studies with the user.
(10) The robot evokes memory.
(11) The robot gives advice to the user participating in a specific competition.

In a case in which it is determined, as the robot action, that “(11) The robot gives advice to the user participating in a specific competition.”, that is, the robot gives advice about a specific competition to the user such as a competitor or a manager participating in the specific competition, the action determination unit 236 first detects emotions of a plurality of competitors participating in the competition in which the user is participating.

In order to detect the emotions of the plurality of competitors described above, the action determination unit 236 includes an image acquisition unit that captures an image of a competition space in which a specific competition in which the user participates is being performed. The image acquisition unit can be realized, for example, by using a part of the sensor unit 200 described above. Here, the competition space may include a space corresponding to each competition, for example, a volleyball court or a soccer ground. The competition space may include a peripheral region of the above-described court or the like. It is preferable that the installation position of the robot 100 is considered so that the competition space can be viewed by the image acquisition unit.

The action determination unit 236 further includes a competitor analysis unit capable of analyzing emotions of a plurality of competitors in the image acquired by the image acquisition unit described above. The competitor analysis unit can determine the emotions of the plurality of competitors, for example, by using a method similar to that of the emotion determination unit 232. Specifically, for example, information of a result of the sensor module unit 210 analyzing an image or the like acquired by the image acquisition unit may be input to a neural network trained in advance, and emotion values indicating emotions of a plurality of competitors may be specified to determine an emotion of each competitor. The data obtained by the image acquisition unit and the competitor analysis unit described above may be collected and stored as part of the collected data 2230 by the related information collection unit 270.

In a case in which it can be specified that an emotion of a competitor is unstable or irritated from the emotion value of the competitor playing a specific competition, for example, volleyball, it is possible to advance the competition in an advantageous manner by reflecting the specified result in the strategy of the team. Specifically, since a competitor having an unstable emotion or a competitor who is irritated tends to have a higher probability of making a mistake than a competitor having a stable emotion, for example, in volleyball, if the competitor having the unstable emotion or the competitor who is irritated has more opportunities to touch the ball, the possibility of making a mistake increases. Therefore, in the present embodiment, advice for advantageously advancing a competition, specifically, an emotion value of each competitor analyzed by the action determination unit 236 is transmitted to the user, for example, a manager of one team during the competition, and thus, advice to the user is performed.

In consideration of the above-described points, a competitor whose emotion is analyzed by the competitor analysis unit may be a competitor belonging to a specific team among a plurality of competitors in the competition space. More specifically, the specific team here may be a team different from the team to which the user belongs, that is, an opponent team. The robot 100 scans emotions of the competitors of the opponent team, specifies a competitor having the most unstable or irritated emotion, gives advice about the fact to the user, and can thus assist the user in creating effective strategy. As the strategy, for example, it may be assumed that a competition is advanced by focusing on a position of a competitor whose emotion is unstable or irritated (for example, in a case in which the competition content is volleyball, the ball distribution is concentrated toward the competitor whose emotion is unstable or irritated).

In a case in which such a robot 100 is used during a game in the type of competition in which teams face each other, it can be expected that the game will be developed dominantly. Specifically, by specifying the most mentally unstable competitor during the competition and executing a strategy of thoroughly aiming at the competitor, the probability of winning the competition may increase.

The above-described advice given by the action determination unit 236 may be autonomously executed by the robot 100 instead of being started by an inquiry from the user. Specifically, for example, it is preferable to detect when a manager who is the user is in trouble, when the team to which the user belongs is about to lose, when a member of the team to which the user belongs is having a conversation that seems to want advice, and the like, and it is preferable for the robot 100 itself to make speech.

The agent system 500 executes the interaction processing according to, for example, following Steps 1 to 6.

(Step 1) The agent system 500 sets a character of the agent. Specifically, the character setting unit 276 sets the character of the agent used when the agent system 500 interacts with the user 10 on the basis of the designation from the user 10.

(Step 2) The agent system 500 acquires the state of the user 10 including the vocal sound or the text input from the user 10, the emotion value of the user 10, the emotion value of the agent, and the history data 2222. Specifically, the processing similar to steps S100 to S103 is performed to acquire the state of the user 10 including the vocal sound or the text input from the user 10, the emotion value of the user 10, the emotion value of the agent, and the history data 2222.

(Step 3) The agent system 500 determines speech content of the agent. Specifically, the action determination unit 236 inputs the text or the vocal sound input by the user 10, the emotions of both the user 10 and the character specified by the emotion determination unit 232, and the conversation history stored in the history data 2222 to the sentence generation model, and generates the speech content of the agent.

For example, a fixed sentence “In this case, how do you answer as an agent?” is added to the text or the vocal sound input by the user 10 and the text representing the emotions of both the user 10 and the character specified by the emotion determination unit 232 and the conversation history stored in the history data 2222, and is input to the sentence generation model to acquire the speech content of the agent.

As an example, in a case in which the text or the vocal sound input by the user 10 is “I need a reservation at 7 pm at a good Chinese restaurant nearby.”, “Understood.”, and “These are recommended restaurants. 1.AAAA. 2.BBBB. 3.CCCC. 4.DDDD” are acquired as the speech content of the agent.

In a case in which the text or the vocal sound input by the user 10 is “Fourth DDDD is good”, “Understood. I will make a reservation. How many seats do you need?” are acquired as the speech content of the agent.

(Step 4) The agent system 500 outputs the speech content of the agent. Specifically, the action control unit 250 synthesizes vocal sound corresponding to the character set by the character setting unit 276, and outputs the speech content of the agent by using the synthesized vocal sound.

(Step 5) The agent system 500 determines whether or not a timing to execute a command of the agent has arrived. Specifically, the action determination unit 236 determines whether or not the timing to execute the command of the agent has arrived on the basis of the output of the sentence generation model. For example, in a case in which the output of the sentence generation model includes that the agent executes the command, it is determined that the timing to execute the command of the agent has arrived, and the processing proceeds to Step 6. On the other hand, in a case in which it is determined that the timing to execute the command of the agent has not arrived, the processing returns to Step 2 described above.

(Step 6) The agent system 500 executes the command of the agent. Specifically, the command acquisition unit 272 acquires the command of the agent from the vocal sound output from the user 10 or the text through an interaction with the user 10. The RPA 274 performs an action corresponding to the command acquired by the command acquisition unit 272. For example, in a case in which the command is “information search”, information search is performed on a search site by using a search query obtained through an interaction with the user 10 and an application programming interface (API). The action determination unit 236 inputs a search result to the sentence generation model and generates speech content of the agent. The action control unit 250 synthesizes vocal sound corresponding to the character set by the character setting unit 276, and outputs the speech content of the agent by using the synthesized vocal sound.

In a case in which the command is “store reservation”, the reservation is made by making a phone call to the reservation destination store by using the reservation information obtained through the interaction with the user 10, the reservation destination store information, and the API according to phone software. In this case, the action determination unit 236 acquires the speech content of the agent with respect to the vocal sound input from the other party by using the sentence generation model having the interaction function. The action determination unit 236 inputs the result of the store reservation (whether or not the reservation has been made) to the sentence generation model, and generates the speech content of the agent. The action control unit 250 synthesizes vocal sound corresponding to the character set by the character setting unit 276, and outputs the speech content of the agent by using the synthesized vocal sound.

The processing returns to Step 2 described above.

In Step 6, the result of the action (for example, store reservation) executed by the agent is also stored in the history data 2222. The result of the action executed by the agent stored in the history data 2222 is used by the agent system 500 to ascertain a hobby or a preference of the user 10. For example, in a case in which the same store is reserved a plurality of times, it is recognized that the user 10 likes the store, or the reserved time zone, or the reservation content such as the content of the course or the fee is used as a criterion for selecting the store at the time of the next reservation.

As described above, the agent system 500 can execute interaction processing and perform an action related to use of the service provider as necessary.

FIGS. 14 and 15 are diagrams illustrating an example of the operation of the agent system 500. FIG. 14 illustrates an aspect in which the agent system 500 makes a restaurant reservation through an interaction with the user 10. In FIG. 14, the speech content of the agent is illustrated on the left side, and the speech content of the user 10 is illustrated on the right side. The agent system 500 can ascertain a preference of the user 10 on the basis of an interaction history with the user 10, provide a recommendation list of restaurants that match the preference of the user 10, and make a reservation of a selected restaurant.

On the other hand, FIG. 15 illustrates an aspect in which the agent system 500 accesses a mail order site through an interaction with the user 10 to purchase a product. In FIG. 15, the speech content of the agent is illustrated on the left side, and the speech content of the user 10 is illustrated on the right side. The agent system 500 can estimate a remaining amount of the beverage stocked by the user on the basis of the interaction history with the user 10, and can propose purchase of the beverage to the user 10 and execute the purchase. The agent system 500 can ascertain the preference of the user on the basis of the past interaction history with the user 10, and recommend a snack that the user likes. As described above, the agent system 500 supports the daily life of the user 10 by performing various actions such as restaurant reservation or product purchase/settlement while communicating with the user 10 as an agent such as a butler.

Other configurations and operations of the agent system 500 of the third embodiment are similar to those of the robot 100 of the first embodiment, and thus description thereof will be omitted.

### (Supplementary Note 1)

An action control system including:
a state recognition unit that recognizes a user state including an action of a user and a state of an electronic apparatus;
an emotion determination unit that determines an emotion of the user or an emotion of the electronic apparatus; and
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, in which
the device operations include giving advice about a specific competition to the user participating in the specific competition,
the action determination unit includes
an image acquisition unit capable of imaging a competition space in which the specific competition in which the user participates is performed, and
a competitor analysis unit that analyzes emotions of a plurality of competitors who are playing the specific competition in the competition space imaged by the image acquisition unit, and
in a case in which it is determined to give advice about the specific competition to the user who participates in the specific competition as an action of the electronic apparatus, the action determination unit gives the advice to the user on the basis of an analysis result from the competitor analysis unit.

### (Supplementary Note 2)

The action control system according to Supplementary Note 1, in which the electronic apparatus is a robot, and
the action determination unit determines any of a plurality of types of robot actions including no action as an action of the robot.

### (Supplementary Note 3)

The action control system according to Supplementary Note 2, in which the action determination model is a sentence generation model having an interaction function, and
the action determination unit inputs text representing at least one of the user state, the state of the robot, the emotion of the user, or the emotion of the robot and text for inquiry about the robot actions to the sentence generation model, and determines an action of the robot on the basis of an output of the sentence generation model.

### (Supplementary Note 4)

The action control system according to Supplementary Note 2 or 3, in which the robot is mounted on a stuffed toy or is connected to a control target device mounted on the stuffed toy in a wireless or wired manner.

### (Supplementary Note 5)

The action control system according to Supplementary Note 2 or 3, in which the robot is an agent for interacting with the user.

### Sixteenth Embodiment

Autonomous processing in the present embodiment includes processing in which the robot 100 spontaneously or periodically specifies a state of a user or a state of a competitor of an opponent team participating in a specific competition, particularly features of the competitor at any timing, and gives advice about the specific competition to the user on the basis of the specified result. Here, the specific competition may be a sport performed by a team including a plurality of people, such as volleyball, soccer, or rugby. The user participating in the specific competition may be a competitor performing the specific competition or a support staff such as a manager or a coach of a specific team performing the specific competition. The features of the competitor indicate information related to the ability related to the competition and the current or recent condition of the competitor, such as the habit, movement, the number of mistakes, movement that is not good, and a reaction speed of the competitor.

The action determination unit 236 uses at least one of the state of the user 10, the emotion of the user 10, the emotion of the robot 100, or the state of the robot 100 and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about the robot actions to the sentence generation model, and determines the action of the robot 100 on the basis of the output of the sentence generation model.

For example, the plurality of types of robot actions includes the following (1) to (11).
(1) The robot does nothing.
(2) The robot has a dream.
(3) The robot speaks to the user.
(4) The robot creates a picture diary.
(5) The robot proposes an activity.
(6) The robot proposes a person with whom the user should meet.
(7) The robot introduces news in which the user is interested.
(8) The robot edits pictures and moving images.
(9) The robot studies with the user.
(10) The robot evokes memory.
(11) The robot gives advice to the user participating in a specific competition.

The action determination unit 236 inputs, to the sentence generation model, text representing the state of the user 10 and the state of the robot 100 recognized by the state recognition unit 230, the current emotion value of the user 10 determined by the emotion determination unit 232, and the current emotion value of the robot 100, and text for inquiry about any of a plurality of types of robot actions including no action every lapse of a certain period of time, and determines the action of the robot 100 on the basis of the output of the sentence generation model. Here, in a case in which the user 10 is absent around the robot 100, the text to be input to the sentence generation model need not include the state of the user 10 and the current emotion value of the user 10, or may include the fact that the user 10 is absent.

As an example, text such as “The robot is in a very pleasant state. The user is in a normally pleasant state. The user is sleeping. Which one of the following (1) to (11) is better as an action of the robot?
(1) The robot does nothing.
(2) The robot has a dream.
(3) The robot speaks to the user.
. . . ” is input to the sentence generation model. On the basis of the output “It can be said that either (1) the robot does nothing or (2) the robot has a dream is the most appropriate action.” of the sentence generation model, “(1) the robot does nothing” or “(2) the robot has a dream” is determined as the action of the robot 100.

As another example, text such as “The robot is in a slightly lonely state. The user is absent. The surroundings of the robot are dark. Which one of the following (1) to (11) is better as the action of the robot? (1) The robot does nothing.
(2) The robot has a dream.
(3) The robot speaks to the user.
. . . ” is input to the sentence generation model. On the basis of the output “It can be said that either (2) the robot has a dream or (4) the robot creates a picture diary is the most appropriate action.” of the sentence generation model, “(2) The robot has a dream” or “(4) The robot creates a picture diary.” is determined as the action of the robot 100.

In a case in which the action determination unit 236 determines that “(2) The robot has a dream.”, that is, the creation of the original event is to be performed as the robot action, the action determination unit creates the original event obtained by combining a plurality of pieces of event data in the history data 2222 by using the sentence generation model. In this case, the storage control unit 238 stores the created original event in the history data 2222.

In a case in which it is determined that “(3) The robot talks to the user.”, that is, the robot 100 speaks, as the robot action, the action determination unit 236 determines speech content of the robot corresponding to the user state and the emotion of the user or the emotion of the robot by using the sentence generation model. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(7) The robot introduces news in which the user is interested.” as the robot action, the action determination unit 236 determines the speech content of the robot corresponding to the information stored in the collected data 2230 by using the sentence generation model. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(4) The robot creates a picture diary.”, that is, the robot 100 creates an event image, as the robot action, the action determination unit 236 generates an image representing event data for the event data selected from the history data 2222 by using the image generation model, generates an explanatory sentence representing the event data by using the sentence generation model, and outputs a combination of the image representing the event data and the explanatory sentence representing the event data as the event image. In a case in which the user 10 is absent around the robot 100, the action control unit 250 stores the event image in the action schedule data 224 without outputting the event image.

In a case in which it is determined that “(8) The robot edits pictures and moving images.”, that is, the robot edits an image, as the robot action, the action determination unit 236 selects event data from the history data 2222 on the basis of the emotion value, edits image data of the selected event data, and outputs the edited image data. In a case in which the user 10 is absent around the robot 100, the action control unit 250 stores the edited image data in the action schedule data 224 without outputting the edited image data.

In a case in which it is determined that “(5) The robot proposes an activity.”, that is, the robot proposes an action of the user 10, as the robot action, the action determination unit 236 determines the proposed action of the user by using the sentence generation model on the basis of the event data stored in the history data 2222. In this case, the action control unit 250 causes the speaker included in the control target 252 to output vocal sound that proposes the action of the user. In a case in which the user 10 is absent around the robot 100, the action control unit 250 stores proposal of the action of the user in the action schedule data 224 without outputting vocal sound that proposes the action of the user.

In a case in which it is determined that “(6) The robot proposes a person with whom the user should meet.”, that is, the robot proposes a partner who should have a contact with the user 10, as the robot action, the action determination unit 236 determines a proposed partner who should have a contact with the user by using the sentence generation model on the basis of the event data stored in the history data 2222. In this case, the action control unit 250 causes the speaker included in the control target 252 to output vocal sound representing proposal of a partner who should have a contact with the user. In a case in which the user 10 is absent around the robot 100, the action control unit 250 stores proposal of a partner who should have a contact with the user in the action schedule data 224 without outputting vocal sound representing proposal of a partner who should have a contact with the user.

In a case in which it is determined that “(9) The robot studies with the user.”, that is, the robot 100 makes speech related to study, as the robot action, the action determination unit 236 uses the sentence generation model to determine speech content of the robot for urging the user to study, giving a study problem, or giving advice related to study, which corresponds to the user state and the emotion of the user or the emotion of the robot. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(10) The robot evokes memory.”, that is, the robot causes event data to be remembered, as the robot action, the action determination unit 236 selects the event data from the history data 2222. In this case, the emotion determination unit 232 determines an emotion of the robot 100 on the basis of the selected event data. The action determination unit 236 creates an emotion change event representing speech content or an action of the robot 100 for changing the emotion value of the user by using the sentence generation model on the basis of the selected event data. In this case, the storage control unit 238 stores the emotion change event in the action schedule data 224.

For example, in a case in which it is stored in the history data 2222 that a moving image the user was watching was related to a panda as event data, and the event data is selected, a sentence such as “What is the word to say about the topic related to a panda when meeting with the user next time? There are three.” is input to the sentence generation model. In a case in which the output of the sentence generation model is “(1) Let's go to the zoo, (2) Let's draw a picture of a panda, and (3) Let's buy a stuffed toy of a panda.”, the robot 100 inputs a sentence such as “What makes the user most happy in (1), (2), and (3)?” to the sentence generation model, and in a case in which the output of the sentence generation model is “(1) Let's go to the zoo”, and a speech of the robot 100 that “(1) Let's go to the zoo” in a case in which the robot 100 meets the user next is created as the emotion change event and stored in the action schedule data 224.

For example, event data having a great emotion value of the robot 100 is selected as impressive memory of the robot 100. This makes it possible to create an emotion change event on the basis of the event data selected as impressive memory.

In a case in which it is determined, as the robot action, that “(11) The robot gives advice to the user participating in a specific competition.”, that is, the robot gives advice about a specific competition to the user such as a competitor or a manager participating in the specific competition, the action determination unit 236 first specifies features of a plurality of competitors participating in the competition in which the user is participating.

In order to specify the above features of the competitors, the action determination unit 236 includes an image acquisition unit that captures an image of a competition space in which a specific competition in which the user participates is being performed. The image acquisition unit can be realized, for example, by using a part of the sensor unit 200 described above. Here, the competition space may include a space corresponding to each competition, for example, a volleyball court or a soccer ground. The competition space may include a peripheral region of the above-described court or the like. It is preferable that the installation position of the robot 100 is considered so that the competition space can be viewed by the image acquisition unit.

The action determination unit 236 further includes a feature specifying unit capable of specifying features of the plurality of competitors in the image acquired by the image acquisition unit described above. The feature specifying unit can specify features of a plurality of competitors by analyzing past competition data, or collecting and analyzing information regarding each competitor from an SNS or the like, according to a method similar to the method of determining an emotion value in the emotion determination unit 232, or combining one or more of these methods. The data obtained by the image acquisition unit and feature specifying unit may be collected and stored as a part of the collected data 2230 by the related information collection unit 270. In particular, the information such as the past competition data of the competitor described above may be collected by the related information collection unit 270.

In a case in which a feature of a competitor playing a specific competition, e.g. volleyball, can be specified, the game can be advantageously advanced by reflecting that specified result in the team's strategy. Specifically, a competitor making a large number of mistakes or a competitor having a specific habit may be a weak point of the team. Therefore, in the present embodiment, advice for advantageously advancing the competition, specifically, the feature of each competitor specified by the action determination unit 236 is provided to the user, for example, the manager of one team during the competition, and thus, advice is given to the user.

In consideration of the above points, a competitor whose feature is specified by the feature specifying unit may be a competitor belonging to a specific team among a plurality of competitors in the competition space. More specifically, the specific team may be a team different from the team to which the user belongs, in other words, an opponent team. The robot 100 scans a feature of each competitor of the opponent team, specifies a competitor having a specific habit or a competitor who frequently makes mistakes, provides the user with information regarding the feature of the competitor as advice, and can thus assist the user in creating effective strategy.

In a case in which the user uses the advice provided from the robot 100 during a game in the type of competition in which teams face each other, it can be expected that the game will be developed dominantly. Specifically, for example, a competitor or the like making many mistakes is specified during the competition on the basis of the advice from the robot 100, and a strategy of intensively attacking the position of the competitor is adopted, so that the probability of winning the game may increase.

### (Supplementary Note 1)

An action control system including:
a state recognition unit that recognizes a user state including an action of a user and a state of an electronic apparatus;
an emotion determination unit that determines an emotion of the user or an emotion of the electronic apparatus; and
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, in which
the device operations include giving advice about a specific competition to the user participating in the specific competition,
the action determination unit includes
an image acquisition unit capable of imaging a competition space in which the specific competition in which the user participates is performed, and
a feature specifying unit that specifies features of a plurality of competitors performing a competition in the competition space imaged by the image acquisition unit, and
in a case in which it is determined to provide advice about the specific competition to the user participating in the specific competition as an action of the electronic apparatus, the advice is given to the user on the basis of a specified result from the feature specifying unit.

### (Supplementary Note 2)

The action control system according to Supplementary Note 1, in which the electronic apparatus is a robot, and
the action determination unit determines any of a plurality of types of robot actions including no action as an action of the robot.

### (Supplementary Note 3)

The action control system according to Supplementary Note 2, in which the action determination model is a sentence generation model having an interaction function, and
the action determination unit inputs text representing at least one of the user state, the state of the robot, the emotion of the user, or the emotion of the robot and text for inquiry about the robot actions to the sentence generation model, and determines an action of the robot on the basis of an output of the sentence generation model.

### (Supplementary Note 4)

The action control system according to Supplementary Note 2 or 3, in which the robot is mounted on a stuffed toy or is connected to a control target device mounted on the stuffed toy in a wireless or wired manner.

### (Supplementary Note 5)

The action control system according to Supplementary Note 2 or 3, in which the robot is an agent for interacting with the user.

### Seventeenth Embodiment

In autonomous processing in the present embodiment, the agent may detect a state or an action of a user spontaneously or periodically by monitoring the user. The agent may be interpreted as an agent system that will be described later. Hereinafter, the agent system may be simply referred to as an agent. It may be interpreted that the agent or the robot 100 spontaneously acquires a state or an action of the user on its own initiative without any trigger from the outside. The trigger from the outside may include a question from the user to the robot 100, an active action from the user to the robot 100, and the like. The term “periodic” may be interpreted as a specific cycle such as a unit of one second, a unit of one minute, a unit of one hour, a unit of several hours, a unit of several days, a unit of week, or a unit of day of the week. The state of the user may include an action tendency of the user. The action tendency may be interpreted as an action tendency of a hyperactive or impulsive user, such as the user frequently running up stairs, the user frequently climbing or attempting to climb on top of a dresser, or the user frequently climbing on the edge of the window to open the window. The action tendency may be interpreted as a tendency of action with hyperactivity or impulsiveness, such as the user frequently walking on a wall or attempts to climb on a wall, or the user frequently walking on a roadway or entering a roadway from a sidewalk.

In the autonomous processing, the agent may ask GPT a question about the detected state or action of the user, and store an answer of the GPT to the question and the detected action of the user in association with each other. In this case, the agent may store action content for correcting the action in association with the answer.

Information in which the answer of GPT to the question, the detected action of the user, and the action content for correcting the action are associated with each other may be recorded as table information in a storage medium such as a memory. The table information may be interpreted as specific information recorded in the storage unit.

In the autonomous processing, an action schedule of the robot 100 for calling attention to the state or action of the user may be set on the basis of the detected action of the user and the stored specific information.

As described above, the agent can record table information in which the answer of GPT corresponding to the state or action of the user is associated with the detected state or action of the user in the storage medium. Hereinafter, an example of content stored in the table will be described.

(1. A Case in which the User Tends to Frequently Run on Stairs)

In a case in which there is the tendency, the agent itself asks GPT a question such as “What other things the child who takes such an action is likely to do?”. In a case in which an answer of GPT to this question is, for example, “There is a possibility that the user may trip on the stairs”, the agent may store the action of the user of running up the stairs and the answer of GPT in association with each other. The agent may store action content for correcting the action in association with the answer.

The action content for correcting the action may include at least one of execution of a gesture for correcting the dangerous action of the user and reproduction of vocal sound for correcting the dangerous action.

The gesture for correcting the dangerous action may include a gesture and a hand gesture of guiding the user to a specific place, a gesture and a hand gesture of stopping the user at the place, and the like. The specific place may include a place other than the place where the user is currently located, for example, the vicinity of the robot 100, a space on the interior side of the window, or the like.

The vocal sound that corrects the dangerous action may include vocal sound such as “Stop” or “oo, dangerous, don't move”. The vocal sound for correcting the dangerous action may include vocal sound such as “Do not run” or “Stay still”.

(2. A Case in which the User Tends to Frequently Climb or Attempt to Climb on the Top of a Dresser)

In a case in which there is the tendency, the agent asks GPT a question in the same manner as described above. In a case in which an answer of GPT to the question is, for example, “There is a possibility that the user may fall from the dresser” or “There is a possibility that the user may be caught in the door of the dresser”, the agent may store the answer of GPT in association with the action of the user who climbs or attempts to climb on the top of the dresser. The agent may store action content for correcting the action in association with the answer.

(3. A Case in which the User Tends to Frequently Climb on the Edge of the Window to Open the Window)

In a case in which there is the tendency, the agent asks GPT a question in the same manner as described above. In a case in which an answer of GPT to the question is, for example, “There is a possibility that the user puts his/her face out of the window” or “There is a possibility that the user is caught in the window”, the agent may store the answer of GPT and the action of the user climbing on the edge of the window to open the window in association with each other. The agent may store action content for correcting the action in association with the answer.

(4. A Case in which the User Tends to Frequently Walk on the Wall or Attempt to Climb on the Wall)

In a case in which there is the tendency, the agent asks GPT a question in the same manner as described above. In a case in which an answer of GPT to the question is, for example, “There is a possibility that the user may fall from the wall” or “There is a possibility that the user may be injured by unevenness of the wall”, the agent may store the action of the user walking on the wall or attempting to climb on the wall in association with the answer of GPT. The agent may store action content for correcting the action in association with the answer.

(5. A Case in which the User Tends to Frequently Walk on a Roadway or Enter a Roadway from a Sidewalk)

In a case in which there is the tendency, the agent asks GPT a question in the same manner as described above. In a case in which an answer of GPT to the question is, for example, “There is a possibility of occurrence of a traffic accident” or “There is a possibility of causing a traffic jam”, the agent may store the action of the user who walks on a roadway or enters a roadway from a sidewalk in association with the answer of GPT. The agent may store action content for correcting the action in association with the answer.

As described above, in the autonomous processing, a table in which the answer of GPT corresponding to the state or the action of the user, the content of the state or the action, and the action content for correcting the state or the action are associated with each other may be recorded in a storage medium such as a memory.

In the autonomous processing, after the table is recorded, the action of the user is autonomously or periodically detected, and the action schedule of the robot 100 that attracts the attention of the user may be set on the basis of the detected action of the user and the content of the stored table. Specifically, the action determination unit 236 of the robot 100 may set the first action content for correcting the action of the user on the basis of the detected action of the user and the content of the stored table. Hereinafter, an example of the first action content will be described.

(1. A Case in which the User Tends to Frequently Run on Stairs)

In a case in which the action determination unit 236 detects the user who runs up the stairs, as the first action content for correcting the action, the action determination unit 236 can execute a gesture and a hand gesture for guiding the user to a place other than the stairs, a gesture and a hand gesture for stopping the user at the place, and the like.

The action determination unit 236 may reproduce, as the first action content for correcting the action, vocal sound for guiding the user to a place other than the stairs, vocal sound for stopping the user at the place, or the like. The vocal sound may include vocal sound such as “oo, dangerous, do not run”, “Don't move”, “Don't run”, or “Stay still”.

(2. A Case in which the User Tends to Frequently Climb or Attempt to Climb on the Top of a Dresser)

The action determination unit 236 can execute a gesture and a hand gesture for stopping the user on the dresser or about to climb on the dresser, or a gesture and a hand gesture for moving the user to a place other than the place where the user is currently located.

(3. A Case in which the User Tends to Frequently Climb on the Edge of the Window to Open the Window)

The action determination unit 236 can execute a gesture and a hand gesture for stopping the user at the edge of the window or the user who is placing the hand on the window at the edge of the window, or a gesture and a hand gesture for moving the user to a place other than the place where the user is currently located.

(4. A Case in which the User Tends to Frequently Walk on the Wall or Attempt to Climb on the Wall)

The action determination unit 236 can execute a gesture and a hand gesture for stopping the user walking on the wall or about to climb on the wall at the place, or a gesture and a hand gesture for moving the user to a place other than the place where the user is currently located.

(5. A Case in which the User Tends to Frequently Walk on a Roadway or Enter a Roadway from a Sidewalk)

The action determination unit 236 can execute a gesture and a hand gesture for stopping the user walking on the roadway or entering the roadway from the sidewalk at the place, or a gesture and a hand gesture for moving the user to a place other than the place where the user is currently located.

The action determination unit 236 may determine whether or not the action of the user is corrected by detecting the action of the user after the robot 100 executes the gesture that is the first action content or reproduces the vocal sound that is the first action content, and may set the second action content different from the first action content in a case in which the action of the user is corrected.

The case in which the action of the user is corrected may be interpreted as a case in which the user has stopped dangerous actions and behaviors or a case in which the dangerous situation has been resolved as a result of execution of the operation of the robot 100 according to the first action content.

The second action content may include reproduction of at least one of vocal sound praising the user for the action or vocal sound expressing gratitude for the action of the user.

The vocal sound praising the user for the action may include vocal sound such as “Are you all right? You listened well”, “Good job, great”, and the like. The vocal sound expressing gratitude for the action of the user may include vocal sound such as “Thank you for coming.”

The action determination unit 236 may determine whether or not the action of the user is corrected by detecting the action of the user after the robot 100 executes the gesture that is the first action content or reproduces the vocal sound that is the first action content, and may set the third action content different from the first action content in a case in which the action of the user is not corrected.

The case in which the action of the user is not corrected may be interpreted as a case in which the user continues the dangerous action and behavior even though the operation of the robot 100 according to the first action content has been executed, or a case in which the dangerous situation has not been resolved.

The third action content may include at least one of transmission of the specific information to a person other than the user, execution of a gesture that attracts an interest of the user, reproduction of sound that attracts an interest of the user, or reproduction of a video that attracts an interest of the user.

The transmission of the specific information to a person other than the user may include distribution of an e-mail describing a warning message to a guardian, a nursery-school teacher, or the like of the user, distribution of an image (a still image or a moving image) including the user and the surrounding scenery, and the like. The transmission of the specific information to a person other than the user may include distribution of vocal sound of a warning message.

The gesture that attracts the interest of the user may include a gesture and a hand gesture of the robot 100. Specifically, the gesture may include that the robot 100 waves both arms vigorously, blinks the LED of the eye portion of the robot 100, and the like.

The reproduction of the sound that attracts the interest of the user may include reproduction of specific music that the user likes, and may also include reproduction of vocal sound such as “Come here” or “Play together”.

The reproduction of the video that attracts the interest of the user may include reproduction of an image of an animal kept by the user, reproduction of an image of parents of the user, and the like.

According to the robot 100 of the disclosure, it is possible to detect whether or not a child or the like is going to go out for a dangerous action (for example, climbing on the edge of the window to open the window) through the autonomous processing, and to autonomously execute an action of correcting the action of the user in the case of detecting the danger. As a result, the robot 100 can autonomously execute a gesture and speech regarding the content such as “Stop”, and “oo, dangerous, come here”. In a case in which the child stops the dangerous action by the speaking, the robot 100 may perform an operation of praising the child such as “Are you all right? You listened well.”.

In a case in which the child does not stop the dangerous action, the robot 100 can prompt the child to stop the dangerous action by sending a warning e-mail to the parent or the nursery-school teacher, sharing the situation by using the moving image, executing the motion in which the child is interested, playing the moving image in which the child is interested, or playing music in which the child is interested.

The action determination unit 236 uses at least one of the state of the user 10, the emotion of the user 10, the emotion of the robot 100, or the state of the robot 100 and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about the robot actions to the sentence generation model, and determines the action of the robot 100 on the basis of the output of the sentence generation model.

For example, the plurality of types of robot actions includes the following (1) to (26).
(1) The robot 100 does nothing.
(2) The robot 100 has a dream.
(3) The robot 100 speaks to the user.
(4) The robot 100 creates a picture diary.
(5) The robot 100 proposes an activity.
(6) The robot 100 proposes a person with whom the user should meet.
(7) The robot 100 introduces news in which the user is interested.
(8) The robot 100 edits pictures and moving images.
(9) The robot 100 studies with the user.
(10) The robot 100 evokes memory.
(11) As the first action content for correcting the action of the user, the robot 100 can execute a gesture and a hand gesture for guiding the user to a place other than the stairs.
(12) As the first action content for correcting the action of the user, the robot 100 can execute a gesture, a hand gesture, and the like for stopping the user at the place.
(13) As the first action content for correcting the action of the user, the robot 100 can reproduce vocal sound for guiding the user to a place other than the stairs.
(14) As the first action content for correcting the action of the user, the robot 100 can reproduce vocal sound or the like for stopping the user at the place.
(15) As the first action content for correcting the action of the user, the robot 100 can execute a gesture and a hand gesture for stopping the user on the dresser or about to climb up the dresser at the place, or a gesture and a hand gesture for moving the user to a place other than the place where the user is currently located.
(16) As the first action content for correcting the action of the user, the robot 100 can execute a gesture and a hand gesture for stopping the user at the edge of the window or placing the hand at the edge of the window at the place, or a gesture and a hand gesture for moving the user to a place other than the place where the user is currently located.
(17) As the first action content for correcting the action of the user, the robot 100 can execute a gesture and a hand gesture for stopping the user walking on the wall or about to climb on the wall at the place, or a gesture and a hand gesture for moving the user to a place other than the place where the user is currently located.
(18) As the first action content for correcting the action of the user, the robot 100 can execute a gesture and a hand gesture for stopping the user walking on the roadway or entering the roadway from the sidewalk at the place, or a gesture and a hand gesture for moving the user to a place other than the place where the user is currently located.
(19) In a case in which the action of the user is corrected, as the second action content different from the first action content, the robot 100 can execute at least one of reproduction vocal sound of praising the user for the action or vocal sound expressing gratitude for the action of the user.
(20) In a case in which the action of the user is not corrected, as the third action content different from the first action content, the robot 100 can execute transmission of specific information to a person other than the user.
(21) As the third action content, the robot 100 can execute a gesture that attracts the interest of the user.
(22) As the third action content, the robot 100 can execute at least one of reproduction of sound that attracts the interest of the user or reproduction of a video that attracts the interest of the user.
(23) As the transmission of the specific information to a person other than the user, the robot 100 can execute distribution of an e-mail including a warning message to a guardian, a nursery-school teacher, or the like of the user.
(24) As the transmission of the specific information to a person other than the user, the robot 100 can execute distribution of an image (a still image or a moving image) including the user and the surrounding scenery.
(25) As the transmission of the specific information to a person other than the user, the robot 100 can execute distribution of vocal sound of a warning message.
(26) As a gesture of attracting the interest of the user, the robot 100 can execute at least one of the robot 100 swinging both arms largely or blinking the LED of the eye portion of the robot 100.

The action determination unit 236 inputs, to the sentence generation model, text representing the state of the user 10 and the state of the robot 100 recognized by the state recognition unit 230, the current emotion value of the user 10 determined by the emotion determination unit 232, and the current emotion value of the robot 100, and text for inquiry about any of a plurality of types of robot actions including no action every lapse of a certain period of time, and determines the action of the robot 100 on the basis of the output of the sentence generation model. Here, in a case in which there is no user 10 around the robot 100, the text to be input to the sentence generation model need not include the state of the user 10 and the current emotion value of the user 10, or may include the fact that there is no user 10.

As an example, text such as “The robot is in a very pleasant state. The user is in a normally pleasant state. The user is sleeping. Which one of the following (1) to (26) is better as an action of the robot?
(1) The robot does nothing.
(2) The robot has a dream.
(3) The robot speaks to the user.
. . . ” is input to the sentence generation model. On the basis of the output “It can be said that either (1) the robot does nothing or (2) the robot has a dream is the most appropriate action.” of the sentence generation model, “(1) the robot does nothing” or “(2) the robot has a dream” is determined as the action of the robot 100.

As another example, text such as “The robot is in a slightly lonely state. The user is absent. The surroundings of the robot are dark. Which one of the following (1) to (26) is better as the action of the robot? (1) The robot does nothing.
(2) The robot has a dream.
(3) The robot speaks to the user.
. . . ” is input to the sentence generation model. On the basis of the output “It can be said that either (2) the robot has a dream or (4) the robot creates a picture diary is the most appropriate action.” of the sentence generation model, “(2) The robot has a dream” or “(4) The robot creates a picture diary.” is determined as the action of the robot 100.

In a case in which the action determination unit 236 determines that “(2) The robot has a dream.”, that is, the creation of the original event is to be performed as the robot action, the action determination unit creates the original event obtained by combining a plurality of pieces of event data in the history data 2222 by using the sentence generation model. In this case, the storage control unit 238 stores the created original event in the history data 2222.

In a case in which it is determined that “(3) The robot talks to the user.”, that is, the robot 100 speaks, as the robot action, the action determination unit 236 determines speech content of the robot corresponding to the user state and the emotion of the user or the emotion of the robot by using the sentence generation model. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(7) The robot introduces news in which the user is interested.” as the robot action, the action determination unit 236 determines the speech content of the robot corresponding to the information stored in the collected data 2230 by using the sentence generation model. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(4) The robot creates a picture diary.”, that is, the robot 100 creates an event image, as the robot action, the action determination unit 236 generates an image representing event data for the event data selected from the history data 2222 by using the image generation model, generates an explanatory sentence representing the event data by using the sentence generation model, and outputs a combination of the image representing the event data and the explanatory sentence representing the event data as the event image. In a case in which the user 10 is absent around the robot 100, the action control unit 250 stores the event image in the action schedule data 224 without outputting the event image.

In a case in which it is determined that “(8) The robot edits pictures and moving images.”, that is, the robot edits an image, as the robot action, the action determination unit 236 selects event data from the history data 2222 on the basis of the emotion value, edits image data of the selected event data, and outputs the edited image data. In a case in which the user 10 is absent around the robot 100, the action control unit 250 stores the edited image data in the action schedule data 224 without outputting the edited image data.

In a case in which it is determined that “(5) The robot proposes an activity.”, that is, the robot proposes an action of the user 10, as the robot action, the action determination unit 236 determines the proposed action of the user by using the sentence generation model on the basis of the event data stored in the history data 2222. In this case, the action control unit 250 causes the speaker included in the control target 252 to output vocal sound that proposes the action of the user. In a case in which the user 10 is absent around the robot 100, the action control unit 250 stores proposal of the action of the user in the action schedule data 224 without outputting vocal sound that proposes the action of the user.

In a case in which it is determined that “(6) The robot proposes a person with whom the user should meet.”, that is, the robot proposes a partner who should have a contact with the user 10, as the robot action, the action determination unit 236 determines a proposed partner who should have a contact with the user by using the sentence generation model on the basis of the event data stored in the history data 2222. In this case, the action control unit 250 causes the speaker included in the control target 252 to output vocal sound representing proposal of a partner who should have a contact with the user. In a case in which the user 10 is absent around the robot 100, the action control unit 250 stores proposal of a partner who should have a contact with the user in the action schedule data 224 without outputting vocal sound representing proposal of a partner who should have a contact with the user.

In a case in which it is determined that “(9) The robot studies with the user.”, that is, the robot 100 makes speech related to study, as the robot action, the action determination unit 236 uses the sentence generation model to determine speech content of the robot for urging the user to study, giving a study problem, or giving advice related to study, which corresponds to the user state and the emotion of the user or the emotion of the robot. In this case, the action control unit 250 causes the speaker included in the control target 252 to output vocal sound representing the determined speech content of the robot. In a case in which the user 10 is absent around the robot 100, the action control unit 250 stores the determined speech content of the robot in the action schedule data 224 without outputting vocal sound representing the determined speech content of the robot.

In a case in which it is determined that “(10) The robot evokes memory.”, that is, the robot causes event data to be remembered, as the robot action, the action determination unit 236 selects the event data from the history data 2222. In this case, the emotion determination unit 232 determines an emotion of the robot 100 on the basis of the selected event data. The action determination unit 236 creates an emotion change event representing speech content or an action of the robot 100 for changing the emotion value of the user by using the sentence generation model on the basis of the selected event data. In this case, the storage control unit 238 stores the emotion change event in the action schedule data 224.

For example, in a case in which it is stored in the history data 2222 that a moving image the user was watching was related to a panda as event data, and the event data is selected, a sentence such as “What is the word to say about the topic related to a panda when meeting with the user next time? There are three.” is input to the sentence generation model. In a case in which the output of the sentence generation model is “(1) Let's go to the zoo, (2) Let's draw a picture of a panda, and (3) Let's buy a stuffed toy of a panda.”, the robot 100 inputs a sentence such as “What makes the user most happy in (1), (2), and (3)?” to the sentence generation model, and in a case in which the output of the sentence generation model is “(1) Let's go to the zoo”, and a speech of the robot 100 that “(1) Let's go to the zoo” in a case in which the robot 100 meets the user next is created as the emotion change event and stored in the action schedule data 224.

For example, event data having a great emotion value of the robot 100 is selected as impressive memory of the robot 100. This makes it possible to create an emotion change event on the basis of the event data selected as impressive memory.

In a case in which the action determination unit 236 detects the action of the user spontaneously or periodically and determines to correct the action of the user as the action of the electronic apparatus that is the robot action on the basis of the detected action of the user and the specific information stored in advance, the action determination unit 236 may execute the following first action content.

The action determination unit 236 can execute, as the robot action, the first action content of “(11)” described above, in other words, a gesture and a hand gesture of guiding the user to a place other than the stairs.

The action determination unit 236 can execute, as the robot action, the first action content of “(12)” described above, in other words, a gesture and a hand gesture of stopping the user at the place.

The action determination unit 236 can reproduce, as the robot action, the first action content of “(13)” described above, in other words, vocal sound that guides the user to a place other than the stairs.

The action determination unit 236 can reproduce, as the robot action, the first action content of “(14)” described above, in other words, vocal sound for stopping the user at the place, or the like.

The action determination unit 236 can execute the first action content of “(15)” described above as the robot action. In other words, the action determination unit 236 can execute a gesture and a hand gesture for stopping the user on the dresser or about to climb on the dresser at the place, or a gesture and a hand gesture for moving the user to a place other than the place where the user is currently located.

The action determination unit 236 can execute the first action content of “(16)” described above as the robot action. In other words, the action determination unit 236 can execute a gesture and a hand gesture for stopping the user at the edge of the window or placing the hand on the window at the edge of the window at the place, or a gesture and a hand gesture for moving the user to a place other than the place where the user is currently located.

The action determination unit 236 can execute the first action content of “(17)” described above as the robot action. In other words, the action determination unit 236 can execute a gesture and a hand gesture for stopping the user walking on the wall or about to climb on the wall at the place, or a gesture and a hand gesture for moving the user to a place other than the place where the user is currently located.

The action determination unit 236 can execute the first action content of “(18)” described above as the robot action. That is, the action determination unit 236 can execute a gesture and a hand gesture for stopping the user walking on the roadway or entering the roadway from the sidewalk at the place, or a gesture and a hand gesture for moving the user to a place other than the place where the user is currently located.

In a case in which the action of the user is corrected, the action determination unit 236 can execute the second action content different from the first action content. Specifically, the action determination unit 236 can execute, as the robot action, reproduction of at least one of the second action content of “(19)” described above, in other words, vocal sound praising the user for the action or vocal sound expressing gratitude for the action of the user.

In a case in which the action of the user is not corrected, the action determination unit 236 can execute the third action content different from the first action content. Examples of the third action content will be described below.

The action determination unit 236 can execute, as the robot action, the third action content of “(20)” described above, in other words, transmission of the specific information to a person other than the user.

The action determination unit 236 can execute, as the robot action, the third action content of “(21)” described above, in other words, a gesture that attracts the interest of the user.

The action determination unit 236 can execute, as the robot action, the third action content of “(22)” described above, that is, at least one of reproduction of sound that attracts interest of the user or reproduction of a video that attracts interest of the user.

The action determination unit 236 can execute, as the robot action, the third action content of “(23)” described above, that is, distribution of an e-mail including a warning message to a guardian, a nursery-school teacher, or the like of the user as transmission of the specific information to a person other than the user.

The action determination unit 236 can execute, as the robot action, the third action content of “(24)” described above, that is, distribution of an image (a still image or a moving image) including the user and the surrounding scenery as the transmission of the specific information to a person other than the user.

The action determination unit 236 can execute, as the robot action, the third action content of “(25)” described above, that is, distribution of vocal sound of a warning message as transmission of the specific information to a person other than the user.

The action determination unit 236 can execute, as the robot action, the third action content of “(26)” described above, that is, at least one of the robot 100 swinging both arms largely or blinking the LED of the eye portion of the robot 100 as a gesture of attracting the interest of the user.

In a case in which vocal sound for guiding the user to a place other than the stairs is reproduced as the first action content indicated in “(13)” described above, the related information collection unit 270 may store vocal sound data for guiding the user to a place other than the stairs in the collected data 2230.

In a case in which vocal sound or the like for stopping the user at the place is reproduced as the first action content indicated in “(14)” described above, the related information collection unit 270 may store vocal sound data for stopping the user at the place in the collected data 2230.

In a case in which at least one of vocal sound praising the user for the action or vocal sound expressing gratitude for the action of the user is reproduced as the second action content indicated in “(19)” described above, the related information collection unit 270 may store these pieces of vocal sound data in the collected data 2230.

The storage control unit 238 may store the above table information in the history data 2222. Specifically, the storage control unit 238 may store, in the history data 2222, table information that is information in which an answer of GPT to a question, a detected action of the user, and action content for correcting the action are associated with each other.

### (Supplementary Note 1)

An action control system including:
a state recognition unit that recognizes a user state including an action of a user and a state of an electronic apparatus;
an emotion determination unit that determines an emotion of the user or an emotion of the electronic apparatus;
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus; and
a storage control unit that stores, in history data, event data including an emotion value determined by the emotion determination unit and data including the action of the user, in which
the device operations include setting first action content for correcting the action of the user, and
the action determination unit spontaneously or periodically detects an action of the user, and executes the first action content in a case in which it is determined to correct the action of the user as an action of the electronic apparatus on the basis of the detected action of the user and specific information stored in advance.

### (Supplementary Note 2)

The action control system according to Supplementary Note 1, in which the first action content includes at least one of execution of a gesture for correcting the action of the user or reproduction of vocal sound for correcting the action of the user.

### (Supplementary Note 3)

The action control system according to Supplementary Note 2, in which the action determination unit determines whether or not the action of the user is corrected by detecting the action of the user after the electronic apparatus executes the gesture or reproduces the vocal sound, and generates second action content different from the first action content in a case in which the action of the user is corrected.

### (Supplementary Note 4)

The action control system according to Supplementary Note 3, in which the second action content includes reproduction of at least one of vocal sound praising for the action of the user or vocal sound expressing gratitude for the action of the user.

### (Supplementary Note 5)

The action control system according to Supplementary Note 2, in which the action determination unit determines whether or not the action of the user is corrected by detecting the action of the user after the electronic apparatus executes the gesture or reproduces the vocal sound, and generates third action content different from the first action content in a case in which the action of the user is not corrected.

### (Supplementary Note 6)

The action control system according to Supplementary Note 5, in which the third action content includes at least one of transmission of specific information to a person other than the user, execution of a gesture that attracts an interest of the user, reproduction of sound that attracts the interest of the user, or reproduction of a video that attracts the interest of the user.

### (Supplementary Note 7)

The action control system according to Supplementary Note 1, in which the electronic apparatus is a robot, and
the action determination unit determines any of a plurality of types of robot actions including no action as an action of the robot.

### (Supplementary Note 8)

The action control system according to Supplementary Note 7, in which the action determination model is a sentence generation model having an interaction function, and
the action determination unit inputs text representing at least one of the user state, a state of the robot, the emotion of the user, or the emotion of the robot and text for inquiry about the robot actions to the sentence generation model, and determines an action of the robot on the basis of an output of the sentence generation model.

### (Supplementary Note 9)

The action control system according to Supplementary Note 7, in which the robot is mounted on a stuffed toy or is connected to a control target device mounted on the stuffed toy in a wireless or wired manner.

### (Supplementary Note 10)

The action control system according to Supplementary Note 7, in which the robot is an agent for interacting with the user.

### Eighteenth Embodiment

In autonomous processing in the present embodiment, the robot 100 cooperates with various devices (not only an air conditioner and a television, but also a weight scale, a refrigerator, and the like) of the house and spontaneously collects information regarding the user 10 at all times. The robot 100 spontaneously collects various types of information regarding home devices. For example, the robot 100 spontaneously collects information regarding when and at what kind of weather the air conditioner is turned on, and at what temperature the emotion value increases. The robot 100 spontaneously collects information regarding how frequently the refrigerator is used and what is frequently taken in and out. The robot 100 spontaneously collects information regarding a change in weight of the user 10 and a relationship between a television program and a change in the emotion value of the user 10. When the user 10 is nearby, the robot 100 informs the user of schedule management and news of interest, and proposes advice about physical condition, recommended dishes, ingredients to be replenished, and the like. The robot 100 may automatically place an order of ingredients to be replenished.

The action determination unit 236 uses at least one of the state of the user 10, the emotion of the user 10, the emotion of the robot 100, or the state of the robot 100, and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about the robot actions to the sentence generation model, and determines the action of the robot 100 on the basis of the output of the sentence generation model.

For example, the plurality of types of robot actions include the following (1) to (11).
(1) The robot does nothing.
(2) The robot has a dream.
(3) The robot speaks to the user.
(4) The robot creates a picture diary.
(5) The robot proposes an activity.
(6) The robot proposes a person with whom the user should meet.
(7) The robot introduces news in which the user is interested.
(8) The robot edits pictures and moving images.
(9) The robot studies with the user.
(10) The robot evokes memory.
(11) The robot gives the user advice about the home.

In a case in which it is determined, as the robot action, that “(11) The robot gives the user advice about the home.”, that is, that advice about the home is to be given, the action determination unit 236 spontaneously collects information regarding the user 10 in conjunction with devices such as an air conditioner, a television, a weight scale, and a refrigerator present in the home. Regarding the “(11) The robot gives the user advice about the home.”, the related information collection unit 270 collects news that the user is interested in at a predetermined time every day from external data by using, for example, ChatGPT Plugins. Regarding the “(11) The robot gives the user advice about the home.”, the storage control unit 238 stores information related to the collected advice in the collected data 2230.

### (Supplementary Note 1)

An action control system including:
a state recognition unit that recognizes a user state including an action of a user and a state of an electronic apparatus;
an emotion determination unit that determines an emotion of the user or an emotion of the electronic apparatus;
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus; and
a storage control unit that stores, in history data, event data including an emotion value determined by the emotion determination unit and data including the action of the user, in which
the device operations include giving the user advice about the home, and
in a case in which it is determined to give the user advice about the home, the action determination unit proposes, as the action of the electronic apparatus, advice about a physical condition, a recommended dish, and an ingredient to be replenished by using a sentence generation model on the basis of data regarding a home device stored in the history data.

### (Supplementary Note 2)

The action control system according to Supplementary Note 1, in which the electronic apparatus is a robot, and
the action determination unit determines any of a plurality of types of robot actions including no action as an action of the robot.

### (Supplementary Note 3)

The action control system according to Supplementary Note 2, in which the action determination model is a sentence generation model having an interaction function, and
the action determination unit inputs text representing at least one of the user state, a state of the robot, the emotion of the user, or an emotion of the robot and text for inquiry about the robot actions to the sentence generation model, and determines an action of the robot on the basis of an output of the sentence generation model.

### (Supplementary Note 4)

The action control system according to Supplementary Note 2 or 3, in which the robot is mounted on a stuffed toy or is connected to a control target device mounted on the stuffed toy in a wireless or wired manner.

### (Supplementary Note 5)

The action control system according to Supplementary Note 2 or 3, in which the robot is an agent for interacting with the user.

### Nineteenth Embodiment

In autonomous processing in the present embodiment, the robot 100 spontaneously and periodically (or constantly) detects a state of the user 10. Specifically, the robot 100 spontaneously and periodically (or constantly) detects an action of the user 10 (for example, a conversation or an action), and gives advice about a labor problem on the basis of the detected action of the user 10. For example, the robot 100 constantly monitors the situation of the workplace of the user 10 who is a worker, stores the action of the user 10 in the history data 2222, and spontaneously detects a labor problem such as power harassment, sexual harassment, or bullying that is difficult for the user to notice on the basis of the action of the user 10. The robot 100 spontaneously and periodically (or constantly) collects favorite information of the user 10 and stores the collected information in the collected data 2230. For example, the robot 100 spontaneously and periodically collects information regarding labor problems and stores the information in the collected data 2230. In a case in which the robot 100 detects the labor problem of the user 10 on the basis of the action of the user 10, the robot spontaneously proposes a coping method regarding the labor problem to the user 10 on the basis of the collected information and an inquiry to the sentence generation model having the interaction function. As a result, it is possible to provide support (for example, information regarding labor laws and appropriate procedures) that closely follows the emotion of the user 10.

The action determination unit 236 uses at least one of the state of the user 10, the emotion of the user 10, the emotion of the robot 100, or the state of the robot 100 and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about the robot actions to the sentence generation model, and determines the action of the robot 100 on the basis of the output of the sentence generation model.

For example, the plurality of types of robot actions includes the following (1) to (11).
(1) The robot does nothing.
(2) The robot has a dream.
(3) The robot speaks to the user.
(4) The robot creates a picture diary.
(5) The robot proposes an activity.
(6) The robot proposes a person with whom the user should meet.
(7) The robot introduces news in which the user is interested.
(8) The robot edits pictures and moving images.
(9) The robot studies with the user.
(10) The robot evokes memory.
(11) The robot gives advice about labor problems.

In a case in which it is determined, as the robot action, that “(11) The robot gives advice about labor problems to the user.”, that is, the advice about the labor problems is given to the user on the basis of the action of the user 10, the action determination unit 236 gives the advice about the labor problems to the user 10 on the basis of the action (a conversation or motion) of the user 10 recognized by the state recognition unit 230. In this case, for example, the action determination unit 236 inputs the action of the user 10 recognized by the state recognition unit 230 to a neural network trained in advance and evaluates the action of the user 10, thereby estimating (detecting) whether or not the user 10 has a labor problem such as power harassment, sexual harassment, or bullying which is difficult for the user 10 to notice. The action determination unit 236 may periodically detect (recognize) an action of the user 10 by using the state recognition unit 230 as the state of the user 10 and store the detected action in the history data 2222, and estimate whether or not the user 10 has a labor problem such as power harassment, sexual harassment, or bullying that is difficult for the user to notice on the basis of the action of the user 10 stored in the history data 2222. For example, the action determination unit 236 may estimate whether or not the user 10 has the labor problem by comparing the recent action of the user 10 stored in the history data 2222 with the past action of the user 10 stored in the history data 2222. Regarding “(11) The robot gives advice about labor problems to the user.”, the related information collection unit 270 periodically (or constantly) collects favorite information of the user from the external data, for example, by using ChatGPT Plugins. Here, the favorite information of the user is information regarding labor problems, and examples thereof include laws regarding labor, news regarding labor, and trends in the world regarding labor. The information regarding labor problems is collected more than information collected by lawyers who are familiar with labor problems. Regarding the “(11) The robot gives advice about labor problems to the user.”, the storage control unit 238 stores information related to the collected advice in the collected data 2230.

Hereinafter, specific examples will be described.

For example, even when not talking with the user, the robot 100 searches for information regarding a topic or a hobby of interest of the user.

For example, even when not talking with the user, the robot 100 searches for information regarding a birthday or an anniversary of the user and considers a congratulatory message.

For example, even when not talking with the user, the robot 100 searches for a review of a place that the user wants to go to, food, or a product.

For example, even when not talking with the user, the robot 100 searches for weather information and provides advice suitable for the user's schedule or plan.

For example, even when not talking with the user, the robot 100 searches for information regarding local events and festivals and proposes the information to the user.

For example, even when not talking with the user, the robot 100 searches for a competition result or news of a sport in which the user is interested and provides a topic.

For example, even when not talking with the user, the robot 100 searches for and introduces information regarding the user's favorite music or artist.

For example, even when not talking with the user, the robot 100 searches for information regarding a social problem or news in which the user is interested and provides an opinion.

For example, even when not talking with the user, the robot 100 searches for information regarding the user's hometown or birthplace and provides a topic.

For example, even when not talking with the user, the robot 100 searches for information regarding the user's work or school and provides advice.

Even when not talking with the user, the robot 100 searches for and introduces information regarding books, comics, movies, and drama in which the user is interested.

For example, even when not talking with the user, the robot 100 searches for information regarding the health of the user and provides advice.

For example, even when not talking with the user, the robot 100 searches for information regarding travel planning of the user and provides advice.

For example, even when not talking with the user, the robot 100 searches for information regarding repair or maintenance of the user's house or car and provides advice.

For example, even when not talking with the user, the robot 100 searches for information regarding beauty and fashion in which the user is interested and provides advice.

For example, even when not talking with the user, the robot 100 searches for information regarding a pet of the user and provides advice.

For example, even when not talking with the user, the robot 100 searches for and proposes information regarding contests and events related to the user's hobby or work.

For example, even when not talking with the user, the robot 100 searches for and proposes information regarding the user's favorite eating place or restaurant.

For example, even when not talking with the user, the robot 100 collects information regarding important decisions related to the user's life and provides advice.

For example, even when not talking with the user, the robot 100 searches for information regarding a person the user is worried about and provides advice.

### (Supplementary Note 1)

An action control system including:
a state recognition unit that recognizes a user state including an action of a user and a state of an electronic apparatus;
an emotion determination unit that determines an emotion of the user or an emotion of the electronic apparatus; and
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus, in which
the device operations include giving the user advice about a labor problem, and
in a case in which it is determined to give the user advice about a labor problem as the action of the electronic apparatus, the action determination unit gives the user the advice about the labor problem on the basis of the action of the user.

### (Supplementary Note 2)

The action control system according to Supplementary Note 1, further including a storage control unit that stores, in history data, event data including an emotion value determined by the emotion determination unit and data including the action of the user, in which
in a case in which it is determined to give the user advice about a labor problem as the action of the electronic apparatus, the action determination unit gives the user the advice about the labor problem on the basis of the action of the user recorded in the history data.

### (Supplementary Note 3)

The action control system according to Supplementary Note 1 or 2, in which the electronic apparatus is a robot, and
the action determination unit determines any of a plurality of types of robot actions including no action as an action of the robot.

### (Supplementary Note 4)

The action control system according to Supplementary Note 3, in which the action determination model is a sentence generation model having an interaction function, and
the action determination unit inputs text representing at least one of the user state, a state of the robot, the emotion of the user, or an emotion of the robot and text for inquiry about the robot actions to the sentence generation model, and determines an action of the robot on the basis of an output of the sentence generation model.

### (Supplementary Note 5)

The action control system according to Supplementary Note 3, in which the robot is mounted on a stuffed toy or is connected to a control target device mounted on the stuffed toy in a wireless or wired manner.

### (Supplementary Note 6)

The action control system according to Supplementary Note 3, in which the robot is an agent for interacting with the user.

### Twentieth Embodiment

In autonomous processing in the present embodiment, the agent may detect an action or a state of the user spontaneously or periodically by monitoring the user. Specifically, the agent may detect an action executed by the user in the home by monitoring the user. The agent may be interpreted as an agent system that will be described later. Hereinafter, the agent system may be simply referred to as an agent.

It may be interpreted that the agent or the robot 100 spontaneously acquires a state of the user on its own initiative without any trigger from the outside.

The trigger from the outside may include a question from the user to the robot 100, an active action from the user to the robot 100, and the like. The term “periodic” may be interpreted as a specific cycle such as a unit of one second, a unit of one minute, a unit of one hour, a unit of several hours, a unit of several days, a unit of week, or a unit of day of the week.

The actions performed by the user in the home may include housework, nail cutting, watering of plants, preparation for going out, walking of animals, and the like. Examples of the housework may include cleaning a toilet, preparing a meal, cleaning a bath, taking in laundry, cleaning a floor, child care, shopping, taking out garbage, and ventilating a room.

In the autonomous processing, the agent may store the detected type of action executed by the user in the home as specific information associated with a timing at which the action was executed. Specifically, user information of the user (person) included in a specific home, information indicating a type of action such as housework performed by the user in the home, and a past timing at which each of the actions was executed are stored in association with each other. The past timing may be the number of times the action was executed at least once.

In the autonomous processing, the agent may estimate an execution timing, which is a timing at which the user should execute an action, spontaneously or periodically on the basis of the stored specific information, and may give the user a proposal for prompting the user to take an action on the basis of the estimated execution timing.

Hereinafter, examples of proposal content to the user by the agent will be described.

(1) In a case in which a husband in the home has performed nail cutting, the agent monitors the action of the husband to record the past nail cutting operation and record the timing at which the nail cutting was executed (a time point at which the nail cutting was started, a time point at which the nail cutting was ended, and the like). The agent records the past nail cutting operation a plurality of times, thereby estimating the interval (for example, the number of days such as 10 days and 20 days) of the nail cutting of the husband for each person who has performed the nail cutting, on the basis of the timing at which the nail cutting was executed. As described above, the agent may estimate the execution timing of the next nail cutting by recording the execution timing of the nail cutting, and propose the execution timing to the user when the estimated number of days has elapsed from the time point at which the previous nail cutting was executed. Specifically, when 10 days has elapsed since the last nail cutting, the agent causes the electronic apparatus to reproduce vocal sound such as “Would you like to cut a nail now?” or “The nail may be elongated”, thereby proposing the user to cut a nail, which is an action the user can take. The agent may display these messages on the screen of the electronic apparatus instead of reproducing such vocal sound.

(2) In a case in which a wife in the home has performed watering of plants, the agent monitors the action of the wife to record the past watering operation and record a timing at which the watering was performed (a time point at which watering was started, a time point at which watering was finished, and the like). The agent records the past watering operation a plurality of times, thereby estimating a watering interval (for example, the number of days such as 10 days and 20 days) of the wife on the basis of the timing of executing the watering for each person who has performed watering. As described above, the agent may estimate the next watering execution timing by recording the watering execution timing, and propose the execution timing to the user when the estimated number of days has elapsed from the time point at which the previous watering was executed. Specifically, the agent proposes watering, which is an action the user can take, to the user by causing the electronic apparatus to reproduce vocal sound such as “Would you like to water now?” or “The water amount of the plants may be reduced.”. The agent may display these messages on the screen of the electronic apparatus instead of reproducing such vocal sound.

(3) In a case in which a child in the home has cleaned a toilet, the agent monitors the action of the child to record a past operation of cleaning the toilet and record a timing of executing toilet cleaning (a time point at which cleaning of the toilet was started, a time point at which cleaning of the toilet was finished, and the like). The agent records the past toilet cleaning operation a plurality of times, thereby estimating a toilet cleaning interval (for example, the number of days such as 7 days and 14 days) of the child for each person who has cleaned the toilet on the basis of the timing at which the toilet cleaning was executed. As described above, the agent may estimate the execution timing of the next toilet cleaning by recording the execution timing of the toilet cleaning, and proposes the toilet cleaning to the user when the estimated number of days has elapsed from the time point at which the previous toilet cleaning was executed. Specifically, the agent proposes toilet cleaning, which is an action the user can take, to the user by causing the robot 100 to reproduce vocal sound such as “Would you like to clean the toilet now?” or “The toilet cleaning time may be close.”. The agent may display these messages on the screen of the electronic apparatus instead of reproducing the vocal sound.

(4) In a case in which a child in the home has performed preparation for going out, the agent monitors the action of the child to record the action of the preparation in the past and record the timing of performing the preparation (a time point at which the preparation was started, a time point at which the preparation was finished, and the like). The agent records the past preparation operation a plurality of times to estimate the timing of performing the preparation of the child (for example, in the case of a weekday, near the time of going out to school, and in the case of a holiday, near the time of going out to take classes) for each person who has performed the preparation on the basis of the timing of executing the preparation. As described above, the agent may estimate the next preparation execution timing by recording the preparation execution timing, and propose the user to start the preparation at the estimated execution timing. Specifically, the agent causes the robot 100 to reproduce vocal sound such as “It is time to go to a cram school” or “Today is not a morning practice day?”, thereby proposing the user to start preparation that is an action the user can take. The agent may display these messages on the screen of the electronic apparatus instead of reproducing the vocal sound.

The agent may make a plurality of proposals to the user at specific intervals. Specifically, in a case in which the user does not take an action related to the proposal even though the agent has made the proposal to the user, the agent may make the proposal to the user once or a plurality of times. Even in a case in which the user delays the specific action for a while since the user cannot immediately execute the specific action, the user can execute the specific action without forgetting to execute the specific action.

The agent may notify the user of the specific action in advance a certain period of time before a time point at which the estimated number of days has elapsed. For example, in a case in which the next watering execution timing is a specific day after 20 days elapse from the time point at which the previous watering was executed, the agent may give a notification for prompting the next watering several days before the specific day. Specifically, the agent causes the robot 100 to reproduce vocal sound such as “The time for watering plants is approaching” or “I recommend watering plants soon”, so that the user can ascertain the timing of performing the watering.

As described above, according to the action control system of the disclosure, the electronic apparatus such as the robot 100 or the smartphone installed in the home stores all the actions of the family of the user of the electronic apparatus, and can spontaneously propose any action at an appropriate timing, such as at which timing it is better to cut the nail, it is better to water, it is better to clean the toilet, or it is better to start preparation.

The action determination unit 236 uses at least one of the state of the user 10, the emotion of the user 10, the emotion of the robot 100, or the state of the robot 100 and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about the robot actions to the sentence generation model, and determines the action of the robot 100 on the basis of the output of the sentence generation model.

For example, the plurality of types of robot actions include the following (1) to (12).
(1) The robot does nothing.
(2) The robot has a dream.
(3) The robot speaks to the user.
(4) The robot creates a picture diary.
(5) The robot proposes an activity.
(6) The robot proposes a person with whom the user should meet.
(7) The robot introduces news in which the user is interested.
(8) The robot edits pictures and moving images.
(9) The robot studies with the user.
(10) The robot evokes memory.
(11) The robot spontaneously executes a proposal for prompting the user in the home to take an action that can be taken by the user by reproducing vocal sound.
(12) The robot spontaneously executes a proposal for prompting the user in the home to take an action that can be taken by the user by displaying a message on the screen.

The action determination unit 236 spontaneously executes, as the robot action, the action content of “(11)” described above, that is, a proposal for prompting the user in the home to take an action that can be taken by the user by reproducing vocal sound.

The action determination unit 236 can spontaneously execute, as the robot action, the action content of “(12)” described above, that is, a proposal for prompting the user in the home to take an action that can be taken by the user by displaying a message on the screen.

With respect to the action content of “(11)” described above, the storage control unit 238 may store, in the history data 2222, information obtained by monitoring the user, specifically, as examples of actions executed by the user in the home, housework, nail cutting, watering of plants, preparation for going out, and walking of an animal. The storage control unit 238 may store these pieces of information regarding the types of actions as specific information associated with the timings at which the actions were executed.

With respect to the action content of “(11)” described above, the storage control unit 238 may store, in the history data 2222, information obtained by monitoring the user, specifically, as examples of actions executed by the user in the home, cleaning of a toilet, preparation for a meal, cleaning of a bath, taking in of laundry, floor cleaning, child care, shopping, taking out garbage, and ventilation of a room. The storage control unit 238 may store these pieces of information regarding the types of actions as specific information associated with the timings at which the actions were executed.

With respect to the action content of “(12)” described above, the storage control unit 238 may store, in the history data 2222, information obtained by monitoring the user, specifically, as examples of actions executed by the user in the home, housework, nail cutting, watering of plants, preparation for going out, and walking of an animal. The storage control unit 238 may store these pieces of information regarding the types of actions as specific information associated with the timings at which the actions were executed.

With respect to the action content of “(12)” described above, the storage control unit 238 may store, in the history data 2222, information obtained by monitoring the user, specifically, as examples of actions executed by the user in the home, cleaning of a toilet, preparation for a meal, cleaning of a bath, taking in of laundry, floor cleaning, child care, shopping, taking out garbage, and ventilation of a room. The storage control unit 238 may store these pieces of information regarding the types of actions as specific information associated with the timings at which the actions were executed.

### (Supplementary Note 1)

An action control system including:
a state recognition unit that recognizes a user state including an action of a user and a state of an electronic apparatus;
an emotion determination unit that determines an emotion of the user or an emotion of the electronic apparatus;
an action determination unit that determines, by using at least one of the user state, the state of the electronic apparatus, the emotion of the user, or the emotion of the electronic apparatus and an action determination model at a predetermined timing, any of a plurality of types of device operations including non-operation as an action of the electronic apparatus; and
a storage control unit that stores, in history data, event data including an emotion value determined by the emotion determination unit and data including the action of the user, in which
the device operations include making a proposal for prompting an action that the user is able to take in a home, and
the storage control unit stores a type of an action that the user executes in the home in association with a timing at which the action was executed, and
in a case in which it is determined to spontaneously or periodically make a proposal for prompting an action that the user in the home is able to take as an action of the electronic apparatus on the basis of the history data, the action determination unit executes the proposal for prompting the action at a timing at which the user is to execute the action.

### (Supplementary Note 2)

The action control system according to Supplementary Note 1, in which the electronic apparatus is a robot, and
the action determination unit determines any of a plurality of types of robot actions including no action as an action of the robot.

### (Supplementary Note 3)

The action control system according to Supplementary Note 2, in which the action determination model is a sentence generation model having an interaction function, and
the action determination unit inputs text representing at least one of the user state, a state of the robot, the emotion of the user, or an emotion of the robot and text for inquiry about the robot actions to the sentence generation model, and determines an action of the robot on the basis of an output of the sentence generation model.

### (Supplementary Note 4)

The action control system according to Supplementary Note 2 or 3, in which the robot is mounted on a stuffed toy or is connected to a control target device mounted on the stuffed toy in a wireless or wired manner.

### (Supplementary Note 5)

The action control system according to Supplementary Note 2 or 3, in which the robot is an agent for interacting with the user.

### Twenty-First Embodiment

In autonomous processing in the present embodiment, the robot 100 installed in a meeting site detects each statement of participants of the meeting by using the microphone function as a state of the user in the meeting. The statement of each of the participants of the meeting is stored as meeting minutes. The robot 100 performs summarization on the meeting minutes of all the meetings by using the sentence generation model, and stores a summary result. In a case in which the talk has come to a dead end during the meeting or in a case in which it has been detected that the meeting goes back and forth, the robot 100 spontaneously speaks arrangement of frequently appearing words and a summary of the meeting so far as progress support of the meeting, summarizes the meeting, and performs an action of cooling the heads of the participants of the meeting.

The action determination unit 236 uses at least one of the state of the user 10, the emotion of the user 10, the emotion of the robot 100, or the state of the robot 100 and the action determination model 221A at a predetermined timing, to determine any of a plurality of types of robot actions including no action as the action of the robot 100. Here, a case in which a sentence generation model having an interaction function is used as the action determination model 221A will be described as an example.

Specifically, the action determination unit 236 inputs text representing at least one of the state of the user 10, the emotion of the user 10, the emotion of the robot 100, or the state of the robot 100 and text for inquiry about the robot actions to the sentence generation model, and determines the action of the robot 100 on the basis of the output of the sentence generation model.

For example, the plurality of types of robot actions includes the following (1) to (12).
(1) The robot 100 does nothing.
(2) The robot 100 has a dream.
(3) The robot 100 speaks to the user.
(4) The robot 100 creates a picture diary.
(5) The robot 100 proposes an activity.
(6) The robot 100 proposes a person with whom the user should meet.
(7) The robot 100 introduces news in which the user is interested.
(8) The robot 100 edits pictures and moving images.
(9) The robot 100 studies with the user.
(10) The robot 100 evokes memory.
(11) The robot prepares meeting minutes.
(12) The robot supports the progress of the conference.

In a case in which it is determined, as the robot action, that “(11) The robot prepares meeting minutes.”, that is, the robot creates meeting minutes, the action determination unit 236 creates the meeting minutes and summarizes the meeting minutes by using the sentence generation model. With respect to the “(11) The robot prepares meeting minutes.”, the storage control unit 238 stores the created summary in the history data 2222. The storage control unit 238 detects a statement of each participant of the meeting as a state of the user by using the microphone function, and stores the statements in the history data 2222. Here, the creation and summarization of the meeting minutes are autonomously performed at predetermined triggers, for example, at predetermined time intervals during the meeting, but the technology of the disclosure is not limited thereto. Summarization of the meeting minutes is not limited to using the sentence generation model, and may be performed by using other known methods.

In a case in which the robot action is “(12) The robot supports the progress of the conference.”, that is, in a case in which the meeting is in a predefined state, the action determination unit 236 spontaneously causes the robot 100 to support the progress of the meeting. Here, the progress support of the meeting includes an action of summarizing the meeting, for example, an action of arranging frequently appearing words, an action of speaking a summary of the meeting so far, and an action of cooling the heads of the participants of the meeting by providing other topics. Performing such an action supports the progress of the meeting. Here, the case in which the meeting is in a predefined state includes a state in which a statement is no longer accepted for a predefined time. In other words, in a case in which a plurality of users has not made any statement for a predefined time, for example, five minutes, it is determined that the meeting has stalled, no good idea is generated, and the participants are in a silent state. Therefore, the meeting is summarized by arranging the frequently appearing words and the like. The case in which a meeting is in a predefined state includes a state in which a term included in a statement is received a predefined number of times. That is, in a case in which the same term is received a predefined number of times, it is determined that the same topic goes back and forth in the meeting and no new idea comes out. Therefore, the meeting is summarized by arranging the frequently appearing words and the like. Materials for the meeting may be input to the sentence generation model in advance, and terms described in the materials are assumed to frequently appear, and thus may be excluded from the count of the number of times.

With such a configuration, even in a dead-end meeting, it is possible to support the progress of the meeting by summarizing the meeting.

It is desirable that the above progress support of the meeting by the action determination unit 236 is not started by an inquiry from the user, but is autonomously executed by the robot 100. Specifically, in a case in which the meeting is in a predefined state, it is preferable for the robot 100 to support the progress of the meeting by itself.

### (Supplementary Note 1)

An action control system including:
a state recognition unit that recognizes a user state including an action of a user and a state of an electronic apparatus;
an emotion determination unit that determines an emotion of the user or an emotion of the electronic apparatus;
an action determination unit that determines, by using at least one of the user state, the state of the electronic apparatus, the emotion of the user, or the emotion of the electronic apparatus, and an action determination model at a predetermined timing, any of a plurality of types of device operations including non-operation as an action of the electronic apparatus; and
a storage control unit that stores, in history data, event data including an emotion value determined by the emotion determination unit and data including the action of the user, in which
the device operations include supporting a progress of a meeting for the user during the meeting, and
in a case in which the meeting is in a predefined state, the action determination unit determines to output progress support of the meeting to the user during the meeting as the action of the electronic apparatus, and outputs the progress support of the meeting.

### (Supplementary Note 2)

The action control system according to Supplementary Note 1, in which the electronic apparatus is a robot, and
the action determination unit determines any of a plurality of types of robot actions including no action as an action of the robot.

### (Supplementary Note 3)

The action control system according to Supplementary Note 2, in which the action determination model is a sentence generation model having an interaction function, and
the action determination unit inputs text representing at least one of the user state, a state of the robot, the emotion of the user, or an emotion of the robot and text for inquiry about the robot actions to the sentence generation model, and determines an action of the robot on the basis of an output of the sentence generation model.

### (Supplementary Note 4)

The action control system according to Supplementary Note 2 or 3, in which the robot is mounted on a stuffed toy or is connected to a control target device mounted on the stuffed toy in a wireless or wired manner.

### (Supplementary Note 5)

The action control system according to Supplementary Note 2 or 3, in which the robot is an agent for interacting with the user.

### Twenty-Second Embodiment

The robot 100 according to the present embodiment may be configured to determine an action of the robot 100 corresponding to an emotion of the user 10 by matching the sentence generation model (so-called AI) with the emotion engine. Specifically, the robot 100 may be configured to recognize an action of the user 10, determine an emotion of the user 10 for the action of the user, and determine an action of the robot 100 corresponding to the determined emotion.

More specifically, in a case in which the robot 100 recognizes the action of the user 10, the robot 100 automatically generates action content to be taken by the robot 100 with respect to the action of the user 10 by using a preset sentence generation model. The sentence generation model may be interpreted as an algorithm and an operation for automatic interaction processing using letters. Since the sentence generation model is known as disclosed in, for example, Japanese Patent Application Laid-Open No. 2018-081444, a detailed description thereof will be omitted. Such a sentence generation model is configured by a large language model (LLM). As described above, in the present embodiment, it is possible to reflect the emotions of the user 10 and the robot 100 and various types of linguistic information in the action of the robot 100 by combining the large language model and the emotion engine. That is, according to the present embodiment, a synergistic effect can be obtained by combining the sentence generation model and the emotion engine.

Here, each robot has an event detection function of detecting the occurrence of a predetermined event and outputting information corresponding to the event that has occurred. For example, each robot can detect the occurrence of a disaster and output information regarding emergency response or evacuation guidance for the disaster that has occurred, thereby outputting appropriate information corresponding to the disaster that has occurred to the user.

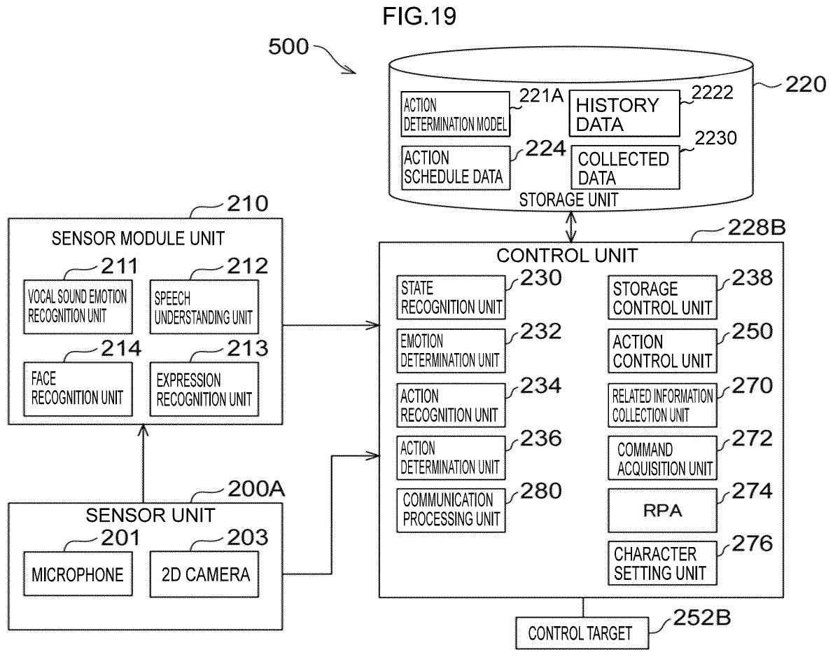

FIG. 19 is a diagram schematically illustrating a functional configuration of the robot 100 according to the twenty-second embodiment. The robot 100 includes a sensor unit 2000, a sensor module unit 2100, a storage unit 2200, a state recognition unit 2300, an emotion determination unit 2320, an action recognition unit 2340, an action determination unit 2360, a storage control unit 2380, an action control unit 2500, a control target 2520, a communication processing unit 2800, and an event detection unit 2900.

The control target 2520 includes, for example, a display device 2521, a speaker 2522, a lamp 2523 (for example, the LED of the eye portion), and a motor 2524 that drives an arm, a hand, a foot, or the like. The posture and the gesture of the robot 100 are controlled by controlling the motor 2524 for an arm, a hand, a foot, or the like. Some of the emotions of the robot 100 can be expressed by controlling these motors 2524. The expression of the robot 100 can be expressed by controlling a light emission state of the LED of the eye portion of the robot 100. The posture, the gesture, and the expression of the robot 100 are examples of the attitude of the robot 100.

The sensor unit 2000 includes a microphone 2010, a 3D depth sensor 2020, a 2D camera 2030, and a distance sensor 2040. The microphone 2010 continuously detects vocal sound and outputs vocal sound data. The microphone 2010 may be provided on the head of the robot 100 and may have a function of performing binaural recording. The 3D depth sensor 2020 analyzes infrared patterns from infrared images continuously captured by an infrared camera by continuously applying the infrared patterns, and detects an outline of an object. The 2D camera 2030 is an example of an image sensor. The 2D camera 2030 captures an image with visible light and generates image information of visible light. The distance sensor 2040 detects a distance to an object by emitting, for example, laser light or ultrasonic waves. The sensor unit 2000 may further include a clock, a gyro sensor, a touch sensor, a sensor for motor feedback, and the like.

Among the constituents of the robot 100 illustrated in FIG. 19, the constituents other than the control target 2520 and the sensor unit 2000 are examples of the constituents included in the action control system included in the robot 100. The action control system of the robot 100 controls the control target 2520.

The storage unit 2200 includes a reaction rule 2210, history data 2222, and character data 2250. The history data 2222 includes past emotion values and a history of actions of the user 10. The emotion values and the history of the actions are recorded for each user 10 by being associated with identification information of the user 10, for example. At least a part of the storage unit 2200 is implemented by a storage medium such as a memory. A person DB that stores a face image of the user 10, attribute information of the user 10, and the like may be included. Among the constituents of the robot 100 illustrated in FIG. 19, the functions of the constituents other than the control target 2520, the sensor unit 2000, and the storage unit 2200 can be realized by a CPU operating on the basis of a program. For example, the functions of these constituents can be implemented as the operation of the CPU by basic software (OS) and a program operating on the OS.

The character data 2250 is data in which a character and an age are associated with each other. For example, the character is a person appearing in a content such as an existing animation, video game, cartoon, or movie. The character may be animals and plants having a personality, or may be an inanimate object (a robot or the like).

For example, the age (use age) associated with the character in the character data 2250 is determined on the basis of an age group of viewers assumed as targets of a content in which the character appears.

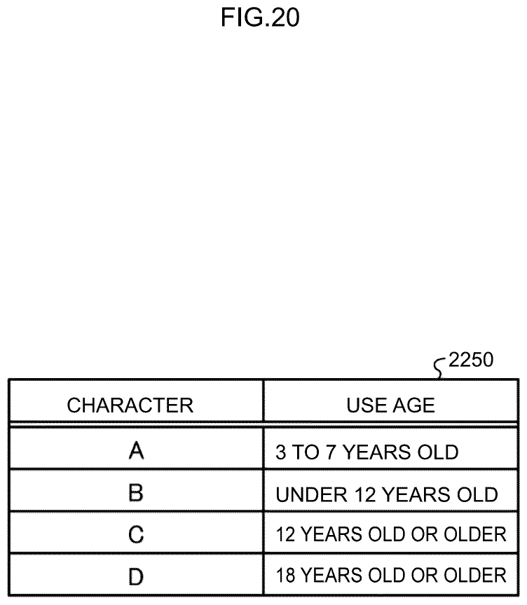

For example, it is assumed that the character “A” appears in an animation for a kindergarten child. In this case, as illustrated in FIG. 20, the character “A” is associated with a use age of “from 3 years old to 7 years old”.

For example, it is assumed that a movie in which a character “C” appears includes a violent scene and is not suitable for viewing of an infant. In this case, as illustrated in FIG. 20, the character “C” is associated with a use age of “12 years old or older”.

The age in the character data 2250 may be determined on the basis of an age rating by a rating organization such as Pan European Game Information (PEGI), Film Classification and Rating Organization, or Computer Entertainment Rating Organization (CERO). The use age may be determined by a range such as “from 3 years old to 5 years old” or “12 years old or older”, or may be determined by one value such as “10 years old” or “15 years old”.

The sensor module unit 2100 includes vocal sound emotion recognition unit 2110, a speech understanding unit 2120, an expression recognition unit 2130, and a face recognition unit 2140. Information detected by the sensor unit 2000 is input to the sensor module unit 2100. The sensor module unit 2100 analyzes information detected by the sensor unit 2000 and outputs an analysis result to the state recognition unit 2300.

The vocal sound emotion recognition unit 2110 of the sensor module unit 2100 analyzes the vocal sound of the user 10 detected by the microphone 2010 to recognize an emotion of the user 10. For example, the vocal sound emotion recognition unit 2110 extracts a feature amount such as a frequency component of vocal sound and recognizes the emotion of the user 10 on the basis of the extracted feature amount. The speech understanding unit 2120 analyzes the vocal sound of the user 10 detected by the microphone 2010 and outputs letter information indicating the speech content of the user 10.

The expression recognition unit 2130 recognizes the expression of the user 10 and the emotion of the user 10 from the image of the user 10 captured by the 2D camera 2030. For example, the expression recognition unit 2130 recognizes the expression and the emotion of the user 10 on the basis of the shapes, positional relationships, and the like of the eyes and the mouth.

The face recognition unit 2140 recognizes the face of the user 10. The face recognition unit 2140 recognizes the user 10 by matching a face image stored in a person DB (not illustrated) with a face image of the user 10 captured by the 2D camera 2030.

The state recognition unit 2300 recognizes a state of the user 10 on the basis of the information analyzed by the sensor module unit 2100. For example, processing mainly related to perception is performed by using the analysis result from the sensor module unit 2100. For example, perception information such as “There is one father.” and “The probability that the father does not smile is 90%.” is generated. Processing of understanding the meaning of the generated perception information is performed. For example, semantic information such as “One father looks lonely.” is generated.

The emotion determination unit 2320 determines an emotion value indicating the emotion of the user 10 on the basis of the information analyzed by the sensor module unit 2100 and the state of the user 10 recognized by the state recognition unit 2300. For example, the information analyzed by the sensor module unit 2100 and the recognized state of the user 10 are input to a neural network trained in advance, and an emotion value indicating the emotion of the user 10 is acquired.

Here, the emotion value indicating the emotion of the user 10 is a value indicating whether the emotion of the user is positive or negative. For example, in a case in which the emotion of the user is a bright emotion accompanied with pleasure or comfort, such as “happy”, “pleasant”, “pleased”, “safe”, “excited”, “relieved”, and “sense of fulfillment”, a positive value is indicated, and the value becomes larger as the emotion becomes brighter. In a case in which the emotion of the user is an emotion that makes the user feel unpleasant, such as “angry”, “sad”, “displeased”, “anxious”, “gloomy”, “worried”, and “sense of emptiness”, a negative value is indicated, and an absolute value of the negative value increases as the user feels unpleasant. In a case in which the emotion of the user is not included in any of the above emotions (“normal”), a value of 0 is indicated.

The emotion determination unit 2320 determines an emotion value indicating the emotion of the robot 100 on the basis of the information analyzed by the sensor module unit 2100 and the state of the user 10 recognized by the state recognition unit 2300.

The emotion value of the robot 100 includes the emotion value for each of the plurality of emotion classifications, and is, for example, a value (0~5) indicating the strength of each of “happy”,” angry “, “sad”, and” pleasant”.

Specifically, the emotion determination unit 2320 determines an emotion value indicating the emotion of the robot 100 according to a rule for updating the emotion value of the robot 100 defined in association with the information analyzed by the sensor module unit 2100 and the state of the user 10 recognized by the state recognition unit 2300.

For example, in a case in which the state recognition unit 2300 recognizes that the user 10 looks lonely, the emotion determination unit 2320 increases the emotion value of “sad” of the robot 100. In a case in which the state recognition unit 2300 recognizes that the user 10 has a smiling face, the emotion value of “happy” of the robot 100 is increased.

The emotion determination unit 2320 may determine the emotion value indicating the emotion of the robot 100 in further consideration of the state of the robot 100. For example, in a case in which a remaining battery level of the robot 100 is low or in a case in which the surrounding environment of the robot 100 is dark, the emotion value of “sad” of the robot 100 may be increased. In the case of the user 10 continuously talking to the robot even though the remaining battery level is low, the emotion value of “angry” may be increased.

The action recognition unit 2340 recognizes an action of the user 10 on the basis of the information analyzed by the sensor module unit 2100 and the state of the user 10 recognized by the state recognition unit 2300. For example, the information analyzed by the sensor module unit 2100 and the recognized state of the user 10 are input to a neural network trained in advance, probabilities of a plurality of predetermined action classifications (for example, “smile”, “angry”, “ask a question”, and “gloomy”) are acquired, and an action classification having the highest probability is recognized as the action of the user 10.

As described above, in the present embodiment, the robot 100 acquires the speech content of the user 10 after specifying the user 10, but in acquiring and using the speech content, the action control system of the robot 100 according to the present embodiment considers protection of personal information and privacy of the user 10 in addition to acquiring necessary consent according to laws and regulations from the user 10.

The action determination unit 2360 determines an action corresponding to the action of the user 10 recognized by the action recognition unit 2340 on the basis of the current emotion value of the user 10 determined by the emotion determination unit 2320, the history data 2222 of the past emotion values determined by the emotion determination unit 2320 before the current emotion value of the user 10 is determined, and the emotion value of the robot 100. In the present embodiment, a case in which the action determination unit 2360 uses one most recent emotion value included in the history data 2222 as the past emotion value of the user 10 will be described, but the disclosed technology is not limited to this aspect. For example, the action determination unit 2360 may use a plurality of most recent emotion values as the past emotion values of the user 10, or may use emotion values that are earlier by a unit period such as one day before. The action determination unit 2360 may determine an action corresponding to the action of the user 10 in further consideration of the history of the past emotion values of the robot 100 in addition to the current emotion value of the robot 100. The action determined by the action determination unit 2360 includes a gesture performed by the robot 100 or speech content of the robot 100.

The action determination unit 2360 according to the present embodiment determines the action of the robot 100 on the basis of a combination of the past emotion value and the current emotion value of the user 10, the emotion value of the robot 100, the action of the user 10, and the reaction rule 2210, as the action corresponding to the action of the user 10. For example, in a case in which the past emotion value of the user 10 is a positive value and the current emotion value is a negative value, the action determination unit 2360 determines an action for positively changing the emotion value of the user 10 as an action corresponding to the action of the user 10.

The action determination unit 2360 may determine an action corresponding to the action of the user 10 on the basis of the emotion of the robot 100. For example, when the emotion value of “angry” or “sad” of the robot 100 increases in a case in which the robot 100 is abused by the user 10, in a case in which the user 10 takes an arrogant attitude (that is, in a case in which the user's reaction is poor), in a case in which the vocal sound of the user 10 cannot be detected due to surrounding noise, in a case in which the remaining battery level of the robot 100 is low, or the like, the action determination unit 2360 may determine an action corresponding to an increase in the emotion value of “angry” or “sad” as the action corresponding to the action of the user 10. When the emotion value of “happy” or “pleasant” of the robot 100 increases in a case in which the user's reaction is favorable, in a case in which the remaining battery level of the robot 100 is large, or the like, the action determination unit 2360 may determine an action corresponding to an increase in the emotion value of “happy” or “pleasant” as an action corresponding to the action of the user 10. The action determination unit 2360 may determine an action different from an action for the user 10 in which the emotion value of “angry” or “sad” of the robot 100 increases, as an action for the user 10 in which the emotion value of “happy” or “pleasant” of the robot 100 increases. As described above, the action determination unit 2360 may determine different actions depending on the emotion of the robot 100 itself or how the user 10 has changed the emotion of the robot 100 due to the action of the user 10.

The reaction rule 2210 defines an action of the robot 100 according to the combination of the past emotion value and the current emotion value of the user 10, the emotion value of the robot 100, and the action of the user 10. For example, in a case in which the past emotion value of the user 10 is a positive value, the current emotion value is a negative value, and the action of the user 10 is gloomy, a combination of a gesture and speech content at the time of making an inquiry to encourage the user 10 including a gesture is defined as the action of the robot 100.

For example, the reaction rule 2210 defines an action of the robot 100 for all combinations of patterns of emotion values of the robot 100 (1296 patterns that is the fourth power of six values of the values “0” to “5” of “happy”, “angry”, “sad”, and “pleasant”), a pattern of the combination of the past emotion value and the current emotion value of the user 10, and an action pattern of the user 10. That is, for each pattern of the emotion value of the robot 100, the action of the robot 100 according to the action pattern of the user 10 is defined for each of a plurality of combinations such as combinations of the past emotion value and the current emotion value of the user 10 being a negative value and a negative value, a negative value and a positive value, a positive value and a negative value, a positive value and a positive value, a negative value and normal, and normal and normal. The action determination unit 2360 may transition to an operation mode of determining the action of the robot 100 by using the history data 2222, for example, in a case in which the user 10 has made speech that intends a conversation continued from a past topic such as “I want to talk about the topic I said earlier”.

In the reaction rule 2210, a gesture and statement content may be defined as an action of the robot 100 for each pattern (1296 patterns) of the emotion values of the robot 100 at most one per pattern. Alternatively, in the reaction rule 2210, at most one of a gesture and statement content may be defined as an action of the robot 100 for each of groups of the patterns of the emotion values of the robot 100.

The intensity of each gesture included in the action of the robot 100 defined in the reaction rule 2210 is defined in advance. In each piece of speech content included in the action of the robot 100 defined in the reaction rule 2210, the intensity of the speech content is defined in advance.

The storage control unit 2380 determines whether or not to store data including the action of the user 10 in the history data 2222 on the basis of the intensity of the action predefined for the action determined by the action determination unit 2360 and the emotion value of the robot 100 determined by the emotion determination unit 2320.

Specifically, in a case in which a total value of the intensities that is a sum of a sum total of the emotion values for the plurality of respective emotion classifications of the robot 100, the intensity predefined for the gesture included in the action determined by the action determination unit 2360, and the intensity predefined for the speech content included in the action determined by the action determination unit 2360 is a threshold or more, it is determined to store data including the action of the user 10 in the history data 2222.

In a case in which the storage control unit 2380 determines to store the data including the action of the user 10 in the history data 2222, the action determined by the action determination unit 2360, information (for example, any surrounding information including data such as vocal sound, an image, and a smell at the place) analyzed by the sensor module unit 2100 from the current time point to a certain period before, and a state (for example, the expression and the emotion of the user 10) of the user 10 recognized by the state recognition unit 2300 are stored in the history data 2222.

The action control unit 2500 controls the control target 2520 on the basis of the action determined by the action determination unit 2360. For example, in a case in which the action determination unit 2360 determines an action including speech, the action control unit 2500 causes a speaker included in the control target 2520 to output vocal sound. In this case, the action control unit 2500 may determine an emission speed of the vocal sound on the basis of the emotion value of the robot 100. For example, the action control unit 2500 determines a higher vocal sound emission speed as the emotion value of the robot 100 becomes greater. As described above, the action control unit 2500 determines an execution form of the action determined by the action determination unit 2360 on the basis of the emotion value determined by the emotion determination unit 2320.

The action control unit 2500 may recognize a change in emotion of the user 10 with respect to execution of the action determined by the action determination unit 2360. For example, the change in emotion may be recognized on the basis of the vocal sound or expression of the user 10. A change in the emotion of the user 10 may be recognized on the basis of detection of an impact by the touch sensor included in the sensor unit 2000. In a case in which an impact is detected by the touch sensor included in the sensor unit 2000, it may be recognized that the emotion of the user 10 is worsened, or in a case in which it is determined that the reaction of the user 10 is smiling or happy from the detection result in the touch sensor included in the sensor unit 2000, it may be recognized that the emotion of the user 10 is improved. Information indicating the reaction of the user 10 is output to the communication processing unit 2800.

After the action control unit 2500 executes the action determined by the action determination unit 2360 in the execution form determined according to the emotion of the robot 100, the emotion determination unit 2320 further changes the emotion value of the robot 100 on the basis of the user's reaction to the execution of the action. Specifically, the emotion determination unit 2320 increases the emotion value of “happy” of the robot 100 in a case in which the user's reaction to the action determined by the action determination unit 2360 performed on the user in the execution form determined by the action control unit 2500 is not bad, and the emotion determination unit 2320 increases the emotion value of “sad” of the robot 100 in a case in which the user's reaction to the action determined by the action determination unit 2360 performed on the user in the execution form determined by the action control unit 2500 is poor.

The action control unit 2500 expresses the emotion of the robot 100 on the basis of the determined emotion value of the robot 100. For example, in a case in which the emotion value of “happy” of the robot 100 is increased, the action control unit 2500 controls the control target 2520 to cause the robot 100 to perform a gesture of being happy. In a case in which the emotion value of “sad” of the robot 100 is increased, the action control unit 2500 controls the control target 2520 so that the posture of the robot 100 becomes a head-drooping posture.

The communication processing unit 2800 performs communication with the server 300. As described above, the communication processing unit 2800 transmits the user reaction information to the server 300. The communication processing unit 2800 receives the updated reaction rule from the server 300. Upon receiving the updated reaction rule from the server 300, the communication processing unit 2800 updates the reaction rule 2210.

The event detection unit 2900 realizes the above-described output function. Details of the event detection unit 2900 will be described later.

The server 300 performs communication between the robot 100, the robot 101, and the robot 102 and the server 300, receives the user reaction information transmitted from the robot 100, and updates the reaction rule on the basis of the reaction rule including the action for which a positive reaction has been obtained.

### (Action Determination Based on Character)

The case in which the action determination unit 2360 determines the action of the robot 100 on the basis of the state recognized by the state recognition unit 2300 has been described above. On the other hand, the action determination unit 2360 may determine the action of the robot 100 on the basis of not only the state of the user but also the set character. In this case, the action determination unit 2360 may acquire an age (use age) associated with the character from the character data 2250, and determine the action of the robot 100 on the basis of the acquired use age.

That is, the action determination unit 2360 determines the action of the robot 100 on the basis of the state recognized by the state recognition unit 2300 and the set character or the age associated with the character. As a result, the robot 100 can be caused to execute an appropriate action according to the age of the user. In particular, it is possible to limit actions of the robot 100 that are not suitable for younger users (for example, outputting a violent content).

A character is set in advance in the system 5. The character setting is input as a prompt (command sentence). The input of the prompt may be performed via an input device provided in the robot 100 or may be performed via an external device such as a server communicatively connected to the robot 100. In the prompt, a name of a character may be specified, or an ID determined for each character may be designated.

For example, the action determination unit 2360 determines an action of causing the display device 2521 (an example of an output device) provided in the robot to output a screen indicating the appearance of the character or a color according to the character. The color corresponding to the character is a theme color or the like that is associated with the character. As a result, the user can obtain a feeling of interacting with the character.

For example, the action determination unit 2360 determines an action of causing the display device 2521 or the speaker 2522 (an example of an output device) provided in the robot 100 to output information according to an aspect corresponding to the use age. For example, the action determination unit 2360 changes the vocal sound of the robot 100 emitted from the speaker 2522 to the tone of the character.

For example, the action determination unit 2360 determines an action of outputting vocal sound or a message with text configured by using words corresponding to the use age. Here, it is assumed that words that can be used for each age group are set in advance. The action determination unit 2360 acquires the use age from the character data 223.

For example, it is assumed that words “What's wrong?” and “What's the matter?” are stored in the storage unit 2200 in advance as words to be output when the robot 100 selects the action of “talking”. It is assumed that the age of “under 12 years old” is associated with “What's wrong?”, and an age of “12 years old or older” is associated with “What's the matter?”. For example, the action determination unit 2360 determines to output the words “What's the matter?” in a case in which the use age is “18 years old or older”. For example, the action determination unit 2360 determines to output the words “What's wrong?” in a case in which the use age is “3 to 7 years old”.

As described above, changing the tone of the vocal sound and the words to be output according to the use age enables to improve the familiarity from the user of the younger age while limiting actions not suitable for the user of the younger age in particular.

The action determination unit 2360 determines an action of causing an output device (the display device 2521 or the like) provided in the robot 100 to output a content corresponding to the character. For example, the action determination unit 2360 determines an action of displaying a video content in which the character appears (movies, animations, and the like) on the display device 2521.

The action determination unit 2360 may determine an action of outputting an educational content according to the use age. Here, the educational content is text, a video, vocal sound, and the like regarding learning subjects such as English, arithmetic, Japanese, science, and society. The educational content may be an interactive content in which the user inputs an answer to a problem. For example, the action determination unit 2360 determines an action for causing the display device 2521 to display the text of the calculation problem corresponding to the grade corresponding to the use age. For example, the action determination unit 2360 determines to display an addition problem when the use age is “under 8 years old”, and determines to display a multiplication problem when the use age is “8 years old or older”.

The action determination unit 2360 may determine an action of causing an output device included in the robot 100 to output a content corresponding to the use age instead of the character. The content in this case may be a content in which a character appears, or may be a content that does not depend on a character, such as a generally known old story or a children's story.

The content according to the character and the grade and the educational content according to the use age may be stored in the storage unit 2200 in advance, or may be acquired from an external device such as a server communicatively connected to the robot 100.

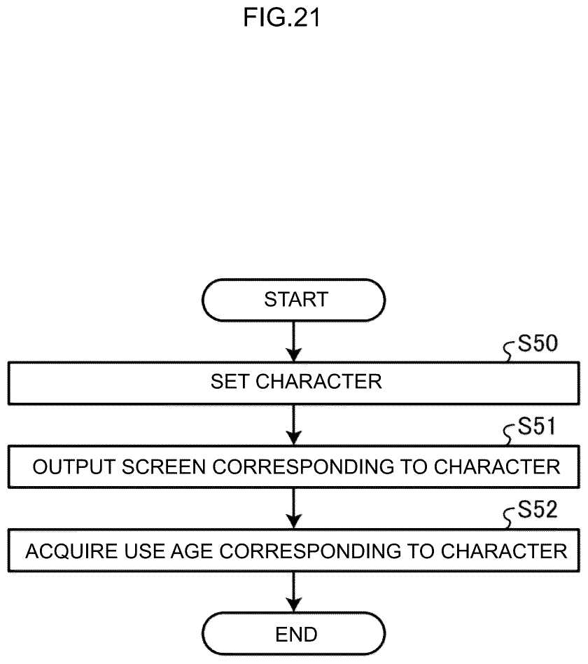

FIG. 21 schematically illustrates an example of an operation flow related to character setting. “S” in the operation flow represents a step to be executed.

In step S50, the robot 100 receives character setting. In step S51, the robot 100 outputs a screen (for example, a screen on which an appearance of the character is displayed) corresponding to the character.

In step S52, the action determination unit 2360 acquires the use age corresponding to the set character from the character data 2250.

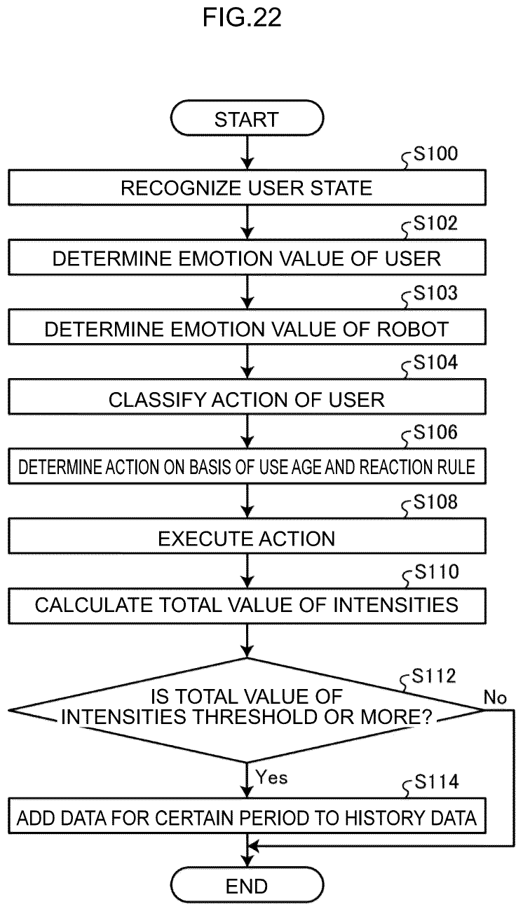

FIG. 22 schematically illustrates an example of an operation flow related to an operation of determining an action of the robot 100. The operation flow illustrated in FIG. 22 is repeatedly executed. In this case, it is assumed that information analyzed by the sensor module unit 2100 is input. “S” in the operation flow represents a step to be executed.

First, in step S100, the state recognition unit 2300 recognizes a state of the user 10 on the basis of the information analyzed by the sensor module unit 2100.

In step S102, the emotion determination unit 2320 determines an emotion value indicating the emotion of the user 10 on the basis of the information analyzed by the sensor module unit 2100 and the state of the user 10 recognized by the state recognition unit 2300.

In step S103, the emotion determination unit 2320 determines an emotion value indicating the emotion of the robot 100 on the basis of the information analyzed by the sensor module unit 2100 and the state of the user 10 recognized by the state recognition unit 2300. The emotion determination unit 2320 adds the determined emotion value of the user 10 to the history data 2222.

In step S104, the action recognition unit 2340 recognizes an action classification of the user 10 on the basis of the information analyzed by the sensor module unit 2100 and the state of the user 10 recognized by the state recognition unit 2300.

In step S106, the action determination unit 2360 determines an action of the robot 100 on the basis of the use age acquired in step S52 in FIG. 21, the combination of the current emotion value of the user 10 determined in step S102 in FIG. 21 and the past emotion value included in the history data 2222, the emotion value of the robot 100, the action of the user 10 recognized by the action recognition unit 2340, and the reaction rule 2210.

In step S108, the action control unit 2500 controls the control target 2520 on the basis of the action determined by the action determination unit 2360.

In step S110, the storage control unit 2380 calculates a total value of intensities on the basis of the intensity of the action predefined for the action determined by the action determination unit 2360 and the emotion value of the robot 100 determined by the emotion determination unit 2320.

In step S112, the storage control unit 2380 determines whether or not the total value of the intensities is a threshold or more. In a case in which the total value of the intensities is less than the threshold, the data including the action of the user 10 is not stored in the history data 2222, and the processing is ended. On the other hand, in a case in which the total value of the intensities is the threshold or more, the processing proceeds to step S114.

In step S114, the action determined by the action determination unit 2360, the information analyzed by the sensor module unit 2100 from the current time point to a certain period before, and the state of the user 10 recognized by the state recognition unit 2300 are stored in the history data 2222.

As described above, according to the robot 100, the emotion value indicating the emotion of the robot 100 is determined on the basis of the user state, and whether or not to store data including the action of the user 10 in the history data 2222 is determined on the basis of the emotion value of the robot 100. As a result, the capacity of the history data 2222 that stores data including the action of the user 10 can be suppressed. For example, in a case in which the robot 100 determines that the user state after 10 years is the same as the user state of 10 years ago, the robot 100 reads the history data 2222 of 10 years ago, and thus, can present the state of the user 10 of 10 years ago (for example, an expression and an emotion of the user 10), and further, any surrounding information including data such as vocal sound, an image, and a smell at the place to the user 10.

According to the robot 100, it is possible to cause the robot 100 to execute an appropriate action with respect to the action of the user 10. Conventionally, an action of a user is classified to determine an action including an expression or an appearance of a robot. On the other hand, the robot 100 determines the current emotion value of the user 10, and executes an action on the user 10 on the basis of the past emotion value and the current emotion value. Therefore, for example, in a case in which the user 10 who was fine yesterday is depressed today, the robot 100 may say, “You were fine yesterday. What's wrong with you today?”. The robot 100 may also make speech with a gesture. For example, in a case in which the user 10 who was depressed yesterday is fine today, the robot 100 may say, “You were depressed yesterday, but you look fine today?”. For example, in a case in which the user 10 who was fine yesterday is better today than yesterday, the robot 100 may say, “You are better today than yesterday. What's better than yesterday?”. For example, the robot 100 may make speech such as “Recently, the mood is stable, which is good.” to the user 10 whose emotion value is 0 or more and whose state in which the fluctuation range of the emotion value is within a certain range continues.

For example, in a case in which the robot 100 asks a question of “Did you finish the homework that you said yesterday?” to the user 10 and an answer of “I did it” is obtained from the user 10, the robot may make affirmative speech such as “Good!” and make an affirmative gesture such as applause or thumbs-up. For example, in a case in which the user 10 says, “The presentation we discussed the day before yesterday was successful”, the robot 100 can make affirmative speech such as “Good job!” and also make the above affirmative gesture. As described above, the robot 100 performs an action based on the history of the state of the user 10, whereby the user 10 can be expected to feel a sense of closeness to the robot 100.

In the above embodiment, the case in which the robot 100 recognizes the user 10 by using the face image of the user 10 has been described, but the disclosed technology is not limited to this aspect. For example, the robot 100 may recognize the user 10 by using vocal sound uttered by the user 10, a mail address of the user 10, an ID of an SNS of the user 10, an ID card in which a wireless IC tag is built and which is possessed by the user 10, or the like.

### (Detection of Event)

The event detection unit 2900 will be described in detail. Here, the event detection unit 2900 is provided in the robot 100 and causes the robot 100 to output information corresponding to a detected event.

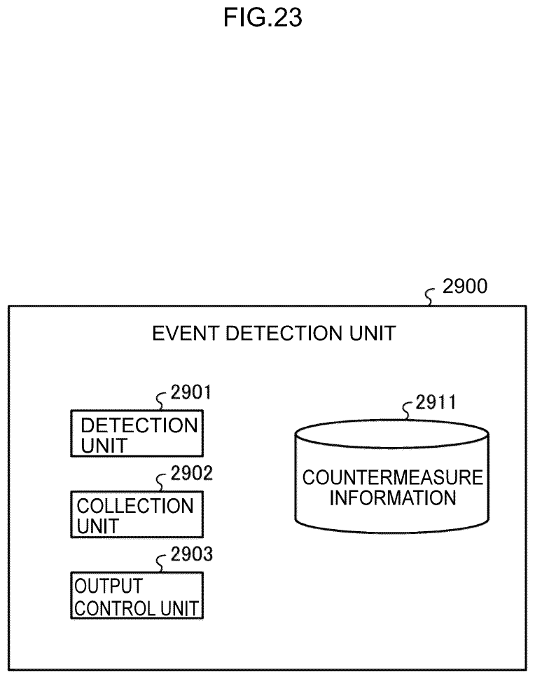

As illustrated in FIG. 23, the event detection unit 2900 includes a detection unit 2901, a collection unit 2902, and an output control unit 2903. The event detection unit 2900 also stores countermeasure information 2911.

Each constituent of the event detection unit 2900 is realized by the CPU operating on the basis of a program. For example, the functions of these constituents can be implemented as the operation of the CPU by basic software (OS) and a program operating on the OS. The countermeasure information 2911 is implemented by a storage medium such as a memory.

The detection unit 2901 detects the occurrence of a predetermined event. The output control unit 2903 controls the robot 100 including the sentence generation model to output information corresponding to the event detected by the detection unit 2901 to the user 10.

The collection unit 2902 collects situation information indicating a situation of the user 10. The output control unit 2903 controls the robot 100 to output information according to the situation information. For example, when an event occurs, the collection unit 2902 collects information indicating a situation of a site where the user 10 is located (vocal sound or the like of the user 10). As a result, the robot 100 recognizes the emotion of the user 10 from the vocal sound or the like of the user 10 to ascertain the situation of the site where the user 10 is located, and can give an appropriate instruction for the event that has occurred by performing gesture control or the like.

The detection unit 2901 detects the occurrence of a disaster. The output control unit 2903 controls the robot 100 to output information corresponding to the disaster that has occurred.

The output control unit 2903 controls the robot 100 to output the information regarding a countermeasure against the event that has occurred, accumulated in the countermeasure information 2911. As a result, the robot 100 can support emergency response and evacuation guidance at the time of disaster.

The detection unit 2901 may detect an event such as an earthquake or a fire from various types of sensor information. The detection unit 2901 may communicate with an external server and detect an event such as torrential rain, tornado, or typhoon. The detection unit 2901 may analyze surrounding sound and detect an event that has occurred from user's speech or sound generated from a television or the like.

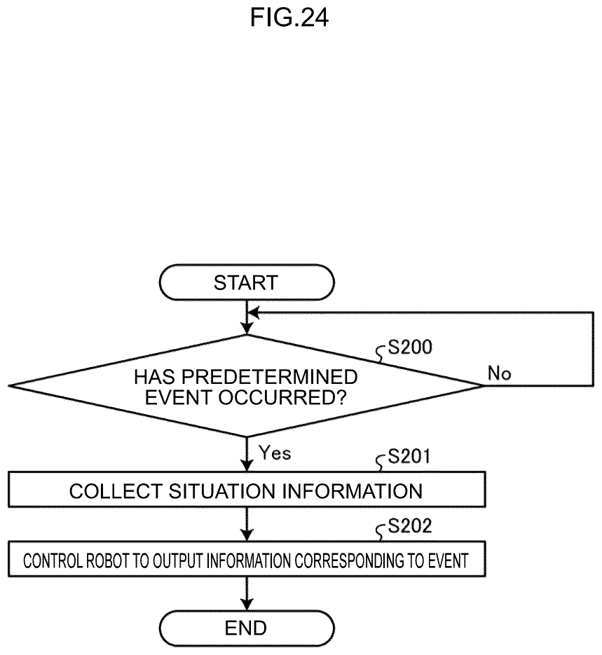

FIG. 24 schematically illustrates an example of an operation flow in the event detection unit 2900. In step S200, the event detection unit 2900 determines whether or not the occurrence of a predetermined event has been detected (step S200). In a case in which the occurrence of the predetermined event has not been detected (step S200; No), the event detection unit 2900 stands by until the occurrence of a predetermined event is detected.

On the other hand, in a case in which the occurrence of the predetermined event is detected (step S200; Yes), the event detection unit 2900 collects situation information indicating the situation of the user 10 (step S201). Subsequently, the event detection unit 2900 controls the robot 100 including the sentence generation model to output information corresponding to the event that has occurred and the situation information to the user 10 (step S202), and ends the processing.

The robot 100 is an example of an electronic apparatus including an action control system. An application target of the action control system is not limited to the robot 100, and the action control system can be applied to various electronic apparatuses. The functions of the server 300 may be implemented by one or more computers. At least some functions of the server 300 may be implemented by a virtual machine. At least some of the functions of the server 300 may be implemented in a cloud.

### (Supplementary Note 1)

An action control system including:
a detection unit that detects occurrence of a predetermined event; and
an output control unit that controls a robot including a sentence generation model to output information corresponding to the event detected by the detection unit to a user.

### (Supplementary Note 2)

The action control system according to Supplementary Note 1 further including a collection unit that collects situation information indicating a situation of the user, in which
the output control unit controls the robot to output the information corresponding to the situation information.

### (Supplementary Note 3)

The action control system according to Supplementary Note 1, in which
the detection unit detects occurrence of a disaster, and
the output control unit controls the robot to output the information corresponding to the disaster that has occurred.

### (Supplementary Note 4)

The action control system according to Supplementary Note 1, in which the output control unit controls the robot to output the information regarding a countermeasure against the event that has occurred.

### (Supplementary Note 5)

The action control system according to Supplementary Note 1, in which the robot is mounted on a stuffed toy, or is connected to a control target device mounted on the stuffed toy in a wireless or wired manner.

### Twenty-Third Embodiment

The action control system of the robot 100 according to the present embodiment may be configured as follows. The detection unit 2901 detects the occurrence of a predetermined event. The detection unit 2901 detects an event in which the user 10 needs to coordinate fashion. For example, the detection unit 2901 detects a gesture of the user 10 of worrying about what to wear when going out, a gesture of selecting clothes, or the like. The detection unit 2901 detects an event in which the user 10 desires relaxation or an event in which the user desires stress reduction. For example, the detection unit 2901 detects such an event by detecting speech from the user 10 or a predetermined action of the user 10 (for example, relaxing in a sofa). The detection unit 2901 detects an event in which the user 10 requests tourist guidance at a travel destination. For example, the detection unit 2901 detects such an event on the basis of speech or the like between the user 10 and the robot 100. The detection unit 2901 detects an event in which the user 10 needs cooking support. For example, the detection unit 2901 detects such an event on the basis of speech or the like between the user 10 and the robot 100.

The collection unit 2902 collects situation information indicating a situation of the user 10. The output control unit 2903 controls the robot 100 to output information corresponding to the situation information. For example, the collection unit 2902 collects information indicating a situation (vocal sound of the user 10, an image of user 10, and the like) of the user 10 when selecting coordination. In this case, the collection unit 2902 may cause the robot 100 to ask the purpose of the coordination of the user 10. The collection unit 2902 collects information indicating a situation (vocal sound of the user 10, an image of the user 10, and the like) of the user 10 when an event in which the user 10 desires relaxation or stress reduction has occurred. The collection part 2902 collects information indicating a situation (vocal sound of the user 10, an image of the user 10, and the like) of the user 10 when an event in which the user 10 desires tourist guidance has occurred. The collection unit 2902 collects information indicating a situation (vocal sound of the user 10, an image of the user 10, and the like) of the user 10 when an event in which the user 10 needs to support cooking has occurred. As a result, the robot 100 can recognize the emotion of the user 10 from the vocal sound, the image, and the like of the user 10.

The output control unit 2903 controls the robot 100 to execute an action corresponding to the generated event and the situation information of the user 10. In a case in which an event in which the user 10 needs to coordinate fashion has occurred, the output control unit 2903 controls the robot 100 to propose a fashion item or coordination by following the taste and the mood of the user 10, season, or a situation (for example, the purpose of going out in fashion) in addition to the body shape and the face of the user 10. The output control unit 2903 controls the robot 100 on the basis of the emotions of the user 10 to make the user 10 happy, such as by praising the user 10 by saying “It suits you” or by encouraging the user 10 by saying “Good luck in the interview”.

The output control unit 2903 controls the robot 100 to output music according to the situation of the user 10 when an event requiring relaxation or stress reduction has occurred. For example, the output control unit 2903 controls the robot 100 to output music according to the emotion and needs of the user 10. As a specific example, in a case in which the user 10 desires relaxation before going to bed, relaxation music is played while inducing sleep. The music may be existing music or may be improvised music created by music generation AI mounted on the robot 100.

The output control unit 2903 controls the robot 100 to perform an action according to the situation of the user 10 when the event in which the user 10 requests tourist guidance has occurred. For example, the output control unit 2903 controls the robot 100 to propose a recommended spot or activity according to the interest or the situation of the user 10.

The output control unit 2903 controls the robot 100 to execute an action according to the situation of the user 10 when an event in which the user 10 requires cooking support has occurred. For example, the output control unit 2903 controls the robot 100 to propose a dish or a recipe according to the situation of the user 10 (cooking skill, ingredients, time for cooking, and the like) for the purpose of the cooking skill of the user 10. In this case, the output control unit 2903 controls the robot 100 to propose a recipe or the like according to the taste or the mood of the user 10.

(Supplementary Note 1) An action control system including:
a collection unit that collects situation information indicating a situation of a user; and
an output control unit that controls a robot including a sentence generation model to make a proposal regarding coordination according to the situation information collected by the collection unit to the user.

### (Supplementary Note 2)

The action control system according to Supplementary Note 1, in which
the collection unit collects situation information regarding an emotion of the user, and
the output control unit controls the robot to make the proposal according to the emotion of the user.

### (Supplementary Note 3)

The action control system according to Supplementary Note 1, in which the output control unit controls the robot to make the proposal according to a purpose of the coordination estimated from the situation information.

### (Supplementary Note 4)

An action control system including: a collection unit that collects situation information indicating a situation of a user; and an output control unit that controls a robot including a sentence generation model to output music according to the situation information collected by the collection unit to the user.

### (Supplementary Note 5)

The action control system according to Supplementary Note 4, in which
the collection unit collects situation information regarding an emotion of the user, and
the output control unit controls the robot to output the music according to the emotion of the user.

### (Supplementary Note 6)

The action control system according to Supplementary Note 4, in which
the output control unit controls the robot to output the music according to a need of the user on the basis of the situation information.

### (Supplementary Note 7)

An action control system including:
a collection unit that collects situation information indicating a situation of a user; and
an output control unit that controls a robot including a sentence generation model to provide a user with tourist guidance according to the situation information collected by the collection unit.

### (Supplementary Note 8)

The action control system according to Supplementary Note 7, in which
the collection unit collects situation information regarding an emotion of the user, and
the output control unit controls the robot to perform the tourist guidance according to the emotion of the user.

### (Supplementary Note 9)

An action control system including: a collection unit that collects situation information indicating a situation of a user; and an output control unit that controls a robot including a sentence generation model to propose a recipe according to the situation information collected by the collection unit to the user.

### (Supplementary Note 10)

The action control system according to Supplementary Note 9, in which
the collection unit collects situation information regarding an emotion of the user, and
the output control unit controls the robot to make the proposal according to the emotion of the user.

### (Supplementary Note 11)

The action control system according to any one of Supplementary Notes 1 to 10, in which the robot is mounted on a stuffed toy, or is connected to a control target device mounted on the stuffed toy in a wireless or wired manner.

(Twenty-fourth Embodiment)

A system 10 according to the present embodiment executes processing of proposing a personal image suitable for the user 10 to the user 10. For example, the system 10 analyzes an expression, an emotion, a way of speaking, and the like of the user 10 in addition to a facial shape, a body shape, and the like of the user 10, and gives advice about fashion, makeup, a hairstyle, manners, and the like that make the user 10 look more attractive.

For example, the system 10 reads the appearance of the user 10 with a camera, a sensor, or the like, and proposes a result to the user 10 on the basis of a so-called image consulting theory (color diagnosis, skeleton diagnosis, face type diagnosis, and the like). The system 10 further takes into consideration aspirations of the user 10 such as a person he/she wants to be or his/her occupation, and features such as a loudness and a tone of the vocal sound, and expressions, and proposes a result. The system 10 reads the transition of the emotion of the user 10 from an expression or a conversation of the user 10 in response to the proposal, and makes a proposal such that the positive emotion is maximized. The system 10 adjusts the manner of proposal while watching the reaction of the user 10 to the proposal. For example, while the robot 100 is speaking the proposal content to the user 10, the impression can be changed by changing the ending of the word to “I think.”, “How about this?”, “So.”, or the like on the basis of the reaction of the user 10.

The diagnosis result acquisition unit 113 acquires a diagnosis result of the image consulting diagnosis of the user 10 who is talking with the robot 100. The image consulting diagnosis may include a color diagnosis. The image consulting diagnosis may include skeleton diagnosis. The image consulting diagnosis may include a facial type diagnosis. The image consulting diagnosis may include other diagnoses.

The diagnosis result acquisition unit 113 may perform the image consulting diagnosis by itself by using the information acquired by the information acquisition unit 122 and acquire a diagnosis result. Information necessary for performing the image consulting diagnosis may be registered in advance and stored in the storage unit 130. The diagnosis result acquisition unit 113 performs color diagnosis of the user 10, for example, by analyzing the captured image of the user 10. The diagnosis result acquisition unit 113 performs skeleton diagnosis of the user 10 by analyzing, for example, the captured image of the user 10. The diagnosis result acquisition unit 113 performs the face type diagnosis of the user 10 by analyzing, for example, the captured image of the user 10.

In a case in which an image consultant is talking with the user 10 together with the robot 100, the diagnosis result acquisition unit 113 may acquire the result of an image consulting diagnosis performed by the image consultant from the image consultant.

The user feature acquisition unit 114 acquires a user feature indicating a feature of the user 10. The user features may include a loudness of the vocal sound of the user 10. The user features may include a tone of the vocal sound of the user 10. The user features may include expressions of the user 10. The user features may include other features. The user feature acquisition unit 114 may acquire the user feature from the information acquired by the information acquisition unit 122 or the user state recognized by the state recognition unit 112.

The user wish acquisition unit 115 acquires the user wish indicating the wish content of the user 10. The user wishes may include an occupation desired by the user 10. The user wishes may include a self-image desired by the user 10. The user wishes may include other wishes.

The user wish acquisition unit 115 may acquire the user wishes from the user 10. For example, the control unit 111 causes the robot 100 to ask the user 10 about his/her wishes. For example, the user wish acquisition unit 115 acquires the user wish that has been written on the diagnostic paper by the user 10 or input to a tablet or the like.

The proposal content generation unit 117 generates a proposal content for the user 10. The proposal content generation unit 117 may generate proposal content for the user on the basis of the diagnosis result acquired by the diagnosis result acquisition unit 113, the user feature acquired by the user feature acquisition unit 114, and the user wish acquired by the user wish acquisition unit 115. The control unit 111 may cause the robot 100 to output the proposal content generated by the proposal content generation unit 117 to the user 10.

For example, the proposal content generation unit 117 generates the proposal content by inputting the diagnosis result acquired by the diagnosis result acquisition unit 113, the user feature acquired by the user feature acquisition unit 114, and the user wish acquired by the user wish acquisition unit 115 to a learning model in which the diagnosis result of the image consulting diagnosis of the user 10, the user feature of the user, and the user wish of the user 10 are input and the proposal content for the user 10 is output. The learning model may be registered in advance and stored in the storage unit 130.

The server 300 may generate the learning model. For example, the storage unit 130 stores a large number of pieces of learning data in which a proposal actually made by the image consultant for a target person, a diagnosis result of the image consulting diagnosis of the target person, a user feature of the target person, and a user wish of the target person are associated with each other. The learning execution unit 118 generates a learning model through machine learning using a plurality of pieces of learning data stored in the storage unit 130. Generating a learning model may include generating a new learning model, and may include updating an existing learning model.

The learning execution unit 118 may execute machine learning in which different weights are applied to the diagnosis result, the user feature, and the user wish to generate a learning model. As a result, it is possible to reflect the difference in the influence of the diagnosis result, the user feature, and the user wish on the proposal content in the learning, and it is possible to contribute to generating more appropriate proposal content.

The proposal content generation unit 117 may adjust the proposal content on the basis of the transition of the user emotion value of the user 10 when the control unit 111 outputs the proposal content to the user 10. For example, in a case in which the control unit 111 determines that the degree of positive has decreased or the degree of negative has increased while the robot 100 is outputting the proposal content, the proposal content generation unit 117 adjusts the proposal content such that the degree of proposal is mitigated. As a specific example, the control unit 111 adjusts a portion of the proposal content that has made an assertive expression such as “It is good to make” or “I propose making” to a soft expression such as “I think it is good to make” or “Why don't you make it?”. As a result, it is possible to prevent the user 10 from intensifying negative emotions due to too strong proposal at a stage where the user 10 is not yet interested.

For example, the proposal content generation unit 117 adjusts the proposal content on the basis of the transition of the user emotion value of the user 10 when the control unit 111 outputs the proposal content to the user 10 such that the degree of positive emotion of the user 10 increases. As a specific example, in a case in which the control unit 111 determines that the degree of positive has not changed or the degree of positive has decreased while causing the robot 100 to output the proposal content, the proposal content generation unit 117 adds explanation content for explaining how the user 10 looks more attractive by following the proposal. The explanation content corresponding to the proposal content may be registered in the storage unit 130 in advance. As a result, the degree of positive emotion of the user 10 increases, which can contribute to making a state in which the proposal is easily accepted.

The proposal content generation unit 117 may adjust the proposal content so that the degree of positive emotion of the user 10 increases further on the basis of the content of the conversation between the robot 100 and the user 10. For example, in a case in which the user 10 makes a negative statement to the proposal content while the control unit 111 is causing the robot 100 to output the proposal content, the proposal content generation unit 117 performs adjustment to change the proposal content. The proposal content generation unit 117 may monitor the transition of the user emotion value of the user 10 in a case in which the proposal is changed, and may adjust the proposal content to advance a conversation about the proposal in a case in which the degree of positive increases, and further change the proposal content in a case in which the degree of positive decreases, the emotion becomes negative, or the degree of negative increases. For example, in a case in which the user 10 makes a negative statement to the proposal content while the control unit 111 is causing the robot 100 to output the proposal content, the proposal content generation unit 117 performs adjustment to propose a plurality of candidates. In a case in which a plurality of candidates are proposed, the proposal content generation unit 117 may adjust the proposal content such that a conversation of a candidate selected by the user 10 from among the plurality of candidates is advanced. Thus, the proposal content can be adjusted such that the degree of positive emotion of the user 10 is maximized.

In a case in which there is another user listening to the conversation between the robot 100 and the user 10 as in a case in which there is a companion of the user 10, the state recognition unit 112 may recognize a user state of the another user, and the emotion determination unit 116 may specify a user emotion value of the another user. The proposal content generation unit 117 may adjust the proposal content on the basis of the transition of the user emotion value of the user 10 and the transition of the user emotion value of the another user when the control unit 111 outputs the proposal content to the user 10.

For example, the proposal content generation unit 117 does not adjust the proposal content in a case in which the degree of positive of the user 10 and another user increases or there is no change in the degree of positive while the control unit 111 is causing the robot 100 to output the proposal content, and adjusts the proposal content in a case in which the degree of positive of the user 10 and the another user decreases or the degree of negative increases. In a case in which the degree of positive of a single user 10 increases even in a case in which the degree of positive of the user 10 decreases or the degree of negative increases, the proposal content generation unit 117 may advance the proposal without adjusting the proposal content. As a result, for example, in a case in which a relatively large style change such as changing long hair to short hair is proposed to the user 10, even if the user 10 feels uneasy, in a case in which the companion feels positive, the proposal can be advanced.

The proposal content generation unit 117 may adjust the proposal content on the basis of the transition of the user emotion value of the user 10 and the transition of the emotion value of another robot 100 by using the another robot 100 as a pseudo companion of the user 10. At least some functions of the server 300 may be implemented by one or more computers. At least some functions of the server 300 may be implemented by a virtual machine. At least some functions of the server 300 may be implemented in a cloud. In the above embodiments, the robot 100 has been mainly described as an example of the electronic apparatus, but the technology of the disclosure is not limited thereto. Examples of the electronic apparatus include a smartphone, a tablet terminal, a personal computer (PC), a smart speaker, a stuffed toy, a vehicle such as an automobile or a motorcycle, and a home appliance. These are examples, and the electronic apparatus is not limited thereto.

(Supplementary Note 1) A control system including:
a diagnosis result acquisition unit that acquires a diagnosis result of image consulting diagnosis including at least any of color diagnosis, skeleton diagnosis, or face type diagnosis of a user who is talking with an electronic apparatus;
a user feature acquisition unit that acquires a user feature including at least any of a loudness of vocal sound, a tone of vocal sound, or an expression of the user;
a user wish acquisition unit that acquires a user wish including at least either of an occupation or a self-image desired by the user;
a proposal content generation unit that generates proposal content for the user on the basis of the diagnosis result, the user feature, and the user wish; and
a control unit that causes the electronic apparatus to output the proposal content to the user.

### (Supplementary Note 2)

The control system according to Supplementary Note 1, further including: a storage unit that stores learning data in which a proposal actually made by an image consultant on a target person, a diagnosis result of an image consulting diagnosis of the target person, a user feature of the target person, and a user wish of the target person are associated with each other; and a learning execution unit that generates a learning model through machine learning using a plurality of pieces of learning data, the learning model having a diagnosis result of the image consulting diagnosis of the user, the user feature of the user, and the user wish of the user as inputs, and having proposal content for the user as an output, in which
the proposal content generation unit generates the proposal content by using the learning model.

### (Supplementary Note 3)

The control system according to Supplementary Note 2, in which the learning execution unit generates the learning model by executing the machine learning in which different weights are applied to the diagnosis result, the user feature, and the user wish.

### (Supplementary Note 4)

The control system according to any one of Supplementary Notes 1 to 3, further including an emotion determination unit that determines a user emotion value indicating an emotion of the user having a conversation with the electronic apparatus, in which
the proposal content generation unit adjusts the proposal content on the basis of transition of the user emotion value of the user when the control unit is outputting the proposal content to the user.

### (Supplementary Note 5)

The control system according to Supplementary Note 4, in which the proposal content generation unit adjusts the proposal content such that a degree of positive emotion of the user increases on the basis of transition of the user emotion value of the user when the control unit is outputting the proposal content to the user.

### (Supplementary Note 6)

The control system according to Supplementary Note 4, in which the proposal content generation unit adjusts the proposal content such that a degree of positive emotion of the user increases further on the basis of content of a conversation between the electronic apparatus and the user.

### (Supplementary Note 7)

The control system according to Supplementary Note 4, in which the emotion determination unit further determines a user emotion value of another user listening to a conversation between the electronic apparatus and the user, and
the proposal content generation unit adjusts the proposal content on the basis of transition of the user emotion value of the user when the control unit is outputting the proposal content to the user and transition of the user emotion value of the another user.

### (Supplementary Note 8)

The control system according to any one of Supplementary Notes 1 to 3, further including the electronic apparatus.

### (Supplementary Note 9)

A program for causing a computer to function as the control system according to any one of Supplementary Notes 1 to 3.

The disclosure of Japanese Patent Application No. 2023-067493 filed on Apr. 17, 2023, the disclosure of Japanese Patent Application No. 2023-068821 filed on Apr. 19, 2023, the disclosure of Japanese Patent Application No. 2023-068822 filed on Apr. 19, 2023, the disclosure of Japanese Patent Application No. 2023-070468 filed on Apr. 21, 2023, the disclosure of Japanese Patent Application No. 2023-069436 filed on Apr. 20, 2023, the disclosure of Japanese Patent Application No. 2023-067248 filed on Apr. 17, 2023, the disclosure of Japanese Patent Application No. 2023-064495 filed on Apr. 11, 2023, the disclosure of Japanese Patent Application No. 2023-068146 filed on Apr. 18, 2023, the disclosure of Japanese Patent Application No. 2023-069667 filed on Apr. 20, 2023, the disclosure of Japanese Patent Application No. 2023-070471 filed on Apr. 21, 2023, the disclosure of Japanese Patent Application No. 2023-068147 filed on Apr. 18, 2023, the disclosure of Japanese Patent Application No. 2023-072216 filed on Apr. 26, 2023, the disclosure of Japanese Patent Application No. 2023-073207 filed on Apr. 27, 2023, the disclosure of Japanese Patent Application No. 2023-074132 filed on Apr. 28, 2023, the disclosure of Japanese Patent Application No. 2023-072763 filed on Apr. 26, 2023, the disclosure of Japanese Patent Application No. 2023-072764 filed on Apr. 26, 2023, the disclosure of Japanese Patent Application No. 2023-073825 filed on Apr. 27, 2023, the disclosure of Japanese Patent Application No. 2023-078822 filed on May 11, 2023, the disclosure of Japanese Patent Application No. 2023-120322 filed on Jul. 24, 2023, the disclosure of Japanese Patent Application No. 2023-126495 filed on Aug. 2, 2023, the disclosure of Japanese Patent Application No. 2023-071853 filed on Apr. 25, 2023, the disclosure of Japanese Patent Application No. 2023-075226 filed on Apr. 28, 2023, the disclosure of Japanese Patent Application No. 2023-075227 filed on Apr. 28, 2023, the disclosure of Japanese Patent Application No. 2023-079461 filed on May 12, 2023, the disclosure of Japanese Patent Application No. 2023-079466 filed on May 12, 2023, the disclosure of Japanese Patent Application No. 2023-080316 filed on May 15, 2023, the disclosure of Japanese Patent Application No. 2023-081013 filed on May 16, 2023, the disclosure of Japanese Patent Application No. 2023-083427 filed on May 19, 2023, the disclosure of Japanese Patent Application No. 2023-083428 filed on May 19, 2023, the disclosure of Japanese Patent Application No. 2023-079679 filed on May 12, 2023, the disclosures of which are incorporated herein by reference in their entireties.

### DESCRIPTION OF REFERENCE NUMERALS

5 System
10, 11, 12 User
20 Communication network
100, 100N, 101, 102 Robot
200 Sensor unit
201 Microphone
202 Depth sensor
203 Camera
204 Distance sensor
210 Sensor module unit
211 Vocal sound emotion recognition unit
212 Speech understanding unit
213 Expression recognition unit
214 Face recognition unit
220 Storage unit
22 Reaction rule
221A Action determination model
2222 History data
230 State recognition unit
230 State recognition unit
232 Emotion determination unit
234 Action recognition unit
236 Action determination unit
238 Storage control unit
250 Action control unit
252 Control target
270 Related information collection unit
280 Communication processing unit
300 Server
500 Agent system
1200 Computer
1210 Host controller
1212 CPU
1214 RAM
1216 Graphic controller
1218 Display device
1220 Input/output controller
1222 Communication interface
1224 Storage device
1226 DVD drive
1227 DVD-ROM
1230 ROM
1240 Input/output chip

1. An action control system comprising:
a memory; and
a processor coupled to the memory,
the processor being configured to:
determine an emotion of a user or an emotion of a robot; and
generate action content of the robot with respect to an action of the user and the emotion of the user or the emotion of the robot based on an interaction function of allowing the user and the robot to interact with each other, and determine an action of the robot corresponding to the action content, wherein
the processor is further configured to:
image a competition space in which a specific competition can be performed, and
analyze emotions of a plurality of competitors performing a competition in the competition space, and
determine an action of the robot based on an analysis result.

2. The action control system according to claim 1, wherein the processor analyzes an emotion of a competitor belonging to a specific team among the plurality of competitors.

3. The action control system according to claim 1, wherein
the robot is mounted on a stuffed toy or is connected to a control target device mounted on the stuffed toy in either a wireless or wired manner.

4. An action control system comprising:
a memory; and
a processor coupled to the memory,
the processor being configured to:
determine an emotion of a user or an emotion of a robot; and
generate action content of the robot with respect to an action of the user and the emotion of the user or the emotion of the robot on the basis of a sentence generation model having an interaction function of allowing the user and the robot to interact with each other, and determine an action of the robot corresponding to the action content, wherein
the processor is further configured to:
image a competition space in which a specific competition can be performed, and
specify features of a plurality of competitors performing a competition in the competition space, and
determine an action of the robot based on a specified result.

5. An action control system comprising:
a memory; and
a processor coupled to the memory,
the processor being configured to:
determine an emotion of a user or an emotion of a robot; and
generate action content of the robot with respect to an action of the user and the emotion of the user or the emotion of the robot based on a sentence generation model having an interaction function of allowing the user and the robot to interact with each other, and determine an action of the robot corresponding to the action content, wherein
when the processor is activated at a predetermined time, the processor adds a fixed sentence for giving an instruction for summarizing a history of a previous day to text representing history data of the previous day, inputs the text to the sentence generation model to acquire a summary of the history of the previous day, and speaks the content of the acquired summary.

6.-32. (canceled)

33. The action control system according to claim 2, wherein
the robot is mounted on a stuffed toy or is connected to a control target device mounted on the stuffed toy in either a wireless or wired manner.
